(19) United States
(12) Patent Application Publication
(10) Pub. No.: US 2014/0153489 A1
(43) Pub. Date: Jun. 5, 2014

(54) Methods, Apparatus and Systems for Inter-Converged Gateway (ICGW) Communications

(71) Applicants: Michelle Perras, Montreal (CA); John Cartmell, North Massapequa, NY (US); Bartosz Balazinski, Montreal (CA); Juan Carlos Zuniga, Ville St. Laurent (CA)

(72) Inventors: Michelle Perras, Montreal (CA); John Cartmell, North Massapequa, NY (US); Bartosz Balazinski, Montreal (CA); Juan Carlos Zuniga, Ville St. Laurent (CA)

(73) Assignee: INTERDIGITAL PATENT HOLDINGS, INC., Wilmington, DE (US)

(21) Appl. No.: 14/123,509

(22) PCT Filed: Jun. 1, 2012
(86) PCT No.: PCT/US2012/040555

§ 371 Date: Feb. 19, 2014

Related U.S. Application Data
(60) Provisional application No. 61/492,635, filed on Jun. 2, 2011.
(60) Provisional application No. 61/506,395, filed on Jul. 11, 2011.

(51) Int. Cl. H04W 8/00

(52) U.S. Cl. CPC H04W 8/005
USPC 370/328

(57) ABSTRACT

User equipment (UE) may include dual mode devices that enable two different radio access technologies (RATs) for connection to wireless communication networks. Recently, these RATs have been used for message splitting in which a message is split into two packet flows, for example, that may enable increased throughput to the (UE). Dynamic mobility management may be provided for the UE by allowing a converged gateway (CGW) to discover the UE. For example, the CGW may identify the UE in communication a first CGW that may be within a first subnet. The CGW may store the identity of the WTRU in the memory. The CGW may transmit the identity of the UE to a second CGW that may be in communication with a second subnet.

### CROSS REFERENCE TO RELATED APPLICATIONS

This application claims the benefit of U.S. Provisional Application No. 61/492,635 filed on Jun. 2, 2011, and U.S. Provisional Application No. 61/506,395 filed on Jul. 11, 2012, which are incorporated by reference as if fully set forth herein.

### BACKGROUND

User equipment (UE) may include dual mode devices that may enable two different radio access technologies (RATs) for connection to wireless communication networks. These RATs may be used for data splitting in which data may be into two packet flows, for example, that may enable increased throughput to the (UE).

### SUMMARY

Embodiments of the disclosure are directed to methods, devices, and systems for managing UE flow discovery associated with a plurality of flows of split messages served by a plurality of flow regulating devices on a network. One representative method may include flow regulating device. The flow regulating device may receive, via a first radio access technology (RAT) interface, registration information indicating that the UE is being served by the first RAT interface. The flow regulating device may receive, via a second RAT interface, further registration information indicating that the UE is being served by the second RAT interface. The flow regulating device may store storing binding information from the information received from the first and second RAT interfaces that may indicate the UE may be simultaneously being served by the first and second RAT interfaces. The flow regulating device may receive at least one data flow from the first RAT interface, as a first RAT flow, and at least one further data flow from the second RAT interface, as a second RAT flow. The flow regulating device may control aggregation of the first and second RAT flows.

A converged gateway (CGW) may be used for discovering a wireless transmit/receive unit (WTRU) in a communication network. The CGW may comprise a memory and a processor. The processor may be configured to identify a WTRU that may be in communication with a network node belonging to a first subnet. The processor may be configured to store the identity of the WTRU in the memory. The processor may be configured to transmit the identity of the WTRU to another CGW that is in communication with a second subnet.

A CGW may be used for discovering a WTRU in a communication network. The CGW may comprise a memory and a processor. The processor may be configured to identify a first connection that may allow a WTRU to communicate with a first subnet. The processor may be configured to identify a second connection that may allow the WTRU to communicate with a second subnet. The processor may be configured to associate the identity of the WTRU with the first connection and the second connection such that the CGW may be able to transmit data to the WTRU using the first connection or the second connection.

Dynamic mobility management may be provided for the UE by allowing a converged gateway (CGW) to discover the UE. For example, the CGW may identify the UE in communication a first CGW that may be within a first subnet. The CGW may store the identity of the WTRU in the memory. The CGW may transmit the identity of the UE to a second CGW that may be in communication with a second subnet.

Dynamic mobility management may be provided by discovering a WTRU in a network. A WTRU may be identified in communication with a first subnet. The identity of the WTRU may be stored. The identity of the WTRU may be transmitted to a first CGW that may be in communication with a second subnet.

Distributed CGW architecture may be provided that may a protocol, such as PMIP protocol, Evolved General Packet Radio Service (GPRS) Tunneling Protocol (GTP), or the like, to provide inter-CGW communication. For example, PMIP, GTP, or the like may be used to enable support for multiple CGWs while providing IP Flow Mobility (IFOM) capabilities (and/or Logical Interface LIF-based support of IFOM). This may be done, for example, to provide support for DMM. The usage of PMIP, GTP, or other such protocols may support communication between CGWs (e.g., inter-CGW communication) to support UEs that may attach to different CGWs. For example, simultaneous connections with different RATs may occur and may allow for data splitting.

The Summary is provided to introduce a selection of concepts in a simplified form that are further described below in the Detailed Description. This Summary is not intended to identify key features or essential features of the claimed subject matter, not is it intended to be used to limit the scope of the claimed subject matter. Furthermore, the claimed subject matter is not limited to any limitations that solve any or all disadvantages noted in any part of this disclosure.

### BRIEF DESCRIPTION OF THE DRAWINGS

A more detailed understanding may be had from the following description, given by way of example in conjunction with the accompanying drawings.

FIG. 1A depicts a system diagram of an example communications system in which one or more disclosed embodiments may be implemented.

FIG. 1B depicts a system diagram of an example wireless transmit/receive unit (WTRU) that may be used within the communications system illustrated in FIG. 1A.

FIG. 1C depicts a system diagram of an example radio access network and an example core network that may be used within the communications system illustrated in FIG. 1A.

FIG. 1D depicts a system diagram of an example radio access network and an example core network that may be used within the communications system illustrated in FIG. 1A.

FIG. 1E depicts a system diagram of an example radio access network and an example core network that may be used within the communications system illustrated in FIG. 1A.

FIG. 2 is an exemplary illustration of a procedure for CGW initialization.

FIG. 3 is an exemplary illustration of a procedure for HNB initialization.

FIG. 4 is an exemplary illustration of a procedure for LGW initialization.

FIG. 5 is an exemplary illustration of a procedure a IMS client initialization.

FIG. 6 is an exemplary illustration of a LGW registration.

FIG. 7 is an exemplary illustration of a proxy call session control function (PCSCF) discovery procedure.

FIG. 8 is an exemplary illustration of a IMS registration procedure.

FIG. 9 is an exemplary illustration of a procedure for subscription to ‘reg’ Event state.

FIG. 10 is an exemplary illustration of a procedure for device registration.

FIG. 11 is an exemplary illustration of a procedure for UE registration (NON CSG UE).

FIG. 12 is an exemplary illustration of a procedure for UE registration (CSG UE).

FIG. 13 is an exemplary illustration of a procedure for a UE attached to its home LGW and accessing a device on its home network.

FIG. 14 is an exemplary illustration of a procedure for a LIPA path setup and data transfer.

FIG. 15 is an exemplary illustration of a procedure for a UE that goes into IDLE state while preserving its PDP context.

FIG. 16 is an exemplary illustration of a procedure for a UE previously attached to its home LGW and the network initiates a data transfer.

FIG. 17 is an exemplary illustration of a procedure for PDP context creation.

FIG. 18 is an exemplary illustration of a procedure for RAB setup and user plane tunnel establishment for one tunnel.

FIG. 19 is an exemplary illustration of a procedure for RAB setup and user plane tunnel establishment for two tunnels.

FIG. 20 is an exemplary illustration of a procedure for RAB release and PDP context preservation.

FIG. 21 is an exemplary illustration of a procedure for Iu release and PDP context preservation.

FIG. 22 is an exemplary illustration of a procedure for a UE attached to a neighbor's HNB accessing a device on the UE's home network.

FIG. 23 is an exemplary illustration of a procedure for ELIPA path setup and data transfer.

FIG. 24 is an exemplary illustration of a procedure for an attached UE going into IDLE state while its PDP context is preserved.

FIG. 25 is an illustration of a procedure for a UE previously attached to its home LGW and a network initiated data transfer.

FIG. 26 is an exemplary illustration of a procedure for PDP context creation.

FIG. 27 is an exemplary illustration of a RAB setup and user plane establishment with one tunnel.

FIG. 28 is an exemplary illustration of a RAB setup and user plane tunnel with two tunnel establishment.

FIG. 29 is an exemplary illustration of a procedure for RAB release and PDP context preservation.

FIG. 30 is an exemplary illustration of a Iu release and PDP context preservation.

FIG. 31 is an exemplary illustration of a procedure for a UE moving to a neighbor's HNB after attachment to the UE's home LGW and the UE accessing a device in its home network.

FIG. 32 is an exemplary illustration of a procedure for a UE moving to its home node B while attached to a neighbor's HNB.

FIG. 33 is an exemplary illustration of a procedure wherein a UE attached to its home HNB moves to a macro network.

FIG. 34 is an exemplary illustration of a procedure wherein a UE attached to a macro network moves to its home network.

FIG. 35A is an exemplary illustration of a procedure for intra HNBGW mobility (LIPA to ELIPA).

FIG. 35B is an exemplary illustration of a procedure for intra HNBGW mobility (LIPA to ELIPA), wherein FIG. 35B is a continuation of 35A.

FIG. 36A is an exemplary illustration of a procedure of a UE accessing a home device and moving to a macro network (LIPA to MRA).

FIG. 36B is an exemplary illustration of a procedure a UE accessing a home device and moving to a macro network (LIPA to MRA), wherein FIG. 36B is a continuation of FIG. 36A.

FIG. 37 A is an exemplary illustration of a procedure for a UE accessing a home device via a macro network and moving to a femto network (MRA to LIPA).

FIG. 37B is an exemplary illustration of a procedure for a UE accessing a home device via a macro network and moving to a femto network (MRA to LIPA), wherein FIG. 37B is a continuation of FIG. 37 A.

FIG. 38 is an exemplary illustration of a procedure for the establishment of data services between a UE and core network.

FIG. 39 is an exemplary illustration of a procedure for the mobility of a UE connected to one HNB to a neighbor's home network, wherein the neighbor is connected to another HNB.

FIG. 40 is an exemplary illustration of a procedure for BWM initialization.

FIG. 41 is an exemplary illustration of a procedure for CGW initialization in the presence of BWM.

FIG. 42 is an exemplary illustration of a procedure for HNB registration.

FIG. 43 is an exemplary illustration of UE registration (Non closed subscriber group (CSG) UE).

FIG. 44 is an exemplary illustration of UE registration for a CSG UE.

FIG. 45 is an exemplary illustration of packet switched (PS) data services establishment.

FIG. 46 is an exemplary illustration of cellular PDP context establishment.

FIG. 47 A is an exemplary illustration of procedures for intra HNB GW mobility (LIPA to ELIPA).

FIG. 47B is an exemplary illustration of procedures for intra HNB GW mobility (LIPA to ELIPA), wherein FIG. 47B is a continuation of FIG. 47A.

FIG. 48 is an exemplary illustration of IKE IPSec procedures between BWM and SeGW.

FIG. 49 is an exemplary illustration of procedures for RAB Setup and user plane establishment with one tunnel establishment.

FIG. 50 is an exemplary illustration of procedures for RAB setup and user plane tunnel establishment with two tunnel establishment.

FIG. 51 is an exemplary illustration of an architecture of a CGW Hybrid Network.

FIG. 52 is an exemplary illustration of architecture of a CGW Hybrid Network.

FIG. 53 is an exemplary block diagram that illustrates the high-level architecture of a Converged Gateway.

FIG. 54 is an exemplary illustration of a network layout including a BWM system.

FIG. 55 is an exemplary illustration of an enterprise implementation of BWM.

FIG. 56 is an exemplary illustration of a downlink data flow in an implementation of BWM.

FIG. 57 is an exemplary illustration of a uplink data flow in an implementation of BWM.

FIG. 58 is an exemplary illustration of a downlink cellular data flow that does not use BWM.

FIG. 59 is an exemplary illustration of a downlink data flow across BWM entities with mobility.

FIG. 60 is an exemplary illustration of an uplink cellular data flow that does not use BWM.

FIG. 61 is an exemplary illustration of an uplink data flow across BWM entities with mobility.

FIG. 62 is an exemplary illustration of an enterprise scenario with no BWM server.

FIG. 63 is an exemplary illustration of an enterprise scenario with one BWM server.

FIG. 64 is an exemplary illustration of an enterprise scenario with multiple BWM servers.

FIG. 65 is an exemplary illustration of a data path layer topology with no BWM server.

FIG. 66 is an exemplary illustration of a control path layer topology with no BWM server.

FIG. 67 is an exemplary illustration of a data path layer topology with a BWM server.

FIG. 68 is an exemplary illustration of a topology with a BWM server.

FIG. 69 is an exemplary illustration of protocol stack with BWM.

FIG. 70A is an exemplary illustration of a data protocol without BWM implemented.

FIG. 70B is an exemplary illustration of a data protocol with BWM.

FIG. 71A is an exemplary illustration of a data protocol with BWM.

FIG. 71B is an exemplary illustration of a data protocol with BWM.

FIG. 72 is an exemplary illustration of a BWM server sitting between the CN and RAN portions of the HNB.

FIG. 73 is an exemplary illustration of a BWM server sitting between the HNB and the SeGW of the MCN.

FIG. 74 is an exemplary illustration of a BWM server sitting somewhere on the Internet.

FIG. 75 is an exemplary illustration of a BWM server sitting somewhere on the Internet.

FIG. 76A is an exemplary illustration of BWM implemented in a selected IP traffic offload (SIPTO) network configuration.

FIG. 76B is an exemplary illustration of BWM implemented in an extended local internet protocol (ELIP A) network configuration.

FIG. 77 depicts a communication network that may use one CGW per subnet.

FIG. 78 depicts a communication network that may use one CGW for multiple subnets.

FIG. 79 depicts a communication network that may use CGWs in a hierarchy.

FIG. 80 depicts a communication network that may use one CGW per subnet.

FIG. 81 depicts a communication network that may use one CGW for multiple subnets.

FIG. 82 depicts a communication network may use CGWs in a hierarchy.

FIG. 83 depicts a method for UE discovery using a communication network.

FIG. 84 depicts another method for UE discovery using a communication network.

FIG. 85 depicts another method for UE discovery using a communication network.

FIG. 86 depicts another method for UE discovery using a communication network.

FIG. 87 depicts another method for UE discovery using a communication network.

FIG. 88 depicts another method for UE discovery using a communication network.

FIG. 88 depicts another method for UE discovery using a communication network.

FIG. 89 depicts another method for UE discovery using a communication network.

FIG. 90 depicts a communication network that may use CGWs that may use PMIP to provide inter-CGW communication.

FIG. 91 depicts another method for UE discovering using a communication network, such as the network depicts in FIG. 90.

FIG. 92 depicts another method for UE discovering using a communication network, such as the network depicts in FIG. 90.

FIG. 93 depicts another communication network that may use CGWs that may use PMIP to provide inter-CGW communication.

FIG. 94 depicts another method for UE discovery using a communication network that may use PMIP to provide inter-CGW communication.

FIG. 95 depicts another method for UE discovery using a communication network that may use PMIP to provide inter-CGW communication.

FIG. 96 depicts another method for flow mobility using a communication network that may use PMIP to provide inter-CGW communication.

FIG. 97 depicts a communication network with access points (AP) that may include MAGs.

FIG. 98 depicts a communication network that may include a Local Mobility Anchor (LMA) node.

FIG. 99 depicts a communication network that may include one or more LMAs.

FIG. 100 depicts a communication network that may use an external CGW with a common LMA.

FIG. 101 depicts a communication network with APs that may include MAGs and a common LMA.

### DETAILED DESCRIPTION

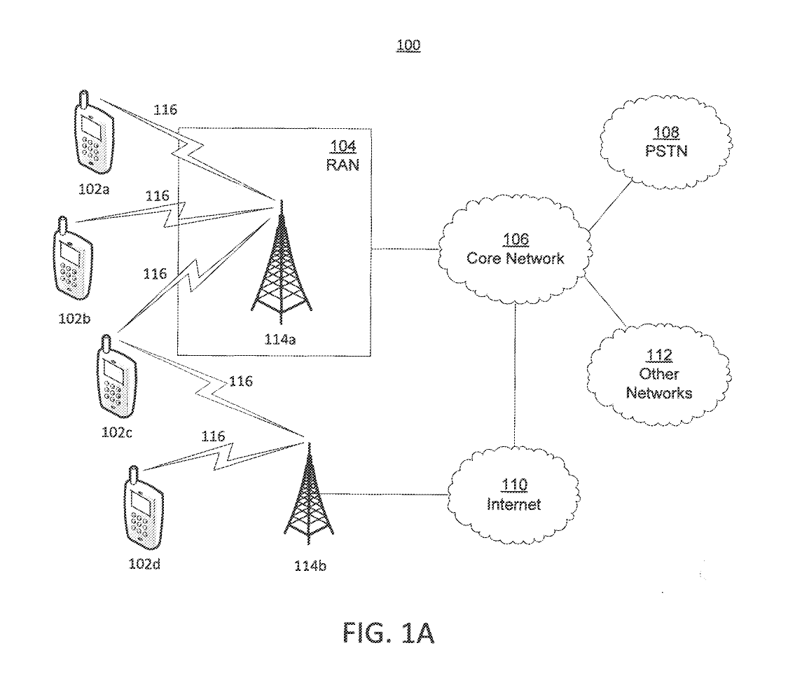

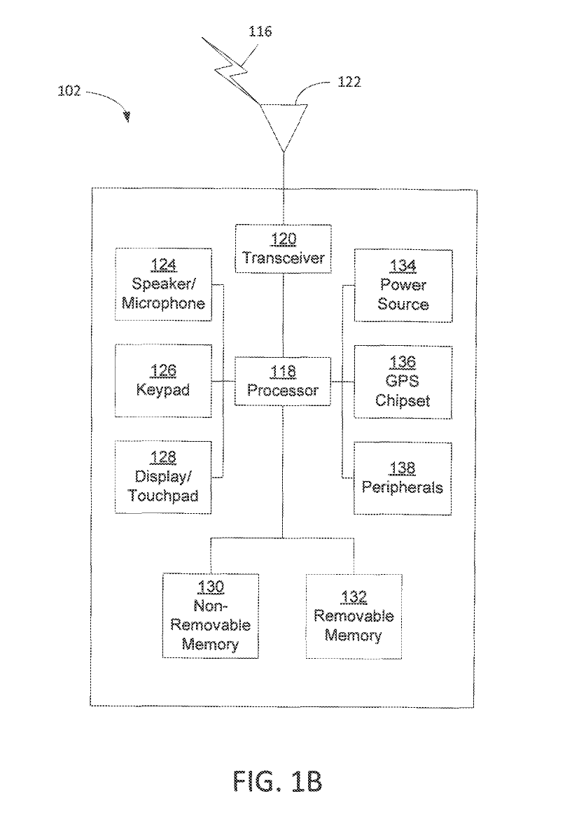

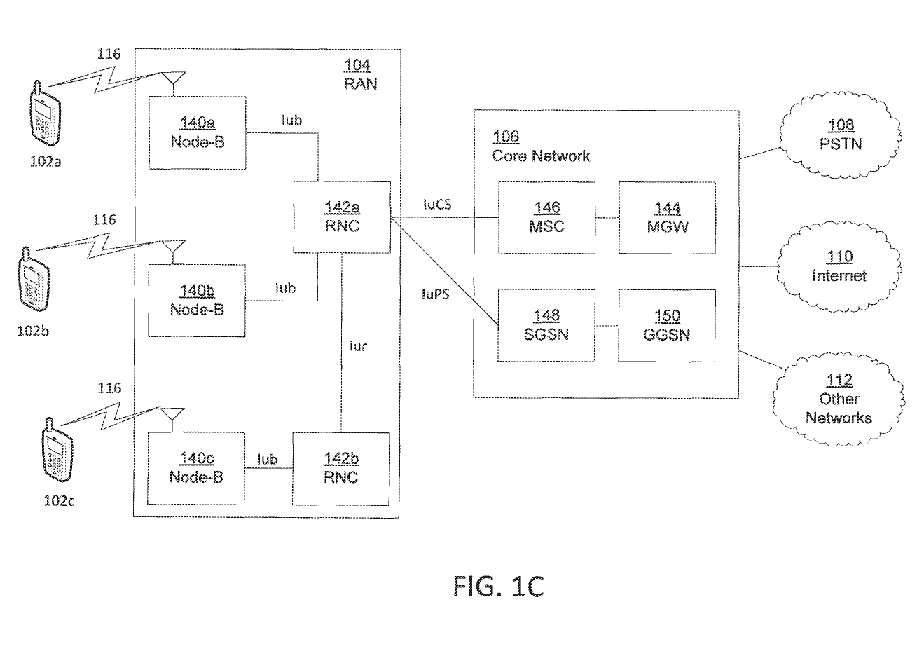

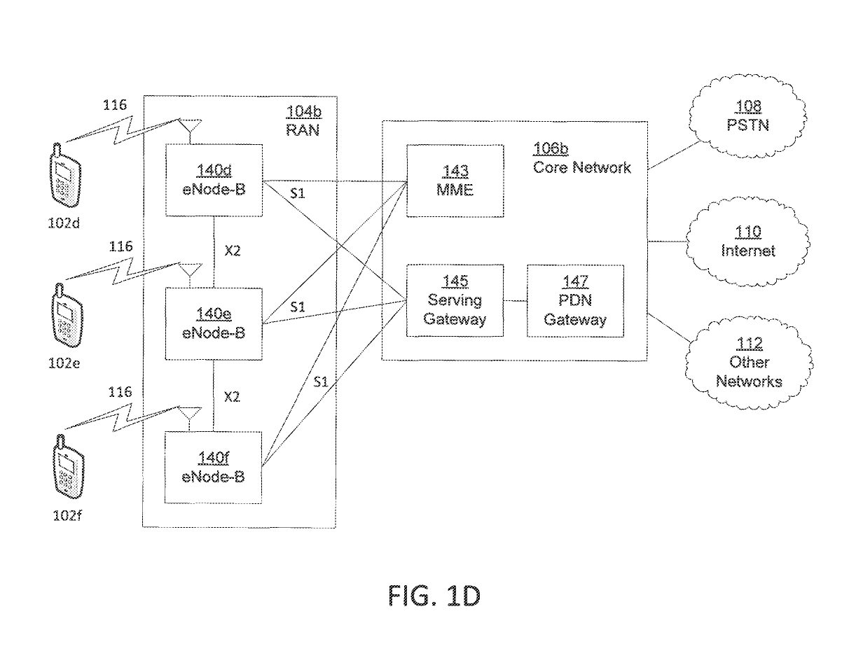

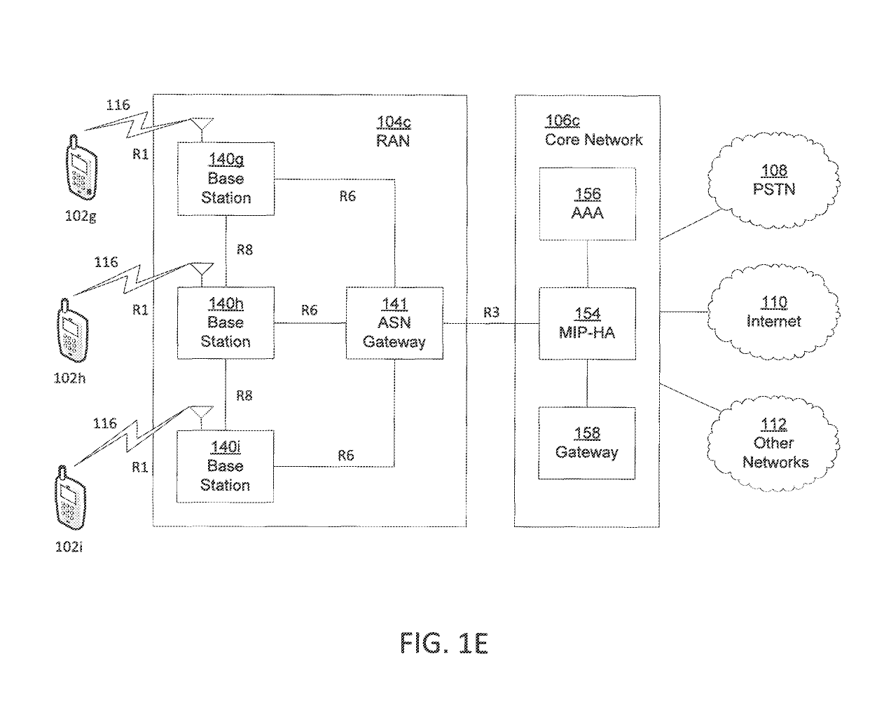

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106a according to an embodiment. As noted above, the RAN 104 may employ a UTRA radio technology to communicate with the WTRUs 102a, 102b, 102c over the air interface 116. The RAN 104 may also be in communication with the core network 106a. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. It will be appreciated that the RAN 104 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106a shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106a, it will be appreciated that any one of these elements may be owned and/or operated by an entity other than the core network operator.

The RNC 142a in the RAN 104 may be connected to the MSC 146 in the core network 106a via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106a via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106a may also be connected to the networks 112, which may include other wired or wireless networks that are owned and/or operated by other service providers.

FIG. 1D is a system diagram of the RAN 104b and the core network 106b according to an embodiment. As noted above, the RAN 104b may employ an E-UTRA radio technology to communicate with the WTRUs 102d, 102e, 102f over the air interface 116. The RAN 104 may also be in communication with the core network 106b.

The RAN 104 may include eNode-Bs 140d, 140e, 140f, though it will be appreciated that the RAN 104 may include any number of eNode-Bs while remaining consistent with an embodiment. The eNode-Bs 140d, 140e, 140f may each include one or more transceivers for communicating with the WTRUs 102d, 102e, 102f over the air interface 116. In one embodiment, the eNode-Bs 140d, 140e, 140f may implement MIMO technology. Thus, the eNode-B 140d, for example, may use multiple antennas to transmit wireless signals to, and receive wireless signals from, the WTRU 102d.

Each of the eNode-Bs 140d, 140e, 140f may be associated with a particular cell (not shown) and may be configured to handle radio resource management decisions, handover decisions, scheduling of users in the uplink and/or downlink, and the like. As shown in FIG. 1D, the eNode-Bs 140d, 140e, 140f may communicate with one another over an X2 interface.

The core network 106b shown in FIG. 1D may include a mobility management gateway (MME) 143, a serving gateway 145, and a packet data network (PDN) gateway 147. While each of the foregoing elements are depicted as part of the core network 106b, it will be appreciated that any one of these elements may be owned and/or operated by an entity other than the core network operator.

The MME 143 may be connected to each of the eNode-Bs 140d, 140e, 140f in the RAN 104b via an Si interface and may serve as a control node. For example, the MME 143 may be responsible for authenticating users of the WTRUs 102d, 102e, 102f, bearer activation/deactivation, selecting a particular serving gateway during an initial attach of the WTRUs 102d, 102e, 102f, and the like. The MME 143 may also provide a control plane function for switching between the RAN 104b and other RANs (not shown) that employ other radio technologies, such as GSM or WCDMA.

The serving gateway 145 may be connected to each of the eNode Bs 140d, 140e, 140f in the RAN 104b via the Si interface. The serving gateway 145 may generally route and forward user data packets to/from the WTRUs 102d, 102e, 102f. The serving gateway 145 may also perform other functions, such as anchoring user planes during inter-eNode B handovers, triggering paging when downlink data is available for the WTRUs 102d, 102e, 102f, managing and storing contexts of the WTRUs 102d, 102e, 102f, and the like.

The serving gateway 145 may also be connected to the PDN gateway 147, which may provide the WTRUs 102d, 102e, 102f with access to packet-switched networks, such as the Internet 110, to facilitate communications between the WTRUs 102d, 102e, 102f and IP-enabled devices.

The core network 106b may facilitate communications with other networks. For example, the core network 106b may provide the WTRUs 102d, 102e, 102f with access to circuit-switched networks, such as the PSTN 108, to facilitate communications between the WTRUs 102d, 102e, 102f and traditional land-line communications devices. For example, the core network 106b may include, or may communicate with, an IP gateway (e.g., an IP multimedia subsystem (IMS) server) that serves as an interface between the core network 106b and the PSTN 108. In addition, the core network 106b may provide the WTRUs 102d, 102e, 102f with access to the networks 112, which may include other wired or wireless networks that are owned and/or operated by other service providers.

FIG. 1E is a system diagram of the RAN 104c and the core network 106c according to an embodiment. The RAN 104c may be an access service network (ASN) that employs IEEE 802.16 radio technology to communicate with the WTRUs 102g, 102h, 102i over the air interface 116. As will be further discussed below, the communication links between the different functional entities of the WTRUs 102g, 102h, 102i, the RAN 104c, and the core network 106c may be defined as reference points.

As shown in FIG. 1E, the RAN 104c may include base stations 140g, 140h, 140i, and an ASN gateway 141, though it will be appreciated that the RAN 104 may include any number of base stations and ASN gateways while remaining consistent with an embodiment. The base stations 140g, 140h, 140i may each be associated with a particular cell (not shown) in the RAN 104c and may each include one or more transceivers for communicating with the WTRUs 102g, 102h, 102i over the air interface 116. In one embodiment, the base stations 140g, 140h, 140i may implement MIMO technology. Thus, the base station 140g, for example, may use multiple antennas to transmit wireless signals to, and receive wireless signals from, the WTRU 102g. The base stations 140g, 140h, 140i may also provide mobility management functions, such as handoff triggering, tunnel establishment, radio resource management, traffic classification, quality of service (QoS) policy enforcement, and the like. The ASN Gateway 141 may serve as a traffic aggregation point and may be responsible for paging, caching of subscriber profiles, routing to the core network 106c, and the like.

The air interface 116 between the WTRUs 102g, 102h, 102i and the RAN 104c may be defined as an R1 reference point that implements the IEEE 802.16 specification. In addition, each of the WTRUs 102g, 102h, 102i may establish a logical interface (not shown) with the core network 106c. The logical interface between the WTRUs 102g, 102h, 102i and the core network 106c may be defined as an R2 reference point, which may be used for authentication, authorization, IP host configuration management, and/or mobility management.

The communication link between each of the base stations 140g, 140h, 140i may be defined as an R8 reference point that includes protocols for facilitating WTRU handovers and the transfer of data between base stations. The communication link between the base stations 140g, 140h, 140i and the ASN gateway 141 may be defined as an R6 reference point. The R6 reference point may include protocols for facilitating mobility management based on mobility events associated with each of the WTRUs 102g, 102h, 100i.

As shown in FIG. 1E, the RAN 104 may be connected to the core network 106c. The communication link between the RAN 104c and the core network 106c may defined as an R3 reference point that includes protocols for facilitating data transfer and mobility management capabilities, for example. The core network 106c may include a mobile IP home agent (MIP-HA) 144, an authentication, authorization, accounting (AAA) server 156, and a gateway 158. While each of the foregoing elements are depicted as part of the core network 106c, it will be appreciated that any one of these elements may be owned and/or operated by an entity other than the core network operator.

The MIP-HA may be responsible for IP address management, and may enable the WTRUs 102g, 102h, 102i to roam between different ASNs and/or different core networks. The MIP-HA 154 may provide the WTRUs 102g, 102h, 102i with access to packet-switched networks, such as the Internet 110, to facilitate communications between the WTRUs 102g, 102h, 102i and IP-enabled devices. The AAA server 156 may be responsible for user authentication and for supporting user services. The gateway 158 may facilitate interworking with other networks. For example, the gateway 158 may provide the WTRUs 102g, 102h, 102i with access to circuit-switched networks, such as the PSTN 108, to facilitate communications between the WTRUs 102g, 102h, 102i and traditional landline communications devices. In addition, the gateway 158 may provide the WTRUs 102g, 102h, 102i with access to the networks 112, which may include other wired or wireless networks that are owned and/or operated by other service providers.

Although not shown in FIG. 1E, it will be appreciated that the RAN 104c may be connected to other ASNs and the core network 106c may be connected to other core networks. The communication link between the RAN 104c the other ASNs may be defined as an R4 reference point, which may include protocols for coordinating the mobility of the WTRUs 102g, 102h, 102i between the RAN 104c and the other ASNs. The communication link between the core network 106c and the other core networks may be defined as an R5 reference, which may include protocols for facilitating interworking between home core networks and visited core networks.

New capabilities may include HNB support for a large number of machine-to-machine (M2M) devices and/or M2M gateways, coordinated multi-RAT delivery of multimedia data, including simultaneous multi-RAT connections, and interconnection of neighboring HNBs to form a neighborhood-area or enterprise-area network, which may facilitate local P2P communications including access to locally cached content.

The new capabilities may also include the interface between a HNB and a wireless access in vehicular environments (WAVE)-enabled vehicle. Such interfaces may assist in session continuity for the users within the vehicle when the users arrive or leave home and the transfer of vehicular data to a network.

The following are examples of service requirements that may be supported by the CGW Hybrid Network Architecture: (1) simplified deployment and operation, including auto configuration; (2) WTRU services (e.g., all WTRU services) as provided by cellular network operators, including mobility to/from macro-cells, support for IMS and/or M2M gateways, among other; (3) local device communication with signaling, and data through the CGW; (4) local device communication with signaling through the CGW, and data through peer-to-peer (P2P) connections between local devices; (5) local IP access from WTRU to the home network; (6) remote access from WTRU to the home network; (7) extension of public warning system to the home network; and/or (8) extension of cellular network television service (e.g., multimedia broadcast multicast services including bandwidth management to the home network).

Examples of access requirements that may be supported by the CGW Hybrid Network Architecture include support for: (1) IP-based broadband backhaul towards cellular operator core network; (2) closed, open, and hybrid subscriber groups for cellular and WLAN access; (3) UMTS air interface, including support for legacy terminals; (4) LTE/LTE-A air interface; (5) 802.1 I-based WLAN air interface, including support for legacy terminals and 802.11 p WAVE devices; (6) M2M using cellular/WLAN interface/gateway, and/or directly via alternate M2M interface such as ZigBee and/or Bluetooth, among others; (7) inter-RAT and/or interHNB access/service transfer; (8) Multi-RAT access/service; and/or (9) local admission control and/or local resource control.

The CGW may include the following elements: (1) initialization of CGW components including 3GPP HNB, Local GW, IEEE 802.11 AP, IEEE 802.15.4 WPAN, RF Sensing Module, and/or M2M GW, as well as CGW applications including Dynamic Spectrum Management (DSM); (2) registration of CGW components with external operator network(s) and/or service provider(s), including support for IMS and non-IMS services, and/or external M2M servers, among others; (3) local IP access (LIPA) between WTRU and the residential/enterprise network via the CGW; (4) selected IP traffic offload (SIPTO) via the CGW; (5) access to local and mobile core operator (MCN) services via bandwidth management enhanced CGW; (6) idle and/or active mobility from HNB-to-HNB, HNB-to-macrocell, and macrocell-to-HNB; (7) proactive interference management (pIM) for Assisted Self Organizing Networks (SON); and/or (8) M2M Gateway functionality, among others.

Various IP addressing formats may be used. In certain exemplary embodiments, the gateway may be designed to conform to IPv4 addressing, in either a static or a dynamic addressing mode. For example, the gateway may obtain a public IP address from an ISP DHCP server, private IP addresses from a local DHCP server within the gateway, and private IP addresses from a remote DHCP server in the MCN. The gateway may also incorporate NAT functionality to translate between the publicly routable ISP-assigned IP address and the private gateway-assigned local IP addresses.

IEEE 802.15.4 Wireless Personal Area Network (WPAN) devices interacting with the gateway via a WP AN Coordinator (WP AN-C) may be “auto-configured” with IPv6 addresses with assistance from the WPAN-C. WPAN devices may be auto-configured based on their MAC addresses and an IPv6 network prefix provided by an IPv6 routing function in the WPAN Coordinator. The HNB functionality in the CGW may be selected to be fully compliant with UMTS HNB standards, and may support IPSec tunnel establishment with the MCN via the Internet.

It is contemplated that other mobile telecommunication technologies such as LTE, LTE-A. SGSN, HNBGW, HNB, and/or LGW may support tunnel (e.g., direct tunnel) functionality. For example, direct tunneling between the LGW and the RAN in the connected mode is disclosed herein. A direct tunnel approach may define procedures for establishing a direct tunnel between the RNC and the GGSN. In certain exemplary embodiments, an HNB may function similar to an RNC and/or an LGW may function similar to a GGSN to an SGSN to allow the SGSN to setup a tunnel. The LGW may perform the same or similar functions as a GGSN, but on a home or enterprise network.

The following LIPAISIPTO IP address situations may apply to CGW implementations. An IP address of a WTRU may be assigned by an LGW, acting as a gateway to a local network that a user wishes to access. An IP address may be assigned to a WTRU by an LGW within a home subnet. User mobility (e.g., change of point of radio interface attachment) during an ongoing PS session may not cause a change in the IP address of a WTRU. User mobility during an ongoing PS session may not cause a change of an anchor LGW.

Each LGW may be uniquely resolvable by an APN name. For example, LGWs may have unique names or an SGSN may have the intelligence to identify a particular LGW. Managed remote access (RMA) (or Remote Managed Access (MRA)) may include remote access to a user's home network from a macro cell or from a remote HNB.

The LGW may behave like a GGSN, but GGSNs may be limited in number and may cater to a huge volume (e.g., above a threshold level) of traffic while LGWs may be enormous in number (e.g., above a threshold number) but each individual LGW may cater to a very small amount of traffic (e.g., below a threshold amount of traffic). A concentration function, such as a GW Aggregator (e.g., LGW or CGW similar to an HNB-GW), which may pose as a GGSN to the Core Network, may enable (e.g., hide) many GGSNs (LGWs) that are downstream (behind it). In many embodiments, an LGW Aggregator may be configured in the MCN, analogous to the HNB-GW.

The traffic on interfaces (e.g., all interfaces) owned/managed by the MNO may be secured (e.g., HNB-to-LGW and/or LGW-to-MNC). Certain interfaces may not be managed by the MNO (although such interfaces may emanate from MNO managed elements) and security may not be a concern (e.g., LGW-to-LIPA network and/or LGW-to-SIPTO network, among others).

Active HNB mobility may support combined hard handover and serving radio network subsystem (SRNS) relocation procedures including support for lossless handover. Bandwidth Management in the CGW may include a Bandwidth Management (BWM) Server that may provide multi-RAT distribution of IP packet data between cellular (e.g., UMTS) and 802.11 air interfaces for devices with BWM clients that support multi-mode capabilities. In certain exemplary embodiments, the BWM server may be integrated into the CGW include integration of the BWM server functionality within the HNB, or the BWM server may be a standalone entity between a standard HNB and the MCN.

In certain exemplary embodiment, the BWM server may be integrated with multiple HNBs, which may be useful in an enterprise deployment.

A BWM server or CGW may have the following functionality: (1) DNS Server (or proxy DNS Server); (2) DNS Client; (3) DHCP Client; (4) GTP entities that support 3GPP TS 29.060, v9.1; and/or (5) IPSec support, among others. The BWM server may have deep packet inspection capabilities for carrying out the following actions: (a) the radio access bearer (RAB) Assignment Request; (b) the RAB Assignment Response; (c) the DNS Request; (d) the TR-069 Set Parameter Value; (e) the RANAP Relocation; (f) the RANAP Forward SRNS Context; and/or (g) forward DL data packets during mobility, among others.

A home or enterprise network may be configured to have a cable modem or digital subscriber line (DSL) connection to the Internet. The network may have HNBs and BWM servers able to connect to each other in the same Home Area Network (HAN) or Enterprise Area Network (EAN) and HNB and BWM server that have IP address on the HAN or EAN.

The HNB and the MCN may be configured to have the following: (1) no change to HNB or MCN element protocols; (2) HNB with initial HNB management system (HMS) fully qualified domain name (FQDN) burnt into memory; (3) HNB configured so that primary DNS server is BWM server; (4) HNB configured to have a pre-shared key in common with the BWM server for use during IPSec tunnel establishment and use; (5) initial or serving (security gateway) SeGW configured to have a pre-shared key in common with the BWM server for use during IPSec tunnel establishment and use; and/or (6) the HNB configured to have initial SeGW FQDN burnt into memory, among others.

The BWM server may be configured so that the initial SeGW FQDN is burnt into memory so that the BWM may agree with the Initial SeGW FQDN in HNB. The BWM server may be configured to know the location of the “outer” DNS server which may be done as part of the DHCP process of assigning the local IP address. “Outer” DNS Server is a DNS Server that may be on the Internet and an “inner” DNS Server is a DNS Server that may be within the MCN. The BWM server may be powered up and have a local IP address prior to the HNB being powered on. A BWM solution may be provided at a macrocell level and may or may not be implemented in the HNBs (e.g., all of the HNBs). The “BWM” layer may reside between the Transport and IP Layers in both the client and server. The exemplary embodiments described herein support lossless, as well as lossy data services.

Multiple ways exist to trigger the BWM server to establish an IPSec tunnel with the initial or serving SeGW. In general, the BWM server may support the establishment of an IPSec tunnel with the HNB and the BWM server may have the MCN IP address provided by the initial or serving SeGW during the establishment of its IPSec tunnel with the serving SeGW. Ways to trigger the BWM server to establish an IPSec tunnel may include: (1) the HNB may trigger the IPSec tunnel from the BWM server to the initial or serving SeGW by requesting the initial or serving SeGW IP address via DNS; (2) the BWM server may listen to the IKE_SA_{—}1NIT message from the HNB and trigger itself to establish an IPSec tunnel with the initial or serving SeGW; and/or (3) the application of power to the BWM server may trigger the IPSec tunnel.

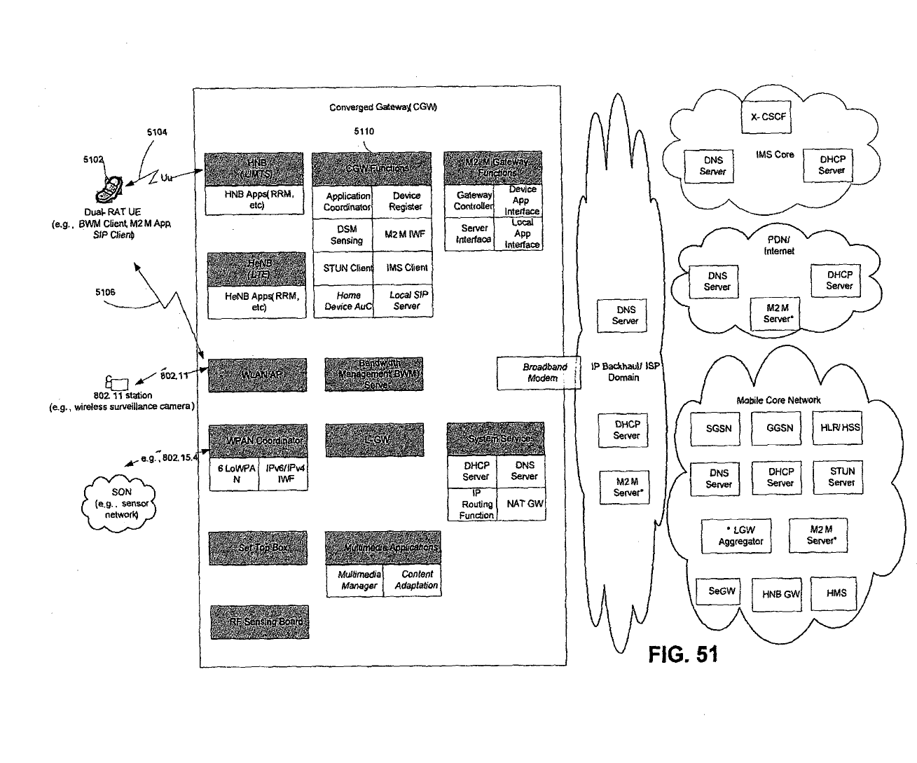

FIG. 51 is an exemplary basic architecture of a CGW Hybrid Network. The physical implementations may vary depending on the specific functions of interest. A description of the major components is summarized herein.

An extension to the architecture shown in FIG. 51 includes one in which a particular interface shown in FIG. 51 (refer to as a logical interface) may actually be implemented by more than one physical interface. For example, an end device, such as a cell phone or an appliance 5102, may have both WiFi 5106 and cellular interfaces 5104. In this example, the logical interface would be a physical multi radio access technology (multiRAT). This may facilitate multiple transmissions to increase the data rate or to provide link robustness (e.g., multiRAT diversity) or to provide flexibility such that each RAT is selected in an adaptive manner depending on the suitability of the RAT to the data being transferred. The suitability may be aspects such as security, data rates supported, QoS supported and/or cost, among others. Variations may be possible in which subsets of functions are implemented. For example, the body area network (BAN) may be absent in a particular variation.

The CGW Infrastructure may consist of home “core network” elements including any hardwired facilities (e.g., Cat. 5 cable, coax cable, phone line, power line and/or fiber, among others). The infrastructure elements may include stationary line-powered devices that may operate via battery-backup in case of temporary power outages to ensure continuity of services involving security, healthcare, and/or public safety, among others. Such devices may include cable/DSL modems, access points, routers, M2M gateways, media servers, registration/security database servers, and/or one or more HNBs, among others.

In FIG. 51, certain functions of the CGW platform are shown in the box labeled CGW Functions 5110. These functions may logically exist within the CGW platform, but may be implemented in either a centralized fashion, e.g., within the HNB, or distributed among multiple nodes.

The high level components of the CGW infrastructure network may be separate entities or modules, however, commercial implementations of the generic architecture may combine various components for improved performance and reduced size/cost/energy consumption. For instance, the HNB could be physically integrated with a residential gateway, WLAN access point, and/or TV STB to provide a single-box multi-technology “converged gateway.” To support such a structure, the HNBs, broadband modems, and/or STBs may share a common application layer protocol for remote management based on the Broadband Forum's TR-069 or other standard. In certain exemplary embodiments femtocell base stations may be integrated with residential gateways and WiFi routers.

In certain exemplary embodiments, the HNB may include the capability to provide WTRU-enabled devices with “Local IP Access” (LIP A) to the home-based network and to the external Internet. The HNB may support logical and/or physical connection to and/or integration with other networks via gateways such as WLAN AP.

The HNB may connect via Ethernet to the customer's residential gateway which may provide access to the cellular operator's core network through broadband cable, fiber, or DSL. Fixed wireless broadband access may also be an option, e.g., WiMAX or LTE cellular technologies may be used. For example, ISP providers may limit and may control indiscriminate use of their broadband facilities by H(e)NBs from competing cellular operators.

Non-operator provided WLAN APs may be used in the home network. The CGW may also utilize 802.11n-based APs managed by the cellular operator. This may allow tighter integration with the overall solutions, including support for all of control functions (e.g., security, mobility, network management, and/or DSM, among others).

M2M devices in the CGW domain may be on the same subnet. IPv4/IPv6 translation may be covered in the WP AN Coordinator such that communication (e.g., all communication) within the home subnet may be IPv4-based. Communication within the WPAN may be IPv6 based. Any IP version (e.g., IPv4 or IPv6) may used to implement the exemplary embodiments herein.

M2M Gateways may support multiple interfaces (e.g., to communicate within wireless capillary networks via short-range low power interfaces), while exchanging information with the CGW, which may further disseminate the information into the WAN. InterM2M Gateway communication (e.g., for inter-gateway mobility) may also be accomplished via the CGW, or directly, for example, when the M2M gateways share a common M2M technology. Although end devices such as sensors are typically designed for extremely low power consumption, the M2M Gateways could themselves be plugged into power outlets and may easily support multiple air interfaces with higher duty cycle communications. The M2M gateways may be candidates for reconfigurable hardware technologies based on FPGAs, SDR, and/or software configurable hardware, such that a single piece of equipment can be marketed to support multiple standards.

Multi-RAT mobile terminals may also act as M2M gateways. For instance, a handset with cellular, WiFi, and Bluetooth capabilities may communicate with healthcare body sensors via Bluetooth or WiFi, and/or convey the information to a remote network via WiFi or cellular.

The traditional role of a set-top box (STB) is to control and display interactive subscription TV services provided via coaxial cable, digital subscriber line (xDSL), optical fiber-to-the-home (FTTH), satellite, or possibly via wireless cellular technologies such as WiMAX or future LTE/LTE-A. Herein primarily the delivery of TV (primarily digital TV (DTV)) to the STBs may be assumed. The DTV content may be delivered using modulated radio frequency (RF) channels or as IPTV. Digital TV and digital radio options may include “over-the-top” transport using the Internet, subscribed satellite broadcasts, and/or terrestrial over-the-air.

Audio visual devices (AN devices) in the multimedia network may be wireless-enabled, and the STB function may wirelessly transmit subscribed AN content from the service provider, as well as local content from the integrated home network (e.g., media server, handset, and potentially via the HNB and AP). As such, the role of the STB can be expanded to that of a “media gateway.”

To support the CGW functions, various nodes such as servers, databases, and/or storage facilities may be used. For example, the nodes may include: (1) personal media and/or data content; (2) identification and/or addressing registries; and/or (3) security and/or access control policies.

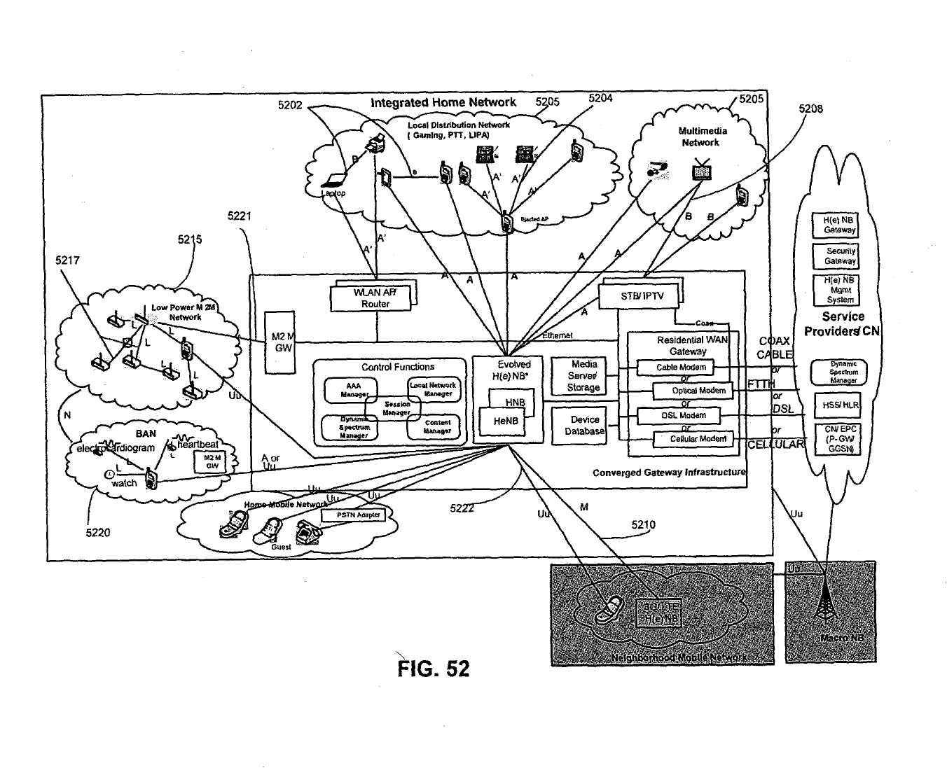

FIG. 52 is another exemplary illustration of a CGW architecture that shows the networks that interact with the CGW. A local distribution network 5205 may include productivity devices that may exchange information between or among local network nodes (e.g., computers, and/or printers, among others) or externally to other networks via gateway-enabled devices. Such networks may operate in infrastructure modes (e.g., via base stations or access points) or non-infrastructure modes (e.g., peer-to-peer or master-slave modes), and may be supported by various wireless technologies including WiFi or cellular. For example, applications may include file transfer, web browsing, and/or email, among others.

In certain exemplary embodiments, the interface can be Ethernet or other wired interface such as backplane and/or power line networking. Similarly, the interface in FIG. 52, which can be termed as ‘M’ 5210, may be the 3GPP defined X2 interface or possibly an enhancement thereof. An M interface may be considered an inter-H(e)NB interface.

FIG. 52 illustrates an example integration of various local networks, such as low power machine-to-machine (M2M) networks, body-area networks (BAN), multimedia networks, and local data/voice communication networks. In FIG. 52, interfaces are shown between devices in the local distribution network. The interface A′ interface 5204, may be an evolved infrastructure mode 802. 11-like interface with a centralized Access Point (AP) controlling communications to connected devices. A′ may be considered a generic name for high speed Ad Hoc interface between elected cluster head and device. Direct links can be set up between peer devices using a logical B interface 5202. The logical B interface 5202 may provide high throughput and low latency.

The Low power M2M network 5215 may include wireless sensor and home automation. Such sensors and home automation networks may involve data gathering devices which convey raw, processed, and/or aggregated information between or among local network nodes, and may include external communication with other networks via gateway-enabled devices. Such sensors may be low data rate, low duty cycle, and power-constrained devices. In addition to passive sensing, some devices may support active control functions such as sounding an alarm or flipping a switch. Cluster formation of the sensor networks may occur via device discovery procedures.

The M2M networks may operate in infrastructure modes (e.g., via base stations or access points) or non-infrastructure modes (e.g., peer-to-peer or master-slave modes), and may be supported by various technologies including ZigBee, Bluetooth, WiFi, and/or cellular. In FIG. 52, the logical L interface 5217 may represent any such aforementioned technologies. An L interface may be a generic term for a relatively low speed ad hoc interface. The interface may provide a low throughput, and may be includes with a device that may be power-constrained. Applications that use such an interface may include home security, surveillance, health monitoring, energy management, HVAC control and/or W AYE, among others.

Somewhat similar to the low power M2M networks, body area networks (BANs) 5220 may include wearable/implantable wireless sensors that may convey information locally to the user or externally to other relevant entities via a CGW. The gateway device may also act as an aggregator of content from the wireless sensors.

Wireless multimedia networks 5206 typically include home entertainment equipment that exchange multimedia information (e.g., audio, video and/or data) between local network nodes, or externally with other networks via gateway-enabled devices. These devices may use for much higher data rates than sensor networks. Such networks may operate in infrastructure modes (e.g., via base stations or access points) or non-infrastructure modes (e.g., peer-to-peer or master-slave modes) and may be supported by various technologies including WiFi or cellular. Applications include real-time audio/video, playback of locally/remotely stored content, automated sync between devices, and/or live transfer of sessions between devices, among others. In FIG. 52, the logical B interface 5208 may be used between devices in the multimedia network.

The cellular network may overlap with parts of the previously described networks, and may include macro-cell, inter-Home (e) Node B, and intra-Home (e)Node B elements. Devices may include Closed Subscriber Group (CSG) and non-CSG WTRUs, and may be used for traditional services such as voice, text and/or email. In addition to traditional functionality, the cellular operator's core network may support future value-added services enabled by the evolved CGW platform.

The CGW may communicate with a number of devices, but may not communicate with all such devices, within the local clouds. For instance, some devices may not have the appropriate radio access capability or some devices may decide to restrict communication within the local cloud in order to conserve resources (power and/or storage, among others). For devices that are capable and willing to communicate with the CGW, this communication may be via a logical A interface 5221, that provides synchronization, control, and/or a data plane functionality. These functions may be achieved through dedicated physical channels, or through shared channels. Synchronization may provide the local cloud devices with reference timing, and/or may optionally provide an indication of where to find the control information. The control information may provide the signaling (between or among local cloud devices and the CGW) to allow local cloud device registration, local cloud device (re)configuration, measurement reporting to the CGW, and/or local cloud device assistance, among others. The logical A interface 5221 may allow a level of centralized control for interference management and load management within the converged gateway network.

The logical A interface 5221 may be implemented using a new air interface, optimized for the specific application and conditions (home, office and/or industrial conditions). Alternatively, the functions may be carried over the Uu interface 5222 (e.g., H(e)NB interface) or over an 802.11-like interface (shown as A′ 5204 in FIG. 52).

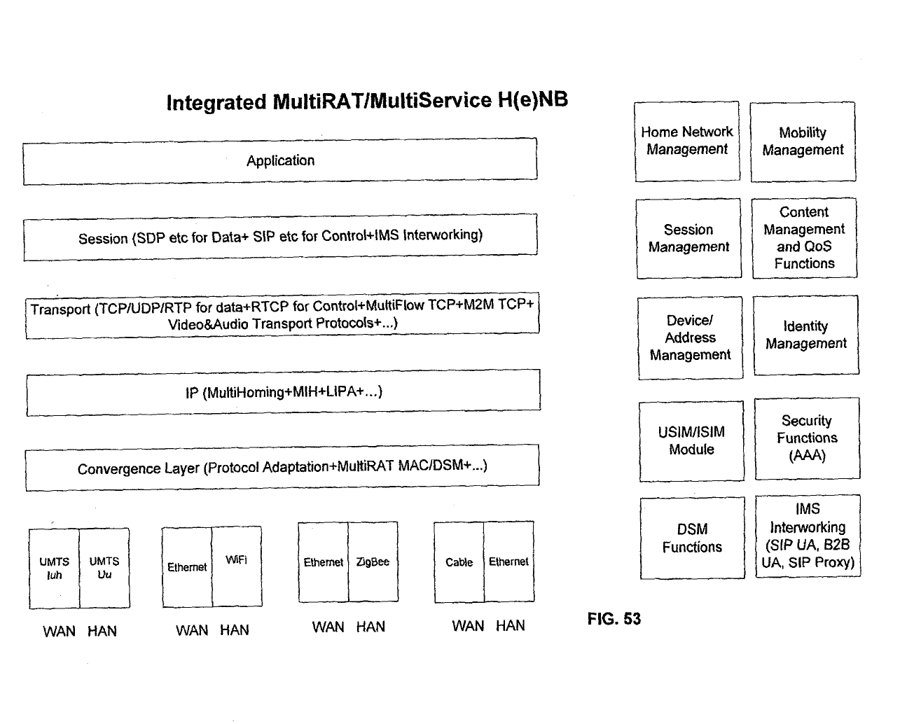

FIG. 53 is an exemplary block diagram that illustrates the high-level architecture of the Converged Gateway.

The CGW may be the central entity in a home (or enterprise) that contains or includes a Broadband Modem, a Cellular H(e)NB, a WiFi Access Point, an IP Router and possibly other functional and physical entities, and/or serves to integrate the various sub-Networks in the integrated home network (IHN). The CGW may provide a logical binding to a home, just as a mobile phone may provide a logical binding to a person. A home, with its devices (e.g., all of the devices), such as sensors, and/or appliances, among others may become identifiable by the CGW so that each of the individual home devices may be indirectly addressable via the CGW. The CGW may become a gateway for each home device to communicate with the wide area network (WAN) as well as other devices locally within the IHN.

The CGW may have a unique identifier, and attached to this identifier may be a list of home devices, each of which may have its own identifier. Because the CGW, may be a communicating entity for which the communication services may be provided by a network operator, the CGW identifier may also include the identity of the network operator. The CGW identity may be any alpha-numeric or binary value, which may also be a user friendly identity. For example, the home address may be the CGW identity, coupled with the Network Operator identity. If the home address is 123 Freedom Drive, Happyville, Pa. 10011, USA and the communication services are provided by Universal Communications Corporation, then the CGW identity may be 123 Freedom_Drive, Happyville, Pa._{—}1OO1I,USA@UniversaLCommunications.com. Individual Sub-Networks and devices may be appended to this identity. For example, Thermostat #123_Freedom_Drive, Happyville, Pa._{—}1OO11,USA@Universal_Communications.com, where the # sign may be used to denote the split in the address.

Other architectures for the CGW are possible, by adding or deleting certain functional entities. For example, the ZigBee modem may be deleted and a Bluetooth modem added.

The CGW architecture may include many elements. For example, the CGW architecture may comprise the following local devices: (1) 802.15.4 devices (WPAN); (2) 802.11 Devices; (3) WTRUs; (4) generic IP devices (e.g., printers and/or digital picture frames, among others); and/or (5) BWM client enabled multimode devices. Some CGW entities may include HNBs, WLAN-APs, WPAN-Cs, LGWs, BWM servers, and/or RF sensing modules, among others. CGW applications may include M2M JWF applications, application coordinators, IMS clients, STUN clients (e.g., for extended local IP access mobility—ELIP A), and/or DSM spectrum sensing functions (SSFs), among others.

Additional CGW architecture elements may include: M2M gateways; M2M servers; M2M applications; system services (e.g., local DHCP servers, local DNS servers, IPv4 routers, and/or NATs); ISP networks (e.g., ISP/“outer” DNS servers); MCNs (MNCs/inner DNS servers, HNB management systems, SeGWs, HNB gateways, LGW aggregators, SGSNs, GGSNs, RNCs (e.g., for handover between HNB and macrocell), STUN server); and/or IMS core networks (e.g., IMS CN DHCPs, IMS CN DNSs, IMS CN x-CSCFs).

The home network manager, may provide semi-static management of the home network including support of Self Organizing Network (SON) features. This function may discover the access technologies and associated functional capabilities available to the Converged Gateway.

A session manager may be in the CGW platform. This function may control the transfer of media, data and voice sessions between various networks or devices shown in FIG. 52. This function may be centralized, e.g., in the H(e)NB, or distributed among home infrastructure nodes. The initiation of session transfers may be based on user interaction, or automated response based on mobility, context awareness, event-driven cues, and stored user profiles. Once initiated, the Session Manager may control the transfer, possibly involving the cellular operator and its knowledge of “registered” devices within the home, e.g., for digital rights management (DRM). This function may interact with the Content Management function for some transfers.

The Content Manager may handle functions such as content adaptation, e.g., transformation of media formats (e.g., required formats) between the home network and mobile handheld devices. This may include a content decomposition function.

The Dynamic Spectrum Manager (DSM), as shown in FIGS. 51 and 52, may be defined as the entity that facilitates assignment of the right RAT(s)/frequencies/bandwidth to the right application at the right time. The DSM may optimize utilization of available spectrum to minimize the local interference levels, satisfy the required QoS, may allow spectrum aggregation using the same or different radio access technologies (RATs), and/or may oversee (e.g., control) the spectrum sensing and environment-based information fusion while enabling high throughput real-time multimedia content sharing among local devices.

In the context of the COW, Dynamic Spectrum Management (DSMT) may be a common service providing spectrum sensing functions (SSF) and bandwidth management functions (BMF). For example, to assist with the self-organization of 802.15.4-based WPANs, the WPAN Coordinator may interact with DSMT to obtain initial and alternate channels for operation. Similarly, the Bandwidth Management server (BWMS) may interact with DSMT to decide on bandwidth aggregation and/or switching policies.

A security manager may include Authentication, Authorization, and Accounting (AAA) functions and may facilitate use of operator resources (e.g., providing proxy functions as appropriate).

The IMS interworking functions may enable managed IMS-based services such as VoIP and IPTV to be delivered to the home. Operator provided services may be accessed via remote application servers, and may also be accessed from local application servers or cached storage. Support may be provided for IMS-enabled and non-IMS-enabled devices in the home. Support for non-IMS-enabled devices may be provided by an IMS inter-working function in the CGW.

An RF sensing module may be a centralized single scanner entity as part of CGW. In certain exemplary embodiments, the sensing may be performed in the CGW may represent the interference that may be sensed by the entire network, in which case a single sensing node may be sufficient. The scanner results (outcomes) may drive a SW entity (“Spectrum Sensing Function”) as part of CGW to determine preemptive frequencies against interference. The scanner outcomes may support interference mitigation and bandwidth aggregation decisions. In certain exemplary embodiments, the RF sensing module may be able to scan approximately 30 Hz.

Exemplary illustrations of system description of the CGW have been captured via message sequence charts (MSCs) detailing the interactions between technology elements of the system. The MSCs capture high-level flows and encapsulate exemplary detailed messaging within individual procedure blocks.

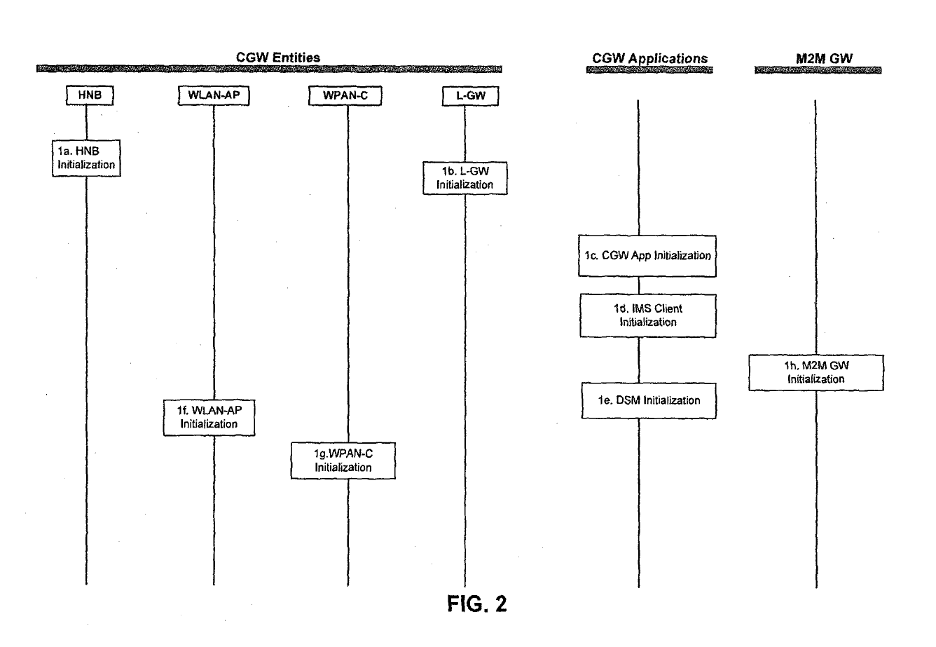

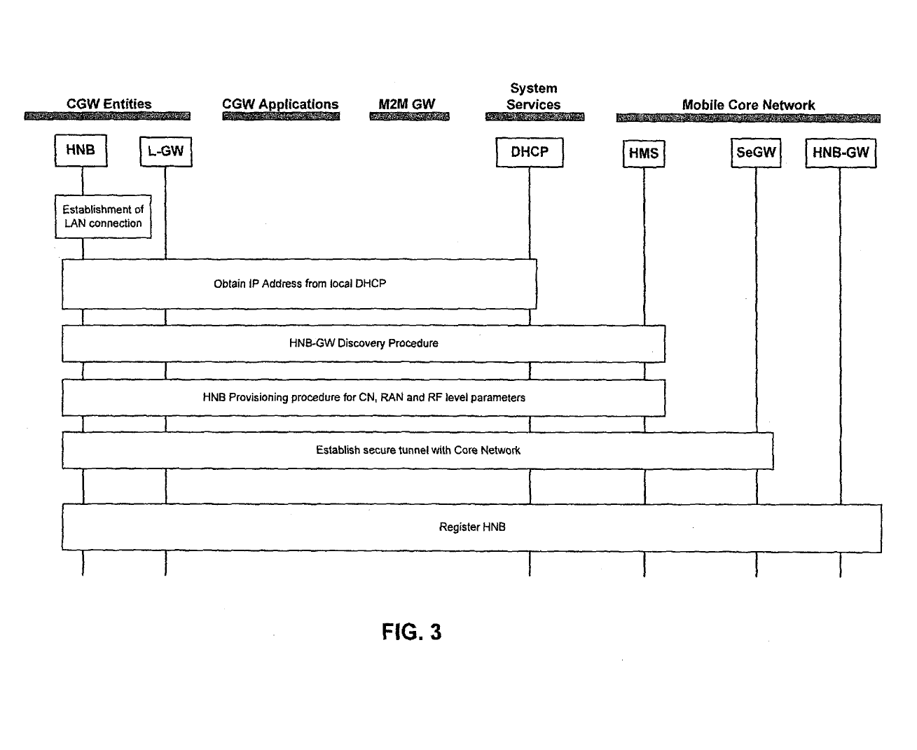

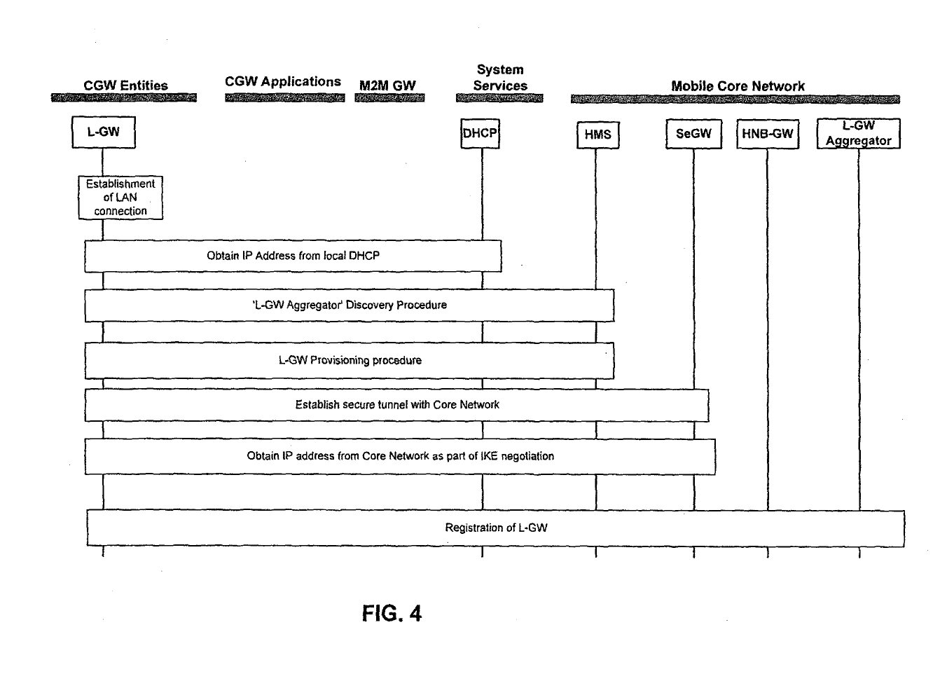

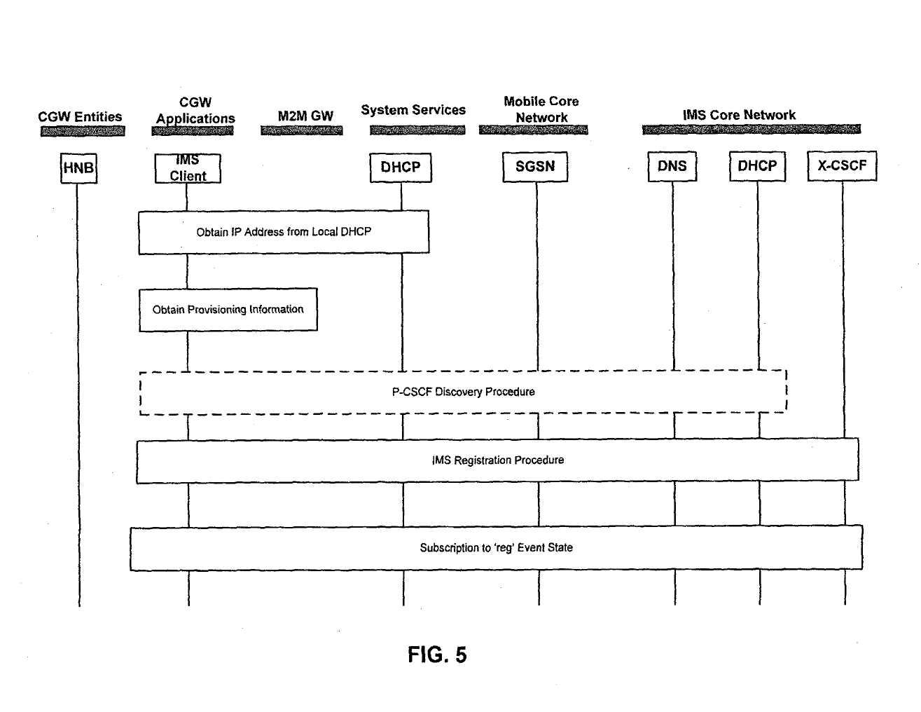

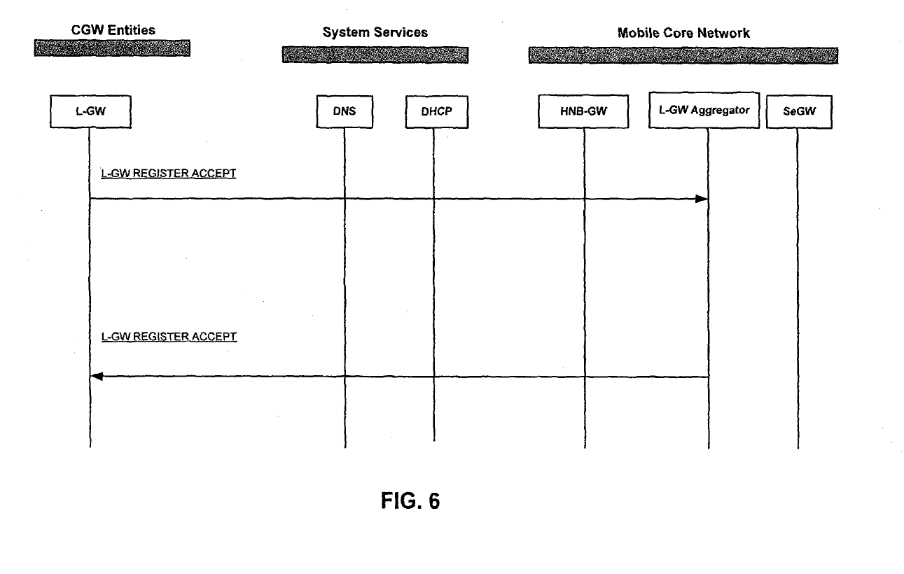

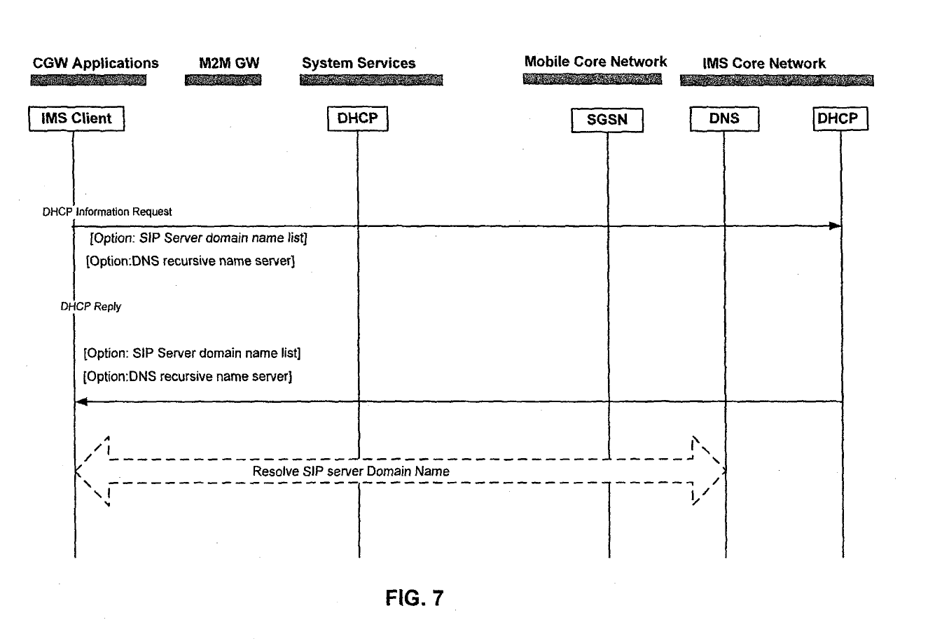

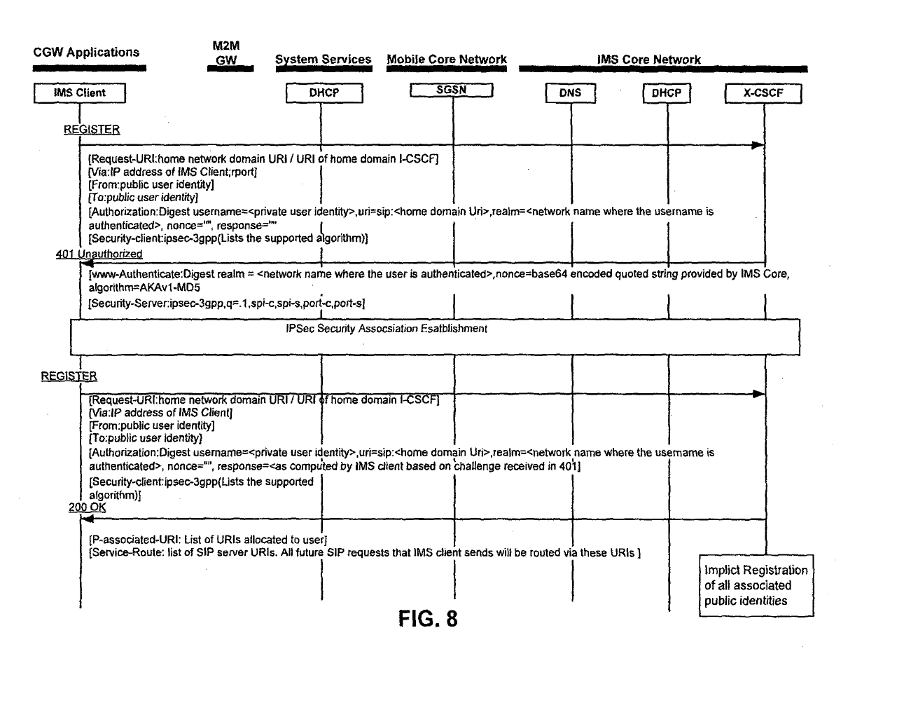

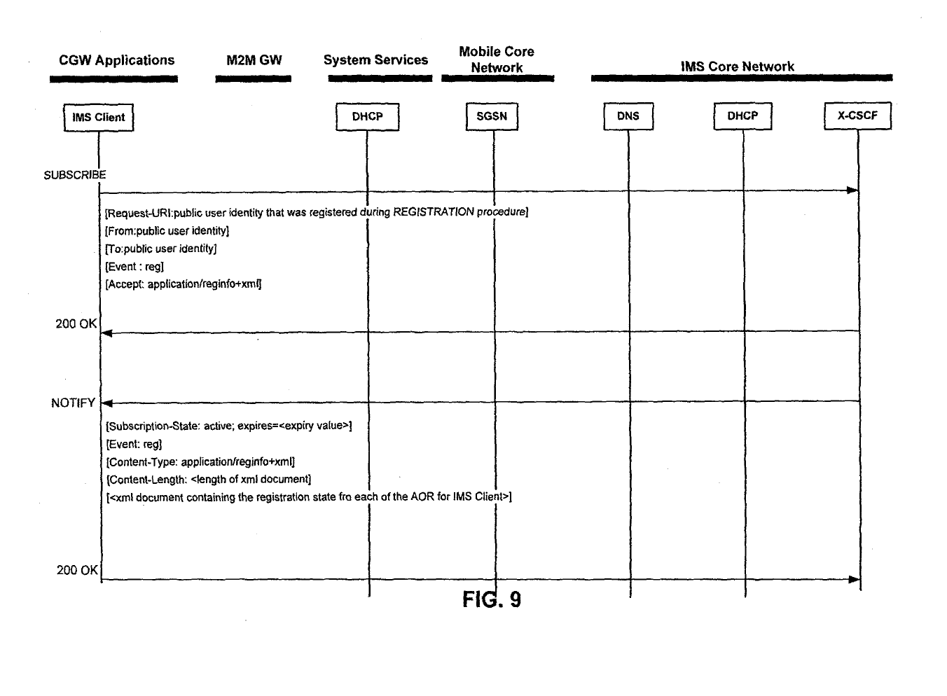

The CGW Initialization and Registration MSCs, as shown in FIG. 2 thru FIG. 9 are exemplary illustrations of the initialization of the CGW entities including HNB, WLAN-AP, WPAN-C, LGW, M2M GW, and CGW Applications including DSM Spectrum Sensing initialization and/or IMS Client registration, among others. FIG. 2 is an exemplary illustration of a procedure for the CGW initialization. FIG. 3 is an exemplary illustration of a procedure for the HNB initialization. FIG. 4 is an exemplary illustration of a procedure for the LGW initialization. The LGW may be a logical entity and its provisioning parameters may be similar to that of a HNB. FIG. 5 is an exemplary illustration of a procedure for the IMS client initialization. FIG. 6 is an exemplary illustration of a LGW registration. FIG. 7 is an exemplary illustration of a proxy call session control function (PCSCF) discovery procedure. FIG. 8 is an exemplary illustration of IMS registration procedure. FIG. 9 is an exemplary illustration of a procedure for subscription to ‘reg’ Event state.

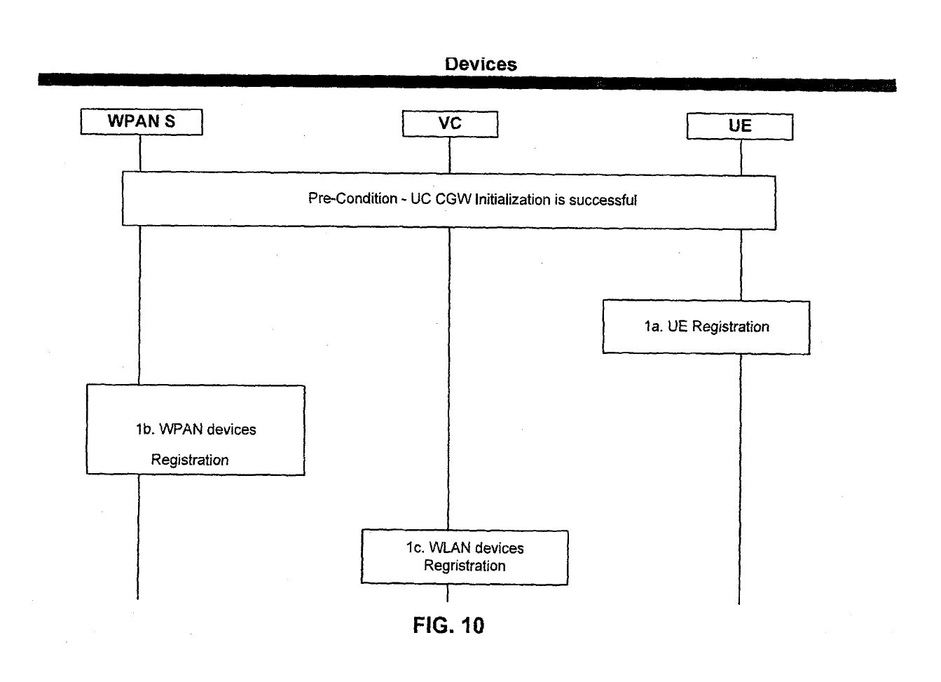

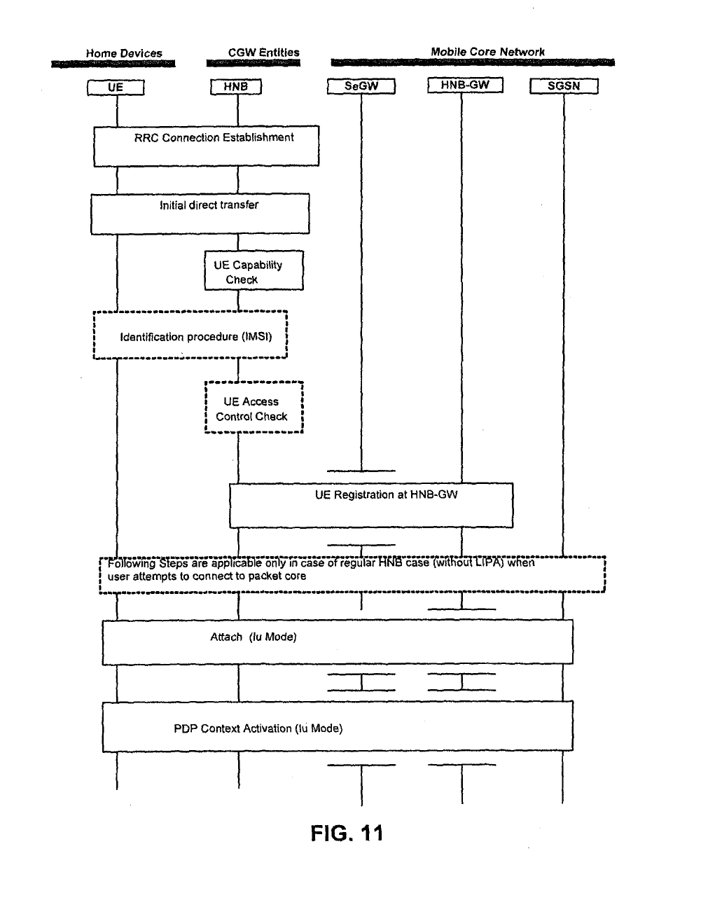

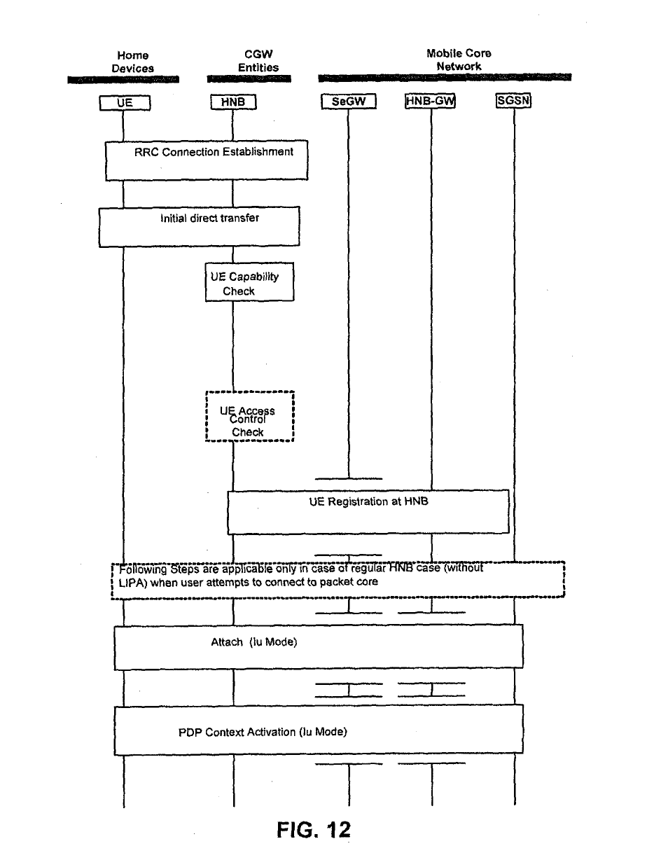

The Device Registration MSCs, as shown in FIG. 10 thru FIG. 12, are exemplary illustrations of the registration of the UE, WLAN, and/or WPAN devices within the CGW, and with external operator/service provider networks. FIG. 10 is an exemplary illustration of a procedure for device registration. FIG. 11 is an exemplary illustration of a procedure for the UE registration (NON CSG UE). FIG. 12 is an exemplary illustration of a procedure for UE registration (CSG UE).

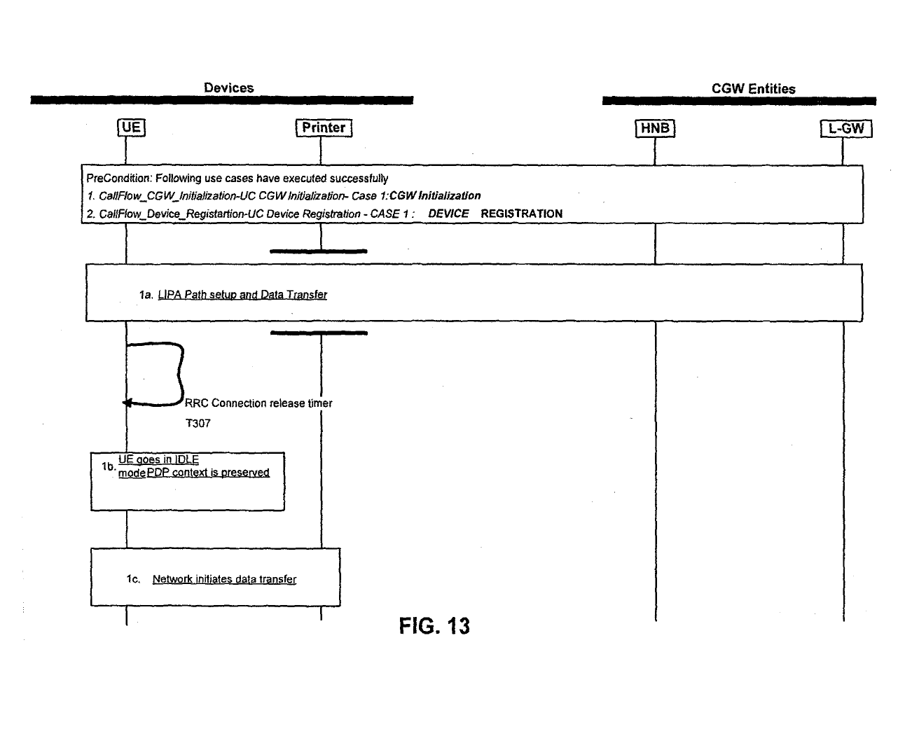

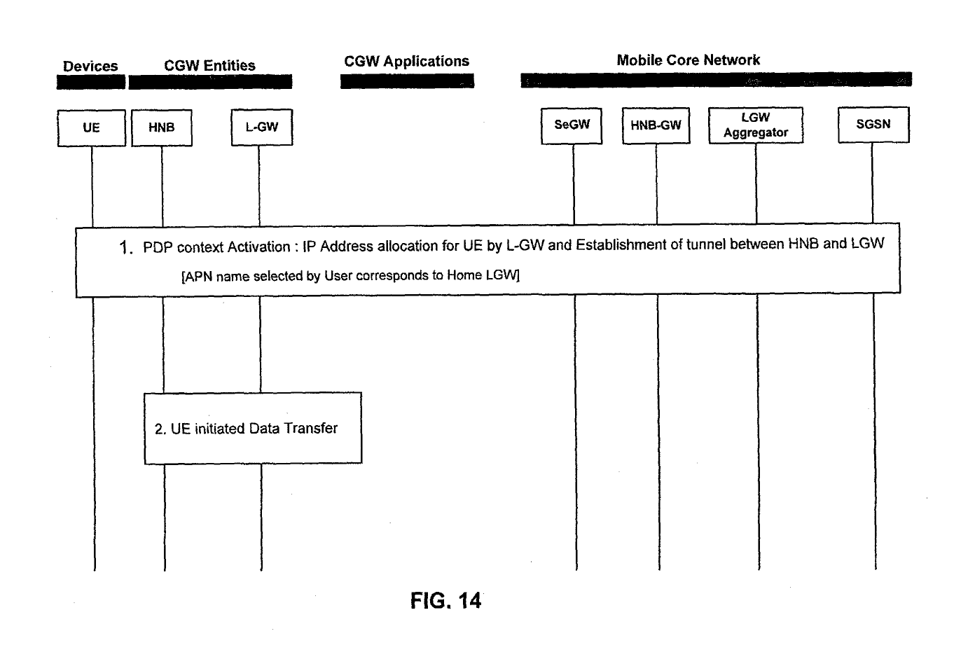

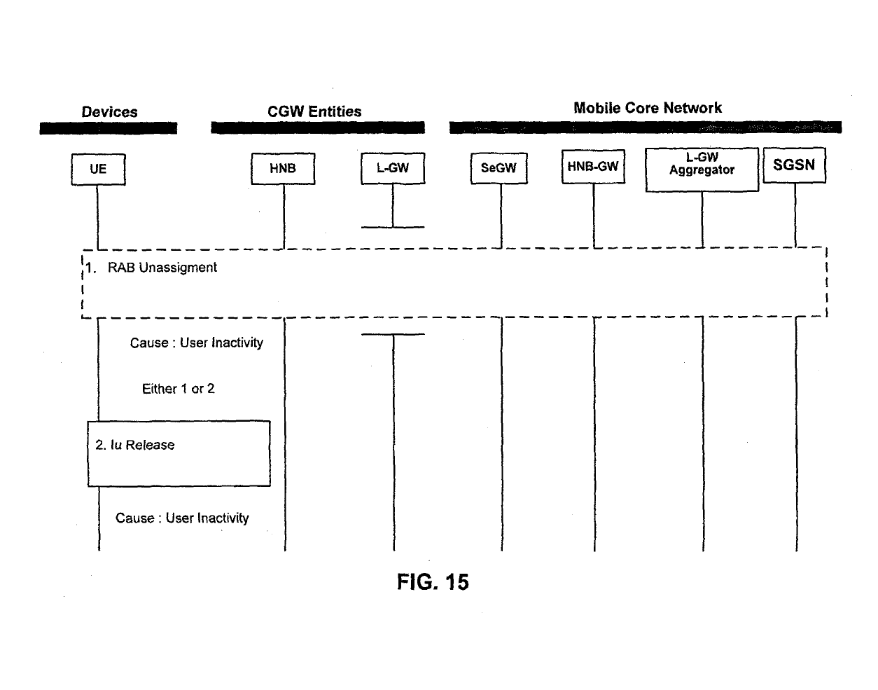

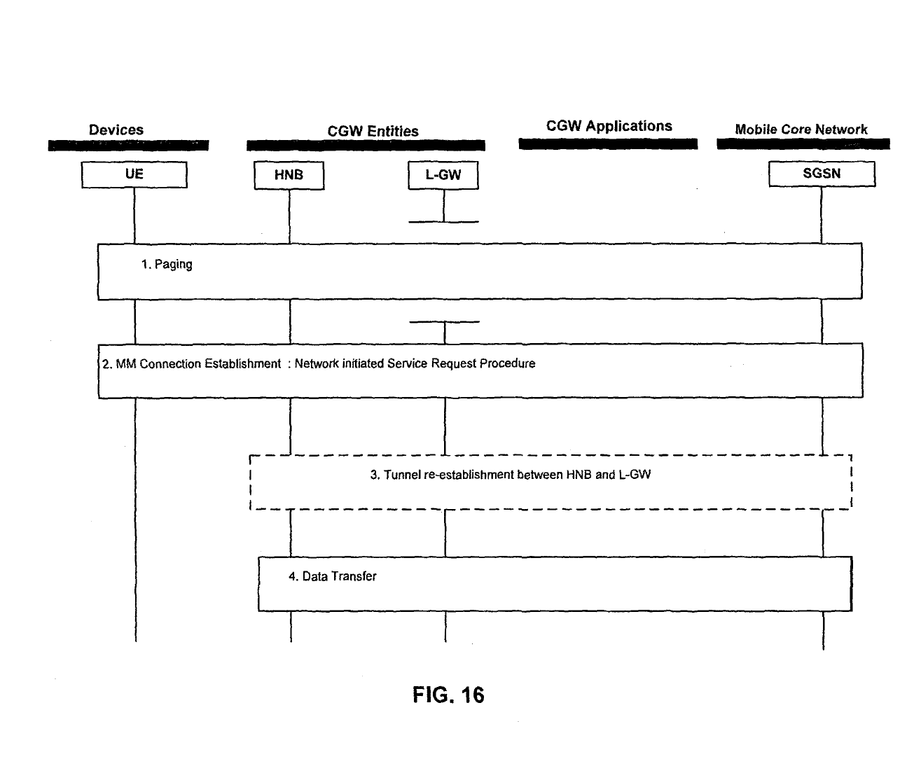

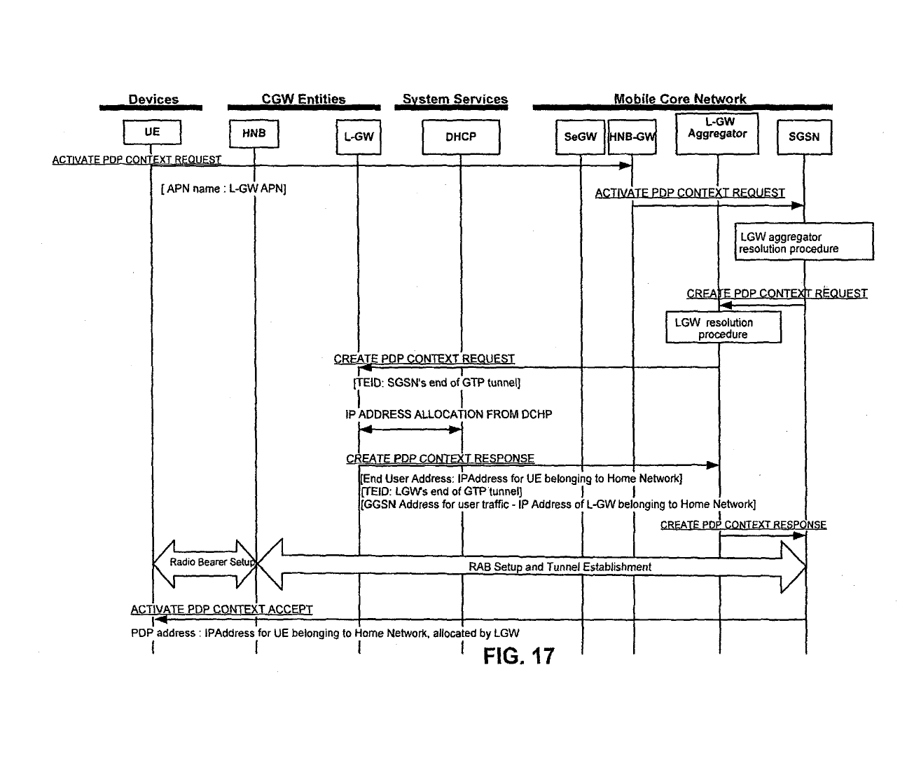

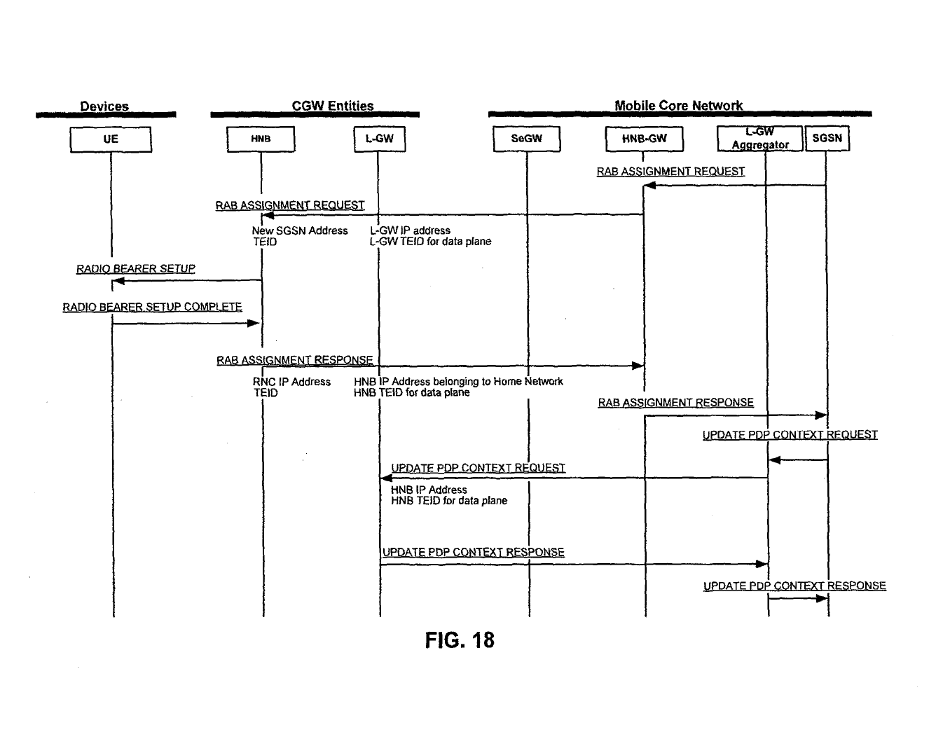

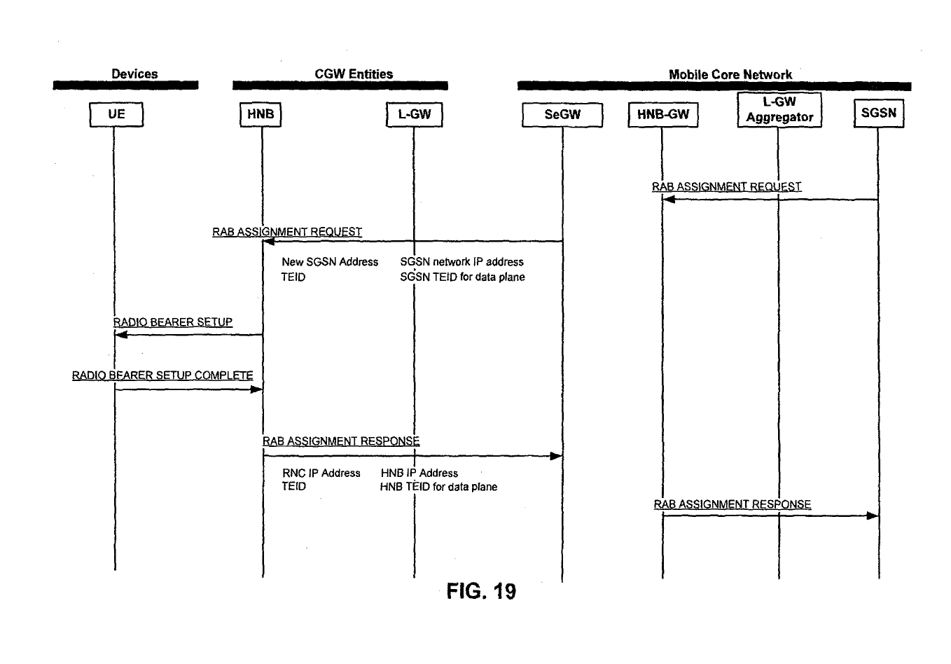

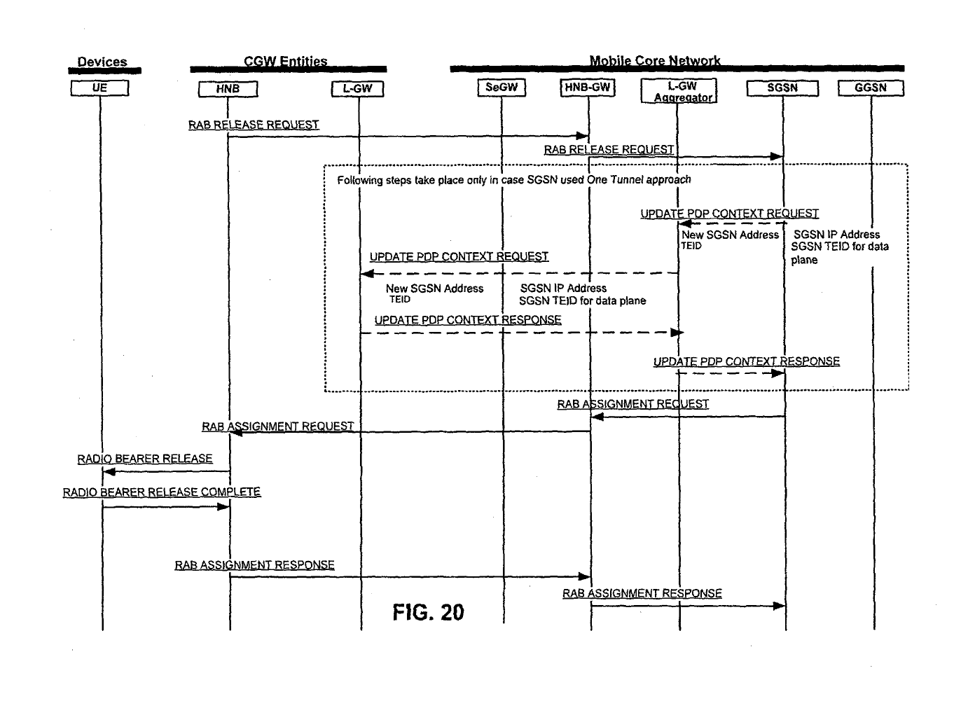

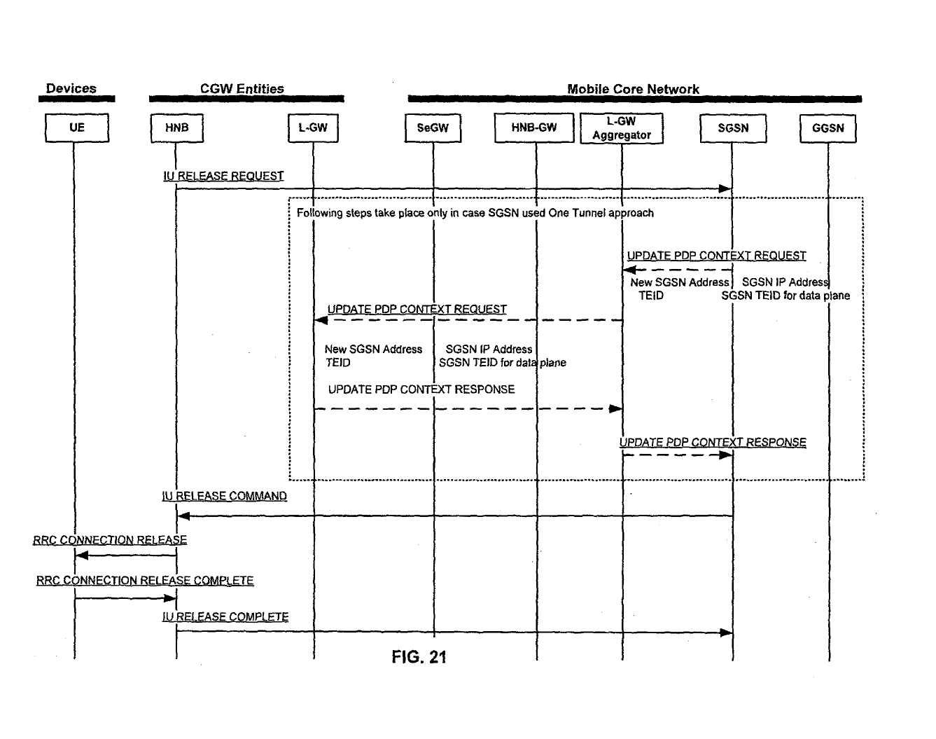

The simple LIPA MSCs, as shown in FIG. 13 thru FIG. 21, are exemplary illustrations of setup of the LIP A path and local data transfer, including transition to idle mode during periods of data inactivity with preservation of PDP context and subsequent paging with connection/tunnel re-establishment for resumption of downlink initiated LIPA sessions. FIG. 13 is an exemplary illustration of a procedure for a UE attached to its home LGW and accessing a device on its home network. FIG. 14 is an exemplary illustration of a procedure for a LIPA path setup and data transfer. FIG. 15 is an exemplary illustration of a procedure for a UE that goes into IDLE state while preserving its PDP context. FIG. 16 is an exemplary illustration of a procedure for a UE previously attached to its home LGW and the network initiates a data transfer. FIG. 17 is an exemplary illustration of a procedure for PDP context creation. FIG. 18 is an exemplary illustration of a procedure for RAB setup and user plane tunnel establishment for one tunnel. FIG. 19 is an exemplary illustration of a procedure for RAB setup and user plane tunnel establishment for two tunnels. FIG. 20 is an exemplary illustration of a procedure for RAB release and PDP context preservation. FIG. 21 is an exemplary illustration of a procedure for Iu release and PDP context preservation.

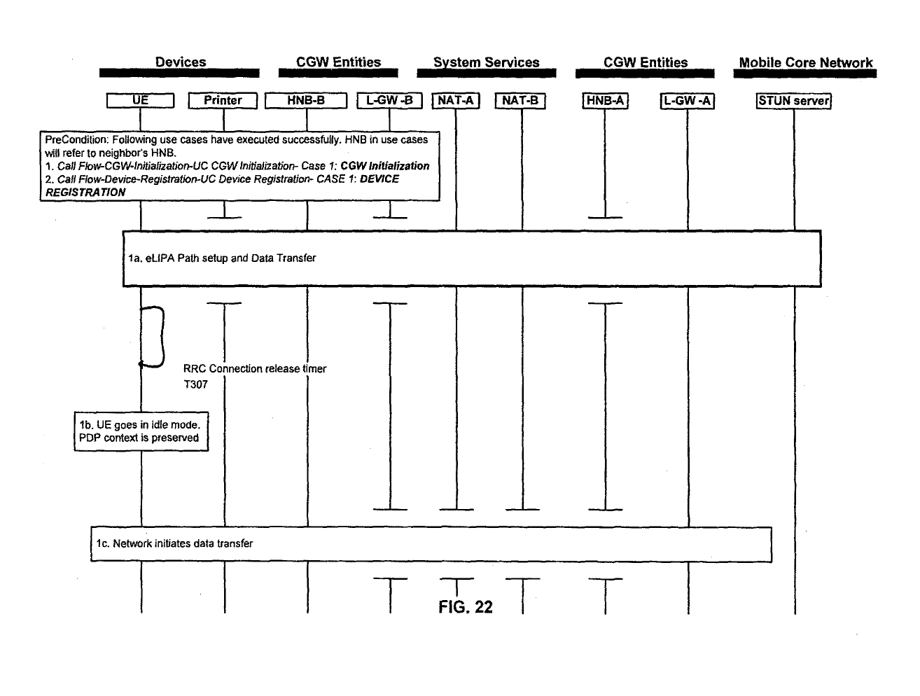

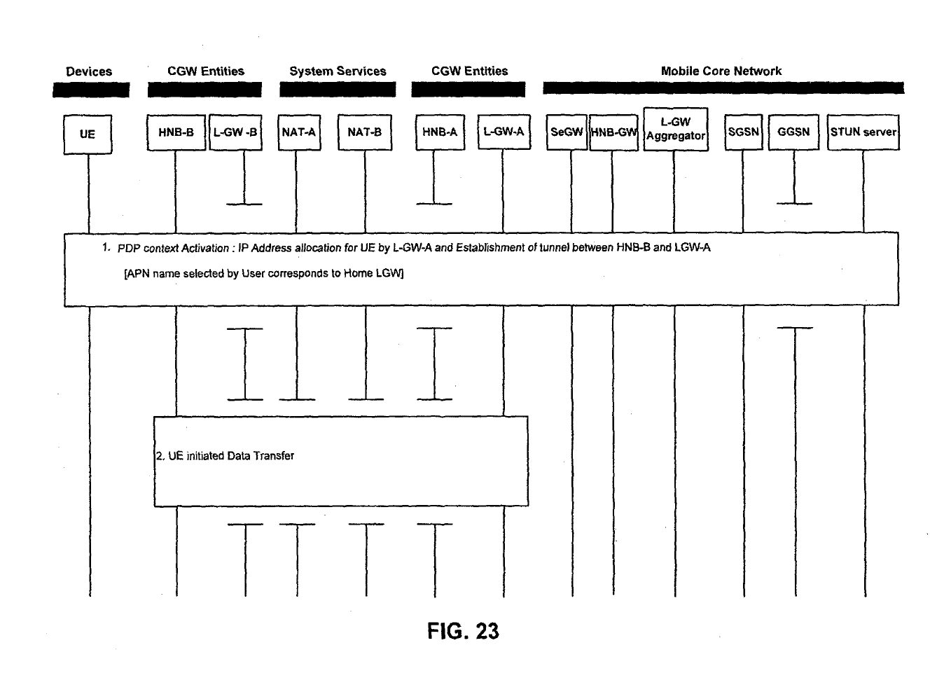

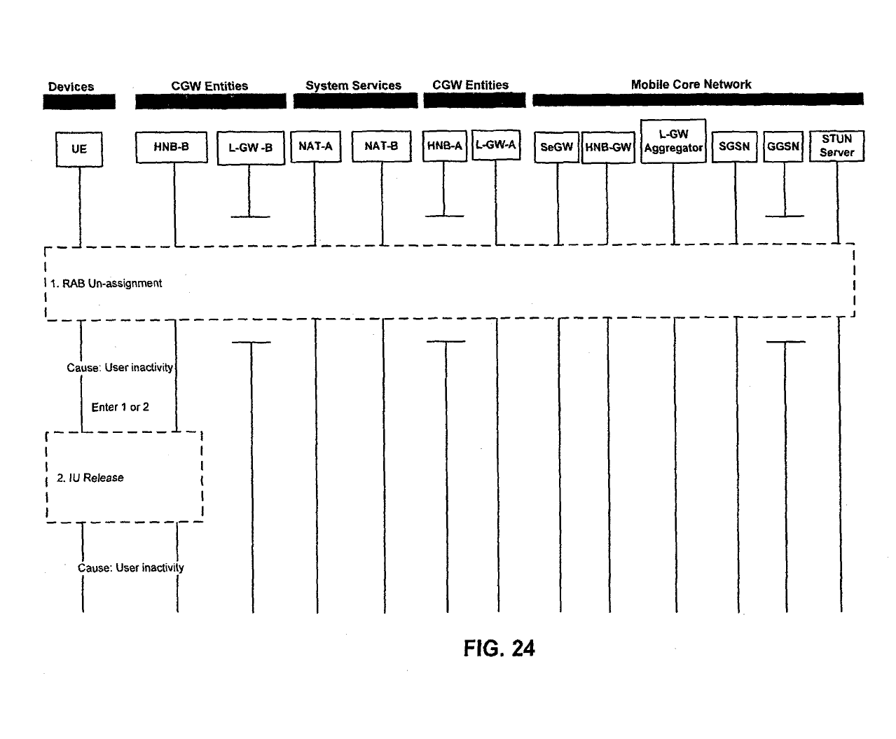

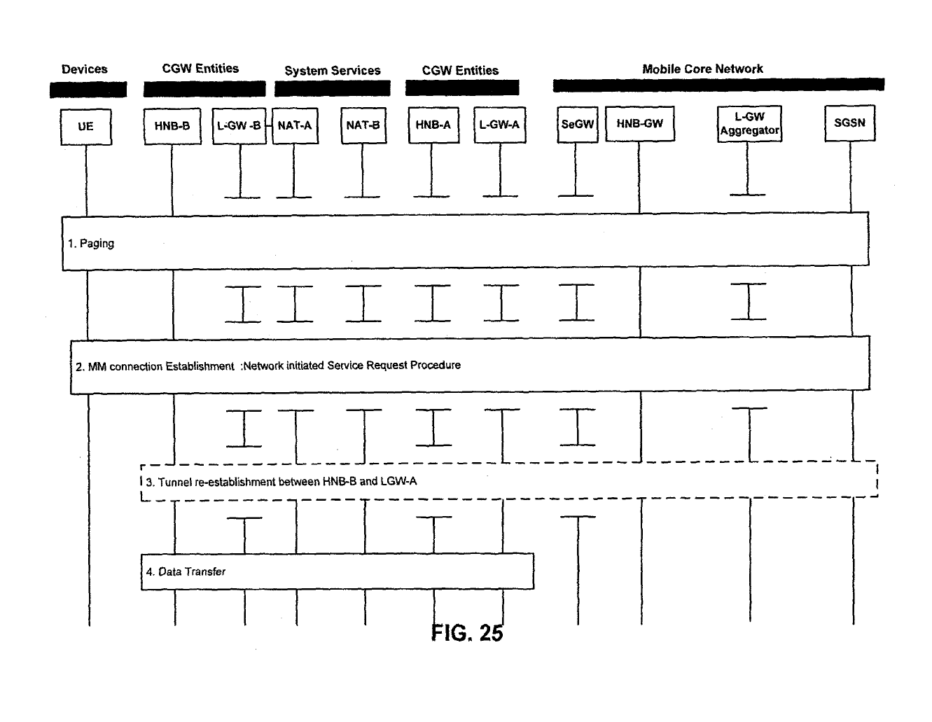

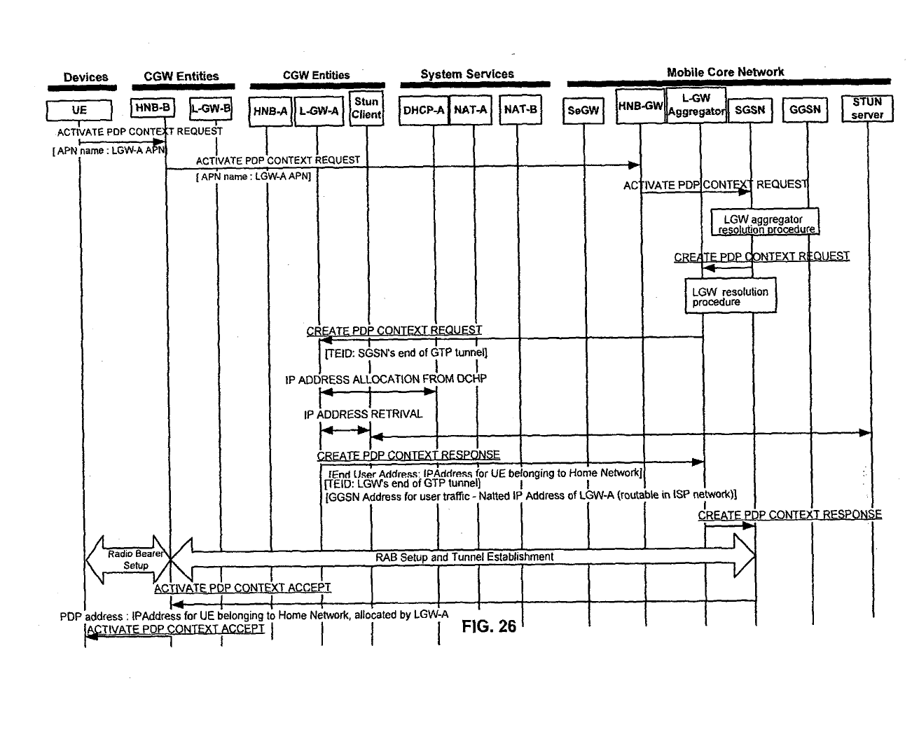

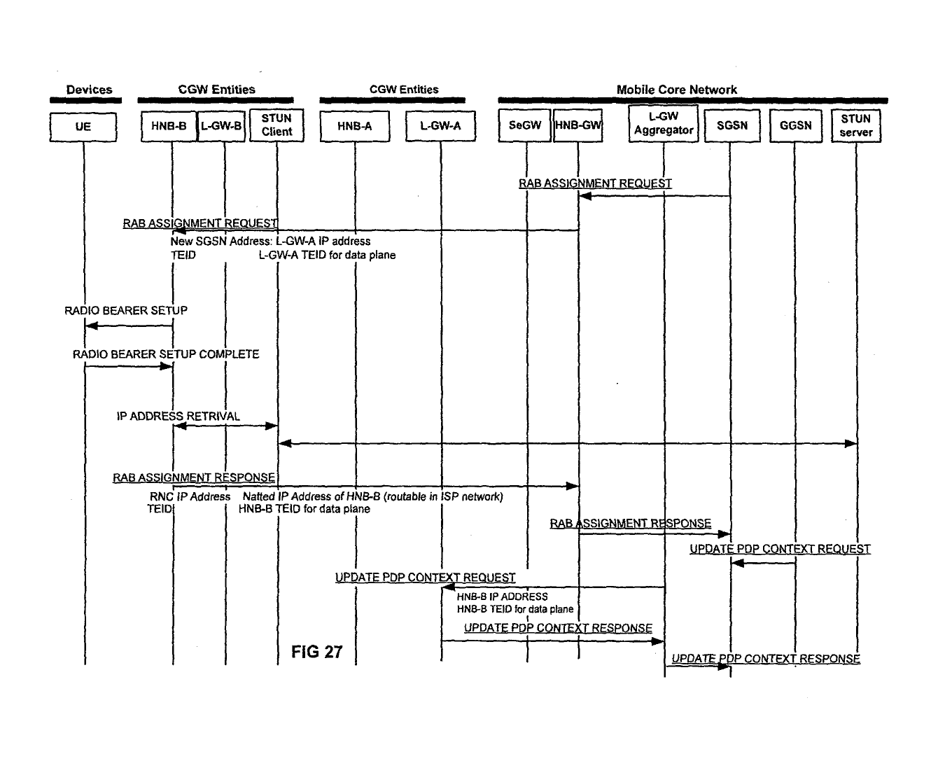

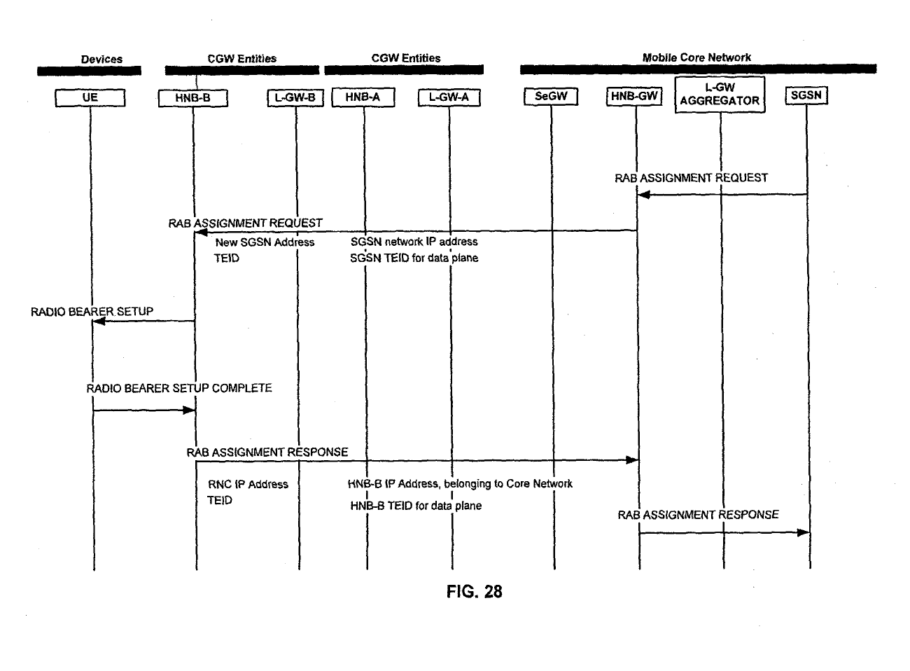

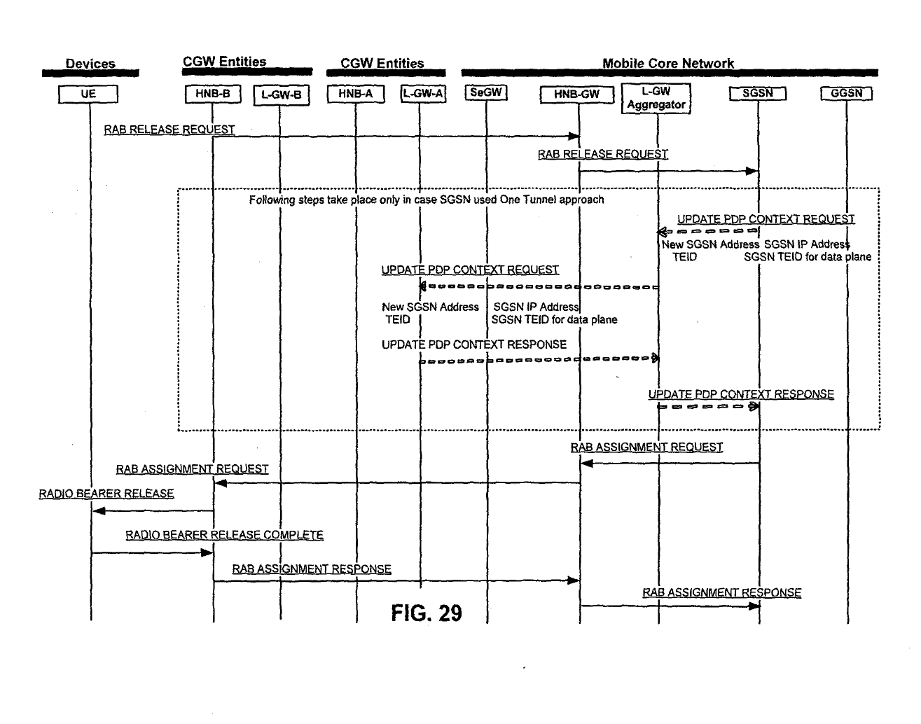

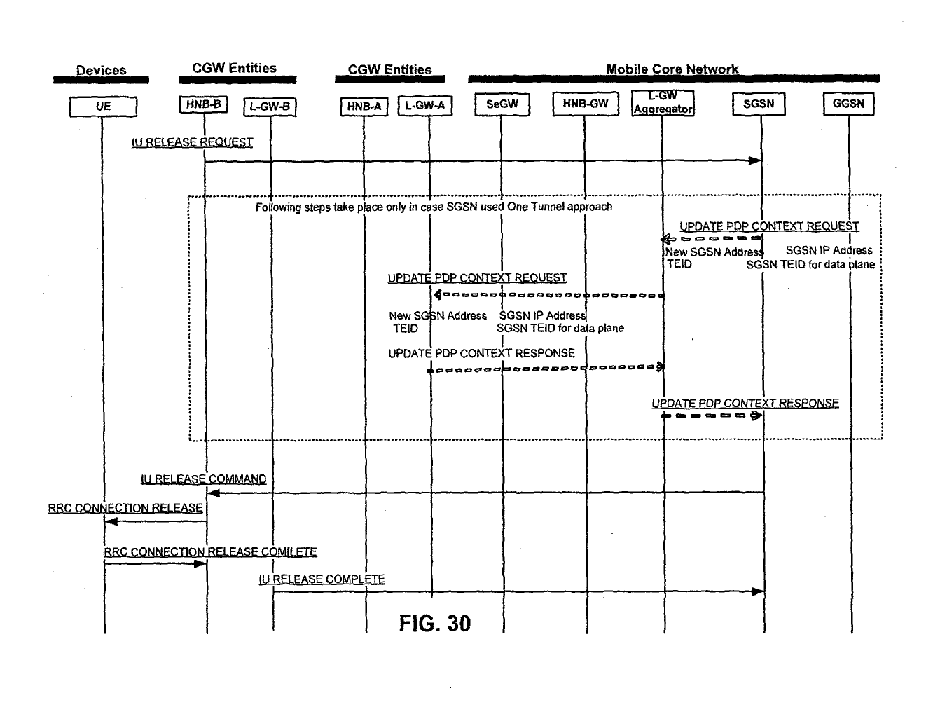

The “Extended” LIPA (E-LIPA) MSCs, as shown in FIG. 22 thru FIG. 30, are exemplary illustrations of setup of the E-LIPA path and local data transfer, including transition to idle mode during periods of data inactivity with preservation of PDP context and subsequent paging with connection/tunnel re-establishment for resumption of downlink initiated E-LIPA sessions. FIG. 22 is an exemplary illustration of a procedure for a UE attached to a neighbor's HNB accessing a device on the UE's home network. FIG. 23 is an exemplary illustration of a procedure for ELIPA path setup and data transfer. FIG. 24 is an exemplary illustration of a procedure for an attached UE going into IDLE state while its PDP context is preserved. FIG. 25 is an illustration of a procedure for a UE previously attached to its home LGW and a network initiates a data transfer. FIG. 26 is an exemplary illustration of a procedure for PDP context creation. FIG. 27 is an exemplary illustration of a RAB setup and user plan establishment with one tunnel. FIG. 28 is an exemplary illustration of a RAB setup and user plane tunnel with two tunnel establishment. FIG. 29 is an exemplary illustration of procedure for RAB release and PDP context preservation. FIG. 30 is an exemplary illustration of an Iu release and PDP context preservation.

The topology of a cellular network may be changing such that HNB devices may be available and deployed in homes (e.g., most homes). The HNB devices may be offered to the end-consumer by the cellular operator or may be sold by equipment manufactures and may utilize the consumers' broadband to connect the HNB to the MCN (MCN). The consumers' broadband modem may use a number of technologies, which may provide a conduit from the broadband modem to the MCN. As UMTS and LTE become more popular, traffic may be offloaded from the MCN. LIPA may be one method to offload local traffic from using bandwidth on the core network. There may be times when two HNB devices that are in close proximity might have to communicate. For example, each HNB may be connected to devices that are to communicate with each other. The data that may be passed during this communication may take many different paths.

The data passed between the HNB devices may travel from each HNB, through the respective broadband modems, the IP backhaul and may then enter the MCN. Once in the MCN, the data may be routed to an SGSN (or SGW) which may route the data back through the MCN to the IP backhaul. Once in the IP backhaul, the data may be routed to the proper broadband modem and then may be delivered to the target HNB. The target HNB may deliver the data to the proper device within its sphere. This approach may be less efficient because bandwidth which may be devoted to other activities may be used for this reflected data. Since more network nodes may be traversed in these operations, there may be a higher likelihood of data being delayed or not delivered at all. Alternatives operations may allow for data to be reflected to its intended target by traversing fewer nodes. These alternatives may be described as “Extended LIPA” or “ELIPA” and may perform inter-HNB communication in a more efficient manner. E-LIPA may allow devices camped on (e.g., registered, connected or join to) different HNB devices to communicate with minimal involvement from the complete MCN.

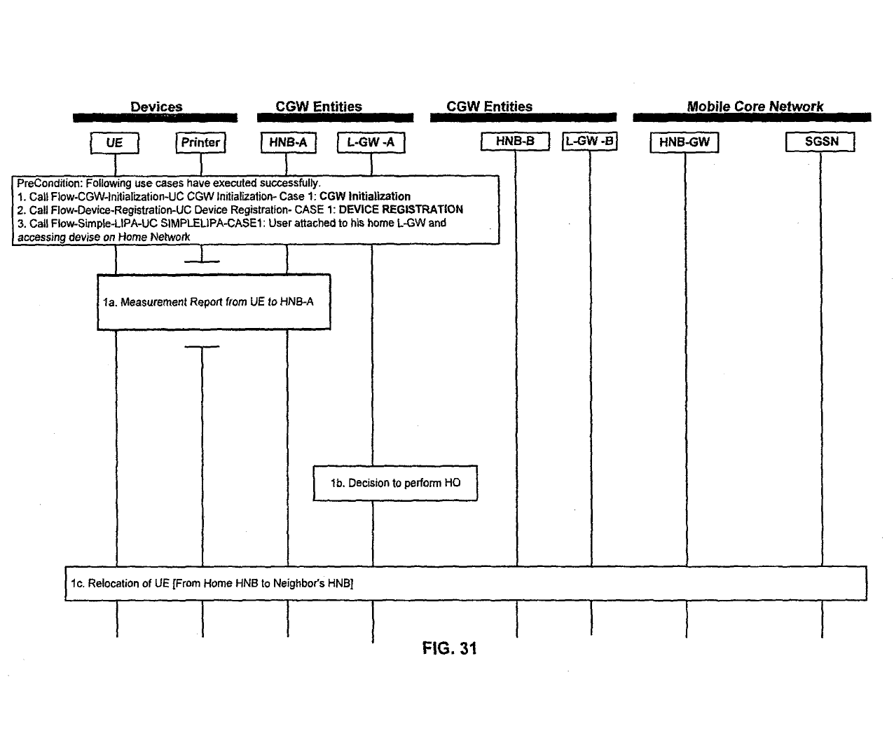

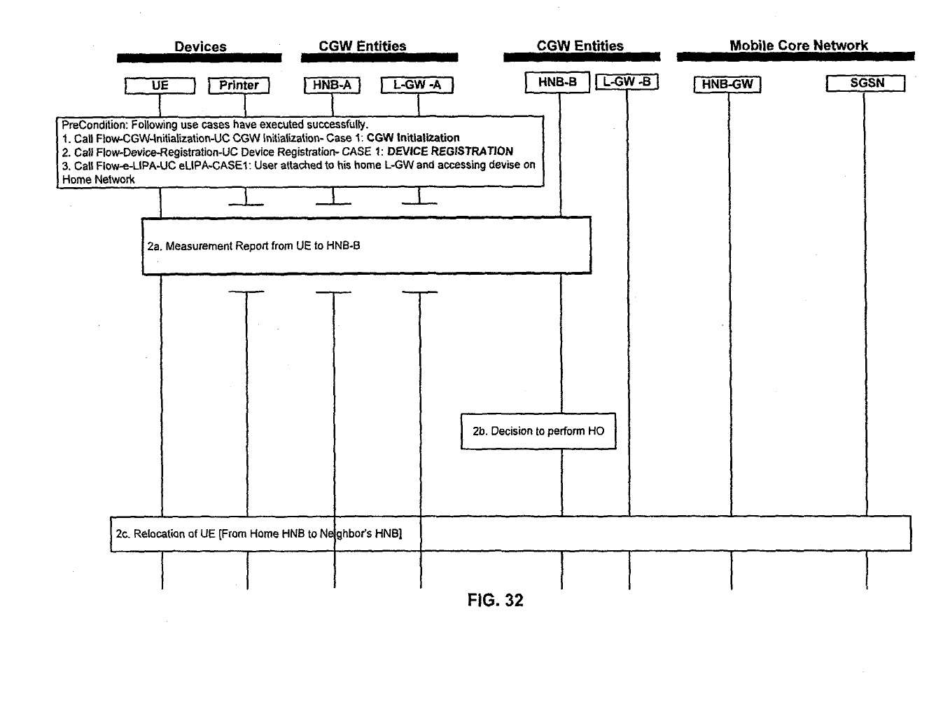

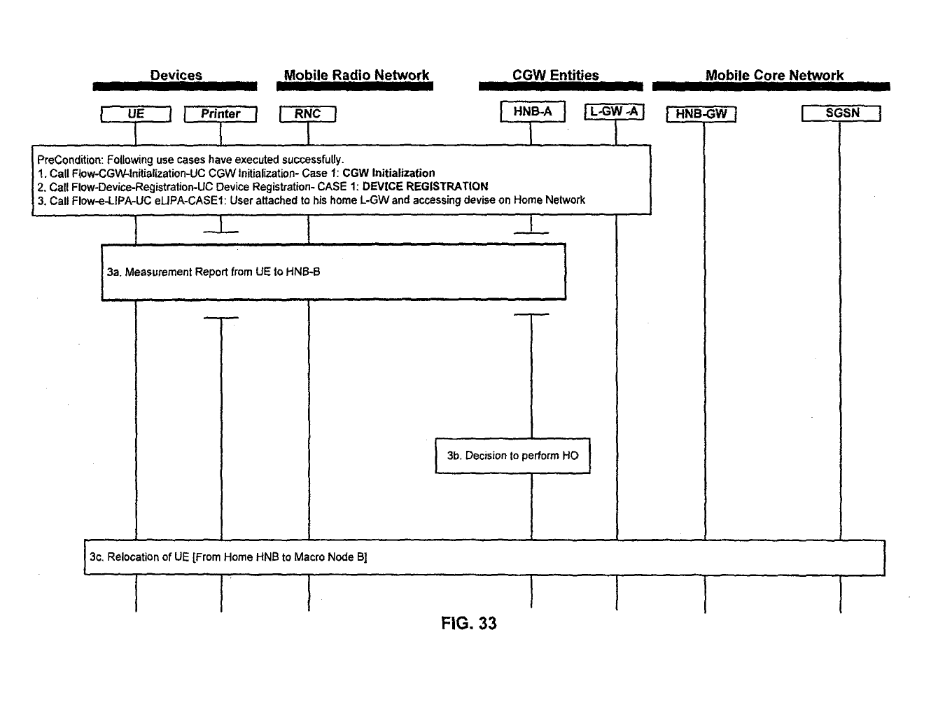

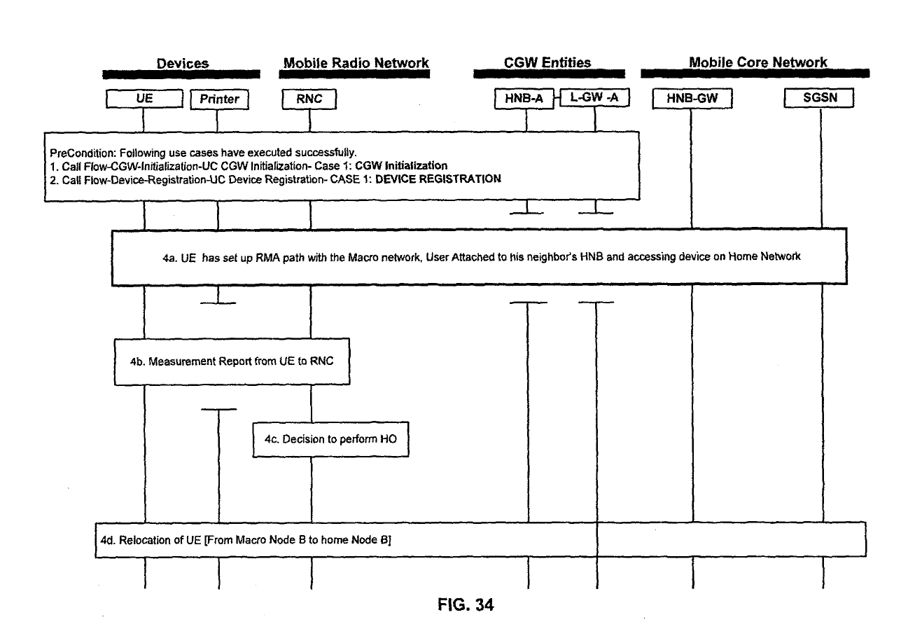

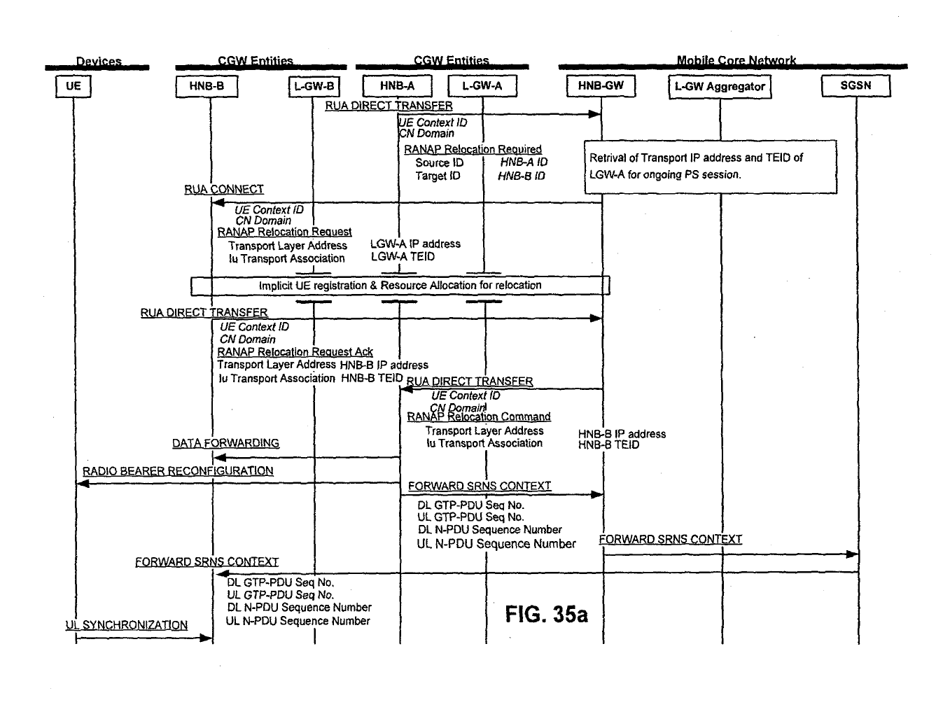

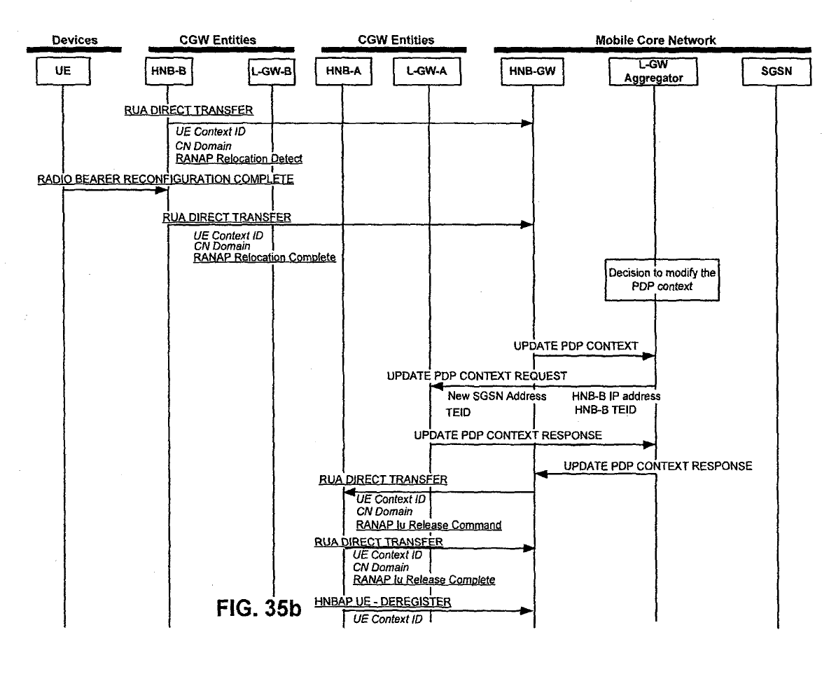

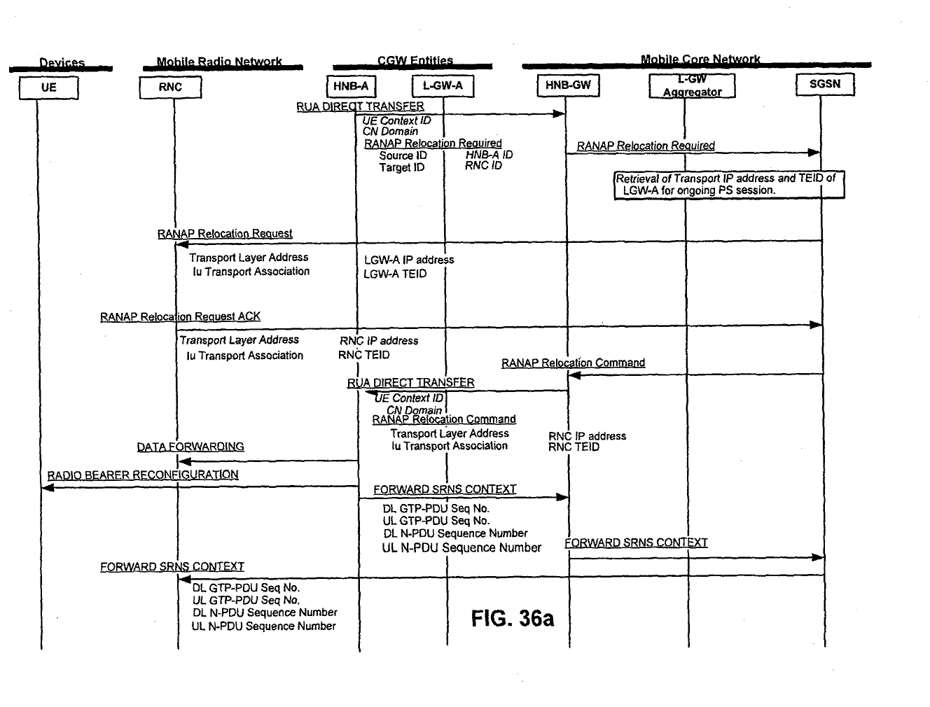

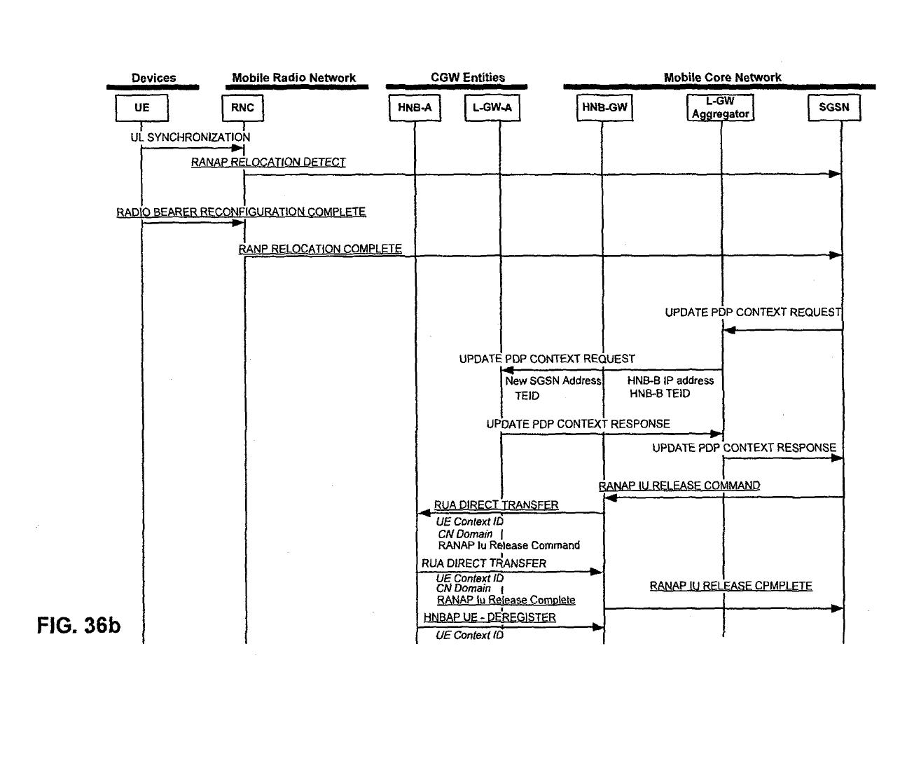

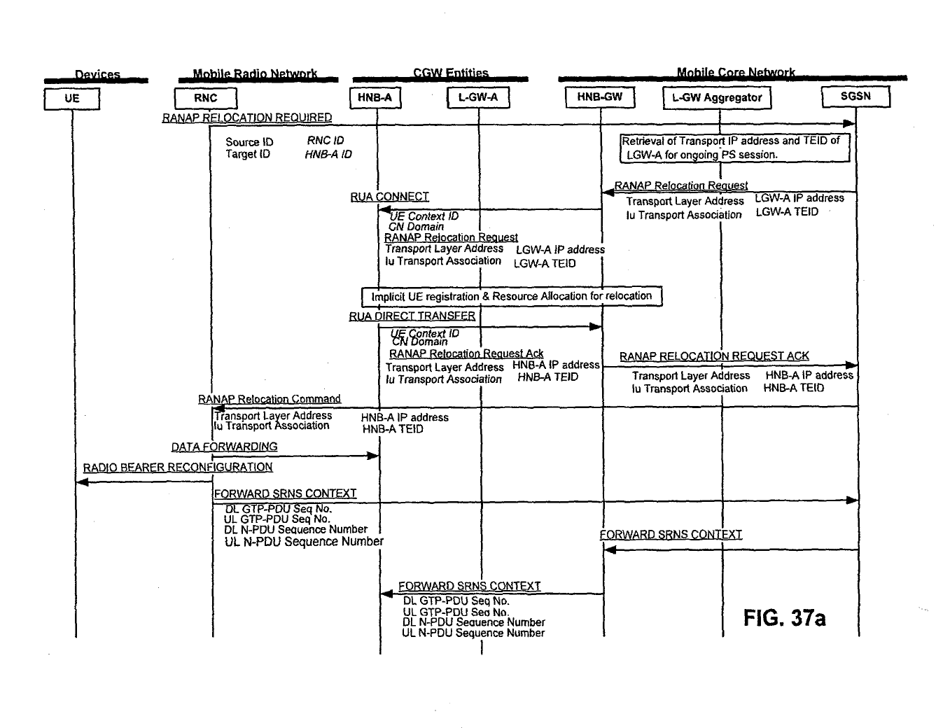

The HNB Handover MSCs, as shown in FIG. 31 thru FIG. 37B are exemplary illustrations of the active handover of packet switched (PS) sessions between HNBs, from HNB-to-macrocell, and from macrocell-to-HNB. FIG. 31 is an exemplary illustration of a procedure for a UE moving to a neighbor's HNB after being attached to the UE's home LGW and the UE accessing a device its home network. FIG. 32 is an exemplary illustration of a procedure for a UE moving to its home node B during a timeframe the UE is accessing its home network while attached to a neighbor's HNB. FIG. 33 is an exemplary illustration of a procedure wherein a UE attached to its home HNB and accessing a device on its home network, moves to a macro network. FIG. 34 is an exemplary illustration of a procedure wherein a UE attached to a macro network and accessing a device on its home network moves to its home network. FIG. 35A and FIG. 35B are an exemplary illustration of a procedure for intra HNBGW mobility (LIPA to ELIPA), wherein FIG. 35B is a continuation of FIG. 35A. FIG. 36A and FIG. 36B are an exemplary illustration of a procedure a UE accessing a home device and moving to a macro network (LIPA to MRA), wherein FIG. 36B is a continuation of FIG. 36A. FIG. 37A and FIG. 37B are an exemplary illustration of a procedure for a UE accessing a home device via a macro network and moving to a femto network (RIMA to LIPA), wherein FIG. 37B is a continuation of FIG. 37A.

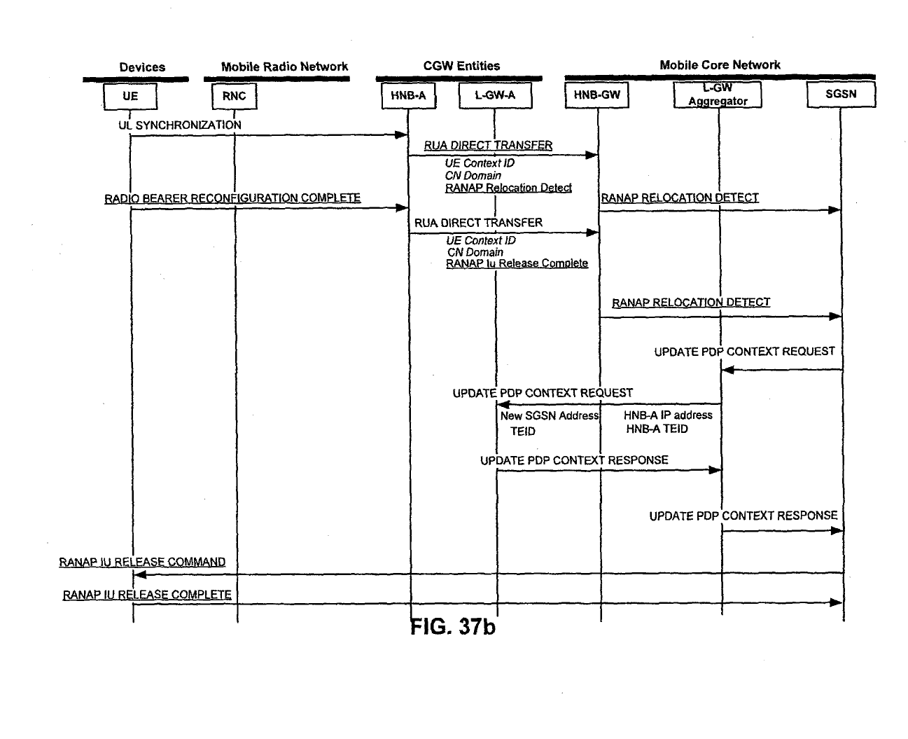

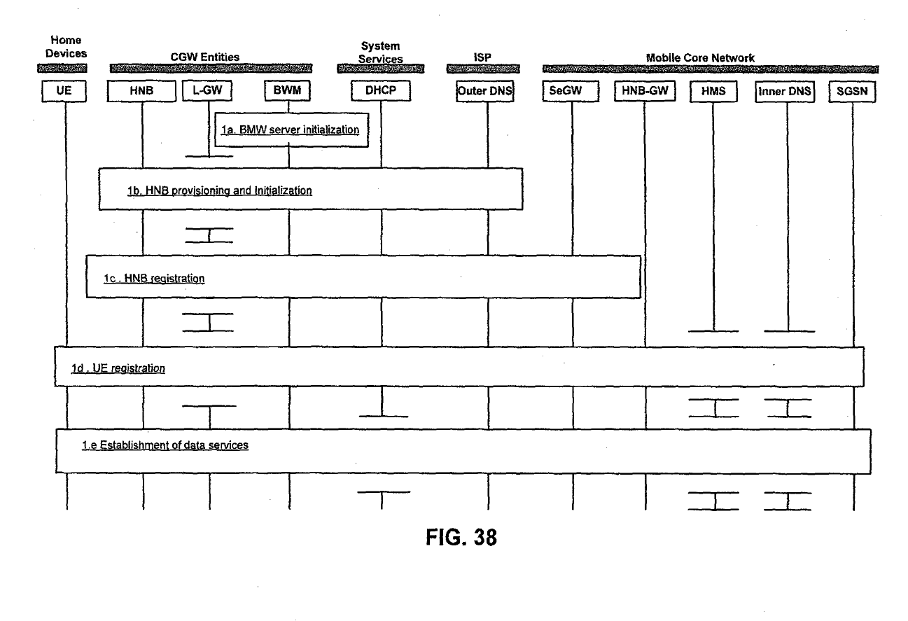

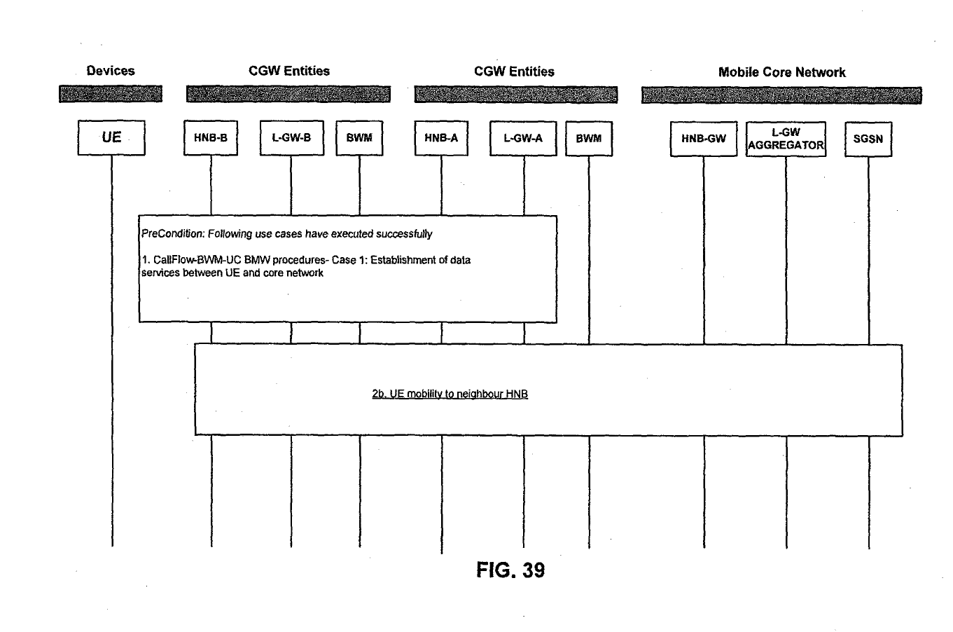

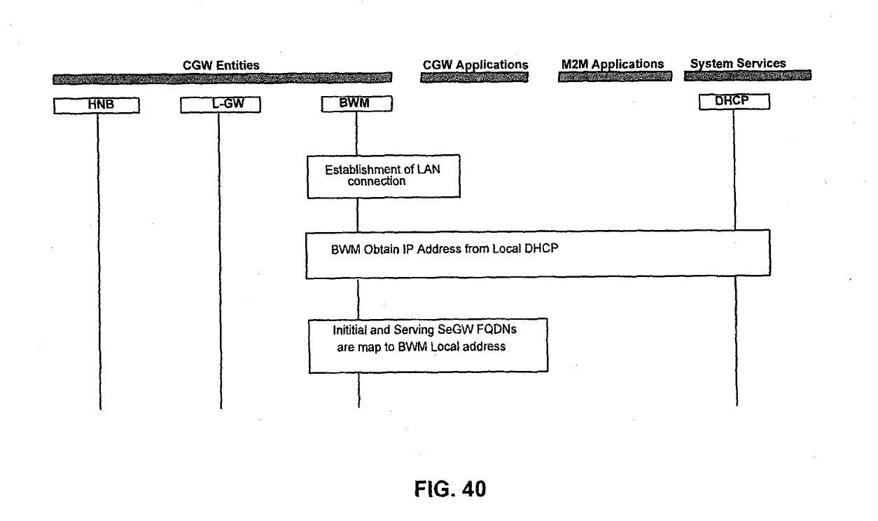

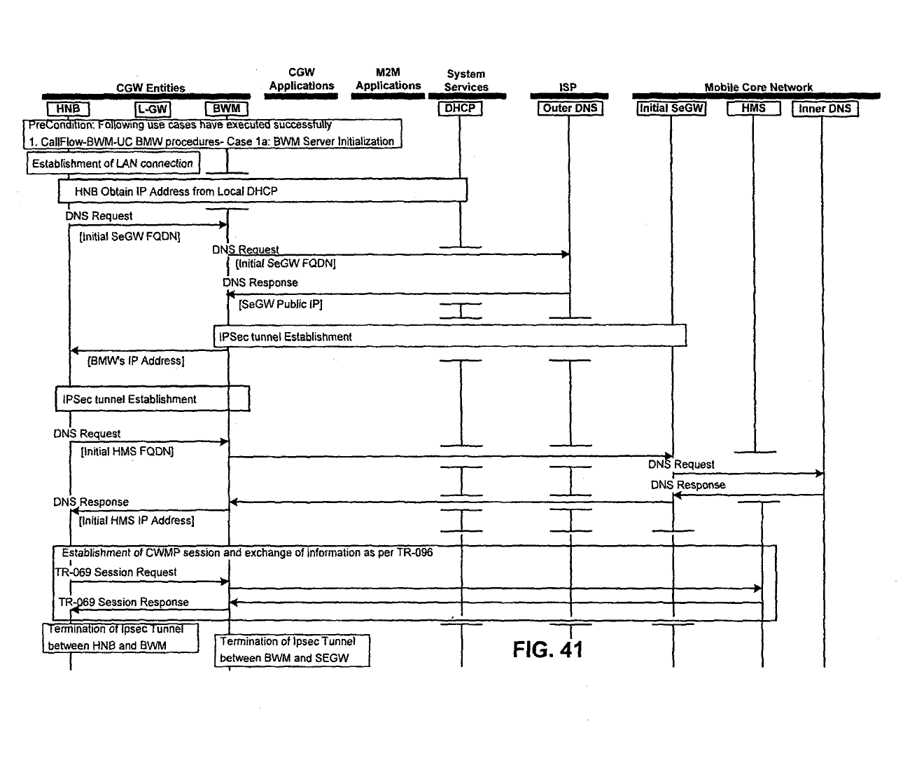

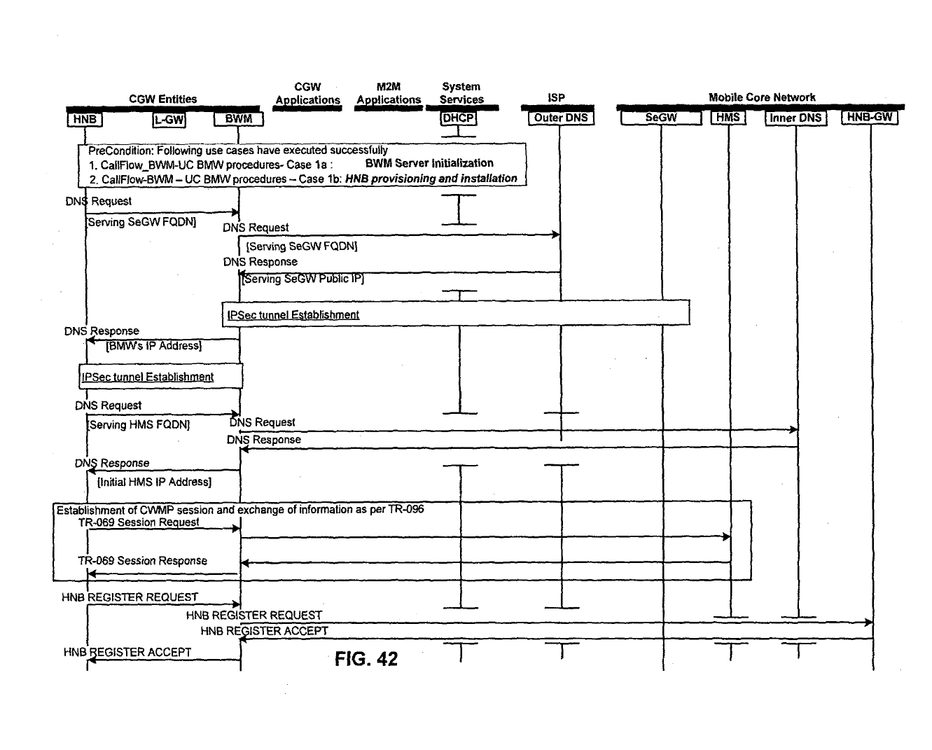

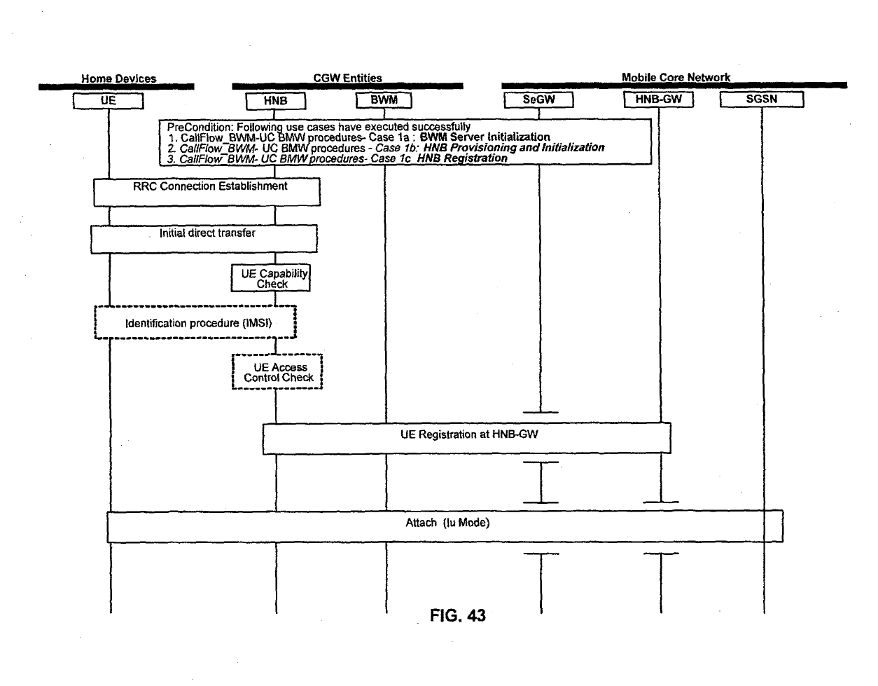

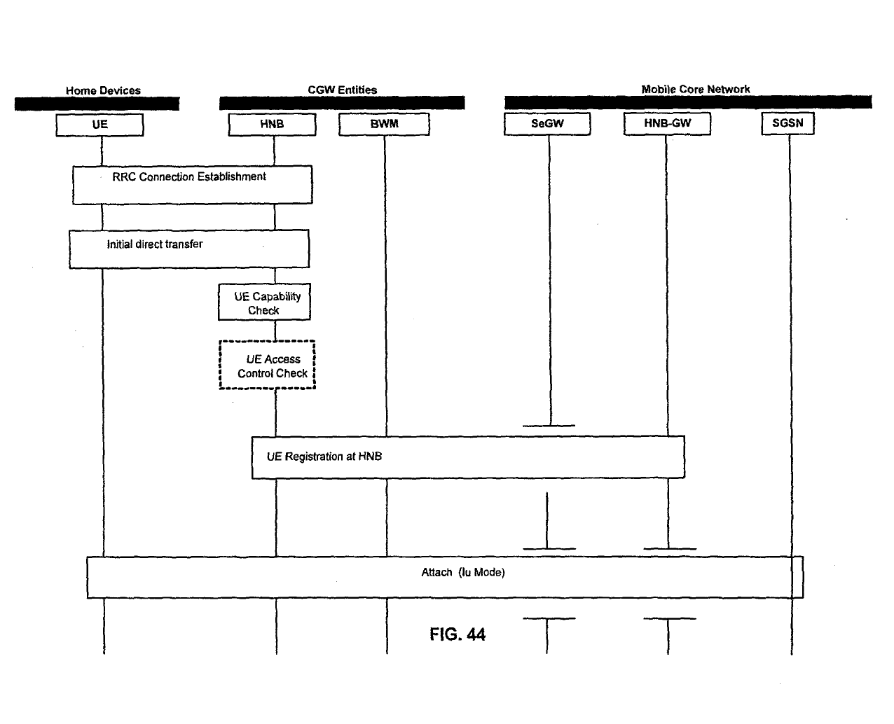

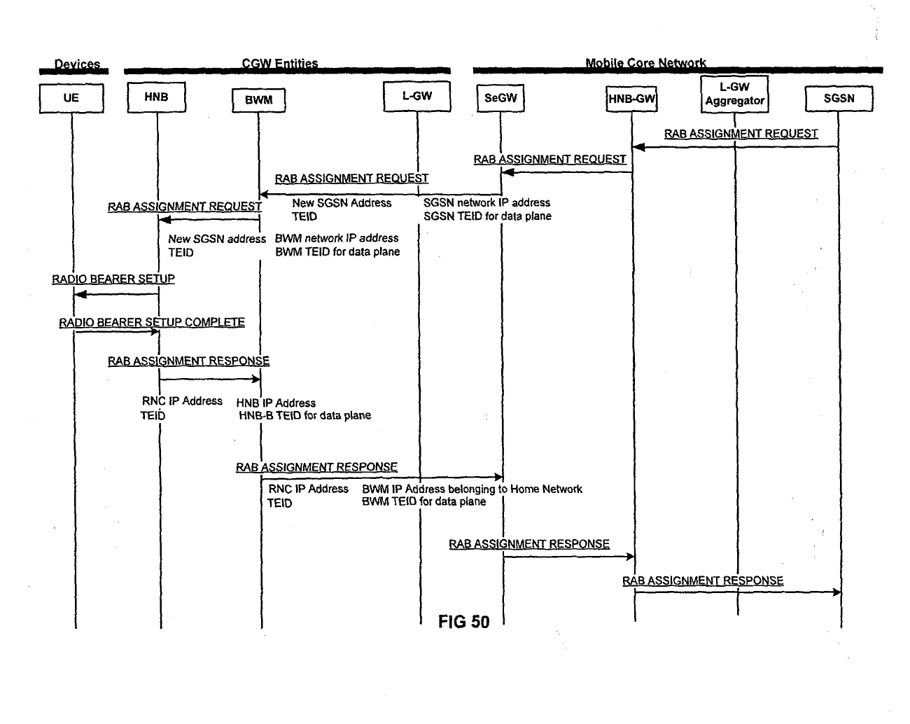

The BWM MSCs, as shown in FIG. 38 thru FIG. 50, are exemplary illustrations of the initialization, session establishment, and mobility procedures associated with the introduction of the BWM server within the CGW between the HNB and the MCN. FIG. 38 is an exemplary illustration of a procedure for the establishment of data services between a UE and core network. FIG. 39 is an exemplary illustration of a procedure for the mobility of UE connected to one HNB to a neighbor's home network, wherein the neighbor is connected to another HNB. FIG. 40 is an exemplary illustration of a procedure for BWM initialization. FIG. 41 is an exemplary illustration of a procedure for CGW initialization in the presence of BWM. FIG. 42 is an exemplary illustration of a procedure for HNB registration. FIG. 43 is an exemplary illustration of UE registration (Non closed subscriber group (CSG) UE). In FIG. 43, messages (e.g., all messages) between the HNB and MCN elements may pass through the HNBGW. The BWM server may unpack messages from one IPSec tunnel and then repack them on the other IPSec tunnel. FIG. 44 is an exemplary illustration of UE registration for a CSG UE.

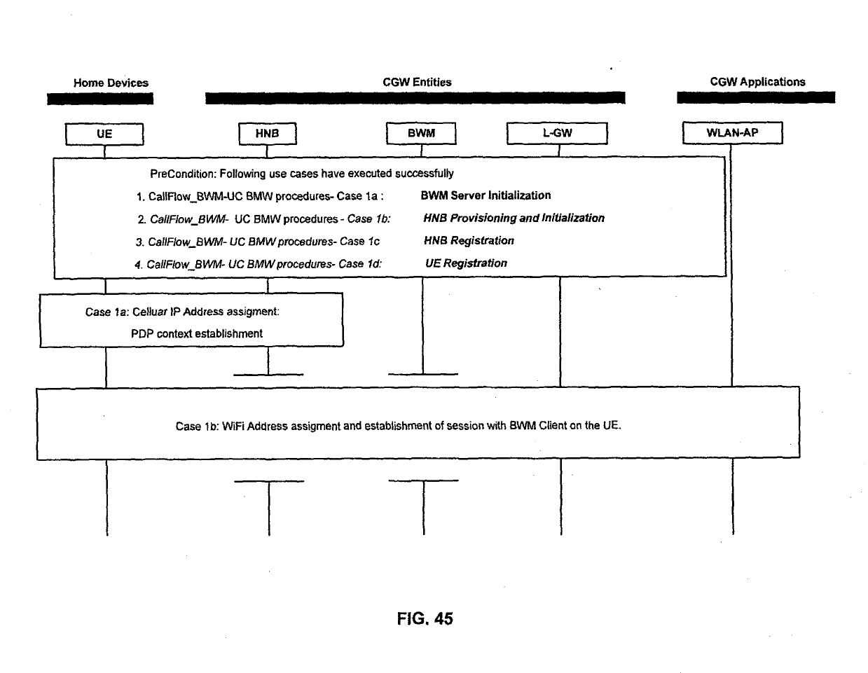

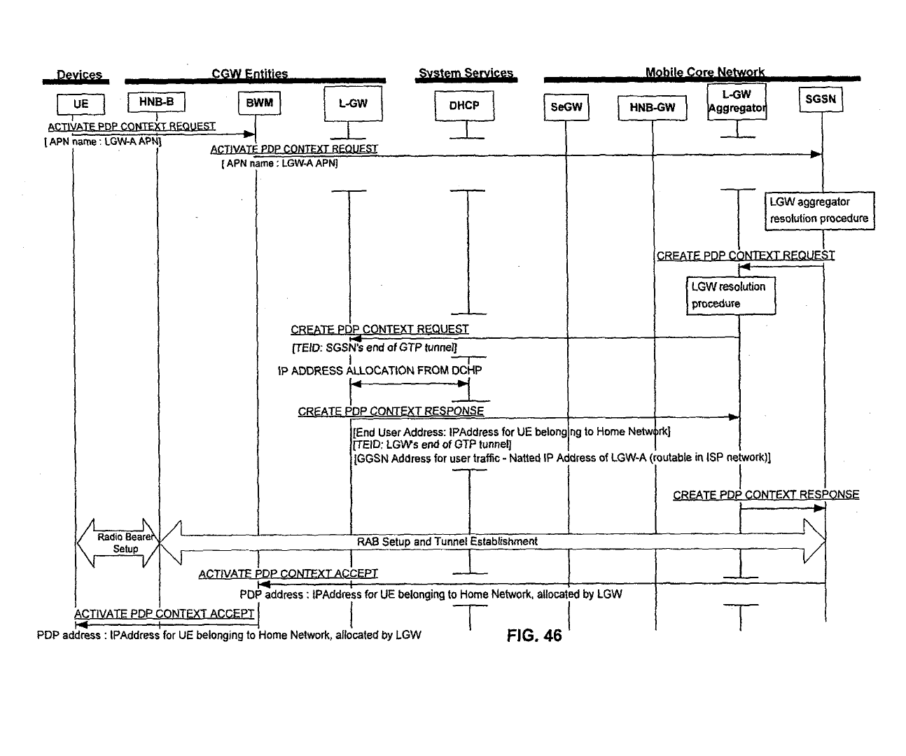

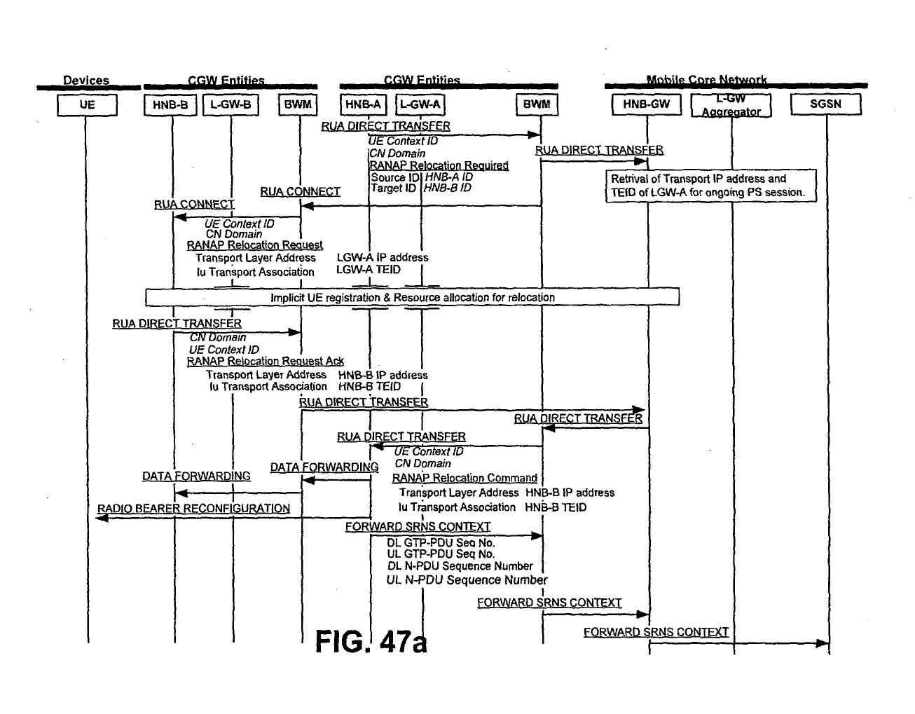

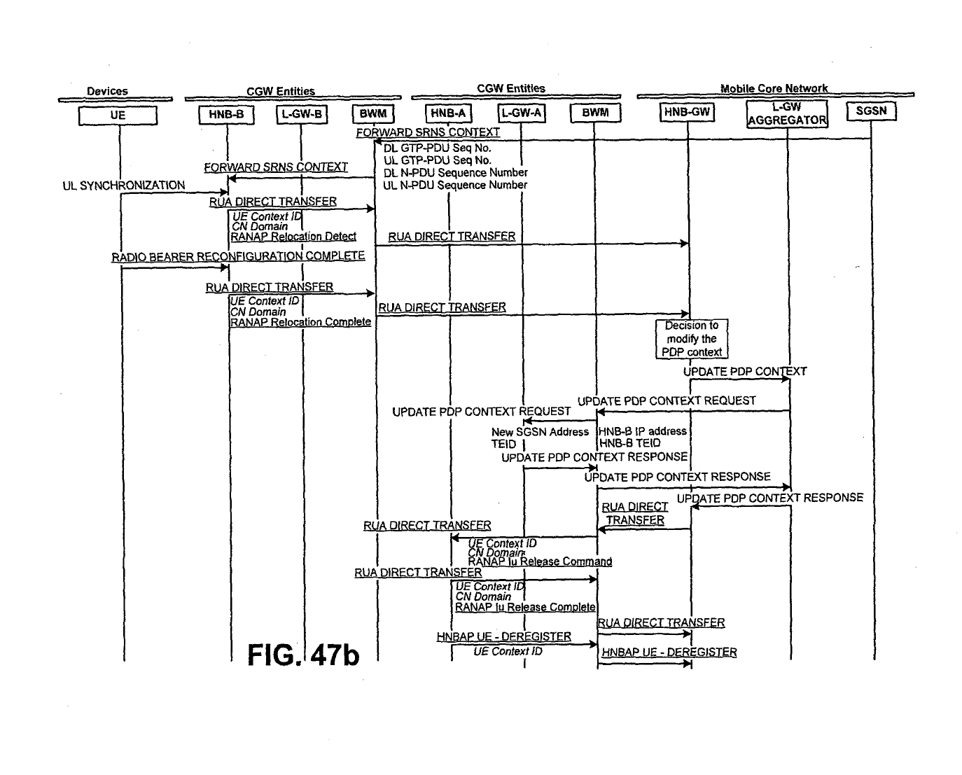

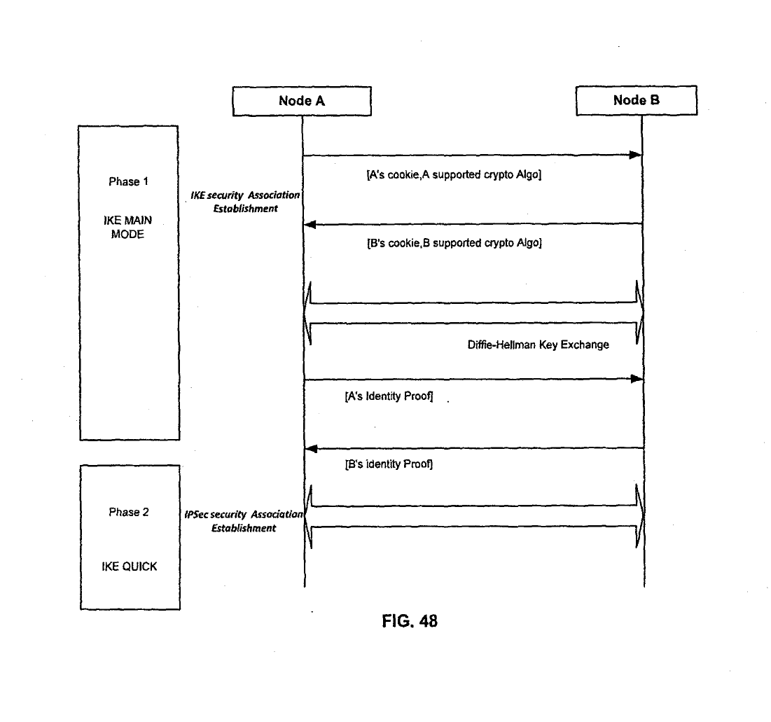

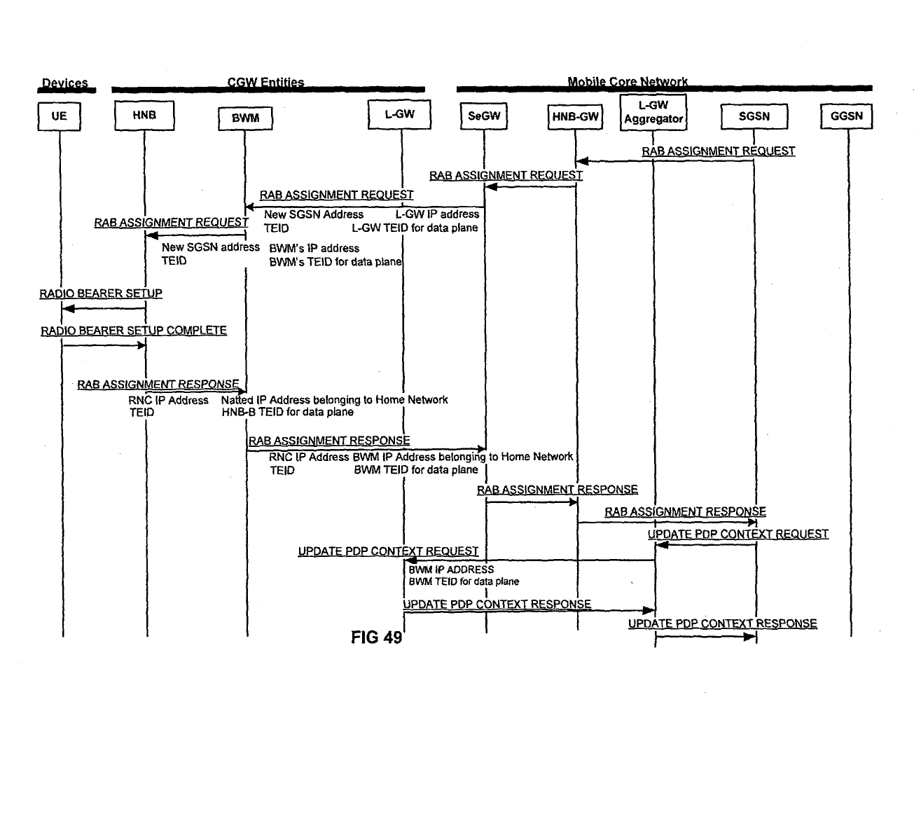

FIG. 45 is an exemplary illustration of packet switched (PS) data services establishment. FIG. 46 is an exemplary illustration of cellular PDP context establishment. FIGS. 47A and 47B are an exemplary illustration of procedures for intra HNBGW mobility (LIPA to ELIPA), wherein FIG. 47B is a continuation of FIG. 47A. FIG. 48 is an exemplary illustration of IKE IPSec procedures between BWM and SeGW. FIG. 49 is an exemplary illustration of procedures for RAB Setup and user plane establishment with one tunnel establishment. FIG. 50 is an exemplary illustration of procedures for RAB setup and user plane tunnel establishment with two tunnel establishment.

Assigning unique APNs to each LGW may lead to a large number of entries in an SGSN APN database. In certain exemplary embodiments, the LGW's IP address may be resolved at runtime based on logic provided by the core network. Typically, each LGW may have a unique identity pre-determined in a manner similar to a HNB. Also, a user profile in the HLR may have entries for the home HNB and/or the home LGW. Under this scheme, the address resolution process may incorporate the following scenarios: (1) the user may be latched to the home HNB and may desire to connect to the home network—the network may resolve the IP address of user's home LGW; (2) the user may be latched to neighbor A's HNB and may desire to connect to the home network—the network may resolve the IP address of user's home LGW; and/or (3) the user may be latched to neighbor A's HNB and may desire to connect A's network—the network may resolve the IP address of Neighbor's LGW.

Many different “digital home” uses may be enabled by the Hybrid Network Converged Gateway architecture. Since WiFi and Cellular accesses is expected to be available within the Integrated Home Network, one use includes the device being a Multi-RAT (e.g., dual mode WiFi & Cellular) device. The data transfer between such a device and the CGW may take place in parallel on both RATs. The parallel transmission may be used to provide higher data rates or improved robustness (by providing multi-RAT diversity) or to provide flexibility (by mapping data packets appropriately and adaptively onto each RAT depending upon various characteristics such as security, data rates, QoS, cost, robustness, and channel quality, among others).

In certain exemplary embodiments, a smartphone may communicate with the CGW using the Cellular RAT (so that QoS is guaranteed, as opposed to the WiFi RAT), and the CGW may communicate with the STB over Ethernet. Following the accessing of the TV Program Guide, the smartphone user may initiate a viewing session. The content, in this example, may be streaming from the WAN. A variation may include the content residing in a DVR unit, which may be connected (or coupled) to the STB. In this example, the video transfer may be local to the IHN.

The CGW architecture may have the following use case categories: (1) local access, (2) remote access, (3) lawful interception, (4) mobility, (5) home security, (5) enterprise (small business), (6) enterprise (network operator), (7) enterprise (home office), (8) self-configuration, (9) store, (10) carry and forward, and/or (11) bandwidth aggregation.

Examples of local access may include session push, local based access to network for L1PA (through the CGW and/or peer-to-peer) and non-L1PA services, mobility within home/enterprise, parental control and guest access, support of legacy devices (non-IMS), session modification, content sharing/multicast, inter-CGW coordination, and get nearest copy.

Examples of remote access may include remote access of media data, media services, and media devices within the home, remote access of security devices within the home, and/or remote access of appliances within the home.

Examples of lawful interception may include lawful interception under LIPA scenarios, surveillance—presence, and/or content protection/digital rights management.

Examples of mobility may include inbound mobility (macrocell-to-CGW), outbound mobility (CGW-to-macrocell) and/or inter-CGW mobility. An example of home security may include notification to remote stakeholders.

Examples of a small business enterprise may include customer guide in shopping center using LIPA access, 1P-PABX and/or mobile IP-PABX.

Examples of a network operator enterprise may include new operator offers NW whose capabilities are IMS capable (e.g., only IMS capable—no CS domain), operator removes legacy services (removes CS domain), open access mode, hybrid access mode, offload of CS domain congestion, offload of PS domain congestion—SIPTO, improved coverage, and/or interoperability across providers.

Examples of a home office enterprise may include access to home based content and devices, and/or access to outside home services.

Examples of self-configuration may include built-in test/diagnostics, self healing, energy savings, self-configuration upon power up of CGW, and/or self configuration upon power up of devices which may access the CGW.

An example of store, carry and forward may include a stationary device that may use the CGW to hold data until the CGW can forward the data to its destination.

Examples of bandwidth aggregation may include mega-data transfers, a security function that may break (or divide) the data over several RATs to hide traffic, and/or minimal error—redundant transmissions.

The term “Bandwidth Management (BWM)” may be used to refer to various ways to control multiple, simultaneously active radio links between a WTRU and a MCN. For example, the multiple radio links may be a cellular radio link and a WiFi radio link. The control schemes may include aggregation of the bandwidths provided by the individual radio links to serve a high bandwidth application, which may not be able to be sustained by any of the individual links. The control schemes may include steering of individual traffic flows to different radio links, so that a better match may exist between or among the QoS, security and/or some other attribute of the radio link and the corresponding requirement of the traffic flow. The control schemes may include switching over a traffic flow from one radio link to another in cases of failure and/or excessive degradation of a particular radio link. The control schemes may include highly dynamic steering of individual traffic packets, for example IP packets, across the multiple radio links in concert with the changing temporal fading characteristics of the radio links.

Although the BWM capability and/or control schemes may be described in relation to certain embodiments, it should be appreciated that the BWM capability and/or control schemes may be applicable to a wide variety of uses beyond the described embodiments.

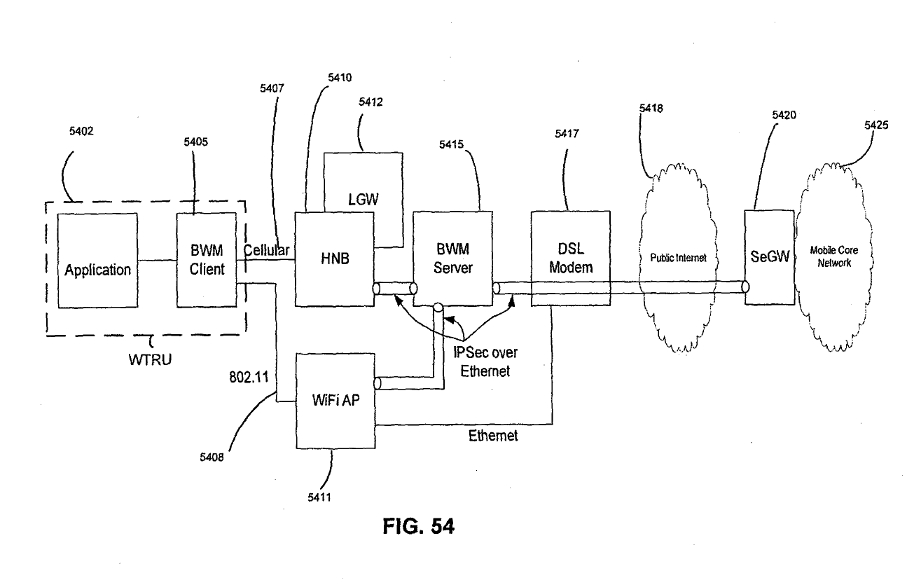

By way of example, a MultiRAT BWM system may be an ‘anchor’ point of the various radio links and another anchor point may be the MultiRAT WTRU itself. In certain exemplary embodiments other anchor point may also exist within the network. FIG. 54 illustrates one option, where the network anchor point may be between the HNB (or femto access point) and the MCN—viewed as a ‘Local-MultiRAT-BWM system’—for example. The anchor-point may be within the HNB itself, which may lead to a modified HNB architecture and may be viewed as an ‘HNB-integrated-MultiRAT-BWM system’. As another example, the anchor-point may be outside the MCN itself, which may lead to a configuration that may be viewed as a Macro MultiRAT-BWM system.

For the Local-MultiRAT-BWM system, in addition to using the cellular network between the MCN and WTRU, some data may be routed between the MCN and WTRU via, for example, a WiFi connection (or other RAT). This traffic offloading may be done at the IP packet level, and one IP flow may be broken up (segregated or divided) using multiple RATs for approximately simultaneous transmission. For example, as shown in FIG. 54, a BWM system may include a BWM server 5415 and a BWM client 5405. The BWM server may be placed between the HNB 5410 and SeGW edge 5420 of the MCN 5425. The BWM client 5405 may be placed within the WTRU device 5402. A local gateway (LGW) 5412, which may be a functional entity for the purposes of local IP connectivity, may be between the WTRU device 5402 and other IP devices (e.g., the BWM server 5415). A WiFi AP 5411 may have an 802.11 interface 5408 that may connect to the WTRU device 5402, and additional interfaces that may connect to the BWM server 5415 and a DSL modem 5417. The BWM server 5415 may have connections to the HNB 5410 and/or LGW 5412, the WiFi AP 5411 and/or the DSL modem 5417. The DSL modem 5417 may connect to the Internet 5418.

A BWM server and BWM client may form an association that may denote the available transports that exist between the client and server. In certain exemplary embodiments, the transports may be one cellular transport and one WiFi transport. A WTRU device may be capable of using multiple transports, but if only one transport is available, using the BWM to perform bandwidth aggregation (BWA) may allow for handoff scenarios when another transport type becomes available. Multiple cellular and multiple WiFi transports may also exist, such as the following exemplary transport pairs: Cellular+WiFi, Cellular+Cellular, or WiFi+WiFi, among others. It is also contemplated that wired transports such as Ethernet may be used with the BWM and/or the CGW.

When an association is performed, a policy entity within the BWM server and client may decide how best to deliver packets to the other entity (e.g., the BWM server may decide the “best” transport to use to deliver a packet to the BWM client). Both the BWM server and client may have a common requirement to perform this segregation/aggregation of packets between the available RATs.

As shown in FIG. 54, the BWM server 5415 may be located in between the HNB 5410 and the SeGW 5420. Other requirements (e.g., additional requirements) may be imposed on the BWM server 5415 based on its location (e.g., logical location) between the HNB 5410 and the SeGW 5415. The BWM server 5415 may appear as the HNB 5410 to (towards) the SeGW 5420 and appear as the SeGW 5420 to (towards) the HNB 5410. In addition to BWM server's duties regarding the handling of data packets, it may terminate IPSec tunnels that may be in-place between the HNB 5410 and the SeGW 5420 and may terminate GTP tunnels between the SGSN (not shown, but may be located in the MCN 5425) and the HNB 5410. As the termination point for the IPSec and/or the GTP (or both), the BWM server 5415 may perform the “un-IPSecing” and “re-IPSecing” of packets that pass between the HNB 5410 and the SeGW 5420 and may perform the “un-GTPing” and “re-GTPing” of packets that pass between the HNB 5410 and the SGSN (not shown, but may be located in the MCN 5425). Deep packet inspection and the modification of message contents may be performed by the BWM server 5415.

Incorporation of the BWM within the MCN may provide one or more benefits. From an end-user point of view, the BWM may provide a better user experience by realizing higher throughput and/or continued connectivity (even in the face of environmental factors such as interference). For the operator, the BWM, which may rely on BWA, may provide a premium service that may result in higher revenues and the offloading of traffic from the HNB cellular infrastructure. The MCN operator may offer a WiFi access point to offload traffic from the HNB access point which may allow the MCN operator control of the WiFi access point into the home or enterprise. The MCN operator may become the provider of the WiFi access point, which may allow the operator to charge the home owner a premium. By using the BWM, the femtocell may appear to be providing higher throughput from a user perspective. The femtocell may be able to deliver a certain maximum throughput and support a maximum number of users. With the addition of the BWM, the HNB may appear to offer a higher throughput and may support more users. The added throughput may go through (traverse) the WiFi transport, but from a user standpoint, a higher throughput may be enabled and more users can use the HNB.

A protocol to enable a communication session over multiple networks may be used in multiRAT BWM. The protocol may be configured to manage communications over multiple data links (e.g., radio access links) to a data network transparently to the communicating device. For example, the protocol may be a Multi-Network Transport Protocol (MNTP), such as the MNTP developed by Attila technologies.

The MNTP may be run over (executed in) a “transparent” UDP layer. Similar transparent UDP layer protocols may be used. By using MNTP, a client may be allowed to effectively utilize its multiple data links (e.g., radio access links) to a data network that the MNTP client (e.g., WTRU device) has available in a way that may be transparent to a peer. The MNTP may provide a way of doing so while preserving and enhancing numerous performance characteristics of transmission control protocol (TCP). A description of how the MNTP protocol may be used in an end-to-end MultiRAT BWM system is disclosed herein.

Implementing BWM server systems may include: (1) BWM server initialization; (2) HNB initialization/provisioning; (3) HNB registration; (4) GPRS attach; (5) establishment of data services using BWM aggregation; (6) data transfer using BWM aggregation; (7) DSM interaction with the BWM server; (8) Mobility; and/or (9) CS Voice, among others.

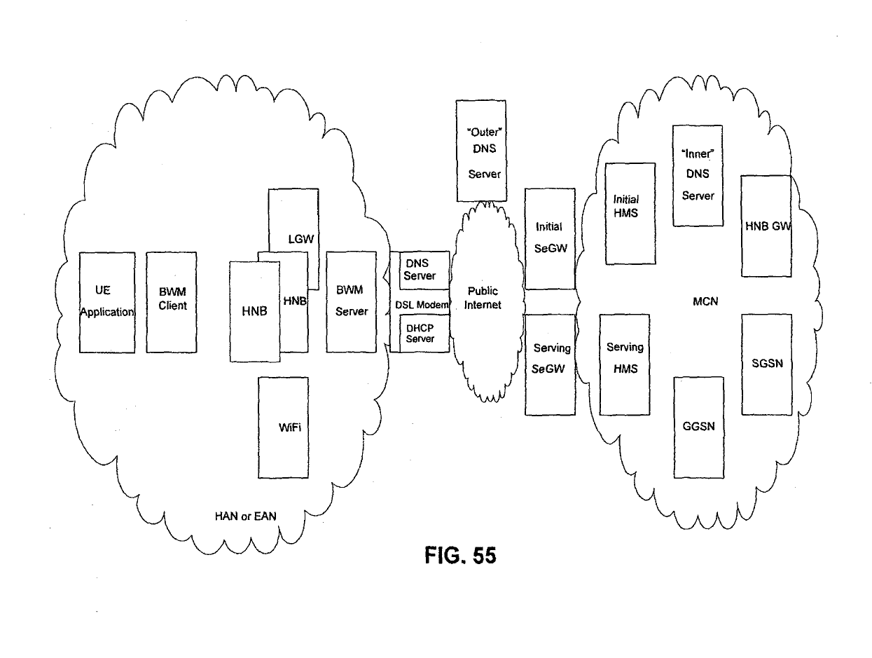

Enterprise scenarios may be implemented in which more than one HNB communicate with the MCN through a single BWM server or multiple BWM servers. FIG. 55 is an exemplary illustration of elements used in such architecture.

Although the following discussion may focus on a PDP context through the MCN (e.g., remote IP access (RIPA), the use of the PDP context may be applied to other systems, such as an LIPA connection. For an LIPA connection, the SGSN may be replaced by the LGW, which may be local within a home. It is also contemplated that multiple PDP contexts may be established (e.g., some combination of LIPA and RIPA) for a single WTRU device.

If a WTRU device supports cellular (e.g., only supports cellular) or if a WiFi AP is not available, for whatever reason, then the BWM may become a pass-through. For example, the data stream may not be bifurcated and may be delivered via the cellular transport. If the cellular service is not available, no data session may exist because the solution makes use of the MCN. That is, if there is no cellular service, there may be no data connection through the MCN.

Some exemplary implementation of BWM operation when the BWM is located between the HNB and the MCN may include: (1) the BWM may replicate many of the NW and HNB functions; (2) the BWM may route and selectively modify signals between the HNB and the MCN; and/or (3) the HNB may register normally and then may provide information to the BWM. For example regarding operation (3) above the following may occur: (a) the HNB may register with the core network normally as defined in standards; (b) once HNB is “operational”, the HNB may share to the BWM via signaling or via some API the network information received during the HNBGW discovery, provisioning and HNB registration process; (c) the HNB to SeGW IP Sec tunnel may then be torn down; and/or (d) two new IPSec tunnels may be put into place (one between the HNB and the BWM and another between the BWM and the SeGW), among others. Once the tunnels are set up, the method may be the same as the other (1) and (2) above. Details regarding different methods are disclosed herein.

A BWM server may be initialized (e.g., upon power-up). For example, the BWM server may perform a dynamic host configuration protocol (DHCP) discovery procedure. Once this is complete, the BWM server may have a local IP address and may have its DHCP server established with an entry for the Initial SeGW.

A local IP address may be acquired by performing the following operations, resulting in the BWM server having a local IP address on the EAN and/or HAN. The BWM server may broadcast a DHCP Discovery message requesting a local IP address, which may be received by a home or enterprise modem (cable/DSL). A DHCP server within the home or enterprise modem may respond with a DHCP offer message comprising the local IP address being offered by the home or enterprise modem. This offer may include information for a DNS server on the Internet (“Outer” DNS server). The BWM server may broadcast a DHCP request indicating that the offer from the above has been accepted (since multiple DHCP servers can offer an IP address). The DHCP server within the home or enterprise modem may respond with a DHCP acknowledgment message.

The BWM server, having a local IP address, may populate a lookup table within its DNS server (or equivalent) that may have a mapping between the Initial SeGW (in memory) and the local IP address provided by the DHCP server. Table 1 illustrates such functionally.

TABLE 1

| FQDN | IP Address |
|---|---|
| Initial SeGW | Local IP address assigned by DHCP Server in |
| | home or enterprise modem |

The mapping may enable the HNB to regard the BWM server as the Initial SeGW. The above describes the use of a DNS server within the BWM server, however, one skilled in the art understands that other methods may be used to perform the DNS server function. For example, the BWM server may have a full DNS server or the BWM server may act as a proxy DNS server by listening to the DNS response for the Initial and Serving SeGW from the “Outer” DNS server and may modify the address for these entities in the messages sent to the HNB. From a functionality standpoint, these operations may bring about the same result. There are different types of DNS requests that may be made by the HNB which is discussed herein.

Initializing and provisioning the HNB (e.g., upon power-up) may provide for the HNB to know (or determine) the FQDN and/or IP address of the MCN entities that the HNB may communicate with during it operations (e.g., the normal course thereof). The HNB may know (or determine) its environment and may provide the information to the Initial HMS, as well. The HNB may use a local IP address. In order to acquire an IP address the HNB may perform the DHCP discovery procedure.

A local IP address may be acquired for the HNB by performing a combination of the following, resulting in the HNB having a local IP address on the EAN and/or the HAN. The BWM server may broadcast a DHCP Discovery message requesting a local IP address, which may be received by a home or enterprise modern (cable/DSL). The DHCP server within the home or enterprise modern may respond with a DHCP Offer message comprising the local IP address being offered by the home or enterprise modem. This offer may include information for the DNS server on the Internet (“Outer” DNS Server). The BWM server may broadcast a DHCP Request indicating that the offer from the above has been accepted (since multiple DHCP servers can offer an IP address) and the DHCP server within the home or enterprise modem may respond with a DHCP Acknowledgment message.

As part of the power on and/or initialization sequence, the HNB may attempt to discern information about its environment. There are many ways for the HNB to learn about its environment. For example, the HNB may listen for macrocells and other HNBs in the area by enabling its cellular receiver (e.g., 2G, 3G, and/or 4G). The HNB may determine its location by enabling its GPS receiver or, the HNB may know (or determine) its location based on the public IP address of the home or enterprise modem to which it is connected. Any of these may be sufficient for the HNB to identify its location.

The HNB may communicate with the Initial SeGW after the device has been energized. The HNB may attempt to resolve the FQDN of the Initial SeGW that was pre-burnt within the HNB. This resolution may be performed with a DNS Request/Response. The BWM server may act as a DNS server (or equivalent) to the HNB for this purpose. The BWM server may resolve the Initial SeGW FQDN by sending a DNS Request to the “Outer” DNS server on the Internet.

The Initial SeGW discovery may be accomplished by performing one or more of the following. The HNB may send a DNS Request to the DNS server (or BWM server) to resolve the Initial SeGW FQDN that was pre-burnt within the HNB. The DNS server within the BWM server may look up the Initial SeGW FQDN in its database and retrieve its local IP address. The DNS server within the BWM server may send this information to the HNB. The BWM server may send a DNS Request to the “Outer” DNS server on the Internet with the Initial SeGW FQDN that it received from the HNB and the “Outer” DNS server may respond to the BWM server with the public IP address of the Initial SeGW.

In order to provide secure communications between the HNB and the Initial SeGW, an IPSec tunnel may be established between the two entities. The process may include a pre-shared key and agreement of security algorithms between the two entities. Since the BWM server, for example, may be placed between the HNB and Initial SeGW, two IPSec tunnels may be established (e.g., BWM server-to-initial SeGW and HNB-to-BWM server).

An exchange of messages may allow the formation of an IPSec tunnel. For an IPSec tunnel establishment between the BWM server and Initial SeGW, one or more of the following may be performed. The BWM server may send an IKE_SA_INIT message to the Initial SeGW (e.g., to request certain encryption algorithms, authentication algorithms and/or DH groups). The Initial SeGW may respond with an IKE_SA_INT response (e.g., may respond with a selected encryption algorithm, authentication algorithm and/or CH group). The BWM server may send an IKE_AUTH message to the Initial SeGW. The BWM server IKE_AUTH message may include a request for an MCN IP address. The Initial SeGW may respond with an IKE_AUTH response. The Initial SeGW IKE_AUTH may include an MCN IP address. The BWM server may send a CREATE_CHILD_SA message to the Initial SeGW. The Initial SeGW may respond with a CREATE_CHILD_SA response.

For IPSec tunnel establishment between the HNB and the BWM server, the same or a similar process may be followed. The BWM server may use the MCN IP address prior to the HNB requesting it. The HNB may use the MCN IP address so that it can use the MCN IP address as the source address for IP packets that it sends to entities within the MCN.

The HNB may be used to communicate with the Initial HMS (e.g., after establishing an IPSec tunnel). The HNB may attempt to resolve the FQDN of the Initial HMS with the “Inner” DNS server located within the MCN network. In the absence of a BWM server, the HNB may send a request to the Initial SeGW via the IPSec tunnel established previously. The Initial SeGW may un-IPSec the request and may send the packet to the “Inner” DNS server for resolution. In the presence of a BWM server, the process may be the same or similar from the point of view of the HNB and/or the Initial SeGW. The BWM server may un-IPSec and then may re-IPSec the signaling between the HNB and Initial SeGW and the HNB may know or determine the MCN IP address of the Initial HMS.

Initial HMS discovery may be accomplished by performing one or more of the following. The HNB may send a DNS request to the “Inner” DNS server located within the MCN to resolve the Initial HMS FQDN pre-burnt within the HNB. The request may be sent through the IPSec tunnel to the BWM server. The BWM server may unpack the DNS Request and then pack it to go into the IPSec tunnel between the BWM server and the Initial SeGW. The Initial SeGW may unpack the DNS Request and push it into the local MCN IP network to the “Inner” DNS server. The “Inner” DNS server may resolve the FQDN of the Initial HMS to an MCN IP address. The “Inner” DNS server may create the DNS Response with this information and push it to the Initial SeGW. The Initial SeGW may put the packet into the IPSec tunnel between it and the BWM server. The BWM server may unpack this DNS Response and then pack it to go into the IPSec tunnel between the BWM server and the HNB. The HNB may unpack this DNS Response.

The HNB may establish a TR-069 CWMP session with the Initial HMS (e.g., once the IP address of the Initial HMS is known). The session may be established so the Initial HMS can provide the IP address or FQDN of some of the MCN entities to the HNB. In the presence of the BWM server, the signaling between the HNB and the Initial HMS may pass through the BWM server which may un-IPSec and re-IPSec each packet. The BWM server may modify or decode the Set Parameter Value message from the Initial HMS. If the Initial HMS supplies the IP Address of the Serving SeGW, the BWM server may modify the value to be that of its local IP address. If the Initial HMS supplies the FQDN of the Serving SeGW, the BWM server may update its DHCP server table by adding the Serving SeGW FQDN and the BWM server local IP address as follows in Table 2:

TABLE 2

| FQJJN | IP Address |
|---|---|
| Initial SeGW | Local IP address assigned by DHCP Server |
| | in home or enterprise modem |
| Serving SeGW | Local IP address assigned by DHCP Server |
| | in home or enterprise modem |

MCN entities discovery may be accomplished by performing one or more of the following. The HNB may establish a TR-069 CWMP session with the Initial HMS. The HNB may send Inform Request with the location information determined above (macro-cell info, geolocation, and IP address). The Initial HMS may respond that it received the message. The Initial HMS may send a Set Parameter Value message with the following IP addresses or FQDN: 1) the Serving SeGW (may be the same as the Initial SeGW); 1a) If IP address, BWM server may be modify to be its own local IP address; 1b) If FQDN, BWM server may add entry to its DHCP server table for this FQDN and its local IP address; 2) the serving HMS; and 3) the HNBGW. The HNB may send a Set Parameter Response message to indicate to the Initial HMS that it received the message and, the TR-069 session may be terminated. The IPSec tunnels may be destroyed (e.g., once the above steps have been concluded). Even if the Serving SeGW is the same as the Initial SeGW, the tunnels still may be destroyed.

The HNB may be registered with the HNB GW in the presence of the BWM. The registration may achieve one or more of the following. The HNB may have an IPSec tunnel established with the BWM server, the BWM server may have an IPSec tunnel established with the Serving SeGW, the HNB may have the MCN provided IP address and the HNB may know (determine) the IP address of the MCN entities.

The HNB may be used to communicate with the Serving SeGW after the initialization and provisioning of the HNB. This operation may be skipped, for example, if the Initial HMS provided the IP address of the Serving SeGW; or, may not be skipped if the Initial HMS provided the FQDN of the Serving SeGW. If resolution occurs, it may be with a DNS Request/Response. The BWM server may act as a DNS server (or equivalent) to the HNB for such purposes. The BWM server may resolve the Serving SeGW FQDN by sending a DNS Request to the “Outer” DNS Server on the Internet. The Serving SeGW discovery may be accomplished by performing one or more of the following. The HNB may send a DNS Request to the DNS server (BWM server) to resolve the Serving SeGW FQDN that was provided as noted above. The DNS server within the BWM server may look up the Serving SeGW FQDN in its database and retrieve its local IP address. The DNS server within the BWM server may send this information to the HNB. The BWM server may send a DNS Request to the “Outer” DNS server on the Internet with the Serving SeGW FQDN that it received from the HNB and the “Outer” DNS server may respond to the BWM server with the public IP address of the Serving SeGW.

The following procedure is similar to that associated with the HNB Initialization/Provisioning. One exception may be that the Serving SeGW may replace the Initial SeGW. In order to provide secure communications between the HNB and the Serving SeGW, an IPSec tunnel may be established between the two entities. This process may include a pre-shared key and agreement of security algorithms between the two entities. Since the BWM server is being placed between the HNB and Serving SeGW, two IPSec tunnels may be established (e.g., the BWM server-to-Serving SeGW and the HNB-to-BWM server).

An exchange of messages may allow the formation of an IPSec tunnel, which is described. For an IPSec tunnel establishment between the BWM server and Serving SeGW, one or more of the following may be performed. The BWM server may send an IKE_SA_INIT message to the Serving SeGW (e.g., that may request certain encryption algorithms, authentication algorithms and/or DH groups). The Serving SeGW may respond with an IKE_SA_INT response (e.g., that may respond with a selected encryption algorithm, authentication algorithm and/or CH group). The BWM server may send an IKE_AUTH message to the Serving SeGW. This may include a request for a MCN IP address. The Serving SeGW may respond with an IKE_AUTH response, which may include an MCN IP address. The BWM server may send a CREATE_CHILD_SA message to the Serving SeGW. The Serving SeGW may respond with a CREATE_CHILD_SA response.

For IPSec tunnel establishment between the HNB and BWM server, the same process may be followed. The BWM server may use the MCN IP address prior to the HNB requesting it. The HNB may use the MCN IP address as the source address for IP packets that it sends to entities within the MCN. Once these tunnels are established, they may be used going forward to provide secure communication between the HNB and BWM server and the BWM server and the Serving SeGW.

The HNB may be used to communicate with the Serving HMS (e.g., after the establishment on an IPSec tunnel). To do this, the HNB may attempt to resolve the FQDN of the Serving HMS with the “Inner” DNS Server located within the MCN network. In the absence of a BWM server, the HNB would make this request to the Serving SeGW via the IPSec tunnel established previously. The Serving SeGW may un-IPSec this request and may send the packet to the “Inner” DNS Server for resolution. In the presence of the BWM server, the process may be the same from the point of view of the HNB and the Serving SeGW. The BWM server may un-IPSec and then re-IPSec the signaling between the HNB and the Serving SeGW and the HNB may know (or determine) the MCN IP address of the Serving HMS.

The Initial HMS discovery may be accomplished by performing one or more of the following. The HNB may send a DNS request to the “Inner” DNS Server located within the MCN to resolve the Serving HMS FQDN determined as described above. The request may be sent through the IPSec tunnel to the BWM server. The BWM server may unpack the DNS Request and then pack it to go into the IPSec tunnel between the BWM server and the Serving SeGW. The Serving SeGW may unpack the DNS Request and push it into the local MCN IP network to the “Inner” DNS Server”. The “Inner” DNS server may resolve the FQDN of the Serving HMS to an IP address. The “Inner” DNS server may create the DNS Response with this information and push it to the Serving SeGW. The Serving SeGW may put the response packet into the IPSec tunnel between it and the BWM server. The BWM server may unpack this DNS Response and then pack it to go into the IPSec tunnel between the BWM server and the HNB. The HNB may unpack the DNS Response.

The HNB may establish a TR-069 CWMP session with the Serving HMS (e.g., once the IP address of the Serving HMS is known or determined). This session may be established so the Serving HMS can provide the operating configuration to the HNB and the HNB can transfer its location information to the Serving HMS. In the presence of a BWM server, the signaling between the HNB and Serving HMS may pass through the BWM server which may un-IPSec and re-IPSec each packet.

The HNB Operating Configuration discovery may be accomplished by performing one or more of the following. The HNB may establish a TR-069 CWMP session with the Serving HMS. The HNB may send an Inform Request with the location information determined above (macro-cell info, geo-location, and IP address). The Serving HMS may responds that it received the message. The Serving HMS may send a Set Parameter Value message with the operating configuration in the following areas: CN, RF and/or RAN. The HNB may send a Set Parameter Response message to indicate to the Serving HMS that it received the message. The TR-069 session may be terminated.

A similar procedure may be followed to resolve the FQDN of the HNB GW to an IP address, if necessary, as was done for the discovery of the Serving HMS IP address.

The HNB may register with the HNB GW by exchanging a series of messages (e.g., once the HNB knows or determines the IP address of the HNB GW). The registration message and response may pass through the BWM server. The BWM server's role may be to un-IPSec and/or re-IPSec each message as it passes through the BWM server. Once the HNB is registered with the HNB GW, the HNB may begin radiating and may be “open for business” to allow the WTRUs to access the operator provided network.

Registration may be accomplished by performing one or more of the following. The HNB may send to HNB GW the HNB Register Request message with location information, identity, and operating parameters. In the location information element (IE), the HNB may use the information determined during the HNB initialization/Provisioning procedure. In the operating parameters, the HNB may use the information received from the Serving HMS above. The HNB GW may respond to the HNB with a HNB Register Accept message. In the location information IE, the HNB may use the information determined during the HNB Initialization/Provisioning procedure. In the operating parameters, the HNB may use the information received from the Serving HMS above. The HNB may begin radiating and may be available for use by a WTRU.

An GPRS Attach procedure may be used for a WTRU registering with the MCN in the presence of the BWM server/Client. Although the following discussion is based on a PS Attach procedure, other standard procedures (such as CS attach or combined CSIPS attach) may be used. One role of a BWM server may be to un-IPSec packets and re-IPSec packets that comprise the signaling communication between the HNB and Serving SeGW during this procedure.

Synchronization between a WTRU and the HNB and the GPRS Attach procedure may be accomplished by performing one or more of the following. The WTRU may be powered on and go through the normal procedure of synchronizing to the synch channels. The WTRU may read and perform cell search and read broadcast channel (BCH) data. And then the WTRU may start the GPRS attach procedure. It may be assumed that powering on the WTRU also powers on the BWM client. If the WTRU and BWM client are different physical entities, they may need to both be powered up. It may be sufficient to power them on separately, without coordination of time or sequence, for example, if they are powered on “at about the same time.”

The GPRS Attach procedure may include one or more of the following. The WTRU may send an RRC Connection Request message to the HNB (e.g., cause set to Initial Registration). The HNB may send an RRC Connection Setup message to the WTRU. The WTRU may establish the DCH and send an RRC Connection Setup Complete message to the HNB. The WTRU may, over this DCH, send a GPRS Attach message to the HNB. This may cause the HNB to send the WTRU Registration message to HNB GW. The HNB GW may send a WTRU Registration Accept message to the HNB. The HNB may then send a Connect message to SGSN with the Initial WTRU Message to establish the signaling connection through HNB GW. The HNB GW may forward this message to the SGSN. The SGSN may respond to the message sent to the HNB GW. At this point, there may be a signaling connection between the WTRU and SGSN. Authentication and other signaling may then occur between the SGSN and the WTRU. The SGSN may send the Attach Accept to the WTRU. The WTRU may respond with the Attach Complete to the SGSN. The HNB may send an RRC Connection Release to the WTRU. The WTRU may respond with an RRC Connection Release Complete to the HNB.

Data services may be established on the BWM equipment. As part of the procedure, the WTRU may get three IP addresses: an MCN provided IP address (RIPA), a local IP address (LIPA), and a WiFi address.

For the WTRU to acquire these three IP addresses, the WTRU may be used to perform the following: establish a RIPA PDP Context, which, as explained below, shows the workings of the PDP context with the BWM server/Client in place; establish a LIPA PDP Context; and establish an association with the WiFi access point located in the CGW.

Once the WTRU has the three IP addresses (RIPA, LIPA, and WiFi), the BWM client may form an association with the BWM server. The BWM client may use the WiFi IP address and at least one of the two cellular IP addresses (multiple radio access technologies for bandwidth aggregation). The BWM client may share this IP address information with the BWM server indicating that it wishes to form an association. The BWM client may use the IP address of the BWM server to form the association. The BWM client may determine the association by performing a DNS Request of the BWM server. The DNS server within the DSL modem may respond with the local IP address of the BWM server. In certain exemplary embodiments, the BWM server may be placed at a static IP address within the enterprise or home and the BWM client may be preconfigured with this information. Regardless of the method used, the BWM client may form an association with the BWM server to perform BWM aggregation.

Although bandwidth aggregation and segregation is shown using a BWM client and server, it is contemplated that other configurations are possible including integrating the functionality of the BWM solution into the CGW.

For both the RIP A and LIP A PDP context activations, the BWM server may unIPSec and then re-IPSec the signaling that traverses between the HNB and the MCN. The WTRU may have a PDP context with the MCN for RIPA, a local IP address for LIPA and a WiFi address.

RIPA PDP Context activation may be accomplished by performing one or more of the following. The WTRU may send an Activate PDP Context Request message. APN may be a GGSN located within the MCN. If the APN was a LGW, the same procedure may work as it is agnostic in regard to the location of the GGSN. The SGSN may derive GGSN from APN name. The SGSN may create TEID for the requested PDP context. The SGSN may send a Create PDP Context Request message to the GGSN. This may establish a GTP tunnel between the SGSN and GGSN. If the APN was local, the GTP tunnel may be between the SGSN and LGW within the home. If the WTRU has requested a dynamic address, the GGSN may create an entry in the PDP context table and establish a charging ID. The entry may allow GGSN to route data between the SGSN and PDN and may allow the NW to charge the user. The GGSN may select the IP address. The GGSN may send the Create PDP Response to the SGSN. The RAB Assignment may be performed between the SGSN and WTRU. The SGSN may send an Activate PDP Context Accept to the WTRU. The WTRU may now have a PDP context through the MCN and an IP address assigned by the GGSN.

The RAB Assignment performed between the SGSN and WTRU for the above RIPA PDP Context activation may be performed by using one or more of the following. The purpose of these steps may be to establish a GTP tunnel between the SGSN and the HNB and a radio bearer between the HNB and the UE. In this case, the purpose may be modified to establish two GTP tunnels, between the SGSN and the BWM server and between the BWM server and the HNB and the establishment of a radio bearer between the HNB and the WTRU. The RAB Assignment Request/Response message pair may set up a GTP tunnel between the two entities that are exchanging this request/response pair. The SGSN may send an RAB Assignment Request to the BWM server. The BWM server may un-IPSec this message and may replace the following fields with its own addresses: New SGSN Address and TEID. The BWM server may re-IPSec this modified message to send the message to the HNB. The HNB may send a Radio Bearer Setup message to the WTRU. The WTRU may respond with a Radio Bearer Setup Complete message to the HNB after the WTRU sets up the radio bearers. The HNB may send an RAB Assignment Response to the BWM server. The BWM server may un-IPSec this message and may replace the following fields with its own information: a RNC IP Address and a TEID. The BWM server may re-IPSec this modified message to send the message to the SGSN. At the end of the RAB Assignment request/response signaling that passed through the BWM server, two GTP tunnels may be established (e.g., between the BWM server and the SGSN and between the BWM server and the HNB and one radio bearer between the WTRU and the HNB. The SGSN may send an Update PDP Context Request to the GGSN. The GGSN may respond with an Update PDP Context Response to the SGSN. The Update PDP context request/response pair of messages may allow the SGSN to inform the GGSN if the QoS was modified during the radio bearer setup process between the HNB and the WTRU. If the original QoS was maintained, these two messages may not be exchanged.

There may be data transfer across the BWM aggregation. After the PDP context is established, where the MCN and the BWM server and client may have associated, the WTRU may desire (want) to send and receive data from sources on the network. The following describes the flow of downlink data from the SGSN to the WTRU and the flow of uplink data from the WTRU to the SGSN. For each direction an example is provided in which a fixed number of packets may be passed and the BWM server or BWM client decides on which RAT to transmit each packet. This discussion contemplates that in-sequence delivery may be used flow/stream recovery.

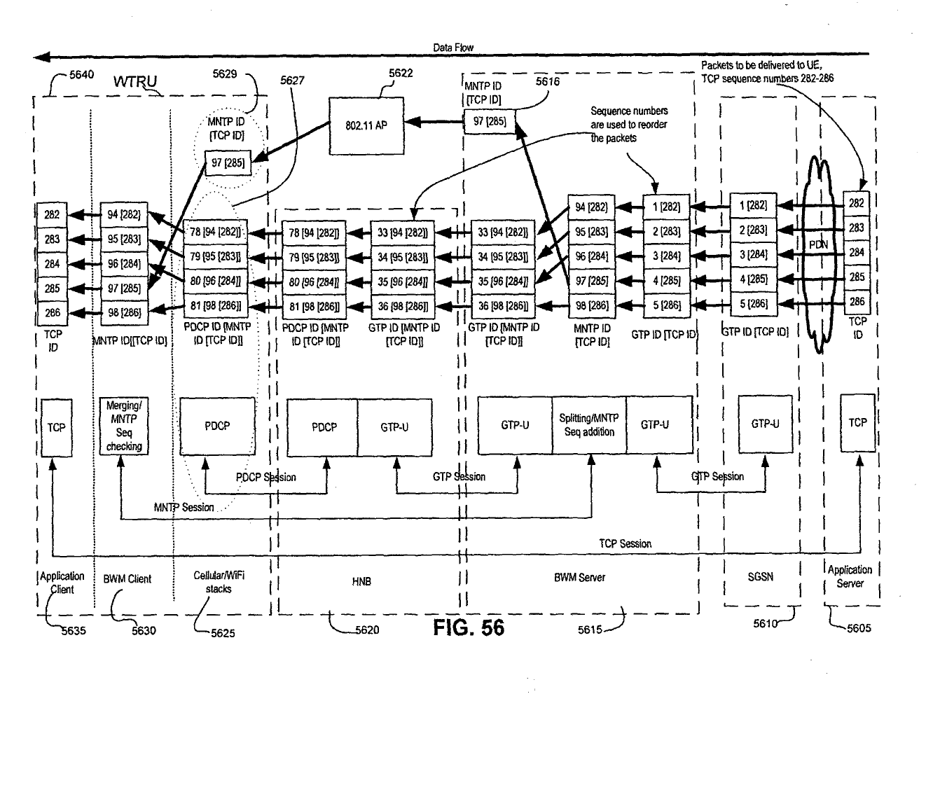

FIG. 56 illustrates a data transfer example. The example contemplates that five downlink packets may be sent to the WTRU from the SGSN and that four of the five packets may be delivered to the WTRU by the cellular RAT and one packet may be delivered to the WTRU by WiFi. In the absence of the BWM or CGW, the GTP entities in the HNB and SGSN may be in-synch with regard to GTP sequence numbers and the PDCP entities within the HNB and the WTRU may be in-synch with regard to PDCP sequence number. In the presence of the BWM server placed between the HNB and the MCN, the sequence number consistency may no longer be maintained. For the non-mobility case, this lack of consistency may not present a problem. However, this may introduce an issue when mobility occurs in the presence of an in-sequence PDP context as discussed herein.

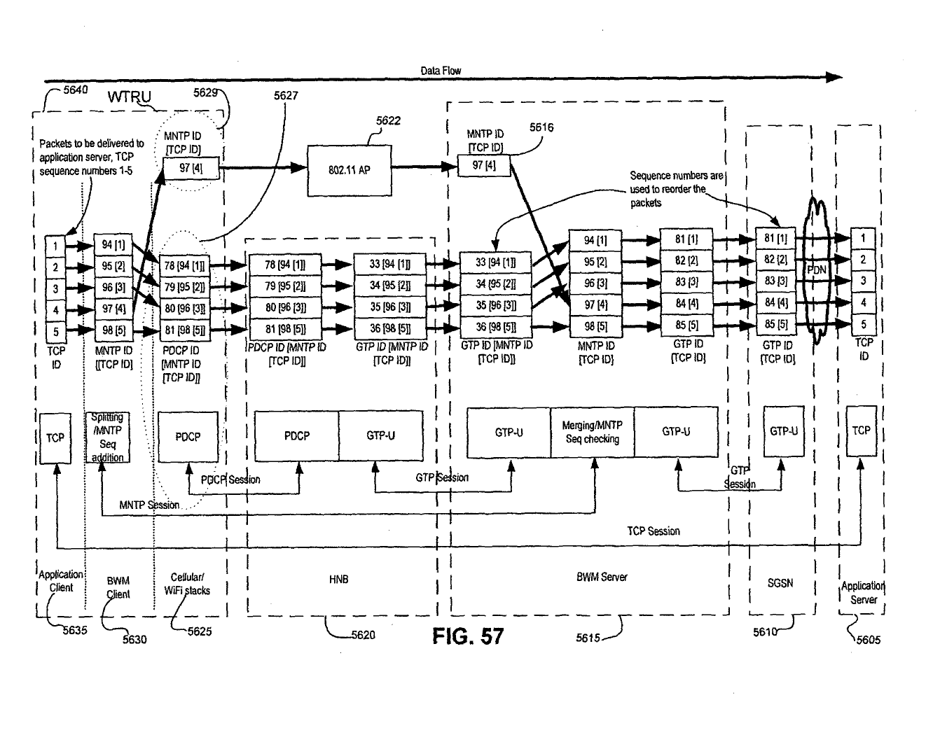

As shown in FIGS. 56 and 57, the ID's for each session may be listed in order as depicted in the figure (e.g., MNTP [TCP ID]). For example, packet 5616 is numbered 97 [285], wherein the MNTP ID is 97 and the TCP ID is 285 in this example. Also note that different sequence numbers are used for each GTP tunnel. FIG. 56 details a flow. The application server 5605, which may be running TCP, may send five TCP packets into the MCN. Eventually, these packets may be received by the SGSN 5610. The five packets may be passed over a GTP-U tunnel between the BWM server 5615 and the SGSN 5610. As shown in FIG. 56, the sequence number of these five packets is 1-5. When the packets are received by the BWM server 5615, the GTP entity within the BWM server 5615 may reorder the packets based on their sequence numbers. The BWM server 5615 processing may then decide to vector one packet (here, packet 5616) to the 802.11 link and the rest through the HNB 5620. For illustrative purposes, the fourth packet was selected to be routed to the 802.11 AP 5622. The BWM server 5615 may then send the remaining four packets to be delivered over the cellular link to the HNB 5620 (e.g., packets 1, 2, 3, and 5). The GTP entity within the BWM server may issue these packets consecutive sequence numbers. These packets may be delivered to the GTP entity within the HNB 5620, which may reorder the packets based on the GTP sequence numbers. As the packets are reordered, they may be delivered, in order, to the PDCP entity within the HNB 5620. The packets may be assigned a PDCP sequence number which may be used to synchronize the communication between the PDCP entities within the HNB 5620 and the WTRU 5640. The BWM client 5630 may then place packets received from the WIFI and cellular network, as recombined, into their original order (e.g., 1, 2, 3, 4, 5) and forward the sequence of packets to the Application client 5635 that is within the WTRU 5640.

FIG. 57 illustrates another data transfer example. This example contemplates five uplink packets to be sent from the WTRU to the SGSN and that four of the five packets may be delivered to the BWM server 315 by the cellular RAT (the HNB 5620 may receive the four packets) and one packet may be delivered to the BWM server 5615 by WiFi (802.11 AP 5622 may receive one packet). In the absence of the BWM, the GTP entities in the HNB and the SGSN may be in-synch with regard to GTP sequence numbers and the PDCP entities within the HNB and the WTRU may be in-synch with regard to the PDCP sequence number. In the presence of the BWM server placed between the HNB and the MCN, the sequence number for the GTP packets, for example, may be changed. For the non-mobility case, this may not be a problem. However, this may introduce an issue when mobility occurs in the presence of an in-sequence PDP context as discussed herein.

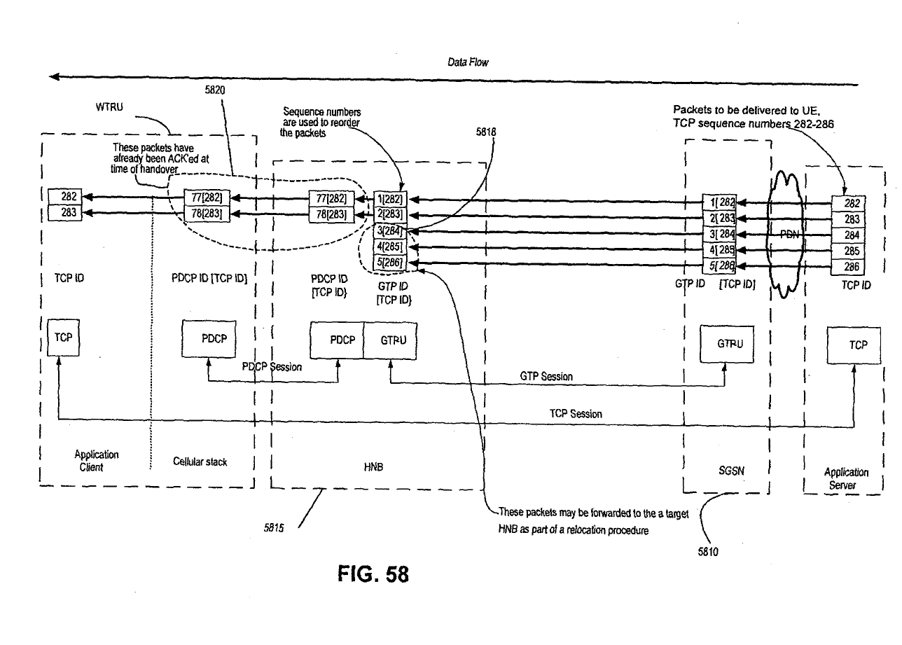

FIG. 58 illustrates an exemplary uplink flow. The application client 5635 may be using TCP and may wish to send five packets to the application server 5605 on the Internet. The BWM client 5630 may decide to pass one packet to the 802.11 interface 5629 and four packets to the cellular stack 5627. The packet that may be delivered to the 802.11 AP 5622 may then be passed to the BWM server 5612. The four packets that may be passed to the cellular stack 5627 may enter the PDCP entity within the WTRU 5640. The PDCP may assign the packets a PDCP sequence number and the packets may be sent to the PDCP entity within the HNB 5620. When the PDCP entity in the HNB 5620 receives these packets, it may reorder the packets based on the PDCP sequence number. The PDCP entity within the HNB 5620 may pass these packets to the GTP entity within the HNB 5620. The PDCP entity may assign GTP sequence numbers and may pass the GTP sequence numbers to the GTP entity within the BWM server 5615. When these packets are received by the GTP entity within the BWM server 5615, they may be reordered based on the GTP sequence numbers assigned by the HNB 5620. The BWM server aggregation “functionality” may merge these four packets with the one packet received over the 802.11 connection, being recombined into their original order (1, 2, 3, 4 and 5). These packets may then be passed to the GTP entity within the BWM server 5615 that is connected to the SGSN 5610. This process may assign GTP sequence numbers to these packets and may send them to the SGSN 5610. The GTP entity within the SGSN 5610 may accept the five packets and may reorder the packets based on the GTP sequence numbers assigned by the GTP entity within the BWM server 5615. The SGSN 5610 may then forward these packets to the GGSN (not shown) in accordance with standard procedures.

There may be DSM interaction with the BWM server. The DSM component of the CGW may perform an analysis of the spectrum within the home or enterprise. Based on this analysis the DSM component may decide which portions of the spectrum are occupied and which are not in use (e.g., currently in use). Given that the BWM entities may be used to make decisions on how to segregate the data between the cellular and WiFi RATs for example, the DSM may be used to communicate this information to the BWM server.

When the BWM server possesses this information, the BWM server may share the information with the BWM client. When the BWM client possesses this information, the BWM client may decide the segregation of the uplink data between the cellular and WiFi RATs, for example.

The DSM information dissemination from the DSM to the BWM server and the BWM client may be accomplished by performing one or more of the following. If the DSM module is a standalone, IP addressable device, the BWM server may perform a DNS Request to learn the IP address of the DSM module. If it is a module within the CGW, the BWM server may take appropriate means to learn the “address” of the DSM device. The BWM server may send a request to the DSM module requesting the DSM module to subscribe to the frequency use information within the DSM module. The DSM module may respond to the BWM server by accepting this request. The DSM module may send its learned spectrum usage information to the BWM server. This may be done periodically, or may be done once. The BWM server may share this information with the BWM client and the BWM entities may use this information as appropriate to help determine the segregation of the uplink data between the cellular and WiFi RATs.

Several types of mobility are contemplated including the following examples: a Macrocell or a HNB without the BWM server-to-HNB with or without the BWM server (Inbound) and a HNB with the BWM server-to-macrocell or HNB with or without the BWM server (Outbound).

For inbound mobility, from a macrocell or HNB without the BWM server, if the target CGW does not have the BWM server, the standard mobility procedures may be used to complete the handover. Once the handover is complete, if the new HNB has a BWM server, the BWM server in the new HNB and the BWM client in the WTRU may attempt to perform an association. If the target CGW does have a BWM server, the standard mobility procedures may be used to complete the handover, as well. However, the BWM server in the target CGW may be aware of this handover and may establish a GTP tunnel between itself and the target HNB. This may be accomplished by performing deep packet inspection of the RANAP signaling from the SGSN to the target HNB which may perform the handover. When the handover is complete, if the new HNB has a BWM server, the BWM server in the new HNB and the BWM client in the WTRU may attempt to perform an association.

For outbound mobility, the standard mobility procedures may be used, but may be augmented with several possible alternatives to allow for a (near or substantially seamless) transition from the source HNB to the macrocell or other HNB.

The BWM server may be involved with the handling of GTP sequence numbers during mobility to enable the GTP sequence number be maintained between the HNB and the SGSN to allow for an in-sequence, lossless link. However, the introduction of the BWM server may introduce factors that make this maintenance a challenge. First, the introduction of the BWM server may cause two GTP tunnels to be in place, each with their own GTP sequence number. Were it not for the addition of an 802.11 RAT to either remove (for DL) or add (for UL) packets, there would be a 1-to-1 correspondence between the GTP tunnels. Software may be used to maintain the 1-to-1 mapping or the sequence numbers of a specific packet in either GTP tunnel at the same. However, with the addition of the 802.11 RAT, a 1-to-1 relationship between the packets in the two GTP tunnels may no longer exist. The GTP tunnel between the HNB and the BWM server may have fewer packets than the GTP tunnel between the BWM server and the SGSN, as was shown in FIG. 3C and FIG. 4C.

In the absence of the BWM server, for downlink data, the sequence numbers are shown in FIG. 58. The maintenance of the sequence numbers between the source HNB 5815, target HNB (not shown), and SGSN 5810 may be used to allow for the target HNB to “pick-up” the data connection where the source HNB 5815 “left off.” In FIG. 58, for example, two packets 5820 have already been Ack'd at time of handover. Three packets 5818 may be forwarded to the target HNB as part of the relocation procedure. The GTP sequences in the three packets 5818 are used because both the target HNB and the source HNB 5815 and the SGSN 5810 may use (may all have) a common sequence number basis. The source HNB 5815 may send the target HNB the Forward SRNS Context which may contain the following: (1) the next DL PDCP sequence number equals 79; and/or (2) the next GTP sequence number equals 6. However, the introduction of the BWM server with multiple RATs may violate this tenant unless the BWM server acts to correct the GTP sequence numbers to a common basis with the SGSN and the target HNB.

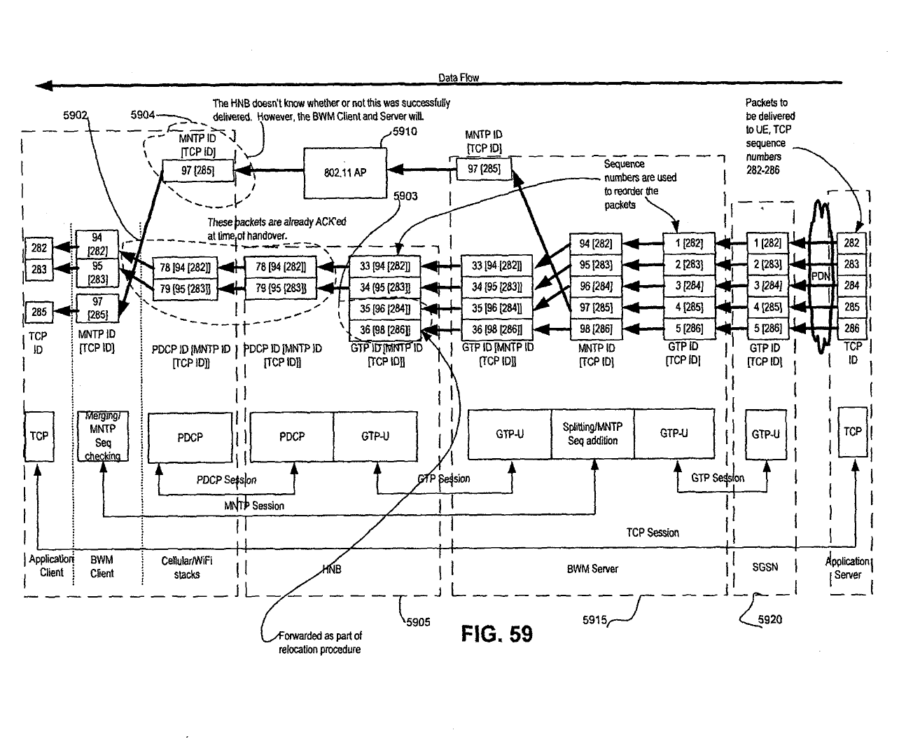

FIG. 59 is an exemplary illustration of the BWM with mobility for downlink data. In the presence of a BWM server, for downlink data, possible sequence numbers are illustrated in FIG. 59. As shown in FIG. 59, one packet may be vectored to the 802.11 AP 5910 for delivery while the other four packets may be sent to the HNB 5905 using the BWM server 5915 to HNB 5905 GTP tunnel. The GTP sequence numbers may not map 1-to-1 since one packet in the middle of the GTP stream received from the SGSN 5920 had been split off to the 802.11 AP 5910. When relocation occurs, the HNB 5905 may forward packet 35 and 36 (reference 5903) to the BWM server 5915 since those may be the packets that were not delivered. However, the BWM server 5915 may not just forward these packets. If the BWM server 5915 just forwarded the packets, the SGSN 5920 and the target HNB (not shown) may think (determine) that the data session can resume at the wrong place in its GTP sequence. If the BWM server 5915 just modified the GTP sequence number as the packets pass through it, then the GTP sequence numbers may not be consecutive (in-sequence lossless data may use consecutive GTP sequence numbers). The BWM server 5915, as shown in FIG. 59, may be used to detect the first forwarded data message (e.g., by performing deep packet inspection), extract the GTP sequence number, look up the sequence number in its list of sequence number mapping between the two GTP tunnels and forward the packets (e.g., all of the packets) to the SGSN 5920 from this sequence number to the end of what it currently has received from the GTP tunnel with the SGSN 5920. The 802.11 routed packet 5904 may be dealt with as the HNB 5905 may not know whether or not the 802.11 packet 5904 was successfully delivered, however the BWM client and server may know otherwise. The 802.11 packet 5904 may be part of the group of forwarded packets during relocation. In this case, the packet may get forwarded to the target HNB and may be delivered via cellular. If the 802.11 packet 5902 is not in the group of forwarded packets, the packet may be lost and a higher layer retransmission scheme (TCP, for example) may correct the problem. If so, the BWM server may not be used to forward the other forwarded data messages received from the HNB 5905. These HNB 5905 data messages may be discarded. The Forward SRNS Context message may pass through the BWM server 5915 and may be modified. The next expected GTP DL sequence number may be changed to the GTP sequence number used in the first forwarded data message by the BWM server 5915 similar to what is described above.

The forwarding procedure as just illustrated may use the maintenance of a buffer of packets received on the GTP tunnel between the BWM server 5915 and the SGSN 5920. Since there may be no feedback from the HNB 5905 as to the delivery of packets, a large buffer may be used and may be configured to wrap-around to save a certain number of the latest packets. In certain exemplary embodiments, the BWM server 5915 may use the acknowledged information from the BWM server/client to know (determine) which MNTP packets were received by the BWM client and which may be left unacknowledged at the time of relocation. The BWM server 5915 may create the messages with the packets which have not yet been acknowledged by the BWM server 5915 and forward these to the target HNB (not shown).

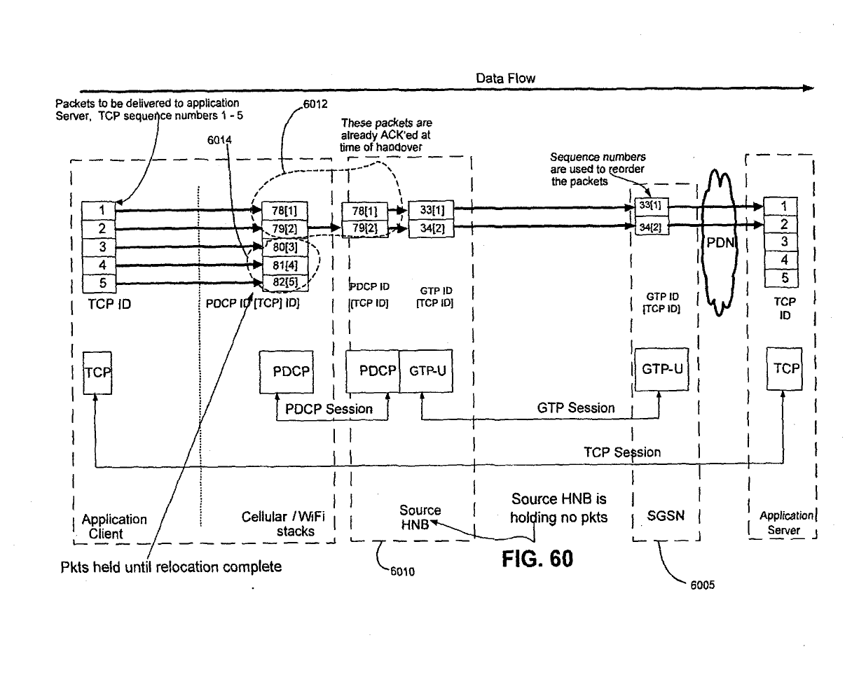

In the absence of the BWM server, for uplink data, a sequence numbering example is illustrated in FIG. 60. If there are no uplink packets held within the source HNB 6010 at relocation, the process may be simpler for uplink data. Packets 6012 may already be ACK'ed at time of handover, while packets 6014 which include PDCP sequence number packets 80, 81, and 82 may be held in the WTRU until the relocation has been completed. For UL, the source HNB 6010 may be holding no packets that may be forwarded as part of the relocation process. At the time of relocation, the source HNB 6010 may create and may send the Forward SRNS Context message, which may comprise the next PDCP UL sequence number and the next GTP UL sequence number. For example in FIG. 60, the next PDCP UL sequence number may be 80 and the next GTP UL sequence number may be 35. As is the case for downlink, the maintenance of the same GTP sequence number basis may be used so that the source HNB 6010, target HNB (not shown), and the SGSN 6005 may be synchronized to provide in-sequence, lossless delivery of the uplink data. However, the introduction of a BWM server with multiple RATs may violate the sequencing unless the BWM server acts to fix the GTP sequence numbers to a common basis with the SGSN 6005 and the target HNB.

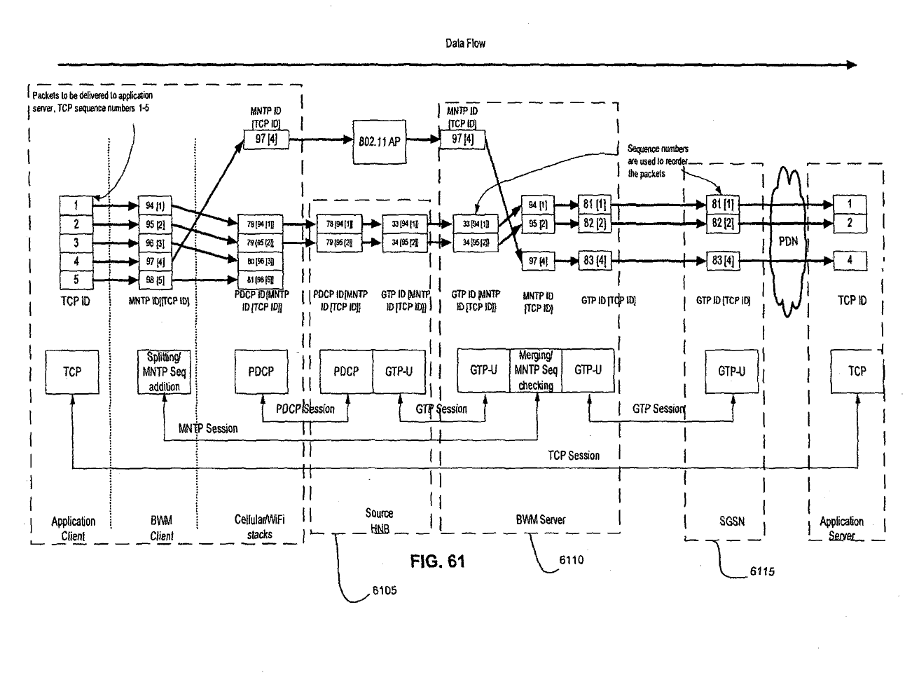

FIG. 61 is an exemplary illustration of the BWM with mobility for downlink data. In the presence of the BWM server, for uplink data, possible sequence numbers are illustrated in FIG. 61. As shown in FIG. 61, when relocation occurs, the source HNB 6105 may create the Forward SRNS Context message with the next expected PDCP UL sequence number and the next expected GTP UL sequence number based on its GTP tunnel with the BWM server 6110. If the BWM server 6110 were to forward this message to the SGSN 6115 and target HNB (not shown) unaltered, the target HNB may think (determine) the next UL packet it may acquire may be incorrect. Therefore, the BWM server 6110 may capture this message and modify it such that the next expected GTP UL sequence number field was set based on the BWM server 6110 to SGSN 6115 GTP tunnel sequence numbers.

Possible alternatives as to how to solve the problem of maintaining GTP sequence numbers are found herein. If a PDP Context is established with in-sequence lossless delivery being selected, the BWM server may become a pass through and packets (e.g., all packets) to and from the WTRU are delivered via the cellular link. In this way, there is a 1-to-1 mapping between the GTP tunnels between the HNB and the BWM server and the BWM server and the SGSN. This alternative may be simpler and more limiting as it excludes certain traffic from benefiting from BWM. The changes to the described procedures may be that the BWM server may recognize the PDP Context and then not perform BWM, if in-sequence loss less delivery is selected. The mobility procedure used for this alternative may be standard (e.g., a default mode of operation).

If a PDP Context is established as in-sequence lossless delivery is selected, an alternative may be that the BWM server/client may perform their normal function of steering packets between the 802.11 AP and the cellular link. The BWM server may perform the corrections to the GTP sequence numbers as described above. This alternative may be more complex but more encompassing as traffic can benefit from BWM. The promulgated procedure may delineate processes to perform mobility in the presence of a BWM server from one HNB (with a BWM server) to another HNB (without a BWM server) or to a macrocell (without a BWM server). The procedure may be based on internal LIPA call flow message sequence charts.

When a WTRU begins to move away from a HNB (source HNB) to which it is connected, the WTRU may be configured to perform measurements. Once the measurements are taken by the WTRU, the measurements may be sent to the source HNB. The source HNB may decide to initiate a handover and may begin the handover process.

Once the source HNB decides to initiate the handover, it may originate the signaling used to effectuate the handover. These steps are as per the defined standards. However, the BWM server may be cognizant of the relocation to prepare for the extinguishment of the BWM session. The BWM server may be used to un-IPSec and re-IPSec each signal that passes through the BWM server.

This relocation preparation may be accomplished by performing one or more of the following. The source HNB may decide to provide a relocation to the target HNB. The HNB may send a RANAP Relocation Required message to the HNB GW. The BWM server may recognize this message and may inform the BWM client to begin shutting down the session, which may comprise the following. The BWM server may not accept any more DL packets to send to the BWM client. The BWM server may, however, continue to send whatever packets it currently possesses to the BWM client and may continue to accept whatever UL packets may be received from the BWM client. The BWM client may not accept any more UL packets to send to the BWM server. The BWM client may, however, continue to send whatever packets it currently possesses to the BWM server and may continue to accept whatever DL packets may be received from the BWM server. The BWM session may end. If there is a large amount of data, it may take some time to clear out what is left. The BWM server/client may possess the ability to set a maximum time that the BWM session has until it ends and whatever is not cleaned up in that time may be dropped.

Regarding the relocation preparation, the HNB GW may send an HNB application part (HNBAP) WTRU Registration Request message to the target HNB. The target HNB may respond with an HNBAP WTRU Register Accept message. The HNB GW may send an RANAP Relocation Request to the target HNB. The target HNB may send an RANAP Relocation Request Ack to the HNB GW. The HNB GW may send an RANAP Relocation Command to the source HNB. The HNB may stop data transfer with the WTRU. The source HNB may begin replicating and sending the unacknowledged downlink packets it possesses to the target HNB (as per the standards). This may be done at the IP layer. Since both the source and target HNB have IP addresses on the MCN, these packets may be routed. Packets received by the source HNB from this point until the WTRU has been de-registered may be forwarded to the target HNB. The BWM server may act at this point to “fix” the sequence numbers as described above, such as when the BWM server/client performs its normal function of actively organizing and steering packets to/from the 802.11 AP and the cellular link.

When the MCN components have been configured for handover, a source HNB may command a WTRU to relocate to the target HNB. The WTRU may reconfigure to the target HNB parameters and synchronize to it. Once synchronized at the physical layers, the WTRU and target HNB may exchange the last received PDCP sequence information to synchronize the PDCP entities in the HNB and the WTRU. These processes, with perhaps the exception of the addition of the BWM server and client actions, may be accomplished per the standards. In addition, the BWM server may be required to un-IPSec and re-IPSec each signal that passes through the BWM server.

WTRU relocation may be accomplished by performing one or more of the following. The source HNB may send a Physical Channel Reconfiguration to the WTRU. The source HNB may send the Forward SRNS Context message to the target HNB. The BWM server may “fix” the GTP sequence numbers as described above. The WTRU may perform synchronization to the target HNB. The PDCP in the WTRU may send the PDCP in the target HNB the PDCP sequence number of the last received DL packet. This may allow the target HNB to know (determine) the last DL packet actually received by the WTRU. The PDCP in the target HNB may send the PDCP in the WTRU the PDCP sequence number of the last received UL packet. This may allow the WTRU to know the last UL packet actually received by the UTRAN. The target HNB may send an RANAP Relocation Detect to the HNB GW. The WTRU may complete the synchronization to the target HNB.

When a WTRU has synchronized to the target HNB, the relocation process may be complete. The resources on the source HNB may be released and the WTRU may be deregistered from the source HNB. The PDP context may be updated in the SGSN so that the GTP tunnel has been moved to the target HNB. The BWM server may be used to un-IPSec and re-IPSec each signal that passes through the BWM server.

Relocation completion may be accomplished by performing one or more of the following. The target HNB may send an RANAP Relocation Complete message to the HNB GW. The HNB GW may send an Update PDP Context Request to the SGSN. This may indicate the GTP endpoint has changed from the source HNB (the BWM server) to the target HNB. The SGSN may update the PDP context. The SGSN may send a PDP Context Response to the HNB GW. The SGSN may no longer send downlink packets to the source HNB (BWM server). The HNB GW may send an RANAP Iu Release Command to the source HNB. The source HNB may send an RANAP Release Complete message to the HNB GW and the HNB GW may send an HNBAP WTRU De-Register message to the source HNB.

The BWM server may support CS voice. In this mode, the function of the BWM server may be to act as a pass-through between the HNB and the Serving SeGW. For packets flowing in either direction, the BWM server may un-IPSec the packets that maybe received from either the HNB or the Serving SeGW, or, re-IPSec these packets and send them to their destination (either the HNB or the Serving SeGW).

Establishing a Mobile Originated (MO) CS voice call may comprise one or more of the following actions. The WTRU may send an RRC Connection Request message to the HNB. The Cause may be set to mobile originated (MO) voice call. The HNB may send an RRC Connection Setup message to the WTRU. The WTRU may establish the DCH and may send an RRC Connection Setup Complete message to the HNB. The WTRU may send a connection management (CM) Service Request to the HNB. The HNB may send a RANAP Initial WTRU message, encapsulating the CM Service Request, to the BWM server. The BWM server may unIPSec and re-IPSec this message as it is sent to the Serving SeGW. The Serving SeGW may unIPSec this message and may send it to the MSC/VLR/HLR within the MCN. The MSC/VLR/HLR within the MCN may send a RANAP Direct Transfer message, encapsulating an Authentication Request, to the Serving SeGW. The Serving SeGW may IPSec this message and may send it to the BWM server. The BWM server may un-IPSec and re-IPSec this message as it is sent to the HNB. The HNB may un-IPSec this message and send it over the air to the WTRU. The WTRU may perform the needed authentication and send an Authentication Response to the HNB. The HNB may encapsulate this response in a RANAP Direct Transfer message and send it to the BWM server. The BWM server may un-IPSec and re-IPSec this message as it is sent to the Serving SeGW. The Serving SeGW may un-IPSec this message and may send it to the MSC/VLR/HLR within the MCN.

Continuing the above regarding the establishment of a MO CS voice call, the MSC/VLR/HLR within the MCN may send a RANAP Security Mode Command to the Serving SeGW. The Serving SeGW may IPSec this message and may send it to the BWM server. The BWM server may un-IPSec and re-IPSec this message as it is sent to the HNB. The HNB may unIPSec this message and may send it over the air to the WTRU. The WTRU may perform security functions and may send a Security Mode Complete message to the HNB. The HNB may IPSec this message and may send it to the BWM server. The BWM server may un-IPSec and reIPSec this message as it is sent to the Serving SeGW. The Serving SeGW may un-IPSec this message and may send it to the MSC/VLR/HLR within the MCN. The MSC/VLR/HLR within the MCN may send a RANAP Direct Transfer message, encapsulating the TMSI Reallocation Command message, to the Serving SeGW. The Serving SeGW may IPSec this message and may send it to the BWM server. The BWM server may un-IPSec and re-IPSec this message as it is sent to the HNB. The HNB may un-IPSec this message and may send the TMSI Reallocation Command to the WTRU. The WTRU may respond with the TMSI Reallocation Complete message to the HNB. The HNB may IPSec this message and may send it to the BWM server. The BWM server may un-IPSec and re-IPSec this message as it is sent to the Serving SeGW. The Serving SeGW may un-IPSec this message and may send it to the MSC/VLR/HLR.

Continuing the above regarding the establishment of a MO CS voice call, the WTRU may send a Setup message to the HNB. The HNB may send a RANAP Direct Transfer message, which encapsulates the Setup message, to the BWM server. The BWM server may un-IPSec and re-IPSec Direct Transfer message, which may encapsulate the Setup message as it is sent to the Serving SeGW. The Serving SeGW may un-IPSec Direct Transfer message, which may encapsulate the Setup message and may send it to the MSC/VLR/HLR. The MSC/VLR/HLR may respond with a RANAP Direct Transfer message, encapsulating the Call Proceeding message, to the Serving SeGW. The Serving SeGW may IPSec RANAP Direct Transfer message which may encapsulate the Call Proceeding message and send it to the BWM server. The BWM server may un-IPSec and re-IPSec this message as it is sent to the HNB. The HNB may un-IPSec this message and may send the Call Proceeding message to the WTRU. The MSC/VLR/HLR may send a RANAP RAB Assignment Request message to the Serving SeGW. The Serving SeGW may IPSec this message and may send it to the BWM server. The BWM server may un-IPSec and re-IPSec this message as it is sent to the HNB. This RAB Assignment Request message may not be used by the BWM server in a similar manner to the RAB Assignment Request message that is sent to the HNB during the establishment of a packet switched service. The BWM server may ignore the RAB Assignment Request message when it is used to setup a CS service, such as a voice call. The HNB may un-IPSec this message and send a Radio Bearer Setup message to the WTRU over the air.

Continuing the above regarding the establishment of a MO CS voice call, the WTRU may setup the radio bearers and may reply with the Radio Bearer Setup Response to the HNB. The HNB may send the RANAP RAB Assignment Response message to the BWM server. The RAB Assignment Response message may not be heeded by the BWM server for the same reasons as set for the RAB Assignment Request message process above. The BWM server may un-IPSec and re-IPSec this message as it is sent to the Serving SeGW. The Serving SeGW may un-IPSec this message and may send it to the MSC/VLR/HLR. The MSC/VLR/HLR may then setup the call with the other device being called, e.g., the device of the dialed number. The MSC/VLR/HLR may send a RANAP Direct Transfer message, encapsulating an Alert message, to the Serving SeGW. The Serving SeGW may IPSec the RANAP Direct Transfer message which is encapsulating the Alert message and may send it to the BWM server. The BWM server may un-IPSec and re-IPSec the RANAP Direct Transfer message which is encapsulating the Alert message as it is sent to the HNB. The HNB may un-IPSec the Direct Transfer message and may send the Alert message to the WTRU over the air. As the call is being answered on the device being called, the MSC/VLR/HLR may send a RANAP Direct Transfer message, encapsulating a Connect message, to the Serving SeGW. The Serving SeGW may IPSec the RANAP Direct Transfer message, which is encapsulating the Connect message, and may send it to the BWM server. The BWM server may un-IPSec and re-IPSec the RANAP Direct Transfer message, which is encapsulating the Connect message, and may send it to the HNB. The HNB may un-IPSec Direct Transfer message and may send the Connect message to the WTRU over the air. The WTRU may send a Connect Acknowledge message to the HNB. The HNB may send a RANAP Direct Transfer message, encapsulating the Connect Acknowledge message, to the BWM server. The BWM server may un-IPSec and re-IPSec this message as it is sent to the Serving SeGW. The Serving SeGW may un-IPSec this message, and may send it to the MSC/VLR/HLR. The call is now “up” and adaptive multi rate (AMR) packets may flow between the two devices, via the HNB to the BWM server to the Serving SeGW to the MSC path. The BWM server may un-IPSec and re-IPSec each AMR packet as it passes between the HNB and the Serving SeGW. At some point, either the WTRU or the device to which the voice call is made may end the call. The signaling that travels between the MCN and the WTRU may be passed through the BWM server. The BWM server may un-IPSec and re-IPSec each of these messages as it travels between the HNB and the Serving SeGW. Upon establishing a Mobile Originated (MO) CS voice call, a WTRU may have a voice call in place on the MCN through the BWM server.

The systems and methods described herein may allow multiple HNBs to communicate with the MCN without a one to one mapping of HNBs to BWM servers. For example, multiple HNBs may communicate with the MCN through a single BWM server. Also, multiple HNBs may communicate with the MCN through multiple BWM servers, where there may be multiple HNBs to each BWM server.

Enterprise scenarios to implement the disclosed systems and methods may include non-BWM scenarios and BWM scenarios. Although the use of one or more BWM servers is being introduced, legacy configurations may continue to be used. For example, a nonBWM scenario may be implemented (e.g., when one or more BWM servers are not used or become unavailable).

In a non-BWM scenario (i.e., a non-BWM enterprise scenario), relating to the MCN's SeGW, multiple HNBs may be directly connected to the MCN's SeGW(s). The SeGW(s) may be in the Internet and may act as an entry point into the MCN. The MCN may allocate the SeGW(s) to the enterprise HNBs. Each HNB may establish a secure tunnel directly with an allocated SeGW. Multiple SeGWs may be considered for reasons of load balancing, or for reasons of discriminating Initial and Serving SeGWs, or for both.

In another non-BWM scenario, relating to a SeGW chain in the enterprise and MCN, multiple HNBs may be connected to enterprise SeGW(s) (it may also be viewed as enterprise Femto aggregator(s)). Each HNB may establish a secure tunnel directly with the allocated enterprise SeGW. The enterprise SeGW(s) in turn may multiplex the HNB traffic over secured tunnels to the MCN's SeGW(s). Again, multiple SeGWs (both within the enterprise and in the Internet/MCN) may be considered for reasons of load balancing, or for reasons of discriminating Initial and Serving SeGWs, or for both.

In a BWM scenario (i.e., a BWM enterprise scenario), relating to the MCN's SeGW, multiple HNBs may be connected to a BWM server, and, the BWM server may be connected to multiple SeGWs (for load balancing or for Initial/Serving SeGW). The BWM server may be manifest as the enterprise SeGW (femto aggregator).

In another BWM scenario, relating to the MCN's SeGW, multiple HNBs may be connected to multiple BWM servers and, the BWM servers may be connected to multiple SeGWs (e. g., for load balancing or for Initial/Serving SeGW). The BWM servers may manifest as the enterprise SeGWs.

In another BWM scenario, relating to a SeGW chain in the enterprise and MCN, instead of having 3-stage security tunnels between HNB←→BWM, BWM←→enterprise SeGW and enterprise SeGW←→MCN SeGW, the BWM may manifest itself as the enterprise SeGW or as an application on enterprise SeGW/femto aggregator.

In the above scenarios, each enterprise BWM server may manifest as an enterprise-level SeGW. Modifications and/or changed/added configurations may be used to support multiple HNBs connecting through a single BWM server to the MCN through multiple (MCN) SeGWs. Possible modifications and/or configurations may include one or more of the following: (1) the modification of the Internet Key Exchange (IKE) protocol; (2) the configuration of the “Outer” DNS Server(s) response to an HNB request to resolve SeGW FQDN (Initial and Serving); (3) the configuration of the DNS server (within DSL modem) response to the HNB request to resolve the BWM server FQDN when a BWM server is available; and/or (4) the HNB configured with burnt-in FQDN for the Initial SeGW, for example, “operatorX-segw.”

As part of a HNB bringup, the HNB may initiate IKE message exchange with a SeGW. As part of the BWM scenarios, a HNB may initiate the IKE message exchange with a BWM server—the BWM server may be manifest as the enterprise SeGW or an application over enterprise SeGW. However, the BWM server may know with which MCN SeGW it may create a secure association. One possibility is that the enterprise SeGW (BWM server) may include its own policies as to how it may “broker” traffic to/from HNB security associations with traffic to/from MCN SeGW security associations. This may imply that the MCN SeGW “attempted” by the HNBs, which may be known to the HNB through preburnt Initial SeGW FQDN configuration or through dynamic TR69 discovery of Serving SeGW FQDN, may be overridden by policies in the BWM server. In such a case, the BWM server may have a separate OAM interface (e.g., TR69) with the MCN that may enable the MCN to influence the SeGW selection policy at the BWM server and thereby orchestrate the SeGW selection by the BWM server. Enhancements to the MCN (and its protocols) may realize the BWM server as an Access Network entity within the enterprise.

Another possibility, for determining which MCN SeGW the BWM server may create a secure association, which may avoid enhancements in the MCN, may be for the BWM server to honor the HNB's existing policies/mechanisms to select the MCN SeGW—although “brokered” through the BWM server. The HNB may include the MCN SeGW information (preburnt Initial SeGW FQDN and/or dynamically discovered Serving SeGW through TR69) and the IKE protocol may be modified to inform the BWM server of this information. The IKE protocol may be modified in such a way as to add an information element to an existing message. When the HNB initiates the IKE process, it may inform the BWM server of the FQDN of the MCN SeGW (Initial or Serving) to which it wishes to connect. The BWM server may then use this information to create a secure association with the “intended” MCN SeGW or multiplex if a secure association already exists with the “intended” MCN SeGW. However, in the “non-BWM scenario,” when a HNB initiates an IKE process directly to a MCN SeGW, the MCN SeGW may receive this additional information element and discard it. This makes the IKE protocol change local between the HNB and the BWM server.

The protocol change in the IKE process at the HNB and the BWM server may proceed as follows. As per IKEv2 protocol (RFC 4306) the Configuration Payload (CP) in the IKE process may be used to exchange configuration information between IKE peers during the process where the IRAC requests a TP address from the IRAS. Configuration payloads may be of type CFG_REQUEST/CFG_REPLY or CFG_SET/CFG_ACK. CFG_REQUEST and CFG_SET payloads may be added to an IKE request. They may allow an IKE endpoint to request data from its peer. “CFG_SET/CFG_ACK” may allow an IKE endpoint to push configuration data to a peer. RFC 4306 may define Configuration Attributes that may be exchanged in the Configuration Payload. RFC 4306 may also provide mechanisms to extend the Configuration Attributes in the Configuration Payload. While Configuration Attribute values 0-15 may be specifically defined in RFC 4306, values 16-16383 may be reserved to JANA and values 16384-32767 may be for private use among mutually consenting parties.

Relating to the disclosed systems and methods, the HNB (the 1RAC) may make use of the Configuration Payload CFG_SET in the IKE_AUTH message to convey the target MCN SeGW FQDN in a new Configuration Attribute to the BWM server (the IRAS). This may be a IRNA registered Configuration Attribute value or a Configuration Attribute value of private use. This may mean that the HNB IRAC, in its IKE exchange, may inform the destination domain with which it wants to connect, where the BWM IRAS is the gateway to multiple MCN SeGWs.

| Attribute Type | Value | Multi-valued | Length |
|---|---|---|---|
| TARGET_SECURITY DOMAIN | xxxx | No | 0 or more |
| | | | octets |

TARGET_SECURITY_DOMAIN may be a string of printable ASCII characters that is not NULL terminated.

The change in the IKE process at MCN SeGW (but as per existing protocol, i.e., no change in the IKE protocol) may proceed as follows. RFC 4306 may provide mechanisms for the IRAC to request multiple private addresses from the IRAS, so that the BWM may use them to reserve a pool of private addresses from MCN SeGW and allocate them one-by-one to the HNBs in their respective IKE requests. The MCN SeGW may be able to handle this. During IKE_AUTH exchange, the IKE IRAC (BWM server) may request a range of IP addresses to be allocated to it by the IRAS (the MCN SeGW) through mechanisms facilitated by the Traffic Selector (TS) Payload. The TS Payload may allow the IRAC to specify TS_IPV4_ADDR_RANGE as the TS type and the IRAS to return an address range bounded within a Starting Address and an Ending Address.

Configuration changes for transactions with the “Outer” DNS may be a configuration level change. A protocol change may or may not be appropriate. The operator may register its FQDN names for the SeGWs with the “Outer” DNS servers. Currently, the operators may have a public IP address mapped to the FQDN name for each SeGW (Initial and Serving). The HNB may perform an ‘A’ type Resource Record (RR) query that the “Outer” DNS may resolve to an IPv4 address (the IPv4 address of the MCN SeGW).

With regard to the configuration changes for transactions with the “Outer” DNS, the HNB may make a NAPTR query for the MCN SeGW FQDN. The “Outer” DNS server configuration may be modified so that it is able to handle a NAPTR query and may be capable of translating the MCN SeGW FQDN into two FQDNs, the FQDN for the BWM server and the FQDN of the MCN SeGW. The BWM server FQDN may be the same for all HNBs for all enterprises. The two FQDNs may include different “ORDER” values or the same “ORDER,” but different “PREFERENCE” values, so as to provide higher priority to the BWM server FQDN. As an outcome of the NAPTR query, the HNB may first try to resolve the FQDN of the BWM server CA′ type RR query). If a BWM server is present within the premise, then this attempt may be successful. The local DNS server within an enterprise may respond to the query and resolve it to the IP address of the BWM server. If a BWM server is not present within a premise, then this attempt may fail (in the absence of a BWM server, the local DNS server may not respond and the “Outer” DNS server may also return a failure), and, the HNB may attempt to resolve the FQDN of the MCN SeGW.

The DNS server within the DSL modem (local DNS server) may be configured such that it can resolve the FQDN of the BWM server to the BWM server's local IP address. If more than one BWM server is present, the DNS server within the DSL modem may be configured to return the local IP address of all the BWM servers present within the premise. This may invoke configuration issues and with no change to behavior of local DNS server.

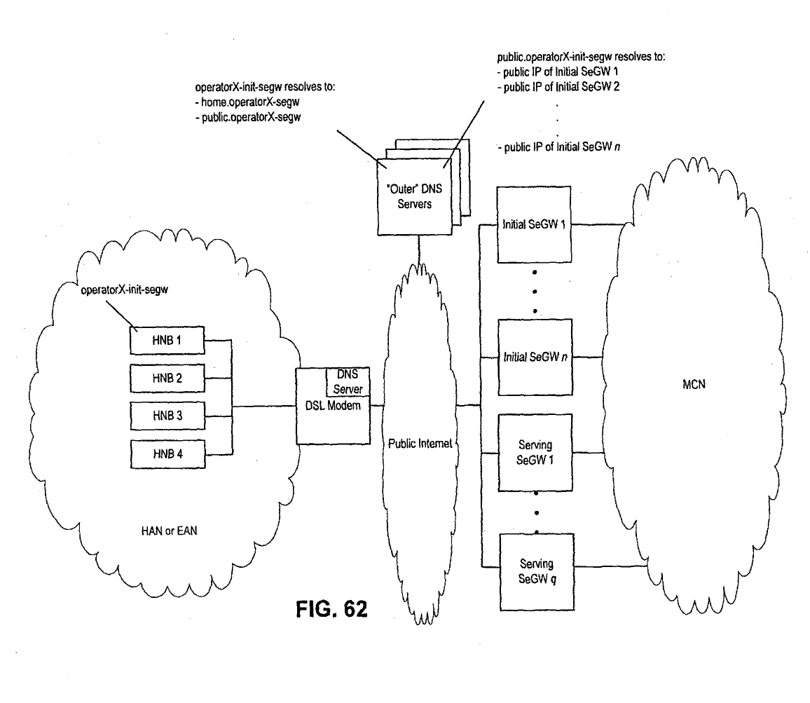

As discussed above, there may be no BWM server within the home or enterprise (e.g., it may not exist or it may not be available, etc.) and the HNBs may connect to the SeGWs using the IP addresses as provided by the “Outer” DNS Server. FIG. 62 illustrates an exemplary enterprise scenario with no BWM server. The operator may have several Initial and Serving SeGWs which the HNB may attach to and each of the public IP addresses of these may have been registered with the “Outer” DNS servers. The “Outer” DNS server may be configured to handle both ‘A’ type and ‘NAPTR” type DNS RR queries. Types of HNBs may be: (1) HNBs which make ‘A’ type DNS RR queries; and/or (2) HNBs that have been enhanced to make “NAPTR” type DNS RR queries (although there is no BWM server in this scenario).

Connecting one or more HNBs to the MCN in a no BWM server scenario may comprise one or more of the following. An HNB may have initial SeGW burnt-in, assume “operatorX-init-segw.” When the HNB is powered on, it may broadcast a DNS Request to resolve the “operatorX-init-segw.” This may be an “A” type query or a “NAPTR” type query. The DNS server in the DSL modem may not resolve this, so it may be broadcast onto the Internet and may be seen by the “Outer” DNS servers. Depending on the DNS RR query type, the “Outer” DNS servers may resolve this to: 1) two FQDNs and return a ‘NAPTR’ type RR DNS Response to the HNB containing 1a) a home.operatorX-init-segw—primary and/or 1b) public.operatorX-init-segw—secondary; or 2) an IP address of a MCN SeGW and return an ‘A’ type RR DNS Response to the HNB. If it was an ‘A’ type RR response, the HNB may be able to create an IPSec tunnel with the Initial SeGW. If it was a ‘NAPTR’ RR response, the HNB may attempt to resolve home.operatorX-init-segw by broadcasting an ‘A’ type RR DNS Request to the DNS server in the DSL modem.

Continuing the above regarding connecting one or more HNBs to the MCN in a single BWM server scenario, the DNS server within the DSL modem may attempt to resolve the home.operatorX-init-segw. Since the home.operatorX-init-segw may not exist, there may be no response and the request may get broadcast onto the Internet where the response may be seen by the “Outer” DNS servers. The “Outer” DNS servers may also not be able to resolve the home.operatorX-init-segw. The HNB may receive no response to the DNS Request and may then try to resolve the public.operatorX-init-segw by broadcasting a DNS Request. The DNS server within the DSL modem may attempt to resolve the public.operatorX-init-segw and may be unable to. The DNS server may then send the DNS Request on the Internet where the DNS Request may be seen by the “Outer” DNS Servers. The “Outer” DNS servers may resolve this to a list of IP addresses of the Initial SeGWs and may return this information to the HNB via a DNS Response. The “Outer” DNS servers may use whatever technique is typically used to ensure load balancing, such as, but not limited to, ordering the list of IP address in a round-robin fashion. The HNB may now be able to create an IPSec tunnel with the Initial SeGW. When the HNB has this tunnel in place with the Initial SeGW, it may go through the initialization and provisioning steps outlined earlier. The MCN may provide the information on the Serving SeGW to the HNB. It may not matter whether or not the Serving SeGW is unique since each HNB may individually go through the above steps to connect with the network.

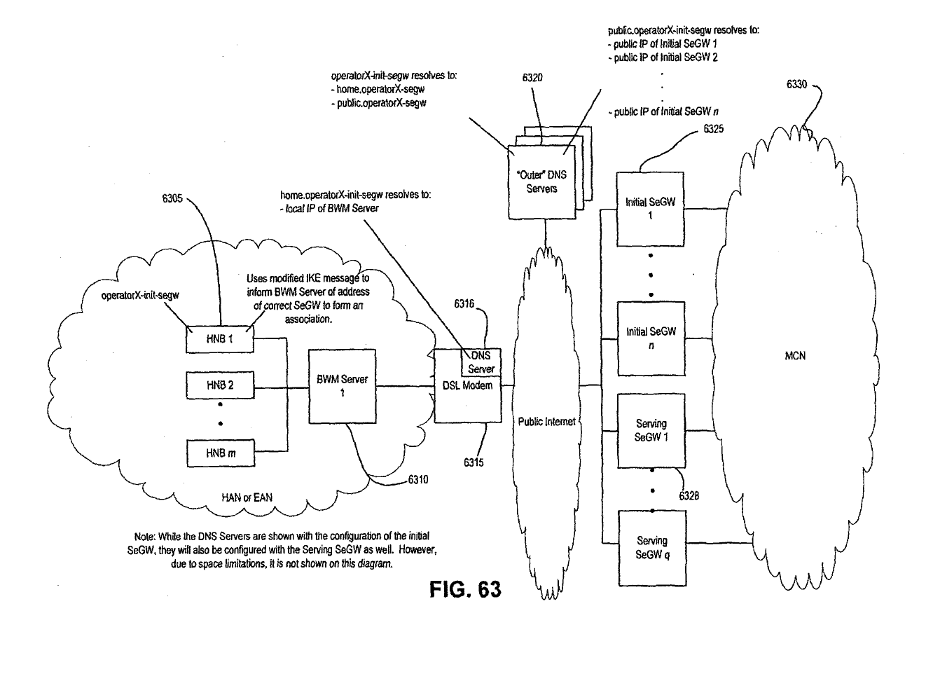

There may be just one BWM server within the home or the enterprise. FIG. 63 illustrates an exemplary enterprise scenario with one BWM server. There may be one BWM server within the home or the enterprise and the HNBs may connect to the SeGWs using the IP addresses as provided by the “Outer” DNS server by going through the BWM server. The BWM server may be able to attach to the correct Initial SeGW since the HNB may pass this IP address to it by the modified IKE protocol message. The operator may have several Initial and Serving SeGWs that the HNB can attach and each of the public IP addresses of these may have been registered with the “Outer” DNS servers.

For example, with reference to FIG. 63, connecting one or more HNBs to the MCN in a single BWM server scenario may comprise one or more of the following. A BWM server 6310 may be powered on, and may retrieve a local IP address from the DSL Modem 6315. The DNS server 6316 within the DSL Modem 6315 may register the local IP address with an association between the FQDN and local IP address. The HNB 6305 may have initial SeGW burnt-in, assume “operatorX-init-segw.” When the HNB 6305 is powered on, it may broadcast a “NAPTR” type RR DNS Request to resolve the operatorX-init-segw. The DNS server 6316 in the DSL modem 6315 may be unable to resolve this, so the DNS server may broadcast onto the Internet where it may be seen by one or more “Outer” DNS servers. An “Outer” DNS server 6320 may resolve “operatorX-init-segw” to two FQDNs and may return a DNS Response to the HNB 6305: (1) home.operatorX-init-segw—primary and/or (2) public.operatorX-init-segw—secondary. The HNB 6305 may then attempt to resolve the home.operatorX-init-segw by broadcasting an ‘A’ type RR DNS Request to the DNS server 6316 in the DSL modem 6315. The DNS server 6316 within the DSL modem 6315 may attempt to resolve the home.operatorX-init-segw. Since DNS server 6316 may be able to resolve the FQDN, it may create and send a DNS response with the local IP address of the BWM server 6310.

Continuing the above regarding connecting one or more HNBs to the MCN in a single BWM server scenario, the HNB 6305 may now be able to create an IPSec tunnel with the BWM server 6310. The HNB 6305 may initiate creation of a secure association between itself and the BWM server 6310, the HNB 6305 may include the public.operatorX-init-segw FQDN that may be part of the enterprise solution. This may be associated with the change that may be needed to the current IKE procedures. Essentially, the change may allow a ‘first node,’ during the security association process, to inform a ‘second node’ of the name (FQDN) of a ‘ third node,’ which may be used for establishing another security association with the second node. This mechanism may allow a chain of security associations to be established, thereby extending the capability of the existing IKE procedure to establish a security association between two nodes via a set of intermediate nodes. In other words, the enhanced IKE may establish a secure ‘path’ as opposed to a secure ‘link.’ This information may be retained, while in the non-BWM scenario mentioned herein the information may not be retained.

Continuing the above regarding connecting one or more HNBs to the MCN in a single BWM server scenario, the BWM server 6310 may attempt to resolve the public.operatorX-init-segw by broadcasting an ‘A’ type RR DNS Request. The DNS server 6316 within the DSL modem may attempt to resolve the public.operatorX-init-segw and may be unable to resolve it. The DNS server may then send the DNS Request on the Internet where the DNS Request may be seen by the “Outer” DNS Server 6320. The “Outer” DNS server 6320 may resolve the public.operatorX-init-segw to a list of IP addresses of the Initial SeGWs and may return this information to the HNB 6305 via a DNS Response. The “Outer” DNS Server 6320 may use whatever technique is typically used to ensure load balancing, such as, but not limited to, ordering the list of IP address in a round-robin fashion. The BWM server 6310 may now be able to create an IPSec tunnel with the Initial SeGW 6325, for example. The MCN may provide a MCN IP address, or range of MCN IP addresses, to the BWM server 6310. When the BWM server 6310 has an IPSec tunnel established with the Initial SeGW 6325, it may complete the establishment of the IPSec tunnel with the HNB 6305. The BWM server 6310 may use the MCN provided IP address while the HNB 6310 may use the Local IP address provided by the DHCP server within the DSL modem 6315. For a message sent from the HNB 6305 to the MCN 6330, the BWM server 6310 may change the source IP address to the MCN 6330 provided IP address. For a message sent from the MCN 6330 to the HNB 6305, the BWM server 6310 may change the destination IP address to the local IP address of the HNB 6305. The HNB 6305 may connect to the MCN 6330 elements that provide the FQDN of the Serving SeGW 6328, for example, as discussed earlier, assume “operatorX-serving-segw.” The HNB 6305 may tear-down the IPSec tunnel between itself and the BWM server 6310. The BWM server 6310 may tear-down the IPSec tunnel between itself and the Initial SeGW 6325. The HNB 6305 may go through the same process as discussed in the paragraphs above, for example, to resolve the FQDN of the Serving SeGW 6328 and for the establishment of an IPSec tunnel between the HNB 6305 and the BWM server 6310 and the BWM server 6310 and the Serving SeGW 6328.

Continuing the above regarding connecting one or more HNBs to the MCN in a single BWM server scenario, each HNB may go through the same process to connect to the MCN. The process may allow for flexibility of different HNBs connecting to different SeGWs through the same BWM server. The MCN may be given a single MCN IP address or may be given a range of MCN IP addresses. A BWM server may manage and may allocate these MCN-allocated IP addresses from the pool or IP range that it is provided. As and when the HNBs connect/disconnect, the BWM server may manage the allocation pool. During a first contact between a SeGW and a BWM server, the BWM server may request the pool of addresses or a single address. If the BWM server is already connected to the SeGW, then the BWM server may already have a pool of addresses that it may assign to a HNB that initiates contact. If it does not have the pool of addresses, then the BMW server may request a MCN allocated IP address from the MCN.

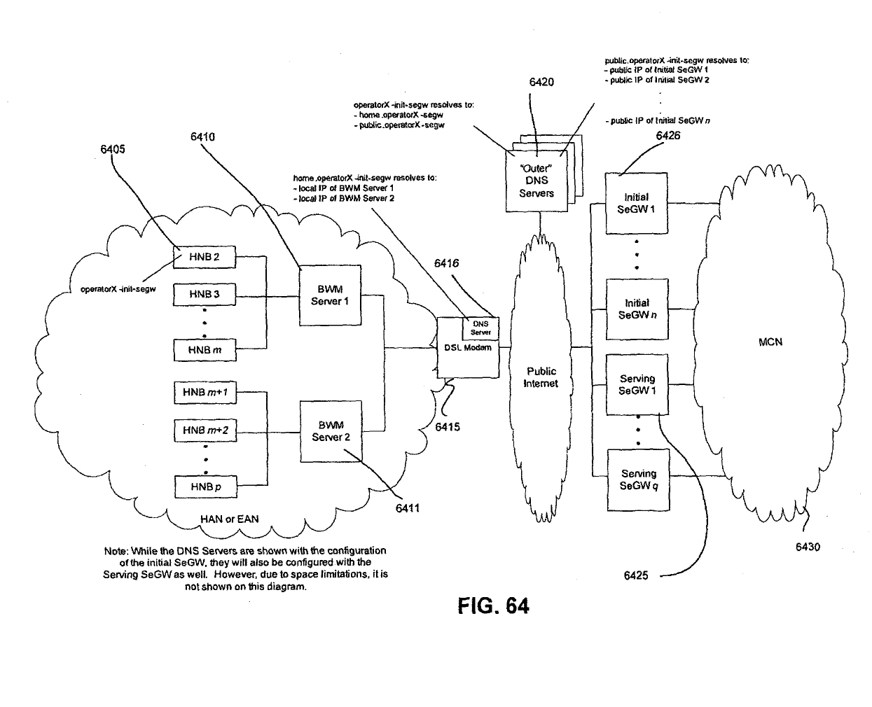

There may be multiple BWM servers within the home or enterprise. FIG. 64 illustrates an exemplary enterprise scenario with multiple BWM servers. The HNBs may connect to the SeGWs using the IP addresses as provided by the “Outer” DNS server by going through these BWM servers. The selection of which BWM server the HNB may attach to may be handled as part of the normal DNS process. The BWM servers may be powered on and registered with the DNS server within the DSL modem, and, the DNS server may use whatever technique is typically used to ensure load balancing, such as, but not limited to, ordering the list of IP address in a round-robin fashion. When a BWM server has been selected, the BWM server may be able to attach to the correct Initial SeGW since the HNB may pass this IP address or FQDN to it by the modified IKE protocol message. Also, it is contemplated that the operator has several Initial and Serving SeGWs which the HNB may attach and each of the public IP addresses of these may have been registered with the “Outer” DNS servers (see FIG. 64).

For example, with reference to FIG. 64, connecting one or more HNBs to the MCN in a multiple BWM server scenario may comprise one or more of the following. BWM servers, for example BWM server1 6410 and BWM server2 6411, may be powered on and may get a local IP address from a DSL Modem 6415. A DNS server 6416 within the DSL Modem 6415 may register these local IP addresses with an association between the FQDN and local IP addresses. An HNB2 6405, for example, may have an initial SeGW1 6426 burnt-in, assume “operatorX-init-segw.” When an HNB is powered on, it may broadcast a “NAPTR” type RR DNS Request to resolve “operatorX-init-segw.” The DNS server 6416 in the DSL modem 6415 may resolve the operatorX-init-segw, so it may be broadcast onto the Internet where it may be seen by an “Outer” DNS server 6420. The “Outer” DNS server may resolve the operatorX-init-segw to two FQDNs and may return a DNS Response to the HNB2 6405: (1) home.operatorX-initsegw—primary and/or (2) public.operatorX-init-segw—secondary. The HNB2 6405 may then attempt to resolve the home.operatorX-init-segw by broadcasting an ‘A’ type RR DNS Request to the DNS server 6416 in the DSL modem 6415. The DNS server 6416 within the DSL modem 6415 may attempt to resolve the home.operatorX-init-segw. Since the DNS server 6416 may be able to resolve the FQDN, it may create and may send a DNS Response with the local IP addresses of the BWM server1 6410 and the BWM server2 6411. The DNS server 6416 within the DSL modem 6415 may use whatever technique is typically used to ensure load balancing, such as, but not limited to, ordering the list of IP address in a round-robin fashion.

In addition, with reference to FIG. 64, connecting one or more HNBs to the MCN in a multiple BWM server scenario, the HNB2 6405 may be able to create an IPSec tunnel with the selected BWM server (for example BWM server1 6410 may be selected). When the HNB2 6405 initiates the creation of a secure association between itself and the BWM server1 6410, the HNB2 6405 may include the public.operatorX-init-segw FQDN that is part of the enterprise solution. This information may be retained, while in the non-BWM scenario it may not be retained. The selected BWM server 6410 may attempt to resolve the public.operatorX-init-segw by broadcasting an ‘A’ type RR DNS Request. The DNS server 6416 within the DSL modem 6415 may attempt to resolve the public.operatorX-init-segw and may be unable to resolve it. The DNS server 6416 may then send the DNS Request on the Internet where it may be seen by the “Outer” DNS Server 6420. The “Outer” DNS server 6416 may resolve this to a list of IP addresses of the Initial SeGWs and may return this information to the HNB 6405 via a DNS Response. The “Outer” DNS server 6420 may use whatever technique is typically used to ensure load balancing, such as, but not limited to, ordering the list of IP address in a round-robin fashion. The selected BWM server 6410 may now be able to create an IPSec tunnel with the Initial SeGW 6426, for example. The MCN 6430 may provide a MCN IP address, or range of MCN IP addresses, to the BWM server1 6410. When the selected BWM server 6410 has an IPSec tunnel established with the Initial SeGW 6426, the selected BWM server 6410 may complete the establishment of the IPSec tunnel with the HNB2 6405. The MCN IP address may be provided to the HNB 6405. The HNB2 6405 may connect to the MCN 6430 elements which may provide the FQDN of the Serving SeGW 6425, for example, as discussed earlier, assume “operatorX-serving-segw.” The HNB2 6405 may tear-down the IPSec tunnel between itself and the selected BWM server 6410. The selected BWM server 6410 may tear-down the IPSec tunnel between itself and the Initial SeGW 6426. The HNB2 6405 may go through a similar process as defined earlier regarding the Initial SeGW 6426 to resolve the FQDN of the Serving SeGWI 6425 and for the establishment of an IPSec tunnel between the HNB2 6405 and the selected BWM server and the Serving SeGW1 6425. Each HNB can go through a similar process to connect to the MCN. The above process may allow for the flexibility of different HNBs connecting to different SeGWs through the different BWM servers.

The following illustrates exemplary source and destination addresses of packets that may be routed between a WTRU and a BWM server, either through a WiFi or cellular connection, and between the BWM server and the application to which the WTRU is communicating:

For packets routed through the MCN:

Uplink
MNTP/IP Packets over WiFi
   Source=WTRU WiFi
   Destination=BWM server
MNTP/IP Packets over Cellular
   Source=WTRU Cellular
   Destination=BWM server
TCP/IP Packets to the Core Network
Source=WTRU Cellular
Destination=Application Server

Downlink
TCP/IP Packets from the Core Network
Source=Application Server
Destination=WTRU Cellular

MNTP/IP Packets over Cellular
Source=BWM server
Destination=WTRU Cellular

MNTP/IP Packets over WiFi
Source=BWM server
Destination=WTRU WiFi
   For packets routed directly to the Internet from the BWM server:

Uplink

MNTP/IP Packets over WiFi
Source=WTRU WiFi
Destination=BWM server

TCP/IP Packets to the Core Network
Source=BWM server
Destination=Application Server

Downlink

TCP/IP Packets from the Core Network
Source=Application Server
Destination=BWM server

MNTP/IP Packets over WiFi
Source=BWM server
Destination=WTRU WiFi

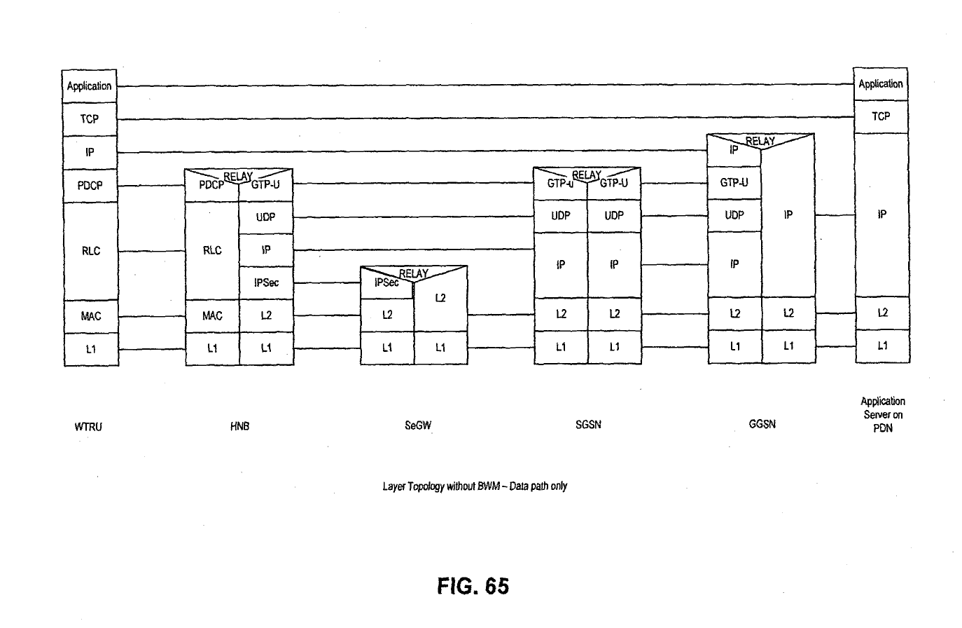

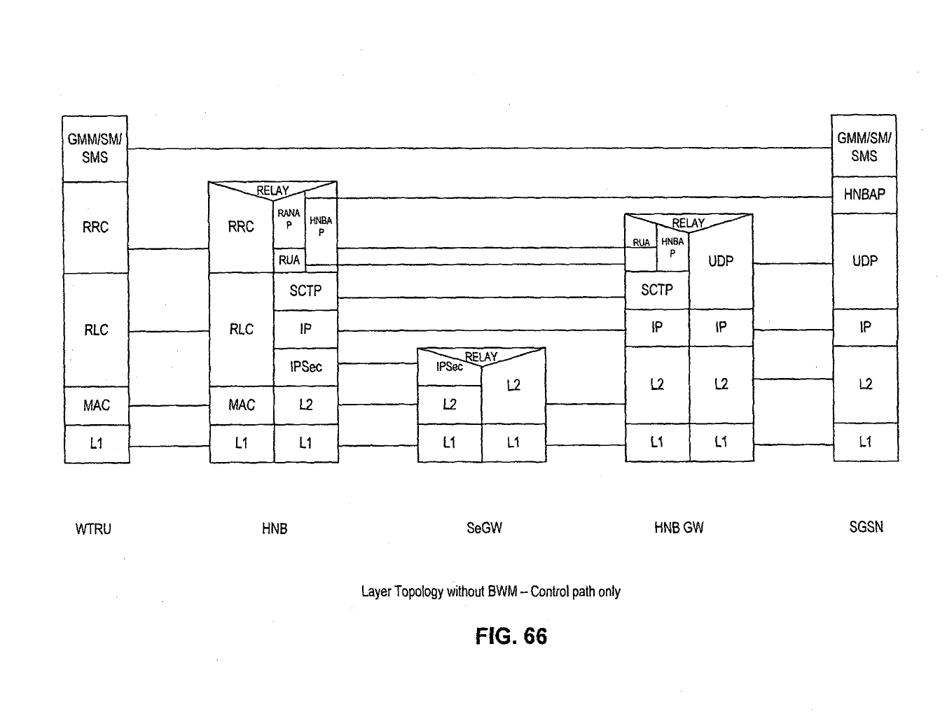

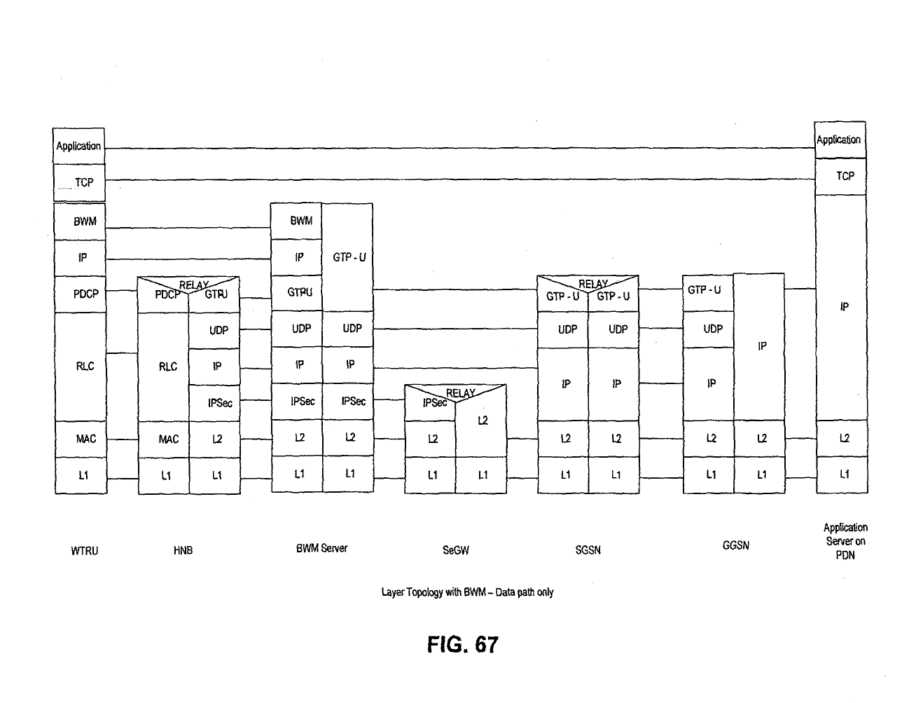

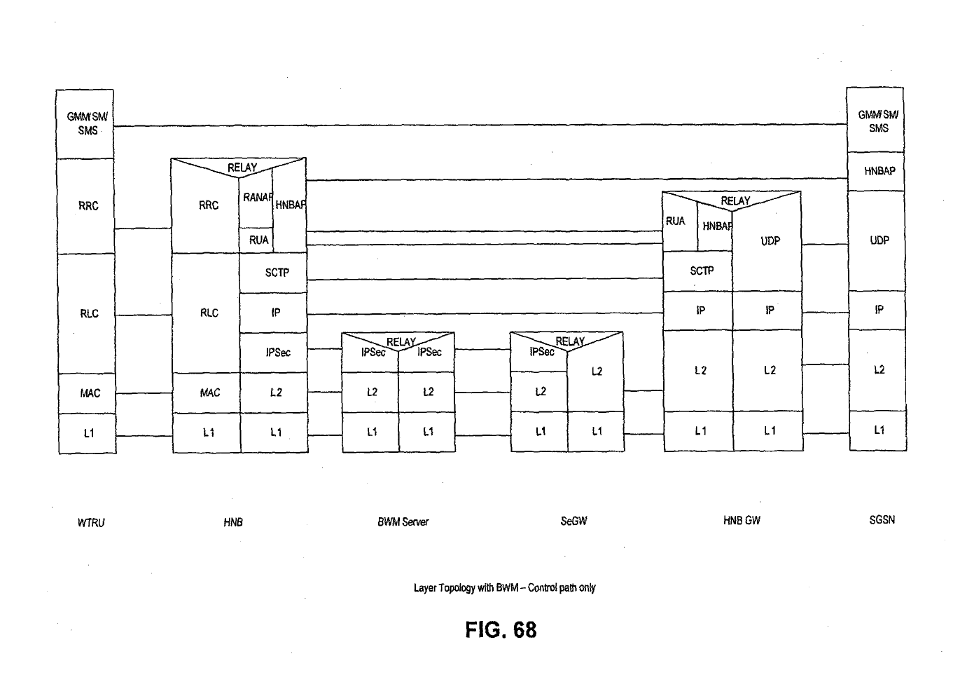

FIGS. 65 and 66 show an exemplary topology of entities in the absence of the BWM. FIGS. 67 and 68 show an exemplary topology of entities in the presence of the BWM. A data path is shown in FIGS. 65 and 67, while a control path is shown in FIGS. 66 and 68. FIG. 67 illustrates an exemplary implementation of a BWM protocol and other protocols mentioned herein to assist in the implementation of the BWM.

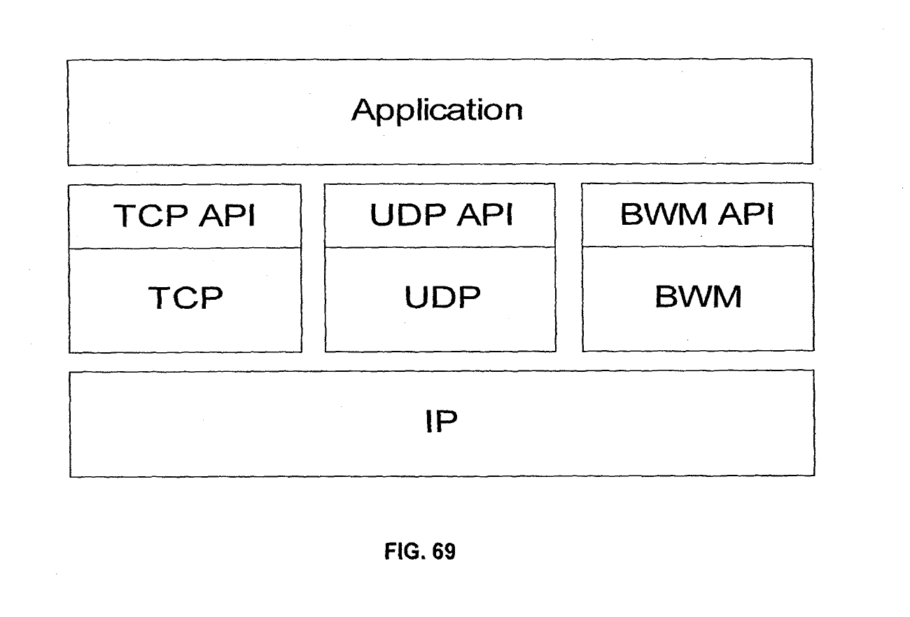

In porting the BWM client to a single device (e.g., a smartphone), various ways to insert the BWM protocol into the existing internet protocol stack exist. Several options are identified herein. One option may be to add the BWM as a separate Transport Layer protocol with its own API as shown in FIG. 69. Applications desiring to use the BWM may do so explicitly, calling its API instead of, for example, the TCP or UDP API. This may not allow legacy applications to use BWM without being modified. If a session is started using BWM, and subsequently the device loses access to the BWM server, the session may be terminated.

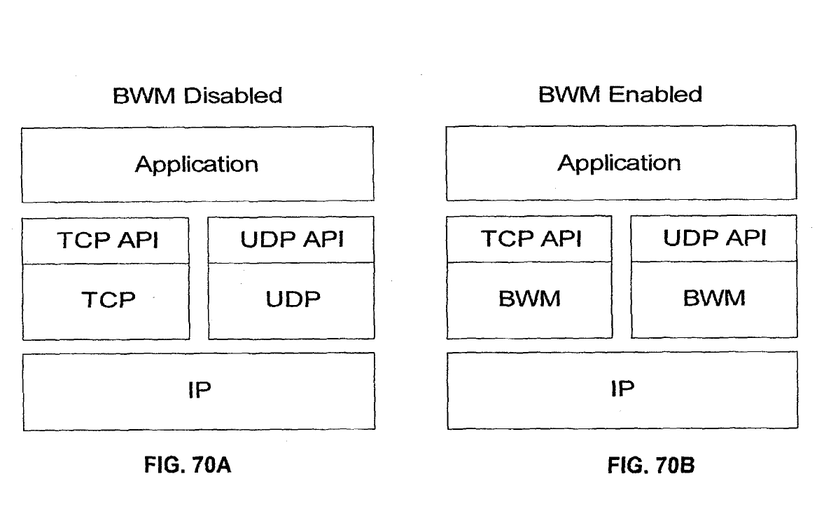

BWM may be added as a transport layer protocol, as shown in FIG. 70B. This may allow it to be enabled (FIG. 70B) or disabled at run time (FIG. 70A). When enabled, calls to TCP and/or UDP API's may be intercepted and the BWM transport layer protocol may run in TCP/UDP's place. Applications may think they are using TCP or UDP. Legacy application may continue to work seamlessly. If BWM is enabled, and a session is started, the session may use the enabled BWM, and may continue to do so until the session terminates. If the enabled BWM is subsequently disabled, any ongoing session may be terminated. If a device loses access to the BWM server, any ongoing session may be terminated. If BWM is disabled, and a session is started, the session may use TCP or UDP, and may continue to do so until the session terminates. If the BWM is subsequently enabled, any ongoing session may be terminated.

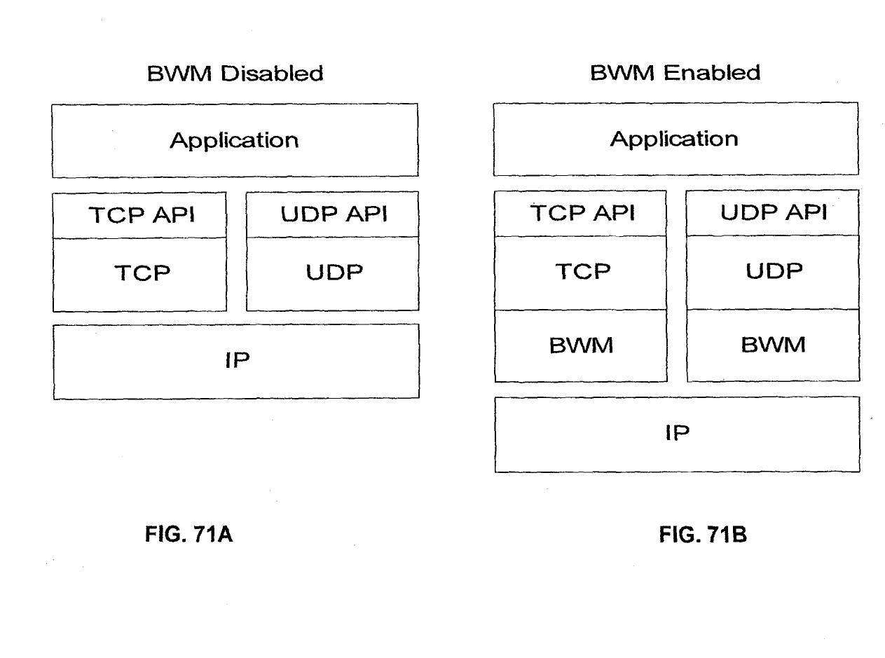

BWM may be added between the transport and internet layers. This may allow it to be enabled (FIG. 71B) or disabled (FIG. 71A) at run time. When enabled, the BWM may run underneath TCP or UDP, as shown in FIG. 71B. Applications may use TCP and/or UDP. Legacy applications may continue to work seamlessly. If the BWM is enabled, and a session is started, the session may use the BWM underneath TCP or UDP. If the enabled BWM is subsequently disabled, any ongoing session may revert to using straight TCP or UDP. If the device loses access to the BWM server, ongoing sessions may revert to using just TCP or UDP. If the BWM is disabled, and a session is started, it may use just TCP or UDP. If BWM is subsequently enabled, any ongoing session may be using the BWM underneath TCP or UDP.

The IPSec tunnel establishment may be used with BWM architecture. A BWM server may establish an IPSec tunnel with a SeGW (as a HNB may) and may interact with the HNB when the BWM server attempts to establish the IPSec tunnel. This behavior imitates what the SeGW does when the HNB attempts to create an IPSec tunnel in the absence of the BWM server.

The BWM server may support 3GPP TS 33.210, v9.0 and IETF RFC 4306. Described below are processes between a HNB and a SeGW that may be performed to establish an IPSec tunnel. Messages may be sent via UDP/IP between the two entities that wish to establish a security association. The BWM server may support these steps.

Six messages may be used to create the IPSec tunnel, three requests from the HNB and three responses from the SeGW. Each pair of these messages (request/response pair) may have specific functions. The first pair may be sent in the clear (no encryption) and the HNB may send a suite of proposed security parameters. The SeGW may respond with its choice for the security parameters, from those offered by the HNB. The second pair may also be sent in the clear and may consist of a request.

For IKEv2, the sequence may be as follows:
HNB may send an IKE_SA_INIT message to the SeGW with the following parameters:
IKE Header
   Exchange type=34 (IKE_SA_INIT)
   Initiator bit=TRUE (Initiator of the request/reply pair)
   Response bit=FALSE
Security Association Payload
   Encryption Algorithm: 3DES in CBC mode or AES in CBC mode
   Pseudo-Random function (hash algorithm): HMAC-SHA 1
   Integrity Algorithm: HMAC-SHA 1-96
   Diffie-Hellman group: Group 2 Or Group 14
Key Exchange Payload
   DH Group #=2 (1024-bit MODP) or 14 (2048-bit MODP)
   Key Exchange Data=DH Public Value
Nonce Payload
   Ni/Nr=Values used to ensure liveness
      SeGW may respond with an IKE_SA_INIT message to the HNB with the following parameters:
IKE Header
   Exchange type=34 (IKE_SA_INIT)
   Initiator bit=FALSE
   Response bit=TRUE (Responder of the request/reply pair)
Security Association Payload
   For each area (encryption, integrity, DH group, and hash), the SeGW may select one of the proposed options by the HNB. This message indicates to the HNB which was selected.
Key Exchange Payload
   DH Group #=May be the same as the IKE_SA_INIT message from the HNB
Key Exchange Data=DH Public Value
Nonce Payload
   Ni/Nr=Values used to ensure liveness
      HNB may send an IKE_AUTH message to the SeGW with the following parameters:
IKE Header
   Exchange type=35 (IKE_AUTH)
   Initiator bit=TRUE (Initiator of the request/reply pair)
   Response bit=FALSE
      SeGW may respond with an IKE_SA_INIT message to the HNB with the following parameters:
      IKE Header Exchange type=35 (IKE_AUTH)
Initiator bit=FALSE
Response bit=TRUE (Responder of the request/reply pair)
   HNB may send a CREATE_CHILO_SA message to the SeGW with the following parameters:
IKE Header
   Exchange type=36 (CREATE_CHILD_ID)
   Initiator bit=TRUE (Initiator of the request/reply pair)
   Response bit=FALSE
      SeGW may respond with a CREATE_CHILO_SA message to the HNB with the following parameters:
IKE Header
   Exchange type=36 (CREATE_CHILD_ID)
   Initiator bit=FALSE
   Response bit=TRUE (Responder of the request/reply pair)
      An exemplary listing of protocol and ports used to send and receive specific information is shown below.
GTP-C—UDP/IP using port number 2123
GTP-U—UDP/IP using port number 2152
GTP′—TCP/IP or UDP/IP using port 3386
DHCP data to server—UDP/IP using port number 67
DHCP data to client—UDP/IP using port number 68
DNS—Usually UDP/IP using port number 53, but if the DNS response is large enough,
TCP/IP using port number 53 is employed
FTP—TCP/IP using port 21 for control and port 20 for data
BGP—TCP/IP using port 179 HTTP—TCP/IP using port 80
IMAP—TCP/IP or UDP/IP using ports 143, 220, and 993
IRC—TCP/IP using ports 113, 194, 531, 6679 through 6697, and 31456
NNTP—TCP/IP using port 119 NNTPS—TCP/IP using port 563
NTP—UDP/IP using port 123
POP—TCP/IP using ports 109, 110, 995, and 1109
RIP—UDP/IP using port 520
RTP—UDP/IP using ports between 1024 and 65535
RTSP—TCP/IP or UDP/IP using port 554
SIP—TCP/IP, UDP/IP, or SCTP/IP using ports 5060, 5061, or 5070
SMTP—TCP/IP using ports 25, 465, or 587
SNMP—UDP/IP using ports 161, 162, or 199

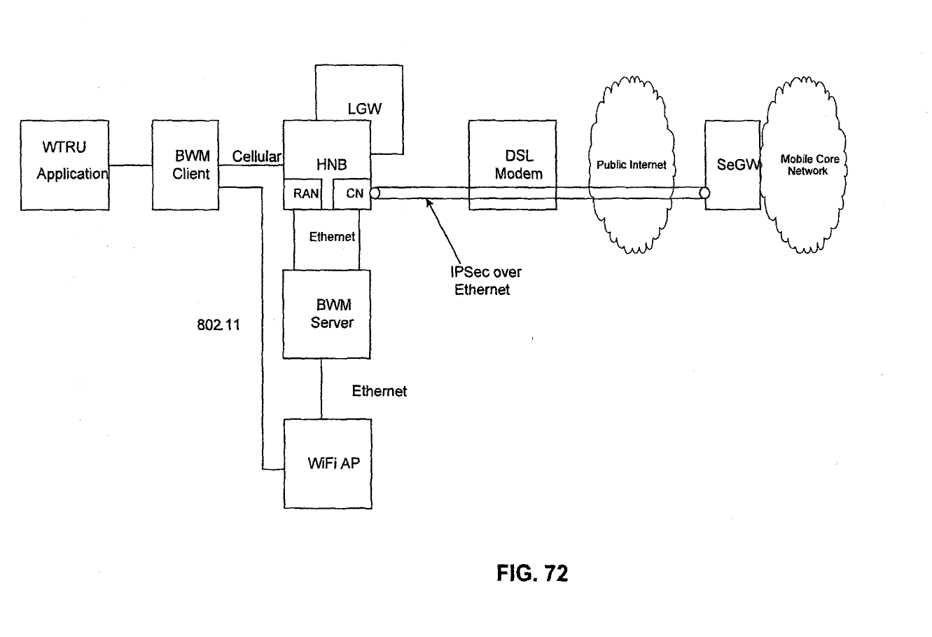

Other possible architectures may be used to effectuate BWM within the HNB environment. One exemplary architecture is shown in FIG. 72. In this configuration, the BWM server may sit (be located logically or physically) between the CN and RAN portions of the HNB. An advantage of this configuration may be that the HNB is allowed to naturally terminate the IPSec and GTP tunnels that exist between the HNB and the SeGW and SGSN, respectively. A disadvantage of this configuration may be that it is customized to the specific HNB implementation and may not be an agnostic solution.

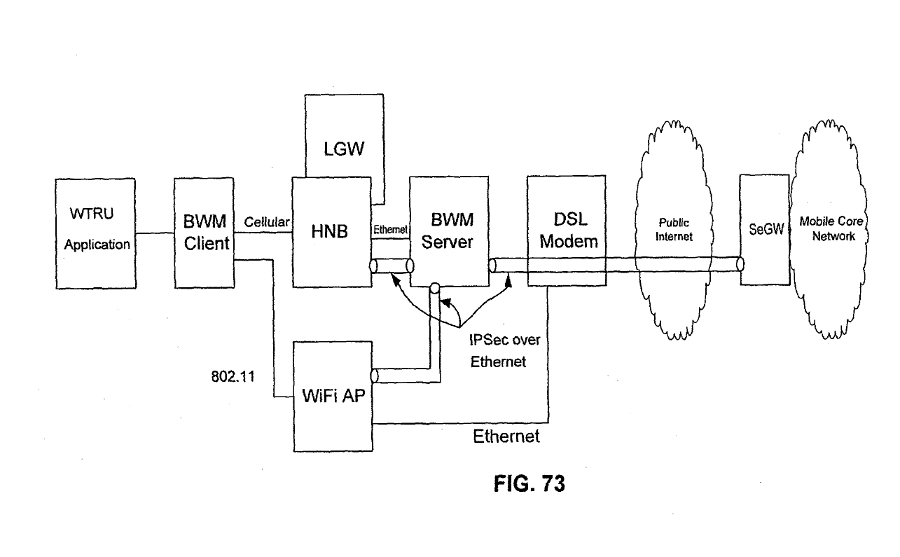

Another exemplary architecture is shown in FIG. 73. In this configuration, the BWM server may sit between the HNB and the SeGW of the MCN. However, a difference with earlier configurations may be that the BWM server may act as a pass-through during the HNB configuration and may then be informed of the network supplied configuration by the introduction of a new protocol between the HNB and the BWM server. An advantage of this configuration may be that the HNB may be allowed to perform its function without the imposition of the BWM server between it and the SeGW of the MCN. A disadvantage of this configuration may be that the HNB now may support the new protocol that may be used to ferry (transfer) configuration information from it to the BWM server. Unlike other architectures, the HNB may have to be modified to implement this configuration.

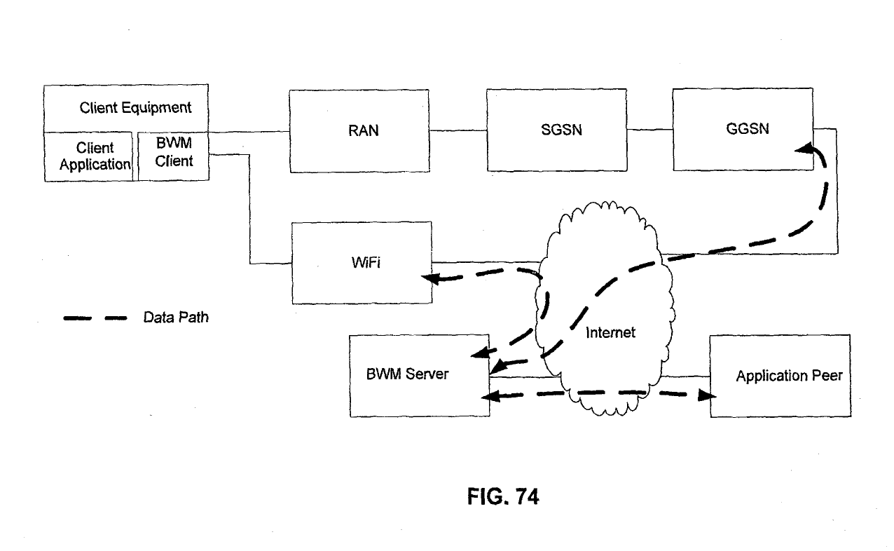

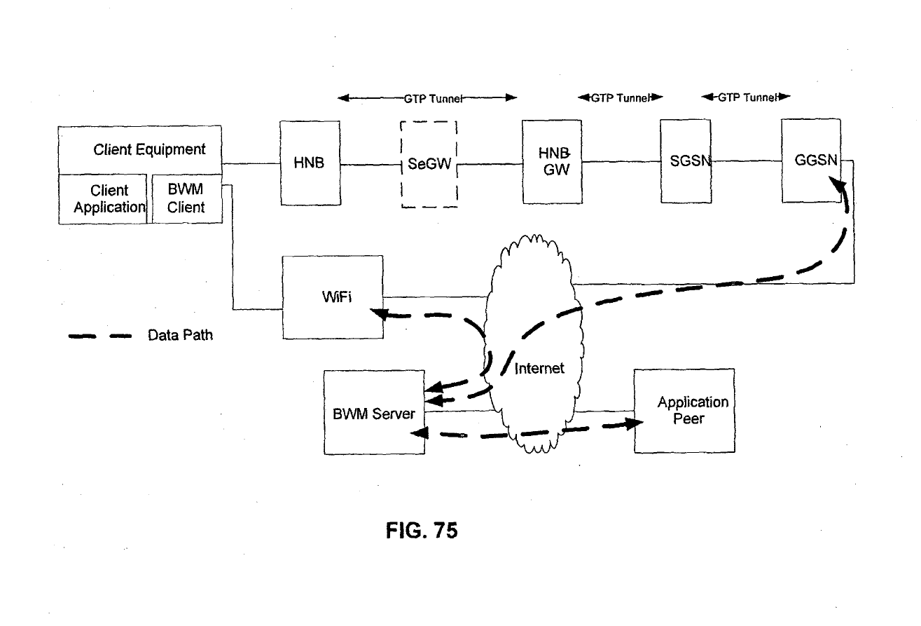

FIGS. 74-76A are additional exemplary illustrations of implementations of BWM architectures. In FIG. 74, the BWM client may be connected to the Internet via cellular and 802.11 based links. The BWM server may reside somewhere in the Internet. When the Client Application sends packets to the Peer, the packets may be intercepted by the BWM client. The BWM client may decide which connections to use to route this data to its destination. The BWM server may receive these packets from the multiple IP connections and forward the packets to the Application Peer using a standard Transport Layer protocol (e.g. TCP). To both the Client Application and the Application Peer, the actions of the BWM client and the BWM server may be transparent. When the Peer sends packets to the Client, the process described above may be performed in reverse. FIG. 75 is similar to FIG. 74, but has extra equipment and shows that a tunneling protocol may be used between the BWM server and the BWM client.

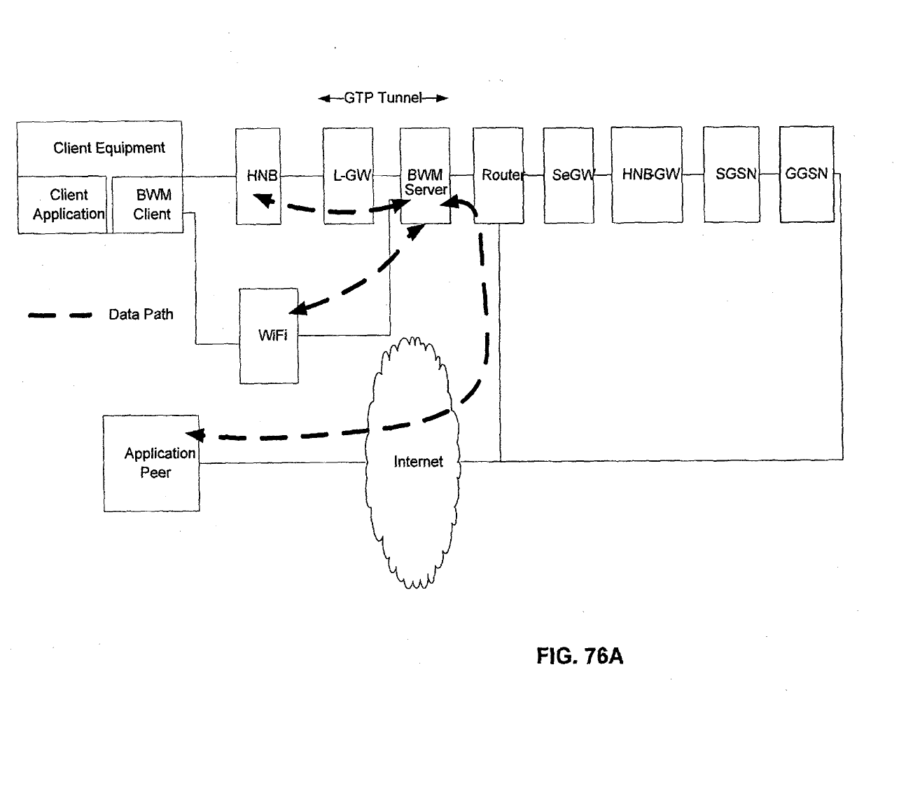

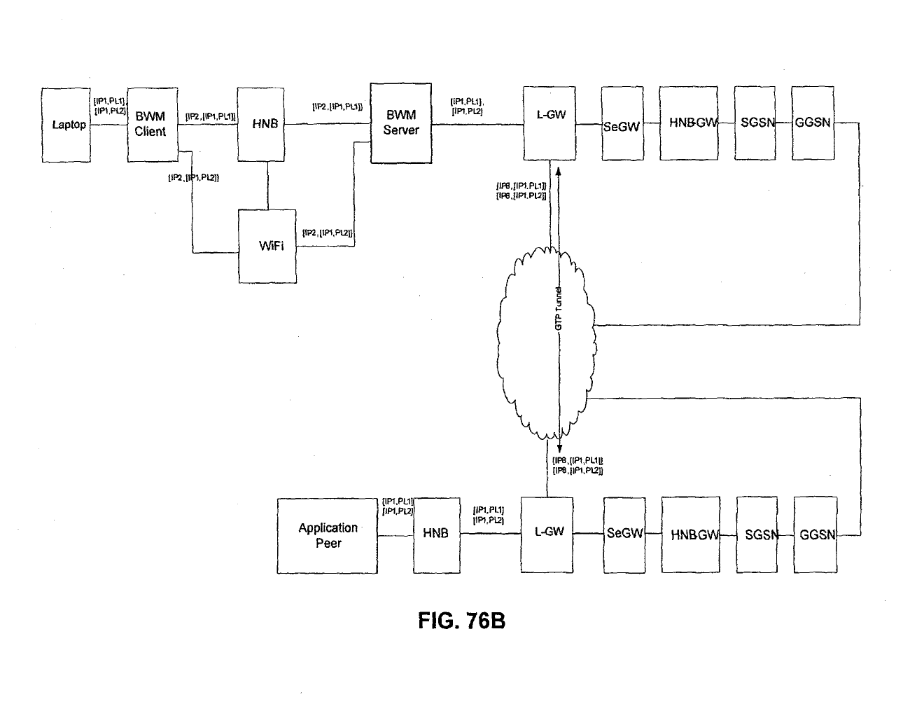

FIG. 76A is an exemplary illustration of a configuration for the placement of BWM technology when SIPTO is present within the cellular network. The placement of the SIPTO breakout point within the cellular network allows the data to bypass (and as a result offload) the core network from moving data packets between devices on the mobile network and the Internet. The placement of the BWM server may be between the router that performs the SIPTO and the local gateway (LGW) which is part of the home network. The BWM server may perform the same function as described in previous sections. FIG. 76B is an exemplary illustration of the BWM implemented in an ELIPA case.

Currently discovery methods used in converged gateway (CGW) architecture cannot support multiple subnets per CGW. Additionally, the current CGW architecture is not able to support multiple CGWs within the same enterprise, premise, metro location, or the like. Embodiments disclosed herein may provide for CGW architecture that supports multiple subnets per CGW and may provide support for multiple CGWs within the same enterprise. For example, one CGW per subnet may be provided, one CGW for all subnets may be provided, or any combination thereof may be provided.

Distributed CGW architecture may be provided that may a protocol, such as PMIP protocol, Evolved General Packet Radio Service (GPRS) Tunneling Protocol (GTP), or the like, to provide inter-CGW communication. For example, PMIP, GTP, or the like may be used to enable support for multiple CGWs while providing IP Flow Mobility (IFOM) capabilities (and/or Logical Interface LIF-based support of IFOM). This may be done, for example, to provide support for DMM. The usage of PMIP, GTP, or other such protocols may support communication between CGWs (e.g., inter-CGW communication) to support UEs that may attach to different CGWs. For example, simultaneous connections with different RATs may occur and may allow for data splitting. The distributed CGW architecture may be used with HNB, HeNB, eNB, access points, or the like.

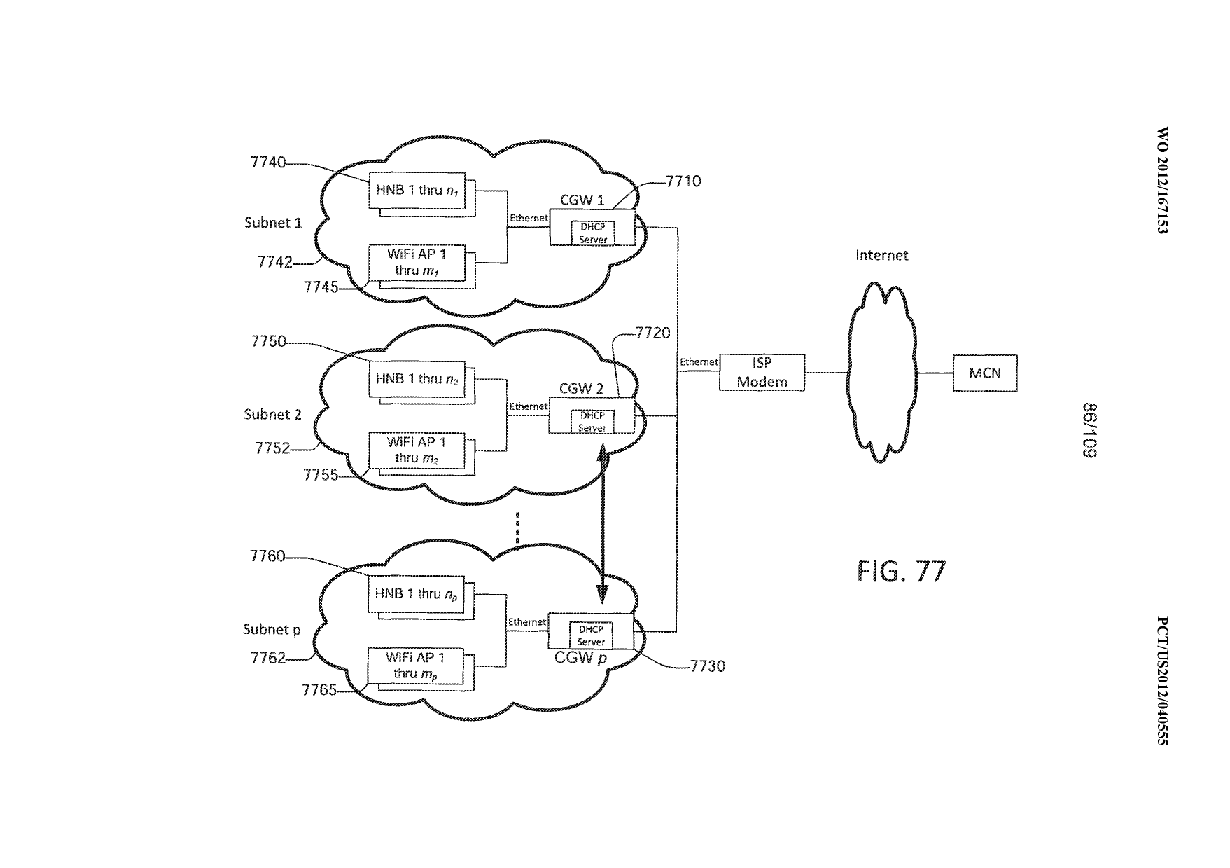

FIG. 77 depicts a communication network that may use one CGW per subnet. As shown in FIG. 77, CGW 1 at 7710, CGW 2, at 7720, and CGW p at 7730 may be separate from one another and may each be a physical device. The number of HNBs on each subnet, such as at 7740, 7750, and 7760, may be arbitrary and may even be zero. The number of WiFi APs on each subnet, such as at 7745, 7755, and 7765, may be arbitrary and may even be zero. Subnets may also have other non-WiFi, non-cellular devices, such as Ethernet devices. The number of subnets may be one.

The configuration shown in FIG. 77 may be used when subnets may be in different locations. For example, subnet 1 at 7742 along with CGW 1 at 7710 may be at a first location, while subnet 2 at 7752 along with CGW 2 at 7720 may be at a second location. This may be done, for example, to provide a one-to-one relationship between CGWs and subnets.

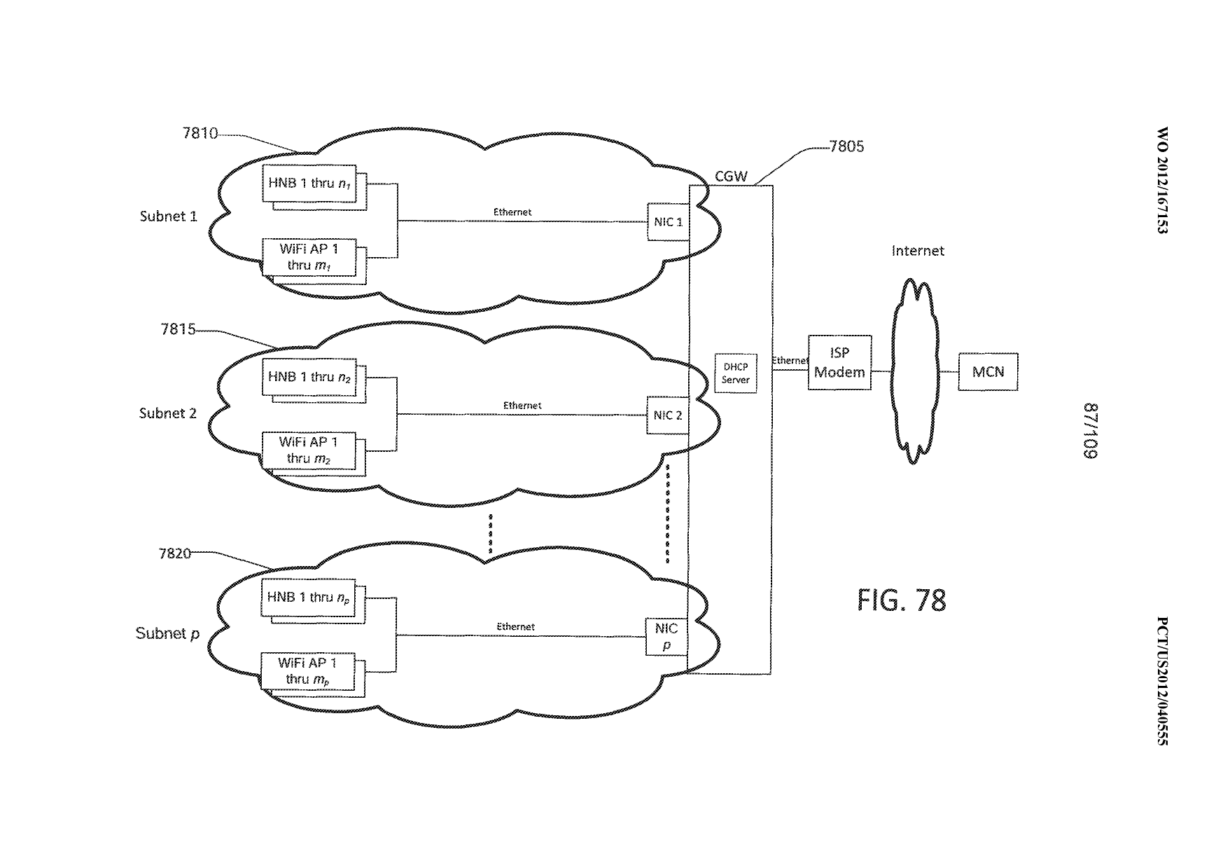

FIG. 78 depicts a communication network that may use one CGW for multiple subnets. The communication network may be used, for example, where subnets may be within the same location, such as a building.

As shown in FIG. 78, the CGW at 7805 may be used for subnet 1 at 7810, subnet 2 at 7815, and subnet p at 7820. The CGW may be a physical device. The number of HNBs on each subnet may be arbitrary and may even be zero. The number of WiFi APs on each subnet may be arbitrary and may even be zero. Subnets may also have other non-WiFi, non-cellular devices, such as Ethernet devices. Any number of subnets may be used.

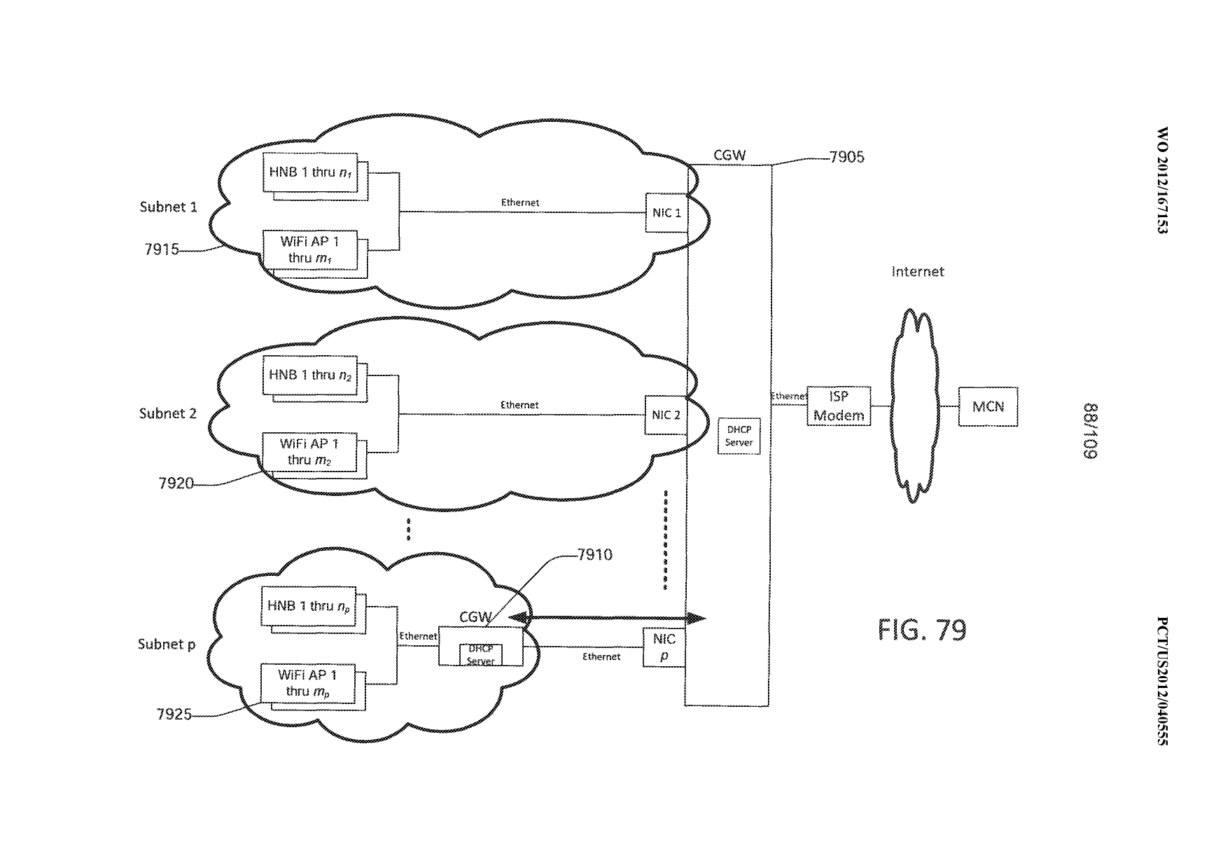

FIG. 79 depicts a communication network where CGWs may be in a hierarchy. This may be done, for example, to provide for multiple subnets across an organization, such as an enterprise or campus.

As shown in FIG. 79, the CGW at 7905 and the CGW at 7910 may be in a hierarchy. There may be at least one CGW per subnet. For example, the CGW at 7905 may be for subnet 1 at 7915 and subnet 2 at 7920, while the CGW at 7910 may be for subnet p at 7925. Each CGW may be a different physical device. The number of HNBs on each subnet may arbitrary and may even be zero. The number of WiFi APs on each subnet may be arbitrary and may even be zero. Subnets may also have other non-WiFi, non-cellular devices, such as an Ethernet device. There may be one or more subnets, such as the subnets at 7915, 7920, and 7925.

In the topologies described herein, a user device, such as a UE, may connect to multiple network elements that may be on different subnets. For example, a user device may connect to multiple subnets such that the UE is connected to the WiFi AP of a first subnet and the HNB of a second subnet. Both the first subnet and the second subnet may have its own CGW. There may be an initial phase where each CGW may learn about its environment. For example, a CGW may search the LAN to find other CGWs. This may be done, for example, to resolve hostnames with a local DNS Server.

To enable data splitting seamlessly within a wireless environment, CGWs may use inter-CGW communications to communicate discovery requests/results between CGWs, and to coordinate the flow of data to or from a UE. For example, inter-CGW communications may be used to determine the CGW network topology, the data flows associated with a data stream, and a CGW responsible for serving those data flows in environments having multiple CGWs or multiple subnets.

As disclosed herein, a number of CGW topologies that may be used. For example, each CGW may be a different physical device with a one-to-one relationship between CGWs and subnets, or a single CGW (e.g., a single physical device) may be used with multiple subnets. Additionally, a hybrid CGW topology may be used where CGWs may be arranged hierarchically such that a subnet may have its CGW that may be under the control of a master CGWs that may be used for an enterprise or campus

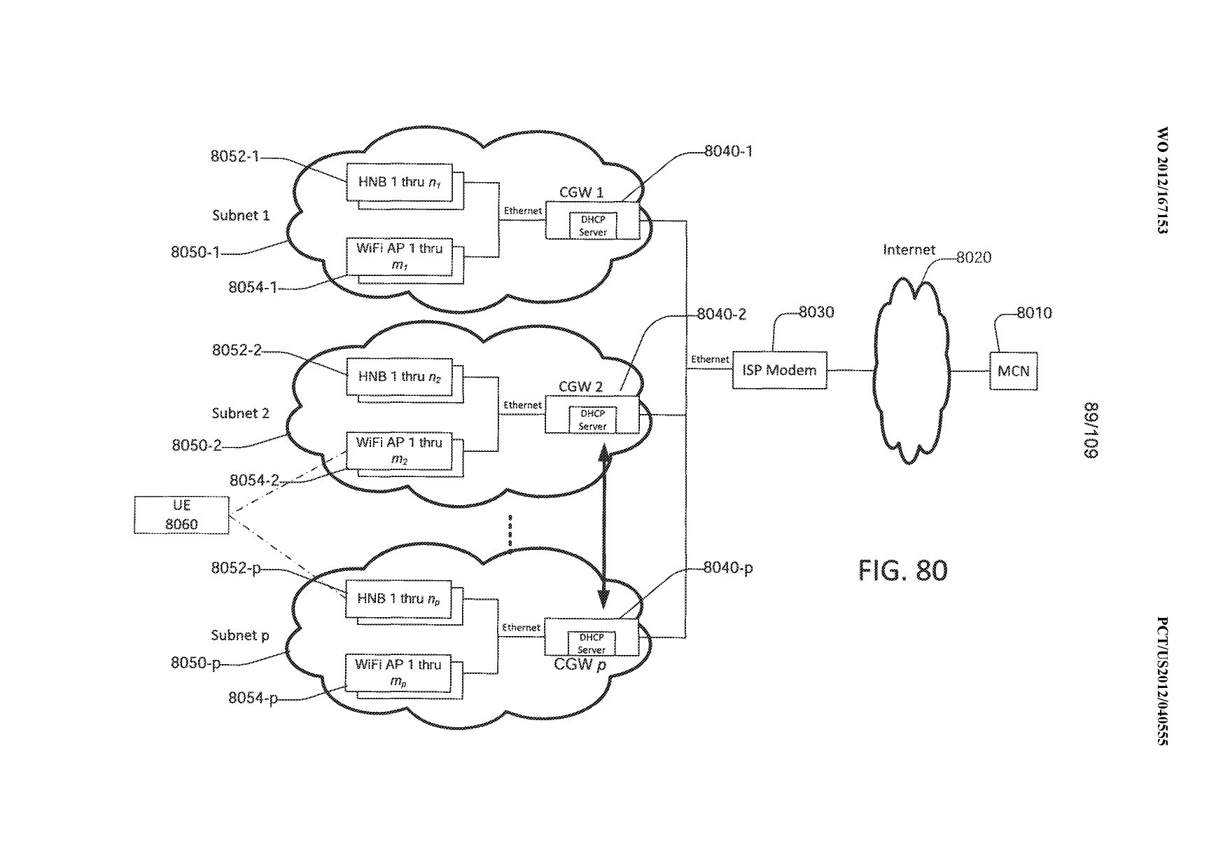

FIG. 80 depicts a communication network that may use one CGW per subnet. The communication network may be used, for example, to discover one or more UEs, communicate discovery requests or results between CGWs, to provide data tunneling between CGWs, or the like.

As shown in FIG. 80, each subnet, such as subnet 8050-1, 8050-2 . . . 8050-p may have a corresponding CGW, such as CGW 8040-1, 8040-2 and 8040-3. The CGWs may use inter-CGW signaling for UE discovery and CGW aggregation and segregation operations for split data (e.g., flow) processing/regulation.

Referring to FIG. 80, the exemplary network 8000 may include the MCN 8010, the Internet 8020, the ISP modem 8030, a plurality of CGWs 8040-1, 8040-2 . . . 8040-p, a plurality of corresponding subnets 8050-1, 8050-2 . . . 8050-p, and the UE 8060. Each CWG 8040-1, 8040-2 . . . 8040-p may communicate with the MCN 8010 via the ISP modem 8030 (or the like) and the Internet 8020 using, for example Internet Protocol.

A CGW, such as CGW 8040-1, 8040-2 . . . 8040-p, may include a DHCP server. The DHCP server may provide an IP address for a corresponding subnet, such as subnet 8050-1, 8050-2 . . . 8050-p, using DHCP.

A CGW, such as CGW 8040-1, may include a network interface card (NIC) (not shown) may be used to interface with the corresponding subnet, such as 8050-1. The interface may be a wired connection, such as Ethernet, or wireless technologies, such as WiFi. Subnet 1 8050-1 may include cellular access points, such as HNB1 thru HNBn₁, (e.g., HNB1 indicated by 8052-1) and wireless access points, such as WiFi1 thru WiFim₁ (e.g., WiFi1 indicated by 8054-1). Subnet 2 8050-2 may include cellular access points, such as HNB1 thru HNBn₂, (e.g., HNB1 indicated by 8052-2) and wireless access points, such as WiFi1 thru WiFim₂ (e.g., WiFi1 indicated by 8054-2). Subnet p 8050-p may include cellular access points, such as HNB1 thru HNBnₚ (e.g., HNB1 indicated by 8052-p), and wireless access points, such as WiFi1 thru WiFimₚ (e.g., WiFi1 indicated by 8054-p).

The number of HNB and WiFi access points for a subnet (e.g., any subnet) may be any number. Wired access points may be included in subnets 8050-1, 8050-2 . . . 8050-p.

Two of more the subnets, such as subnet 8050-2 and subnet 8050-p may be established near, adjacent and/or overlapping each other. For example, a subnet 8050-2 may have a coverage area on one floor of a building and subnet 8050-p may have a coverage area on a second floor of the building. The RATs associated with subnet 8050-2 and 8050-p may overlap such that a first RAT (e.g., the HNB 8052-p of the subnet p 8050-p) and a second RAT (e.g., the WiFi 8054-2 of Subnet 8050-2) may each carry a portion of a data stream to or from UE 8060. For example, to increase throughput to UE 8060, HNB 8052-p of subnet 8050-p and WiFi 8054-2 of subnet 8050-2 may carry a split data stream that may be associated with UE 8060. This may occur, for example, by splitting the packets (e.g., packet flows) between the two different RATs. Because the packet flows may be split between subnet 8050-p and subnet 8050-2, the CGWs 8040-1, 8040-2 . . . 8040-p may coordinate certain operations (e.g., including UE discovery, and flow regulation) for the subnets 8050-1, 8050-2 . . . 8050-p. For example, data tunneling may be used between CGWs to communicate discovery requests/results between CGWs, and to coordinate the flow of data to or from a UE.

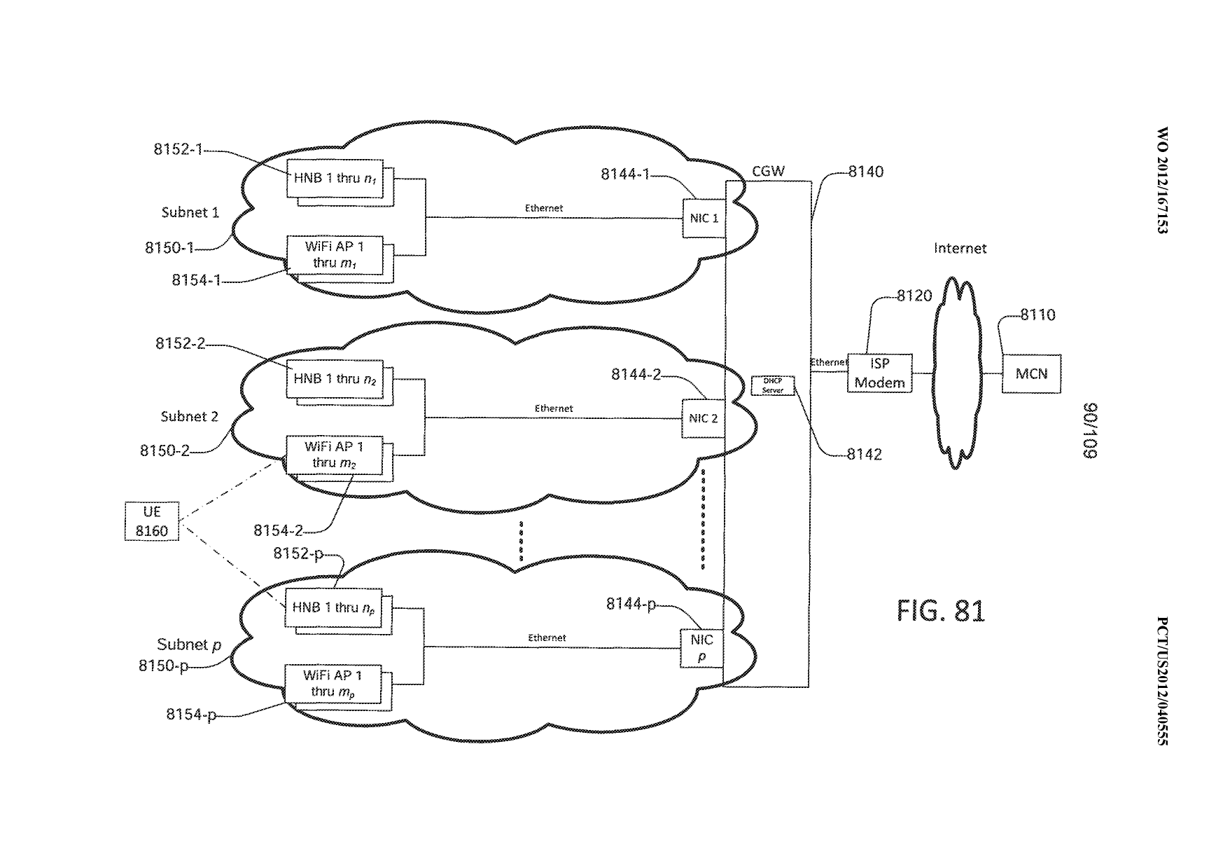

FIG. 81 depicts a communication network that may use one CGW for multiple subnets. As shown in FIG. 81, the communication network may include a MCN 8110, an Internet 8120, an Internet Service Provider (ISP) modem 8130, a CWG 8140, a plurality of subnets 8150-1, 8150-2 . . . 8150-p and a UE 8160. The CWG 8140 may communicate with the MCN 8110 via the ISP modem 8130 and the Internet 8120 using, for example Internet Protocol. Other configurations may possible including the use of a VPN (not shown) or other wired or wireless backhaul connections to the MCN.

The CGW 8140 may include a Dynamic Host Configuration Protocol (DHCP) server 8142. The DHCP server 8142 may provide IP addresses for a subnet, such as subnets 8150-1, 8150-2 . . . 8150-p. The DHCP server may use using DHCP to automate network-parameter assignment to network devices. For example the DHCP server may: dynamically allocate an IP address such that a UE (e.g. a DHCP client) may, for a period of time, request an IP address from an allocated range of IP addresses; automatic allocate an IP address by assigning a free IP address to the requesting UE; or statically allocate an IP address based on a on a table with MAC address/IP address pairs. While the DHP server may be shown within the CGW, the DHCP server may be located outside CGW.

The CGW 8140 may also include a plurality of network interface cards (NIC) NIC₁, NIC₂ . . . NICₚ (e.g., 8144-1, 8144-2 . . . 8144-p) that may interface with the plurality of subnets 8150-1, 8150-1 . . . 8150-p via, for example a wired connection, such as Ethernet, or a wireless connection, such as WiFi. Subnet 8150-1 may include cellular access points, such as HNB1 thru HNBn₁ (e.g., HNB1 indicated by 8152-1), and wireless access points, such as WiFi1 thru WiFim₁ (e.g., WiFi1 indicated by 8154-1). Subnet 8150-2 may include cellular access points, such as HNB1 thru HNBn₂ (e.g., HNB1 indicated by 8152-2), and wireless access points, such as WiFi1 thru WiFim₂ (e.g., WiFi1 indicated by 8154-2). Subnet p 8150-p may include cellular access points, such as HNB1 thru HNBnₚ (e.g., HNB1 indicated by 8152-p), and wireless access points, such as WiFi1 thru WiFimₚ (e.g., WiFi1 indicated by 8154-p).

Any number of HNB and WiFi access points may be included in a subnet. Wired access points may also be included in subnets 8150-1, 8150-2 . . . 8150-p.

The subnets may include other network access points, such as WLAN, Bluetooth, or the like. The UE 8160 may include two or more radio access technologies (RATs) and/or may be attached to two or more subnets via such RATs. For example, the UE 8160 may include a cellular RAT and a WiFi RAT.

Two or more of the subnets 8150-1 and 8150-2 may be established near, adjacent and/or overlapping each other. For example, a subnet 8150-1 may have a coverage area on one floor of a building and subnet 8150-2 may have a coverage area on a second floor of the building. As another example, subnet 8150-2 may have a coverage area for one geographic area and subnet 8150-p may have a coverage area for a second geographic area. The RATs associated with subnets 8150-2 and 8150-p may overlap such that a first RAT (e.g., associated with the HNB 8152-p of the subnet p 8150-p) and the second RAT (e.g., associated with the WiFi 8154-2 of Subnet 8150-2) may carry a portion of a data stream to or from UE 8160. For example, to increase throughput to the UE 8160, HNB 8152-p of subnet p 8150-p and WiFi 8154-2 of subnet 2 8150-2 may carry a data stream associated that may be with the UE 8160. This may be accomplished, for example, by splitting the data packets (e.g., packet flows) between the two different RATs. Because the data packet flows may be split between subnets 8150-2 and 8150-p, the CGW 8140 may coordinate certain operations (e.g., including UE discovery) for the subnets 8150-1, 8150-2 . . . 8150-p. The splitting of the data stream may also be done to provide benefits to any number of characteristics of the network, such as increased throughput for a user of the system, less interference on a particular RAT, or the like.

Although a data packet flow as split between two RATs may be illustrated, data packet flows may be divided among any number of different RATs.

As shown in FIG. 81, a UE may connect to multiple subnets. Each of the subnets may be connected to the same CGW. For example, subnet 8150-1, subnet 8150-2, and subnet 8150-p may be connected to CGW 8140. Subnets that may connect to the same CGW may not require coordination between CGWs, as the same CGW may be used. CGW 8140 may provide discovery, such as UE discovery, on the multiple subnets that may be connected. This may be done, for example, using DHCP server 8142.

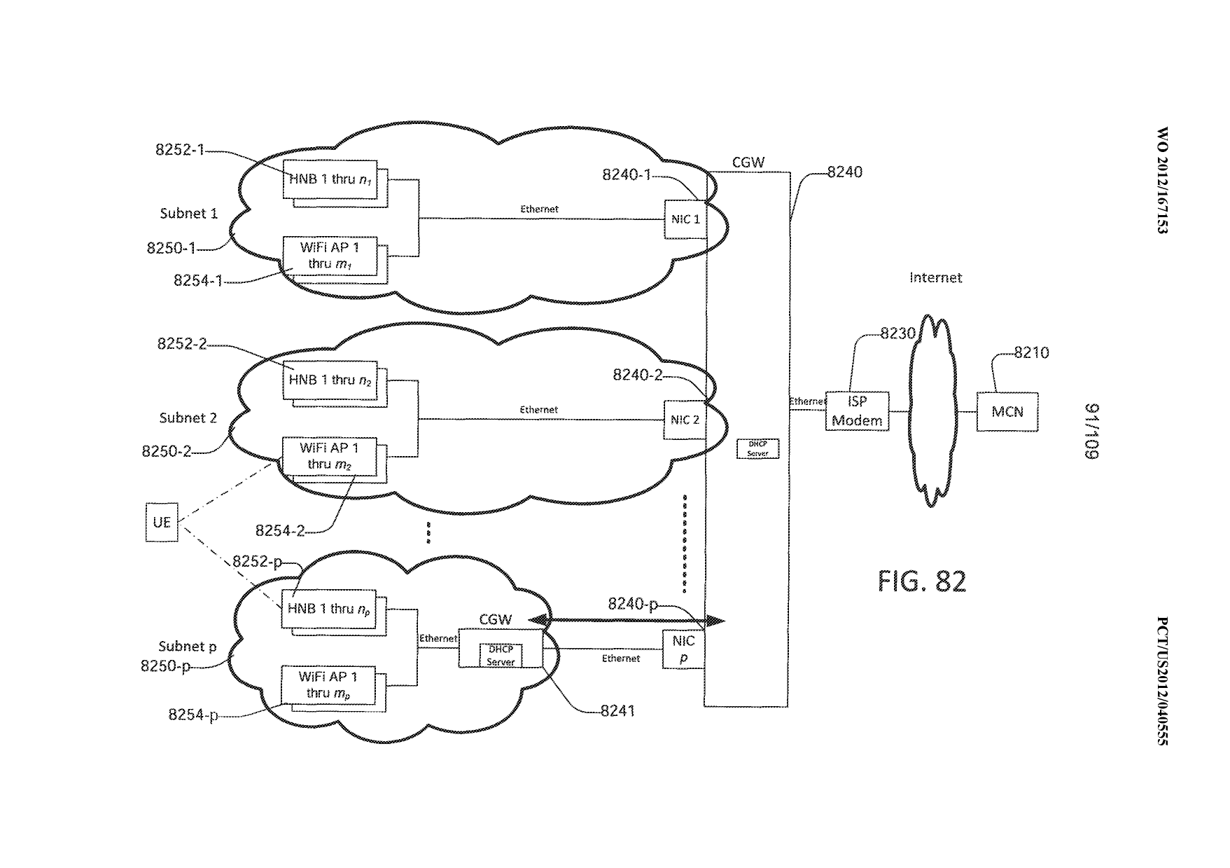

FIG. 82 depicts a communication network that's that may use CGWs in a hierarchy topology.

As shown in FIG. 82, CGW 8240 may correspond to and may provide data flow regulation for subnet 8250-1, 8250-2 . . . 8250-p. CGW 8241 may provide flow regulation for subnet 8250-p such that the CGW 8240 and the CGW 8241 may be in a hierarchical arrangement. In this network topology, the CGWs 8240 and 8241 may use inter-CGW signaling for UE discovery and/or for CGW data flow regulation, data aggregation, data segregation, or the like. This may be done, for example, to split a data flow to or from UE 8260.

The communications network may include MCN 8210, Internet 8220, ISP modem 8230, CGW 8240, CGW 8241, subnets 8250-1, 8250-2 . . . 8250-p, and UE 8260. CWG 8240 may communicate with MCN 8210 via ISP modem 8230 and Internet 8220. The CGW 8241 may communicate with MCN 8210 via CGW 8240, ISP modem 8230, and Internet 8220.

CGW 8240 and 8241 may include a DHCP server. The DHCP server of CGW 8240 may provide IP addresses for subnets 8250-1, 8250-2 . . . 8250-p. The DHCP server of the CGW 8241 may provide IP addresses for subnet 8250-2.

Each CGW may include NICs. For example, CGW 8240 may include NICs 8242-1, 8242-2 and 8242-p that may interface with subnets 8250-1, 8250-2 and 8250-p. The NICs may interface using a wired connection, such as Ethernet, or a wireless connection, such as WiFi. Subnet 8250-1 may include cellular access points, such as HNB1 thru HNBn₁, (e.g., HNB1 indicated by 8252-1), and wireless access points, such as WiFi1 thru WiFim₁ (e.g., WiFi1 indicated by 8254-1). Subnet 8250-2 may include cellular access points, such as HNB1 thru HNBn₂, (e.g., HNB1 indicated by 8252-2), and wireless access points, such as WiFi1 thru WiFim₂ (e.g., WiFi1 indicated by 8254-2). Subnet 8250-p may include cellular access points, such as HNB1 thru HNBnₚ (e.g., HNB1 indicated by 8252-p), and wireless access points, such as WiFi1 thru WiFimₚ (e.g., WiFi1 indicated by 8254-p).

CGW 8241 may interface with CGW 8240 via the NIC 8242-p using, for example, an Ethernet connection in a hierarchical arrangement. The hierarchical arrangement may be, for example, and hierarchy in which CGW 8241 may perform flow regulation point for subnet 8250-p and CGW 8240 may perform flow regulation for the subnets 8250-1, 8250-2 . . . 8250-p.

The number of HNB and WiFi access points for a subnet may be any number. Wired access points may also be included in subnets 8250-1, 8250-2 . . . 8250-p.

Two or more of the subnets, such as subnet 8250-p and subnet 8250-2 may be near to, adjacent to and/or overlap each other. The RATs associated with subnet 8250-p and 8250-2 may overlap such that a first RAT (e.g., HNB 8252-p of the subnet 8250-p) and a second RAT (e.g., WiFi 8254-2 of subnet 8250-2) may carry a portion of the data stream of UE 8260. Because the data packet flows may be split between subnet 8250-p and subnet 8250-2, CGW 8240 and CGW 8241 may coordinate certain operations (e.g., including UE discovery and/or flow regulation) for the subnets 8250-1, 8250-2 . . . 8250-p.

During an initial phase (e.g., at startup, power up or a duration thereafter) a CGW may learn about its environment, for example by searching the LAN to find other CGWs. Each CGW may resolve hostnames with a local DNS Server to find the other CGWs and/or may broadcast inter-CGW messages to announce itself and its IP address to other CGWs on the network. For example, when a respective CGW is powered up, it may learn about its environment and may continue to do so periodically. The respective CGW may learn about other CGWs that may be powered on or powered off while the respective CGW may be powered on.

In certain exemplary embodiments, the CGWs may learn about their environment by periodically broadcasting a message that may identify the CGW and the CGW's local IP address. Each CGW may listen for these messages. Upon receipt of a message from another CGW (e.g., the broadcasting CGW), the receiving CGW may compare the CGWs local IP address with the address range of the subnets that the receiving CGW controls. If the broadcasting CGWs address may be within one or more subnets controlled by the receiving CGW, the receiving CGW may forward the UE Discovery message to a CGW that may have been discovered to be part of a subnet controlled by the receiving CG. The CGW may forward the UE Discovery message to a CGW that was discovered not to be part of a subnet controlled by the receiving CGW. If the broadcasting CGWs address is not within the subnets controlled by the receiving CGW, the receiving CGW may forward the UE Discovery message to a CGW that may have been discovered to be part of a subnet controlled by the receiving CGW.

UE 8260 may connect to a HNB of one subnet and a WiFi AP of another subnet. CGWs may coordinate UE Discovery, communications of UE Discovery requests/results; and/or data tunneling between CGWs. A CGW may be a physical device and may provide flow regulation operations for a subnet.

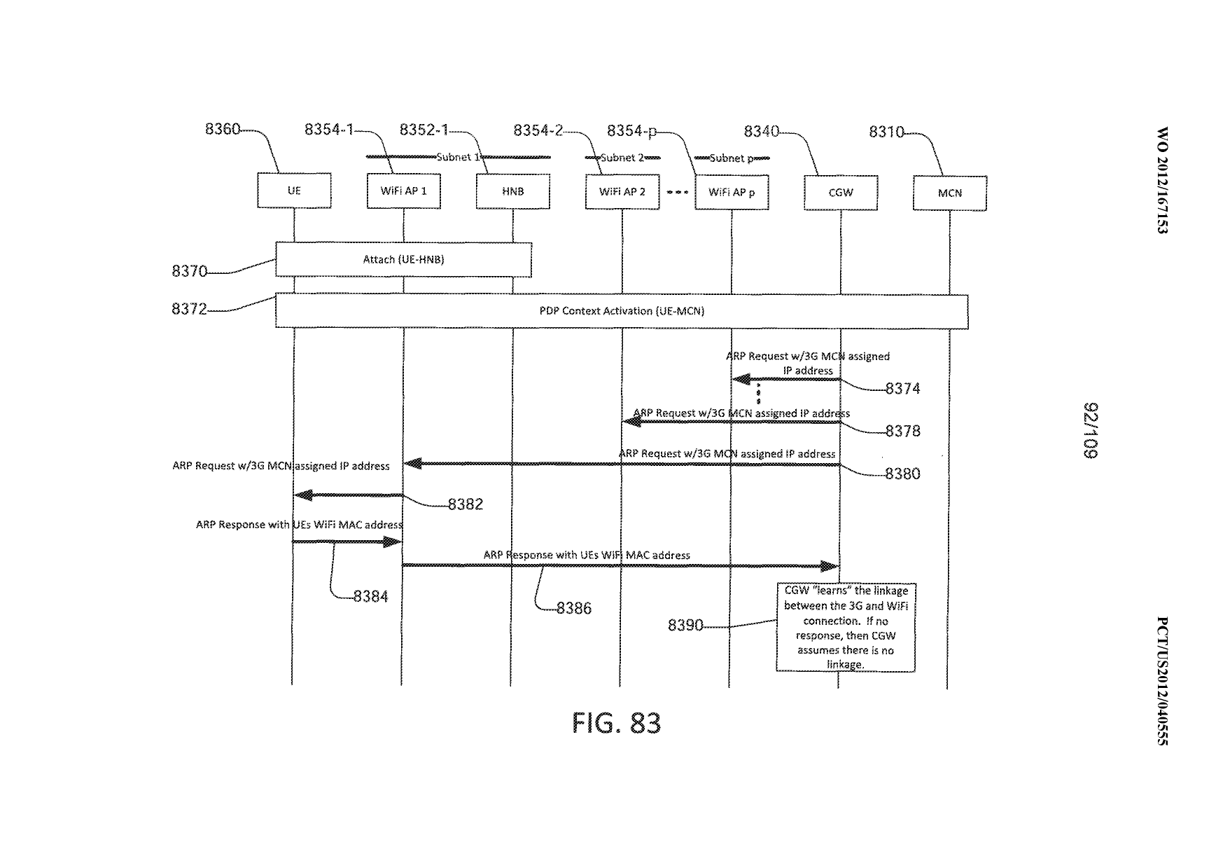

FIG. 83 depicts a method for UE discovery using a communication network.

A CGW may discover that a user device may be connected by both WiFi and cellular. A CGW may query the single subnet that it may control to link the WiFi IP address to the cellular IP Address. When successful, the CGW may know that a WiFi and a cellular IP address connect to the same device. If the query fails, the CGW may assume that the path to the device may be via the cellular connection. If the device may have connected via WiFi to a different subnet, the CGW may not know this and may have to learn this. This CGW may perform this query periodically.

As shown in FIG. 83, a communication network may include UE 8360, WiFi AP 1 at 8354, HNB at 8352-1, WiFi AP 2 at 8354-2, WiFi AP p at 8354-p, CGW 8340, and MCN 8310. The communication network may include one or more subnets, such as subnet 1, subnet 2, and subnet p. WiFi AP 1 at 8354-1 and HNB at 8352-1 may belong to subnet 1. WiFi AP 2 at 8354-2 may belong to subnet 2. WiFi AP p at 8354 may be belong to subnet p.

At 8370, UE 8360 may attach to HNB at 8352-1 via WiFi AP 1 at 8354. At 8372, PDP context activation may be performed. PDP context activation may include, for example, UE 8360, WiFi AP 1 at 8354, HNB at 8352-1, WiFi AP 2 at 8354-2, WiFi AP p at 8354-p, CGW 8340, and MCN 8310. At 8374, CGW 8340 may transmit an ARP request with a MCN assigned IP address to WiFi AP p at 8354-p. At 8378, CGW 8340 may transmit an ARP request with a MCN assigned IP address to WiFi AP 2 at 8354-2. At 8380, CGW 8340 may transmit an ARP request with a MCN assigned IP address to WiFi AP 1 at 8354-1. At 8382, WiFi AP 1 at 8354-1 may transmit an ARP request with a MCN assigned IP address to UE 8360. At 8384, UE 8360 may transmit an ARP response with a WiFi MAC address to WiFi AP 1 at 8354-1. The WiFi MAC address may belong to UE 8360. At 8386, WiFi may transmit an ARP response with the WiFi MAC address to CGW 8340. At 8390, CGW 8340 may learn of the linkage between the 3G and WiFi connection. If CGW 8340 does not receive a response, then CGW 8340 may assume that there may not be a linkage.

After the activation of a PDP context through a first CGW, as shown in FIG. 83 one or more subnets controlled by the first CGW may send an ARP request using the 3G MCN assigned IP. If a response may be received, then the first CGW may note that the device may be reachable via both WiFi, for example using the MAC address in the ARP Response, and the 3G MCN, for example using an assigned IP address. If a response may not be received, the first CGW may attempt to contact a CGW within the enterprise with the 3G MCN assigned IP address. If a response may be received from a second CGW, the first CGW may note that a device may be reachable via both WiFi, for example using the responding CGW, and the 3G MCN assigned IP address. FIG. 83 may assume multiple subnets may be used and that the subnets may connect to the same CGW.

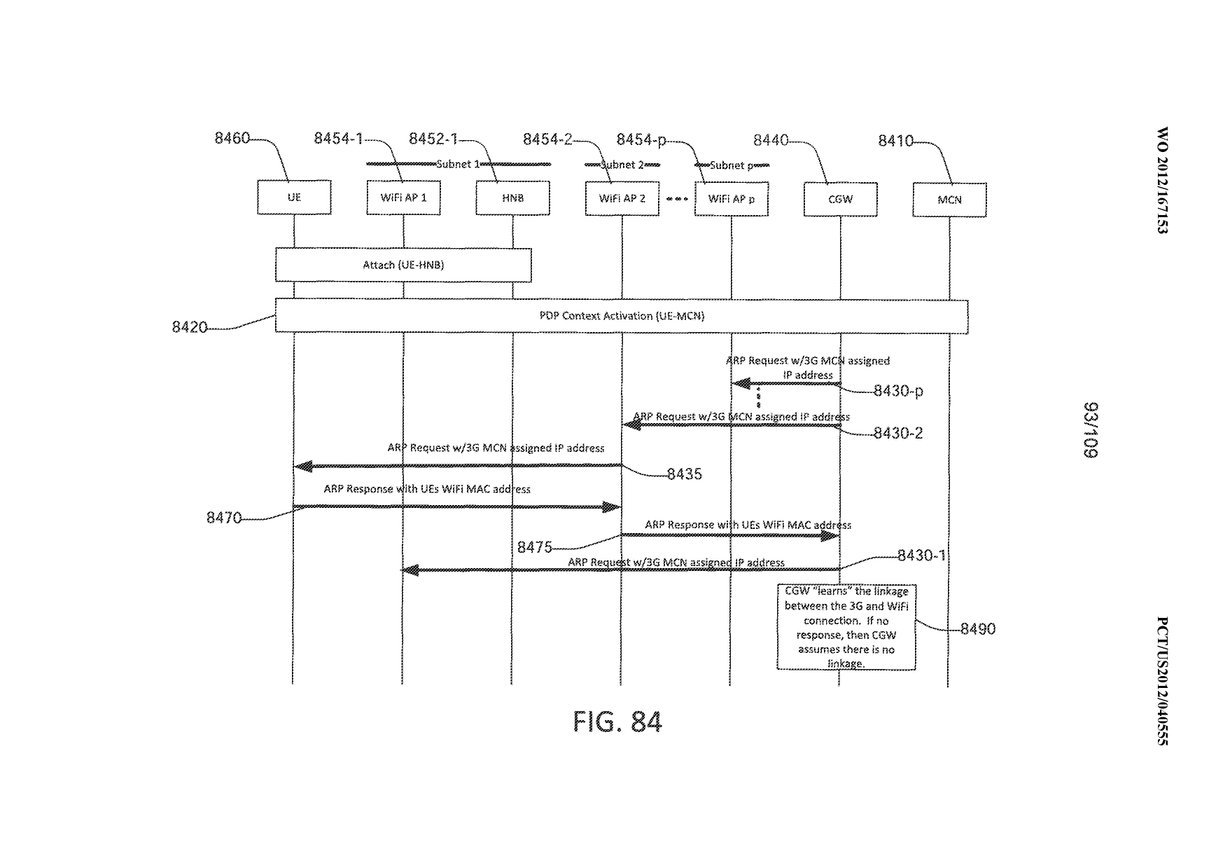

FIG. 84 depicts another method for UE discovery using a communication network. Referring to FIG. 84, at 8410, the UE 8460 may attach to the HNB1 8452-1 of subnet 1 and at 8420, a PDP context activation with the MCN 8410 through the CGW 8440 may establish an IP address for the UE 8460. At 8430-1, 8430-2 and 8430-p, after receiving the IP address of the UE 8460 from the PDP context activation, the CGW 8440 may send an Address Resolution Protocol (ARP) request to the WiFi access points 8454-1, 8454-2 and 8454-p of each subnet 8450-1, 8450-2 . . . 8450-p controlled by the CGW 8440. The ARP request may use the assigned address (e.g., 3G MCN assigned IP address) of the UE 8460. Because the WiFi access points 8454-1 and 8454-p of subnets 8450-1 and 8450-p may not connect with the UE 8460 (e.g., they may not have an IP address that may be reachable), an ARP response may not be sent back from the WiFi access points 8454-1 and 8454-p of subnets 8450-1 and 8450-p. The WiFi access points 8454-2 of subnet 2, however, may have a connection with the UE 8460 (e.g., it may have an IP address that may be reachable). At 8435, the WiFi access point 8454-2 may forward the ARP request to the UE 8460. At 8470, the UE 8460 may send back an ARP response to the WiFi access point 8454-2. At 8475, the ARP response may then be forwarded by the WiFi access point 8454-2 from the WiFi access point 8454-2 to the CGW 8440. The ARP response may include the WiFi MAC address such that it may indicate that the UE 8460 may be reachable via the WiFi access point 8454-2 of the subnet 8450-2 and the PDP context activation operation may indicate that the UE 8460 may also be reachable using the IP address via the HNB 8452-1 of the subnet 8450-1.

The ARP request and ARP response or another signaling mechanism may be used and may include the MAC address of the UE 8460 in addition to or in lieu of the IP address of the UE 8460. The MAC address may be provided via a lookup table, for example stored in the CGW 8440 or DHCP server 8442 or a lookup service available to the CGW 8440.

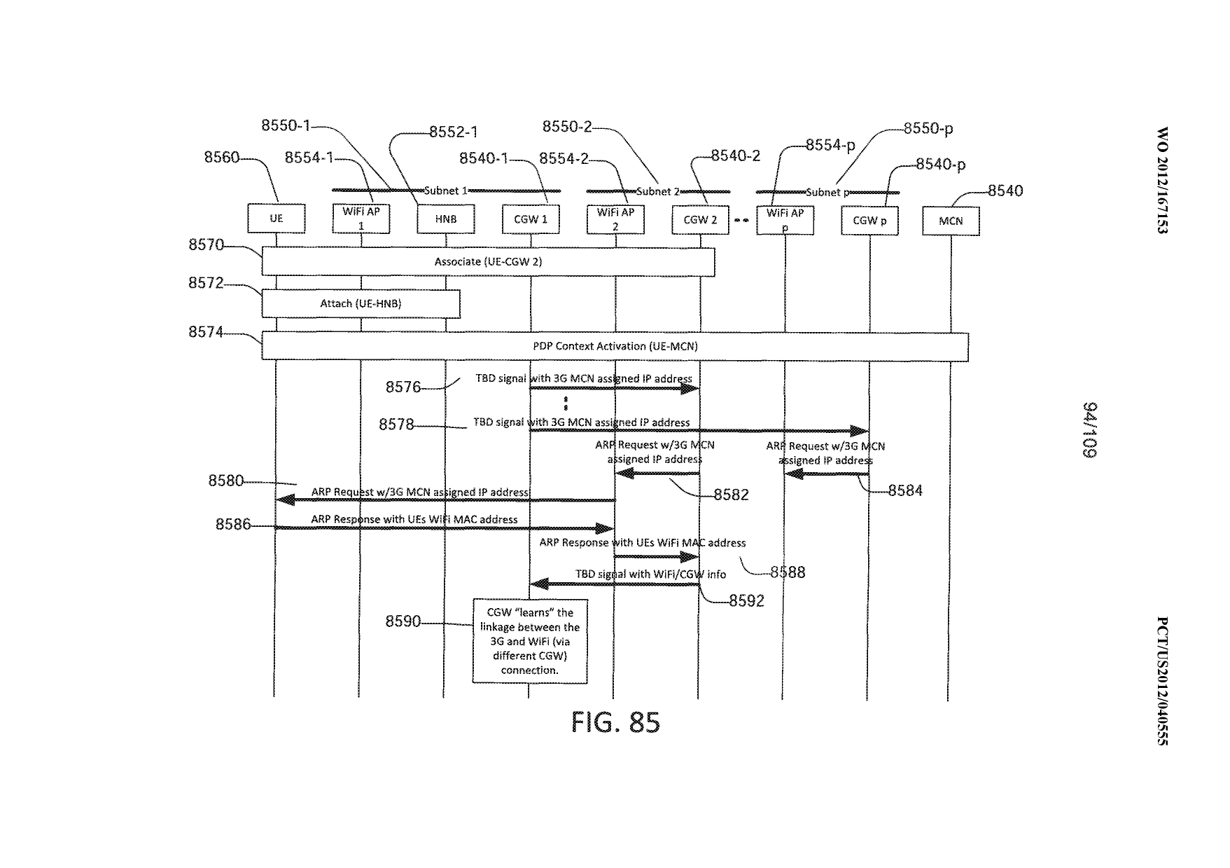

FIG. 85 depicts another method for UE discovery using a communication network.

Referring to FIG. 85, at 8570, the UE 8560 may associate with the WiFi access point 8554-2 after coming into range of the WiFi access point 8554-2. The UE may be provided an IP address by the DHCP server within the CGW 8540-2 and may be provided the CGW local IP address as the default gateway. At 8572, the UE 8560 may attach to the HNB1 8552-1 of subnet 8550-1 and at 8574, a PDP context activation with the MCN 8510 through the CGW 8540-1 may establish an IP address for the UE 8560. The CGW 8540-1 may search for a linkage of access points on the subnets controlled by the CGW 8540-1.

For example, an ARP request may be generated by the CGW 8540-1 and may be sent to WiFi access point 8554-1. If an ARP response may not been received in response to such a search, for example from WiFi access points 8554-1 on the subnet 8550-1, it may indicate that a WiFi access point of this subnet may not be connected to (e.g., attached to) the UE 8560. In such a case, the CGW 8540-1 may expand it search for the UE's WiFi or other connection and may contact (e.g., send an inter-CGW message or signal) other CGWs within the enterprise or network that may be known to the CGW 8540-1. The CGW 8540-1 may include the assigned IP address of the UE 8560 in the inter CGW message or signal in order for these enterprise or network CGWs 8540-2 and 8540-p to generate (e.g., issue) an ARP request for the UE 8560. If an ARP response may be received from the search, it may be forwarded and/or inter-CGW response message may be generated by the respective CGW 8540-2 or 8550-p and may be sent to the CGW 8540-1 to indicate that the UE 8560 may have been found by the respective CGW 8540-2 or 8540-p.

Responsive to the CGW 8540-1 receiving an ARP response or an inter-CGW response by the CGW 8540-2, the CGW 8540-1 may link the HNB 8552-1 of subnet 8550-1 and the WiFi access point 8554-2 of subnet 8550-2 (e.g., that is associated with the ARP response from the UE 8560). For example, if a response may be received from a CGW, the UE 8560 may be reachable via both WiFi (through the responding CGW) and the assigned IP address. If, however, a ARP response may not be received, the CGW 8540-1 may determine that no linkage may exist between the HNB 8552-1 and any access points (e.g., WiFi and/or other access points) searched that may be known to the CGW 8540-1 that initiated the discovery.

For example, at 8576 and 8578, after receiving the IP address of the UE 8560 from the PDP context activation, and searching its internal subnets for a linkage, a linkage may not be discovered. The CGW 8540-1 may send inter-CGW messages and/or inter-CGW signals to the CGWs on the network (e.g., local area network (LAN)), such as CGWs 8540-2 and 8540-p. At 8582, the CGW 8540-2 receiving the inter-CGW message or signal may generate (e.g., issue) an ARP request and may send it to its associated access points (e.g., WiFi access points) 8554-2 of subnet 8550-2. At 8584, the CGW 8540-p receiving the inter-CGW message or signal may generate an ARP request and may send the ARP request to its associated access points (e.g., WiFi access points) 8554-p of subnet 8550-p. An ARP request may use the assigned address (e.g., 3G MCN assigned IP address) of the UE 8560. At 8580, the WiFi access point 8554-2 may forward the ARP request to the UE 8560. At 8586, UE 8560 may generate an ARP response including, for example, the UE's WiFi MAC address and may send the response to the WiFi access point 8554-2. At 8588, the WiFi access point 8554-2, after receiving the ARP response, may forward it to the CGW 8540-2. At 8592, the CGW 8540-2 may generate and may send an inter-CGW message or signal (e.g., including the MAC address of the UE 8560, the identity of the responding CGW and its IP address) to the CGW 8540-1. At 8590, the CGW 8540-1 may link the HNB access point 8552-1 with the WiFi access point 8554-2. The ARP response may indicate that the UE 8560 may be reachable via the WiFi access point 8554-2 of the subnet 8550-2 and the PDP context activation operation indicates that the UE 8560 may also be reachable using the 3G MCN assigned IP address via the HNB 8552-1 of the subnet 8550-1. Because the WiFi access points 8554-p of subnet 8550-p may not connect with (e.g., link to) the UE 8560 (e.g., WiFi access points 8554-p may not have an IP address that may be reachable), an ARP response may be not be sent back from the WiFi access points 8554-p of subnet 8550-p.

An ARP response may not be issued because, for example, the UE 8560 may be unattached or offline during the ARP request, due to interference or other difficulties. An ARP response from WiFi access points 8554-1, 8554-2 and 8554-p on the subnets 8550-1, 8550-2 and 8550-p may not be issued, which may indicate that no known WiFi access point may be connected to (e.g., linked to) the UE 8560. When CGW 8540-1 may not receive an ARP response after it may expand its search for the UE's WiFi connection, it may wait a period of time and may retry to establish a linkage.

After the receipt of an assigned IP address (e.g., the 3G MCN assigned IP address) from another CGW, as shown in FIG. 85, an ARP Request may be sent using the 3G MCN assigned IP address such that if a response may be received from another CGW, information may be passed back to the CGW that sent the query. If no response may be received from another CGW, no action may be taken (e.g., there is no response).

After the activation of a PDP context through a first CGW, as shown in FIG. 85 one or more subnets controlled by the first CGW may send an ARP request using the 3G MCN assigned IP. If a response may be received, then the first CGW may note that the device may be reachable via both WiFi, for example using the MAC address in the ARP Response, and the 3G MCN, for example using an assigned IP address. If a response may not be received, the first CGW may attempt to contact a CGW within the enterprise with the 3G MCN assigned IP address. If a response may be received from a second CGW, the first CGW may note that a device may be reachable via both WiFi, for example using the responding CGW, and the 3G MCN assigned IP address. The CGW may note and/or store information regarding the responding CGW including its IP address, route information and possibly other information for establishing a tunnel between the CGWs. FIG. 85 may assume multiple subnets may be used and that one CGW may be provided for each subnet.

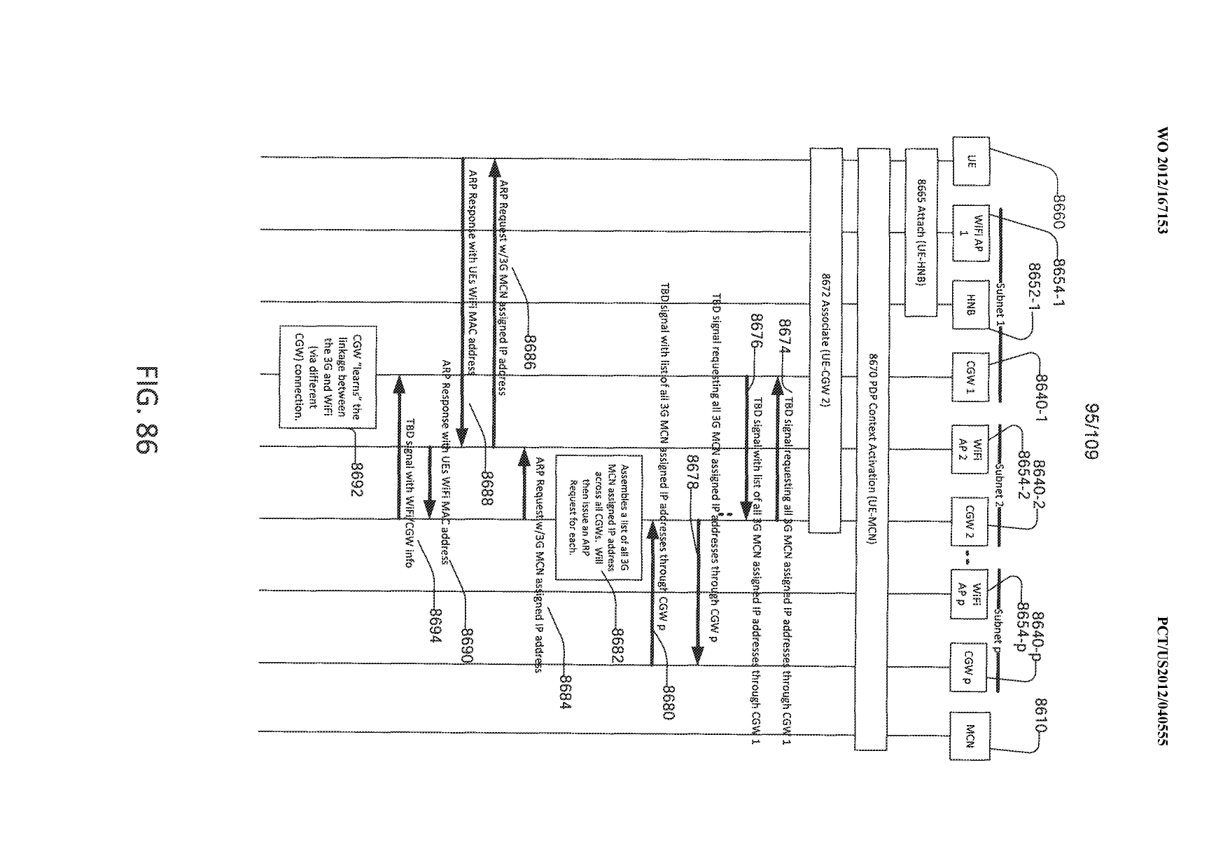

FIG. 86 depicts another method for UE discovery using a communication network. Referring to FIG. 86, at 8665, the UE 8660 may attach to the HNB1 8652-1 of subnet 8650-1 and, at 8670, a PDP context activation with the MCN 8610 through the CGW 8640-1 may establish a 3G MCN IP address for the UE 8660. At 8672, the UE may associate (e.g., register) with the WiFi access point 8654-2 using the DHCP server in the CGW 8640-2. Responsive to the association of the UE with the CGW 8640-2, the CGW 8640-2 may contact (e.g., send an inter-CGW message or signal) each CGW within the enterprise or network that may be known to the CGW 8640-2 (e.g., from a discovery or DNS process).

Each respective CGW 8640-1, 8640-2 or 8640-2 may store a list or a table of IP addresses (e.g., 3G MCN assigned IP addresses) that may have been assigned though the respective CGW 8640-1, 8640-2 or 8640-2 such that the enterprise or network CGW 8640-2 and 8640-p may respond to the inter-CGW-request to provide its list of IP addresses. At 8674, the CGW 8640-2 may send an inter-CGW message or signal to the CGW 8640-1 requesting the assigned IP addresses (e.g., all of the assigned IP addresses) assigned though the CGW 8640-1. At 8676, the CGW 8640-1 may respond by sending an inter-CGW message or signal including a list or table of the assigned IP addresses. At 8678, the CGW 8640-2 may send another inter-CGW message or signal to the CGW 8640-p that may request the assigned IP addresses assigned though the CGW 8640-p. At 8680, the CGW 8640-p may respond by sending an inter-CGW message or signal that may include a list or table of the assigned IP addresses.

At 8682, the CGW 8640-2 may assemble a composite list of assigned IP addresses (e.g., 3G MCN assigned IP addresses) that may be known. The CGW 8640-2 may generate and may send an ARP request for each assigned IP address. A 8684, an ARP request to the WiFi access point 8654-2 may include the 3G MCN assigned IP address of the UE 8660. At 8686, the WiFi access point 8654-2 may forward the ARP request to the UE 8660. At 8688, UE 8660 may generate an ARP response that may include, for example, the UE's WiFi MAC address and may send the response to the WiFi access point 8654-2. At 8690, the WiFi access point 8654-2, may receive the ARP response and may forward it to the CGW 8640-2.

At 8690, the CGW 8640-2 may generate and may send an inter-CGW message or signal to the CGW 8640-1. The inter-CGW message or signal may include CGW information, such as information regarding the CGW 8640-2 and the MAC address of the UE 8660. At 8692, the CGW 8640-1 may link the HNB access point 8652-1 with the WiFi access point 8654-2. The ARP response may indicate that the UE 8660 may be reachable via the WiFi access point 8654-2 of the subnet 8650-2 and the PDP context activation operation may indicate that the UE 8660 may also be reachable using the IP address via the HNB 8652-1 of the subnet 8650-1.

As shown in FIG. 86, after the assignment of a WiFi IP address by this CGW an ARP Request may be sent for each assigned IP address assigned through this CGW. Although ARP may be used, other methods may also be used. For example, a client and a server may be on a UE and a CGW and the UE may register itself to the CGW. The CGW may then communicate with the UE.

As shown in FIG. 86, if a response is received, the CGW may note and/or store information that the device may be reachable via both WiFi (for example, using the MAC address in the ARP Response) and the 3G MCN assigned IP address of the device. If a response may not have been received, the CGW may continue by requesting a list of the assigned IP addresses from each CGW within the enterprise. As CGWs respond to the requesting CGW, an ARP Request may be sent. If a response to the ARP Request may be received, the information may be transmitted to the CGW that provided the 3G MCN assigned IP address that may have invoked the user device to respond to the ARP Request. The information may note that that the device may be reachable via WiFi and may include CGW information of the CGW initiating the search for the device for possibly establishing a tunnel between CGWs.

After a CGW receives a request from another CGW for a list of assigned IP address assigned through this CGW, the CGW may send a list of assigned IP address through this CGW to the CGW that made the request.

Although the inter-CGW communications are shown as using standard message routing, tunnels may be established between CGWs for improved inter-CGW communications.

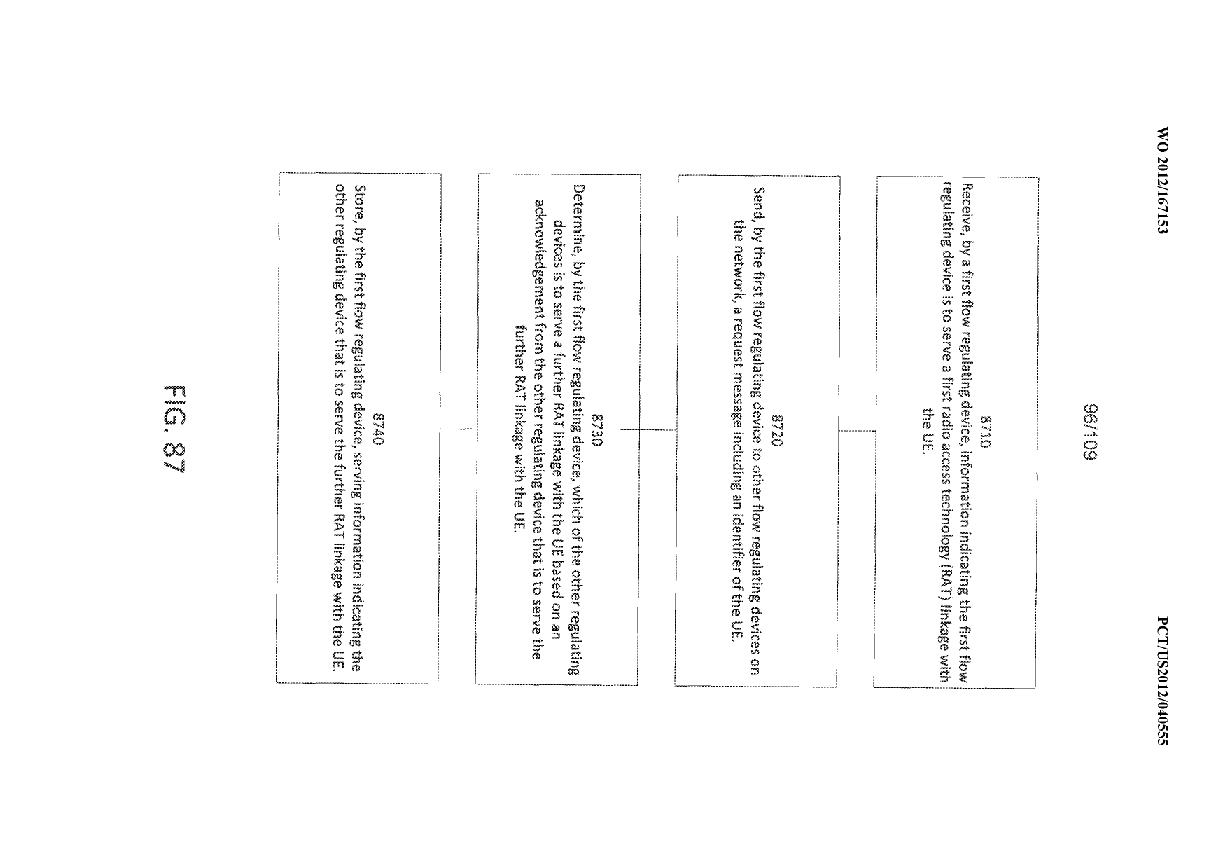

FIG. 87 depicts another method for UE discovery using a communication network. For example, the method shown in FIG. 87 may be used for managing user equipment (UE) flow discovery that may be associated with a plurality of flows of split messages served by a plurality of flow regulating devices, such as a CGW, on a network.

Referring to FIG. 87, at block 8710, a first flow regulating device, such as a CGW, may receive information indicating that the first flow regulating device may be able to serve a first radio access technology (RAT) linkage with a UE. At block 8720, the first flow regulating device may send to other flow regulating devices a request message that may include an identifier of the UE. At block 8730, the first flow regulating device may determine which of the other regulating devices may serve a further RAT linkage with the UE. This may be done, for example, based on an acknowledgement that may be from the other regulating device or that may be able to serve the further RAT linkage with the UE. At block 8740, the first flow regulating device may store serving information that may indicate the other regulating device that may be able to serve the further RAT linkage with the UE.

The flow regulating device may establish a linkage between the first RAT linkage with the UE and the further RAT linkage with the UE. The first flow regulating device may use a domain naming service to discover other flow regulating devices on the network. This may be done, for example, by transmitting a request to other flow regulating devices discovered using the domain naming service. The first flow regulating device may send a broadcast to the other flow regulating devices on the network.

The flow regulating device may determine a type of RAT linkage served by the first flow regulating device based on received information. A priority of the type of RAT linkage may be determined. Responsive to the determined priority being a highest priority, the flow regulating device may initiate sending of the request message. For example, the flow regulating device may respond to the determined priority being less than the highest priority, may wait a predetermined period, and may determine whether a request message from a second flow regulating device may have been received that may be associated with the UE. Responsive to having received the request message from the second flow regulating device, the flow regulating device may block the sending of the request message, and may send an acknowledgement to the request message sent from the second flow regulating device.

In another example, responsive to the determined priority being less than the highest priority, the flow regulating device may wait a predetermined period and may determine whether a request message from a second flow regulating device may have been received that may be associated with the UE. If a request message may not have been received, the flow regulating device may initiate the sending of the request message after the predetermined period ends.

Different predetermined period may be associated with each priority such that a respective flow regulating device that may be able to serve a different RAT linkage with the UE may wait a different predetermined period.

Other exemplary UE discovery methods may also be possible. For example, a flow regulating device may receive a request message that may request whether the flow regulating device may be able to serve a radio access technology (RAT) linkage with the UE. The flow regulating device may send a discovery request to each of the RAT linkage access points served by the flow regulating device. Responsive to one of the RAT linkage access points connecting with the UE, the flow regulating device may receive a response from the one RAT linkage access point. The flow regulating device may send an acknowledgement to the request message sender that may indicate that the flow regulating device may be able to serve the RAT linkage with the UE. The request message may include an address of the UE used by the network and the discovery request may include an address resolution protocol request.

As another example, flow regulating device may receive information that may indicate that the flow regulating device may be able to serve a first radio access technology (RAT) linkage with the UE from a first subnet. The flow regulating device may send a discovery request to RAT linkage access points of subnets that may be served by the flow regulating device. The flow regulating device may receive a discovery response from the one RAT linkage access point that may be responsive to one of the RAT linkage access points that may have sent the discovery request connecting with the UE. The flow regulating device may determine from the discovery response that the flow regulating device may be able to serve a second RAT linkage with the UE from a second subnet. The flow regulating device may establish a link between the first RAT linkage with the UE from a first subnet and the second RAT linkage with the UE from the second subnet.

A first flow regulating device may receive information indicating the first flow regulating device may be able to serve a first radio access technology (RAT) linkage with the UE and may send to other flow regulating devices on the network, an inter-flow regulation message requesting first identifiers of UEs assigned using the other flow regulating devices. The first flow regulating device also may send to each respective UE that may have a first identifier assigned using one of the other flow regulating devices, a request message requesting a second identifier of the respective UE and may send the second identifier to the other flow regulating device that may have provided the corresponding first identifier. For example, the first flow regulating device based on one or more replies to the inter-flow regulation message may assemble a listing of the IP addresses assigned to UEs using the first and other flow regulating devices such that the UEs in the assembled list may be sent an ARP request that may include the assigned IP address.

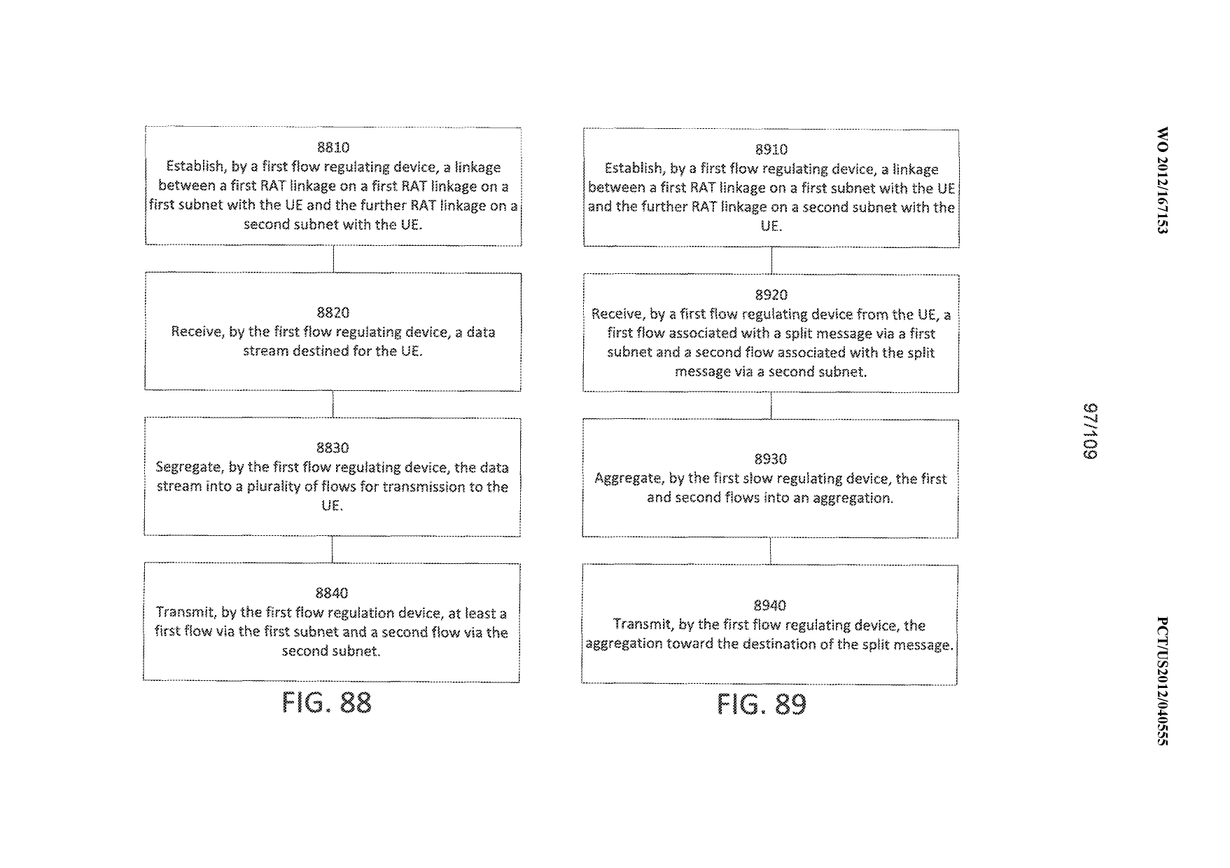

FIG. 88 depicts another method for UE discovery using a communication network. The method may be used, for example, to manage flows associated with split messages sent to a UE using flow regulating devices

Referring to FIG. 88, at block 8810, a first flow regulating device may establish a linkage between a first RAT linkage on a first subnet with a UE and the further RAT linkage on a second subnet with the UE. At block 8820 the first flow regulating device may receive a data stream destined for the UE. At block 8830, the first flow regulating device may segregate the data stream into a plurality of flows for transmission to the UE. At block 8840, the first flow regulation device may transmit at least a first flow via the first subnet and a second flow via the second subnet.

Flows associated with a downlink message may be segregated for transmission to a UE in a network using one or more flow regulating devices. A plurality of network access points (NAPs) may be associated with the UE for registration to the network. Each of the associated NAPs may be served by a first flow regulating device and one of the associated NAPs may be associated with a further flow regulating device. In accordance with this configuration, the first flow regulating device may segregate the downlink message into a plurality of flows for transmission to the UE and may transmit each of the flows including sending one of the segregated flows via the further flow regulating device. For example, the first flow regulating device may send at least the first flow via a first flow path that may traverse the at least one further flow regulating device and a second flow via a second flow path.

FIG. 89 depicts another method for UE discovery using a communication network. The method may be used, for example, to manage flows associated with split messages from UE using flow regulating devices

Referring to FIG. 89, at block 8910, a first flow regulating device may establish a linkage between a first RAT linkage on a first subnet with the UE and the further RAT linkage on a second subnet with a UE. At block 8920, the first flow regulating device may receive from the UE a first flow associated with a split message via a first subnet and a second flow associated with the split message via a second subnet. At block 8930, the first flow regulating device may aggregate the first and second flows into an aggregation. At block 8940, the first flow regulating device may transmit the aggregation toward the destination of the split message.

The first flow regulating device may receive messaging that may indicate that flows from the UE may be sent to a further flow regulating device. The first flow regulating device may receive from the UE a flow associated with a split message. The first flow regulating device may send to the further flow regulating device the flow associated with the split message for aggregation with one or more further flows of the split message.

The first flow regulating device may receive a first flow of the split uplink message via a first path that may include including a further flow regulating device. The first flow regulating device may receive a second flow of the split uplink message using a second path that may not include the further regulating device. The first flow regulating device may aggregate the first and second flows associated with the split uplink message into an aggregation. The first regulating device may transmit the aggregation towards a destination.

The first flow regulating device may manage flows associated with messages traversing the first flow regulating device. The message may be associated with a plurality of subnets in a communication network. The first flow regulating device may receive a split uplink message via a first one of the subnets. The first flow regulating device may determine whether a second flow of the split uplink message may have been received via a further one of the subnets associated with flow regulating device of the communication network. Responsive to the flow regulating device determining that a second flow of the uplink message may have been received by the flow regulating device via the further one of the subnets, the first flow regulating device may reassemble the first and second flows associated with the split uplink message into a reassembled uplink message. The first flow regulating device may transmit the reassembled uplink message. For example, the flow regulating device and a further regulating device may be hierarchically associated with the further one of the subnets such that the second flow may be passed through the further flow regulating device to the flow regulating device for reassembly of the split message.

Disclosed herein are systems, methods, and architectures that may enable multiple CGWs to be supported using proxy mobile IP (PMIP) protocol. This may allow for the integration of PMIP functionality in distributed CGWs architectures, which may be applicable to communication networks, such as IPv4 and IPv6 networks. The disclosed systems, methods, and architectures may be used to provide for distributed mobility management (DMM). For example, as described herein, CGWs, localized mobility anchors (LMA), and mobile access gateways (MAG) may be used in one or more architectures to provide DMM.

A distributed CGW architecture may use a protocol (e.g., open protocol) such as PMIP protocol, Evolved General Packet Radio Service (GPRS) Tunneling Protocol (GTP), or the like. PMIP may enable support for multiple CGWs while providing IP Flow Mobility (IFOM) capabilities (and/or Logical Interface LIF-based support of IFOM). This may be done, for example, to provide support for DMM. The usage of PMIP, GTP, or other such protocols may support communication between CGWs (e.g., inter-CGW communication) to support UEs that may attach to different CGWs. For example, simultaneous connections with different RATs may occur and may allow for data splitting.

Although the integration of PMIP functionality in CGW architecture is illustrated and may be applicable to IPv4 and/or IPv6 networks, multi-homed UEs and IFOM functionality support, it is not limited thereto. For example, PMIP based inter-CGW communications may be applicable DMM. Additionally PMIP based inter-CGW communications may be applicable to on-IP based networks. Other protocols for inter-CGW communications may be used.

Local traffic may include WiFi-to-WiFi traffic, Ethernet-to-WiFi traffic, WiFi-to-Ethernet traffic, Ethernet-to-Ethernet traffic, or the like. Local traffic may also include data plane traffic to or from a non-3G terminal device to another non-3G device. For example, local traffic may include data from a wireless terminal device to a local printer such that the printer may be connected to the LAN through the WiFi and/or the Ethernet. Local traffic may include local IP access (LIPA) traffic, 3G-to-3G traffic, 3G-to-WiFi traffic, 3G-to-Ethernet traffic, or the like. LIPA may be where a cellular device may connect through a HNB and a local gateway (LGW) to access, for example, a device within the LAN that may include the HNB and LGW. For example, LIPA traffic may be data from a 3G terminal device to a local printer where the printer may be connected to the LAN through the WiFi and/or the Ethernet.

Internet traffic may include WiFi-to-Internet traffic, Ethernet-to-Internet traffic, data plane traffic to or from a non-3G terminal device on the LAN to a device on the Internet, or the like. For example, a terminal device may be connected with a WiFi (via a WiFi AP) to a CGW within the LAN such that data (e.g., any data) may be passed between the terminal device and the Internet device through the CGW. The data may pass, for example, between the terminal device and the Internet device without going through an MCN. Internet traffic may include Internet traffic through MCN. For example, internet traffic may include data plane traffic to or from the wireless terminal device on the LAN within a premise to a device on the Internet that may pass through the MCN. There may be at least one 3G connection and there may be one or more WiFi connections. An example may include a wireless terminal device connected with WiFi (via a WiFi AP) and cellular (via a HNB) to a CGW within the LAN. There may be at least one PDP context through the CGW to the MCN. The data between the wireless terminal device and the application server on the Internet may traverse the MCN.

Internet traffic may include MCN-based SIPTO traffic, such as data plane traffic to/from the wireless terminal device that may be offloaded from within the MCN to the Internet. For MCN-based SIPTO, there may be at least one 3G PDP context. The CGW may have no knowledge of which traffic may be offloaded within the MCN.

Internet traffic may include CGW-based SIPTO traffic, such as data plane traffic to or from the wireless terminal device on the LAN within a premise to a device on the Internet. The data may be broken out (e.g., at the CGW) for the Internet and/or the UE. For CGW-based SIPTO, there may be at least one 3G PDP context. An example may include a wireless terminal device connected with the WiFi (via a WiFi AP) and cellular (via a HNB) to a CGW within the LAN. There may be at least one PDP context through the CGW to the MCN. The CGW may be pre-configured to send selected IP data of a specific data type to the Internet (e.g., bypassing the MCN) based on identifying and tagging, for example, the specific data type. Such data passed between the wireless terminal device and the Internet device through the CGW may bypass (e.g., may completely bypass) the MCN by using (e.g., only using) the Internet.

Internet traffic may include MCN Value Added traffic, such as the traffic of an Application Server located within the MCN and/or data plane traffic to or from the wireless terminal device on the LAN within a premise to a device within the MCN. There may be a 3G connection. An example may include a wireless terminal device connected with WiFi (via a WiFi AP) and cellular (via a HNB) to a CGW within the LAN. There may be at least one PDP context through the CGW to the MCN. The data (e.g., all data) between the wireless terminal device and the application server within the MCN may enter the MCN, destined for the application server.

The CGW may implement DHCP server functionality and may handle IP address allocation for connections over the WiFi within a single subnet or multiple subnets. The DHCP server functionality within the CGW may be enabled when the CGW may be located outside of the subnets. The DHCP server may provide DHCP services to each of the subnets and may allocate different IP addresses to the different subnets (e.g., for multiple domains). The CGW may be configured (e.g., have the ability) to decide if an MCN IP address may be linked to a local IP address when an mobile node (MN) connects over the WiFi.

The CGW architectures described below may use inter-CGW communications including PMIP. Any number of HNB and WiFi APs (e.g., none, one or multiple HNBs and/or WiFi APs) may be associated with a CGW and the supporting communication protocol may be irrelevant except for support of “local breakout” functionality. A CGW may support one or more IP address domains and/or a single IP address domain that may not expand beyond a single CGW.

In certain representative embodiments, the communication protocol (e.g., PMIP) may support the inter-CGW communication to support the UE discovery performed by a CGW. The UE discovery may include the process of association of different IP addresses at different CGWs with a single UE. For example, a CGW may seek via different CGWs an association (e.g., an IP association) with different modems of the same UE, e.g., for message splitting or offloading.

A single CGW may support multiple IP address domains and that UEs may be discovered using UE discovery operations among these domains. Tunneling (e.g., secure IP tunneling) may be used for inter-CGW communications. The PMIP protocol may support nomadic (e.g., mobile and/or roaming) UE operation that may include intra CGW mobility (e.g., within same subnet or subnets of a particular CGW) and inter-CGW mobility (e.g., across multiple subnets of two or more CGWs).

A UE may connect to different subnets, e.g., using different interfaces, simultaneously (e.g., a first subnet with an HNB and a second subnet with a WiFi AP, among others). The UE discovery process may include an authentication protocol. Traffic handling operations may include data being passed to the MCN through at least one CGW. Local traffic may be allowed to stay (remain) on the LAN, without going through the MCN or Internet. Internet traffic that may not use the MCN may be allowed to be forwarded to (e.g., directly to) the PDN (without going through MCN) via local WiFi or Ethernet.

For example, Table 3 indicates various representative traffic that may be handled.

TABLE 3

| Internet | MCN Value Added Traffic |
|---|---|
| 3G connection Internet traffic | Application Server located within |
| through MCN | MCN (endpoint of data is in the |
| MCN-based SIPTO | MCN) |

PMIP protocols may support IP flow mobility (IFOM) (e.g., based on LIF implementation on the UE), network-initiated BWA using a MNTP client on the terminal and MNTP server in the CGW, policies (e.g., hardcoded, predetermined, and/or dynamic policies), or the like. The policies may be established/determined on a per user basis (and/or UE basis) within the network to perform segregation for downlink IP flows.

Subnets may be located in different locations, may be located in the same location, or may overlap. Subnets within the same location and/or overlapping may be split. For example, subnets may be split based on access technology such that a first subnet may handle HNB APs and a second subnet may handle WiFi APs.

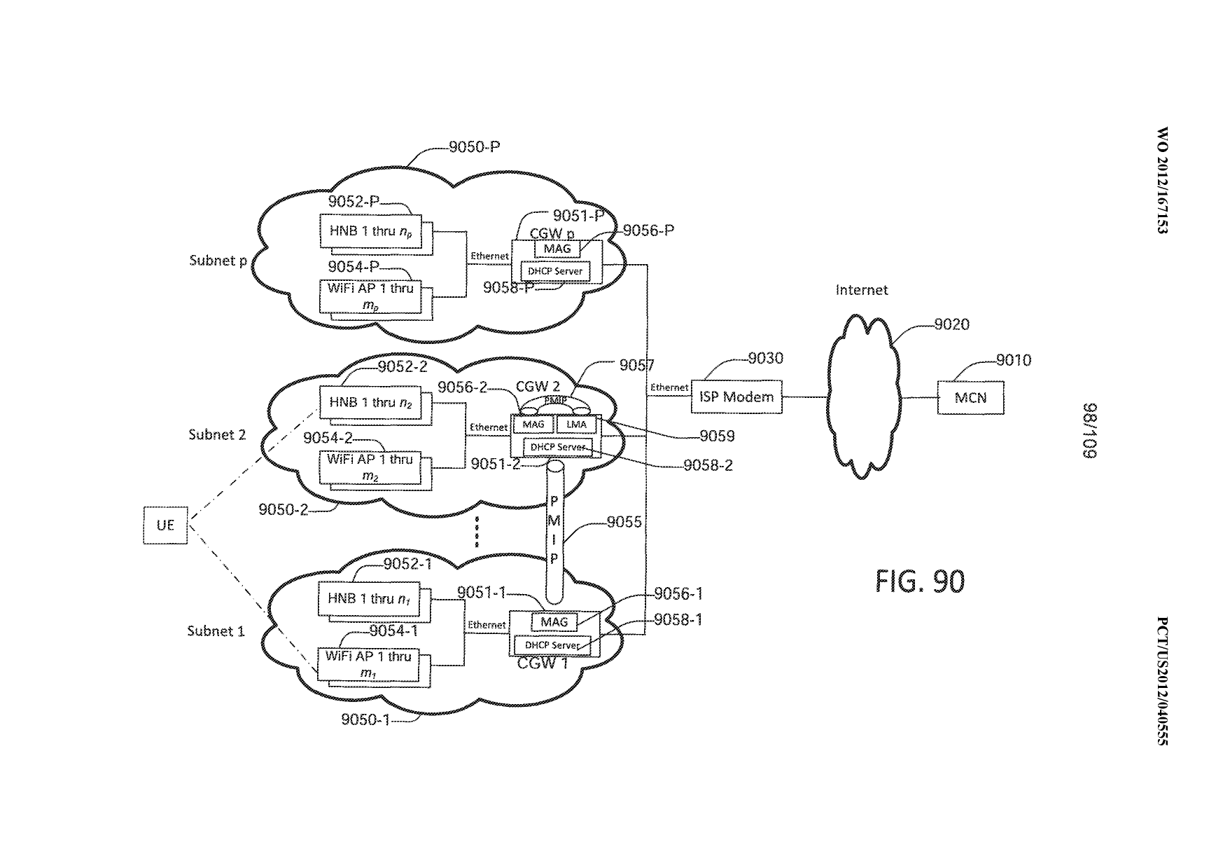

FIG. 90 depicts a communication network that may use CGWs that may use PMIP to provide inter-CGW communication. As shown in FIG. 90, CGW 9051-1, 9051-2 and 9051-P may include a MAG 9056-1, 9056-2 and 9056-P and one of the CWGs (e.g., CGW 9051-2) may include a LMA 9059. In this network topology, the CGWs may use tunneling for UE discovery and CGW aggregation and segregation operations for split message, offloading and/or load balancing (e.g., flow) processing/regulation.

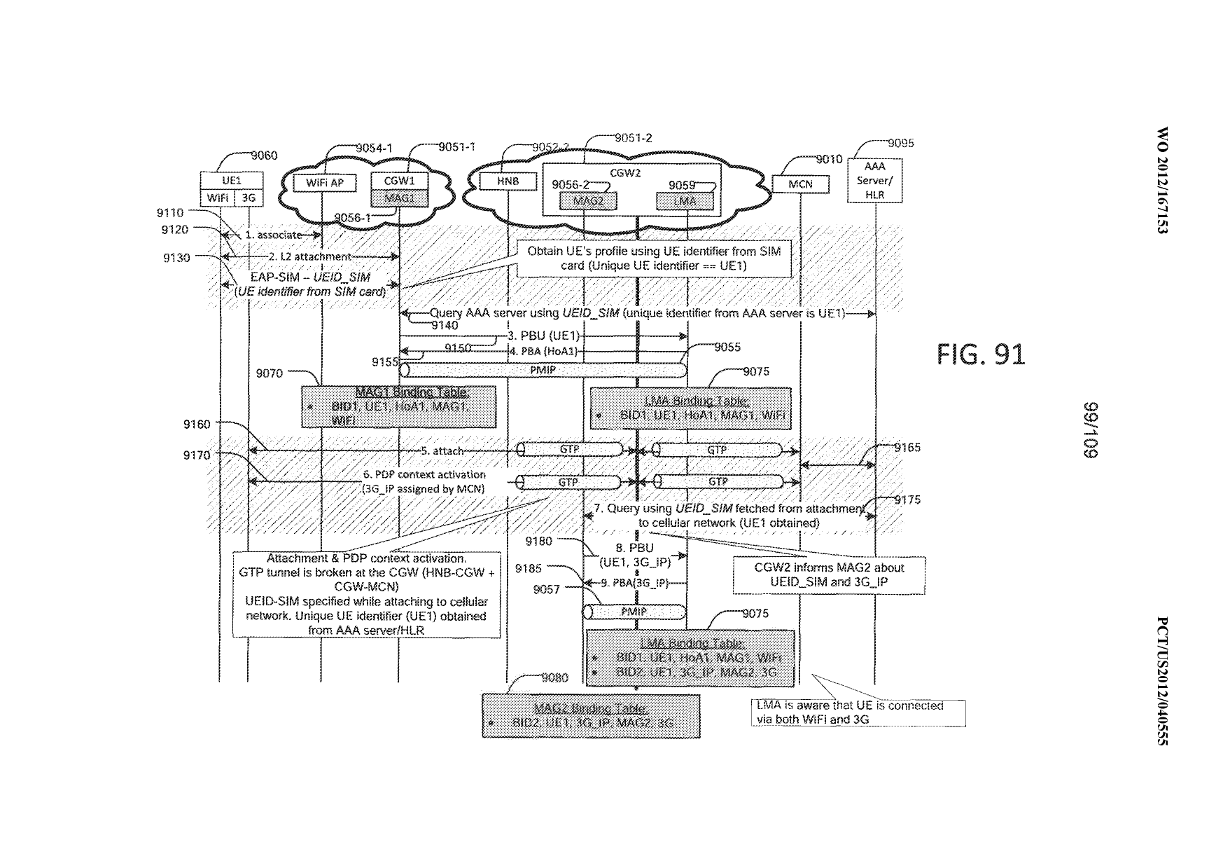

FIG. 91 depicts another method for UE discovering using a communication network, such as the network depicts in FIG. 90. For example, FIG. 91 may depict a diagram illustrating UE discovery by the LMA 9059.

Referring to FIGS. 90 and 91, the representative network 9000 may include the MCN 9010, the Internet 9020, the ISP modem 9030, a plurality of CGWs 9051-1, 9051-2 . . . 9051-p, a plurality of corresponding subnets 9050-1, 9050-2 . . . 9050-p and the UE 9060. Each CWG 9051-1, 9051-2 . . . 9051-p may communicate to the MCN 9010 via the ISP modem 9030 and the Internet 9020 using, for example IP.

CGW 9051-1, 9051-2 . . . 9051-p may include a DHCP server 9058-1, 9058-2, . . . 9058-p. A DHCP server may provide IP addresses for its corresponding subnet 9050-1, 9050-2 . . . 9050-p, respectively, using DHCP.

A CGW, for example CGW 9051-1, may include a NIC (not shown) that may interface with the corresponding subnet, for example 9050-1, using a wired connection, such as Ethernet, or wireless technology, such as WiFi. The subnet 9050-1 may include cellular access points, for example HNB1 thru HNBn1, (e.g., HNB1 indicated by 9052-1) and other wireless access points WiFi1 thru WiFim1 (e.g., WiFi1 indicated by 9054-1). The subnet 9050-2 may include cellular access points, for example HNB1 thru HNBn2, (e.g., HNB1 indicated by 9052-2) and other wireless access points WiFi1 thru WiFim2. (e.g., WiFi1 indicated by 9054-2) The subnet 9050-p may include cellular access points, for example HNB1 thru HNBnp, (e.g., HNB1 indicated by 9052-p) and other wireless access points WiFi1 thru WiFimp (e.g., WiFi1 indicated by 9054-p).

The number of HNB and WiFi access points for a subnet (e.g., any subnet) may be any number including zero. Other wired access points may be included in subnets 9050-1, 9050-2 . . . 9050-p.

Two or more of the subnets 9050-1 and 9050-2 may be established near, adjacent to and/or overlapping each other. For example, a first subnet, such as subnet 9050-1, may have a coverage area on one floor of a building and a second subnet, such as subnet 9050-2, may have a coverage area on a second floor of the building. In such a situation, the RATs associated with different subnets 9050-1 and 9050-2 may overlap such that a first RAT (e.g., the WiFi 9054-1 of the subnet 9050-1) and the second RAT (e.g., the HNB 9052-2 of the subnet 9050-2) may each carry a portion of a data stream of the UE 9060. For example, to increase throughput to the UE 9060, the HNB 9052-2 of the subnet 9050-2 and the WiFi 9054-1 of the subnet 9050-1 may carry a split data stream associated with the UE 9060 by splitting the packets (e.g., packet flows) between the two different RATs. Because the packet flows may be split between different subnets 9050-1 and 9050-2, the CGWs 9051-1, 9051-2 . . . 9051-p may coordinate certain operations (e.g., including UE discovery, and flow regulation) for the subnets 9050-1, 9050-2 . . . 9050-p.

Although FIG. 90 may show the LMA included in CGW 9051-2, the LMA may be a separate entity, apparatus, or part of any other network apparatus.

Incoming data (e.g., all incoming data and/or data flows) from the MCN 9010 to the UE 9060 may be directed to the LMA 9059. The LMA 9059 may redirect the data and/or the data flows to MAGs 9056-1 and/or 9056-p or may send the data locally to the MAG 9056-2 and into subnet 9050-2 based on rules (e.g., internal or received rules). For example, an IFOM rule may establish that certain data flows (e.g., based on flow type, application type, and/or QoS, among others) may be sent on a specific subnet while other flows may be sent on other subnets). The data or data flow redirected to a CGW-MAG 9056-1 for the WiFi AP 9054-1 and MAG 9056-2 for the HNB 9052-2 may be sent over respective PMIP tunnels 9055 and 9057 (and may be encapsulated for tunneling). For example, the MAG 9056-1 may de-encapsulate the data or data flow and the WiFi 9054-1 may forward the de-encapsulated data to the UE 9060 and/or the MAG 9056-2 may de-encapsulate the data or data flow, and the HNB 9052-2 may forward the de-encapsulated data to the UE 9060.

Outgoing data sent from the UE 9060 may pass through the serving CGW-MAG (e.g., the MAG 9056-1 for the WiFi data or data flow and the MAG 9056-2 for the HNB data or data flow). The respective MAG 9056-1 and/or 9056-2 may send the data or data flow through the respective PMIP tunnel 9055 and/or 9057 to the CGW-LMA 9059 (as encapsulated data). The LMA 9059 may de-encapsulate the data or data flow and may send it to the Internet. The UE 9060 may be connected to the subnet served by the LMA 9059 and the data or data flow from the UE 9060 may be received by the CGW-MAG-LMA and may be sent to the Internet. This may occur, for example, without tunneling involved since the MAG-LMA functionalities may be implemented into the same physical node.

A CGW configured with the MAG functionality may implement PMIP protocol and may send proxy binding updates (PBU) to the LMA 9059 on behalf of the UE 9060. MAGs 9056-1, 9056-2 . . . 9056-p may maintain a binding table (e.g., MAG1 9070 and MAG2 9080) with, for example, UE_ID, IF_ID, HoA, LMA-MAG addresses, or the like, for tunneling. The sending of the PBU may be triggered when the UE accesses the network, the UE may successfully authenticated over WiFi, or when a PDP context may successfully be activated over the 3G interface. The CGW 9051-2 configured with the LMA functionality may keep track of UEs' registrations (e.g., all UE registrations) in a local binding table 9075 (e.g., the UE_ID, the HoA and/or the LMA-MAG addresses for tunneling). The DHCP functionality within the LMA 9059 may be used to allocate the HoA to the UE 9060, for example, when connecting via WiFi.

Different IP addresses may be assigned to different interfaces, e.g. WiFi and 3G interfaces). The UE 9060, by using a logical interface (LIF), may connect transparently to the CGW-LMA 9059 using different interfaces. The internal communications between the MAG 9056-2 and LMA 9059 (e.g., only these communications) may be modified to be more efficient (e.g. function calls may be used instead of messaging and PMIP encapsulation may be avoided).

The UE 9060 may connect twice to a single MAG (e.g., MAG 9056-2) using different interfaces (e.g., HNB 9052-2 and WiFi 9054-2) and may be enabled by an enhanced PMIP protocol that may allow multiple bindings for the same UE or binding updates to be maintained at the MAG 9056-2.

Referring to FIG. 91, at operation 9110 the WiFi of UE 9060 may associate with the WiFi AP 9054-1 of subnet 9050-1. At 9120, a layer 2 attachment may be established between the WiFi of UE 9060 and the mobility access gateway 9056-1 and/or the converged gateway 9051-1. At 9130, the UE 9060 may initiate authentication (e.g., automatically without user intervention) using the identifier of the SIM card of the UE 9060. For example, the UE 9060 may send this identifier (e.g., unique identifier) to the CGW 9051-1. At 9140, responsive to receiving the UE identifier (UEID) or EAP-SIM ID, the CGW 9051-1 may send a query including the UEID to an AAA server 9095 for authentication of the UEID. If the UEID may not be authenticated, further operations with the WiFi of UE 9060 may be stopped/blocked (e.g., temporarily, permanently, for a period of time and/or after user intervention, among others). Responsive to the UEID being authenticated, at 9140, the MAG 9056-1 of CGW 9051-1 may send to LMA 9059 a message or signal (e.g., a PBU) to bind UE1. At 9150, the LMA 9059 may send a response message (e.g., a PBA including the HoA of the LMA 9059) to the MAG 9056-1 to establish the PMIP tunnel 9055.

The UE discovery may be handled with the PMIP registration (and/or de-registration) procedure (e.g., the binding table 9075 may be maintained at the LMA 9059). The MAG 9056-1 may register the UE 9060 with the LMA 9059. The LMA 9059 may keep the binding table 9075 with UE's information (e.g., UE_ID, HoA, CoA, MAG ID, and/or RAT, among others). Multiple binding entries in the bind table 9075 may be associated to a single UE (e.g., UE 9060 may be simultaneously registered from different locations, with different RATs and/or different MAGs). By looking up entries in the binding table 9075, the LMA 9059 may know where (e.g., to which APs) the UE 9060 may be connected.

At 9160, GTP tunnels may be established between the CGW 9051-2 and MCN 9010 and between the CGW 9051-2 and HNB 9052-2. The 3G RAT of the UE 9060 may attach to the HNB 9052-2 using the GTP tunnels via the CGW 9051-2 and MCN 9010. The UEID may be used during the attachment to identify the UE to the MCN 9010. The MCN 9010 may verify the UEID with the AAA server or HLR 9095, as part of the attachment operation. Responsive to validation (authentication) of the UEID, at 9170, the PDP context activation may be initiated and the MCN 9010 may assign a 3G_IP address to the UE 9060. At 9175, the MAG 9056-2 may query the AAA server or HLR 9095 using the UEID (e.g., associated with the SIM card) fetched from the attachment operation to obtain UE 3G_IP address. At 9180 and 9185, the MAG 9056-2 and the LMA 9059 may exchange PBU and PBA messages to bind the UE in the LMA binding table 9075 and the MAG binding table 9080 for the 3G connection. A PIMP tunnel 9057 may be established between the MAG 9056-2 and the LMA 9059. The LMA binding table 9075 may include entries (e.g., BID1, UE1, HoA1, MAG1, WiFi and BID2, UE1, 3G_IP, MAG2, 3G. As such, the MAG 9056-1 may be bound to the UE 9060 via a WiFi connection and MAG 9056-2 may be simultaneously bound to the UE 9060 via a 3G connection. The MAG binding tables 9070 and 9080 may provide corresponding binding entries.

The PMIP may handle the tunneling between the LMA 9059 and the MAGs (e.g., MAG 9051-1). The data or data flows from the UE 9060 or the data or data flows to the UE 9060 may transition through the MAGs and LMA 9059. Having the LMA 9059 handling the anchor role may enable the support of IFOM features.

A further example of an LMA binding table is shown below in Table 4. In this example, the UE 9060 may be registered via 3G and WiFi interfaces.

TABLE 4

| | MN | | | |
|---|---|---|---|---|
| Binding ID | ID | Home Address | Routing Address | Interface |
| BID1 | MN1 | HoA1 | CoA_x | 3GPP |
| BID2 | MN1 | HoA2 | CoA_y | WiFi |

The rules configured on the LMA 9059 for IFOM support may be integrated within a flow table 9085. An example of a flow table is given in LMA flow Table 5.

TABLE 5

| Flow ID | Traffic Selectors | Action (Rule) | Binding ID |
|---|---|---|---|
| FID1 | e.g., 5-tuple | Forward to specified BID | BID2 |

The LMA flow table may include rules, for example, for flow routing between or among RATs. Flow mobility may be based on time, traffic congestion, QoS, available bandwidth, application type, or the like. Using the tables above, the LMA 9059 may send the downlink traffic corresponding to the specified 5-tuple to the CoA_y, which may be identified by the BID2.

The UE (e.g., UE 9060) may use DHCP to obtain an IP address when connecting to the network over the WiFi interface. Over the cellular interface an IP address may be obtained dynamically during the PDP context activation procedure. If a static IP address has been assigned to the UE 9060, it may be specified during network DHCP or PDP context activation procedures.

FIG. 91 may illustrate how UE detection may be handled for the network using PMIP. The PMIP registration and the binding table 9075 by the LMA may be used to detect from where the UE is connected (e.g., currently connected).

The UE may power-on the WiFi interface and may associate with a WiFi AP;

The UE may be authenticated when accessing the network (for example, the EAP-SIM may be used between the UE and the CGW1);

The AAA server may be queried to authenticate the UE and obtain its profile. For example, UE_ID may be set to UE1 and may be obtained from the UE's profile. The MAG functionality in the CGW1 may notice that the UE may be connected to the subnet and may register the UE with the LMA by sending a PBU. For example, a unique UE identifier UE1 may be specified. The LMA may keep the UE information in its binding table such that the LMA may allocate an IP address, using the DHCP server functionality in the CGW2 and may return this IP address to the MAG by sending a PBA. The 3G interface may be turn-on and the UE may attach to the cellular network. An APDP context may be activated with the MCN. A 3G IP address such as a MCN_A 3G IP address may also be obtained when the PDP context may be successfully activated. This may trigger the PMIP registration with the LMA. For example, the UE's profile may be first obtained to get the unique UE identifier. A PBU may be sent by the MAG functionality and the LMA may return the 3G IP address on the PBA and may keep the information in its binding table. The MAG may save (or store) that information in its own binding or mapping table. The LMA may know, for example, by looking at its mapping or binding table that the UE may be connected via WiFi and 3G interfaces.

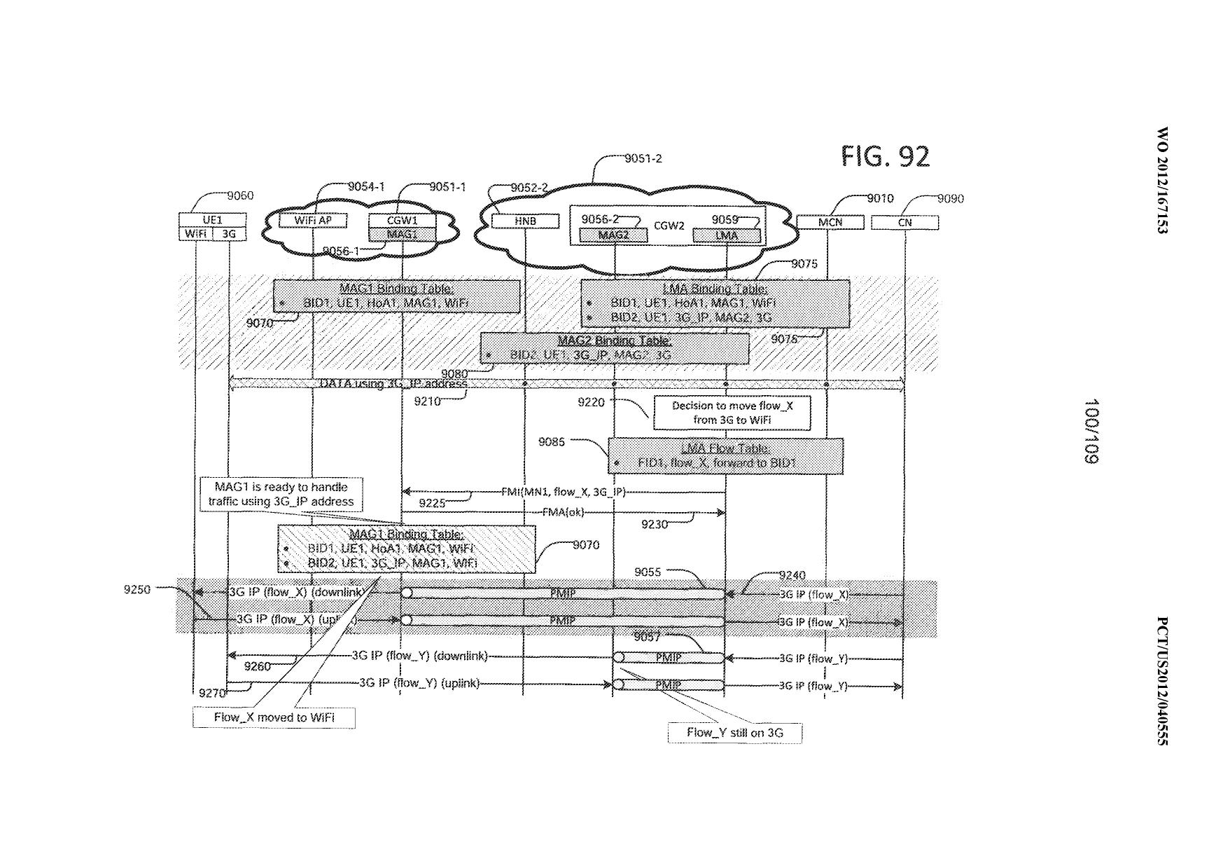

FIG. 92 depicts another method for UE discovering using a communication network, such as the network depicts in FIG. 90.

Referring to FIG. 92, a flow adjustment operation may start with the initial conditions that may be within the binding table 9070 of MAG 9056-1 and may include an entry of BID1, UE1, HoA1, MAG1, WiFi. The binding table 9080 of MAG 9056-2 may include the entry of BID2, UE1, 3G_IP, MAG2, 3G such that the MAG 9056-1 may connect (bind) to the UE 9060 for WiFi access and the MAG 9056-2 may connect (bind) to the UE 9060 for cellular 3G access. The LMA 9059 may include corresponding entries in its binding table 9075.

At 9210, the connection of the UE 9060 via the HNB 9052-2 may enable data or data flows to be bidirectional provided between the UE 9060 and a correspondent node (CN) 9090. At 9220, a portion of data (e.g., one or more flows) or the entire data routed between the UE 9060 and the correspondent node 9090 via the HNB 9052-2 may be directed (e.g., redirected, moved and/or offloaded) to another RAT (e.g., the WiFi connection). For example, at 9220, based on an internal or an external trigger, the LMA 9059 may determine to move a data flow or the entire data routed via the HNB 9052-2 to another RAT interface (e.g., the WiFi AP 9054-1). The LMA 9059 may include an entry in its flow table 9085 of FID1, flow_X, forward to BID1. At 9225, the LMA 9059 may send a flow mobility initiate (FMI) message from the LMA 9059 to the MAG 9056-1 to create or adjust a flow mobility state in the MAG 9056-1. The FMI message may convey information used to manage the flow mobility (e.g., in a PMIPv6 Domain). In certain representative embodiments, the FMI message may create, refresh or cancel a flow to a MAG.

At 9230, the MAG 9056-1 may send an acknowledgement (e.g., a flow mobility acknowledge (FMA) message to the LMA 9059 indicating that it successfully received the FMI message. The LMA 9059 may also send another FMI message to the MAG 9056-2 to cancel the flow_X forwarded to the MAG 9056-1. The binding table 9070 of the MAG 9056-1 may be updated to include an entry for the forwarded flow_X. At 9240, the PMIP tunnel 9055 may be established and the data flow (e.g., flow_X) may be sent to the UE 9060 via the WiFi AP 9054-1 in the downlink direction using the PMIP tunnel 9055 and, at operation 9250, the data flow (e.g., flow_X) may be sent from the UE 9060 via the WiFi AP 9054-1 in the uplink direction using the PMIP tunnel 9055.

At 9260 and 9270, the PMIP tunnel 9057 may be established and another data flow (e.g., flow_Y) associated with (bound to the 3G connection) may be sent to the UE 9060 via the HNB 9052-2 in the downlink direction (e.g., 9260) and, from the UE 9060 via the HNB 9052-2 in the uplink direction (e.g., 9270).

The data flows to the UE 9060 may be segregated by the LMA 9059 during operations 9240 and 8900 and the data flows from the UE 9060 may be aggregated by the LMA 9059 during the 9250 and 9270. The operations shown at steps 9240 and 9250 may illustrate the Flow_X mobility from HNB 9052-2 to WiFi AP 9054-1, initiated by the LMA. Segregation may be supported at the UE and the LMA as well and initiated by either the UE or LMA. Similarly, aggregation may be supported by the UE and LMA and may be initiated by either the UE or LMA.

Segregation may also be supported on the UE. For example, the UE, based on the application type and policies, may decide on which interface to send the data. This may include associating an IP address to an application opening a socket.

Aggregation may be done by the UE and/or the LMA (using e.g. MNTP client/server/L4 protocols like MPTCP, L3 aggregation, etc)

One or more data flows associated with a data stream may be moved to new interfaces and/or RATs using this mechanism.

The UE may be registered with the LMA via WiFi and 3G and data or data flows may be exchanged between the UE and a CN over 3G (e.g., using CGW2-LMA-MAG2). A decision may be made to move the “flow_X” from the 3G interface to the WiFi interface. The LMA may be the anchor point to move the flow_X to the WiFi interface. An entry may be created in the LMA flow table. This entry may be the rule to move the flow_X to the WiFi Interface. The LMA may inform the MAG in the WiFi subnet where the UE is connected (e.g., MAG1) (e.g., that traffic using the 3G_IP address is associated to UE1). The MAG1 may update its binding table, accordingly. The traffic associated to the “flow_X” may be redirected to the WiFi interface associated with MAG1 using the PMIP tunneling and traffic associated to “flow_Y” may remain on the 3G interface.

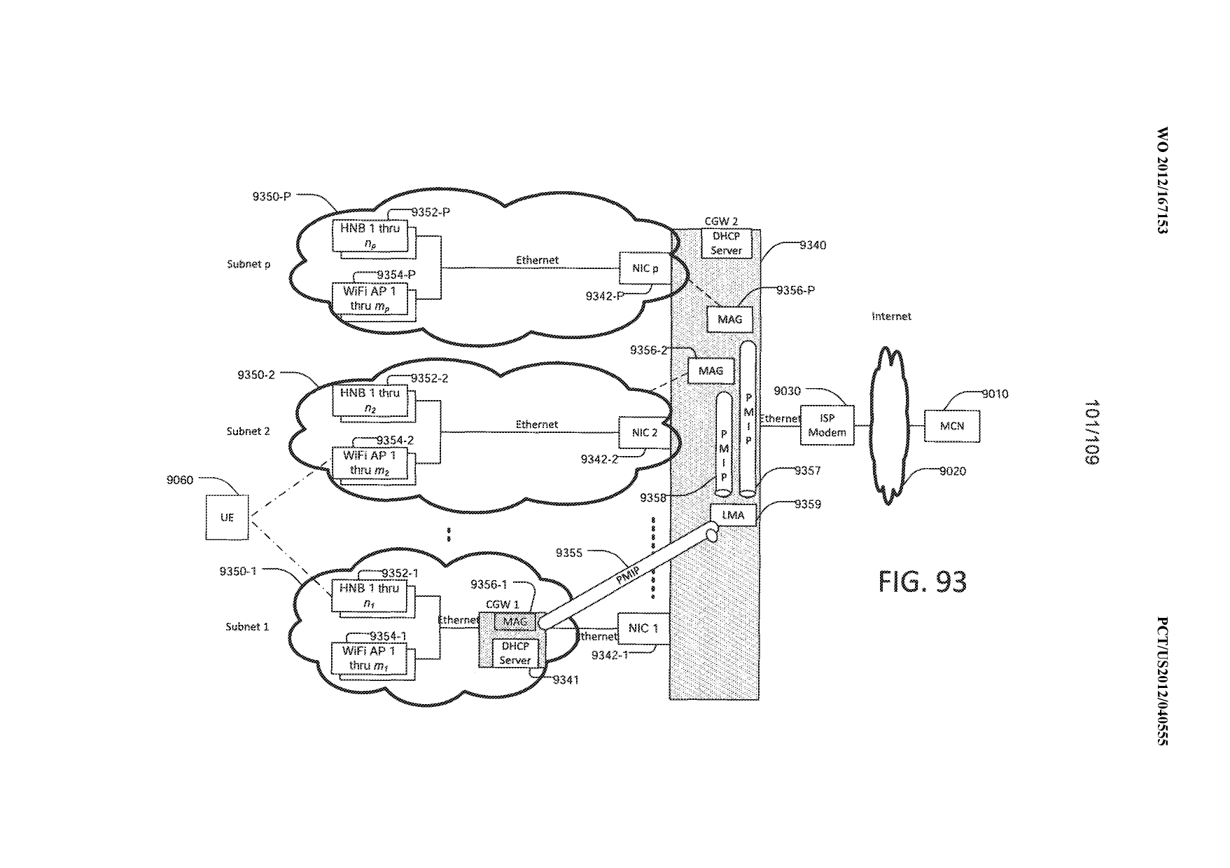

FIG. 93 depicts another communication network that may use CGWs that may use PMIP to provide inter-CGW communication. As shown in FIG. 93, CGWs may include other entities such as one or more MAGs 9356 and/or a LMA 9359 and may establish PIMP tunnels 9355, 9357 and 9358 for split messages or offloading.

Referring to FIG. 93, the network may include the MCN 9010, the Internet 9020, the ISP modem 9030, a plurality of CGWs 9340 and 9341, a plurality of subnets 9350-1, 9350-2 . . . 9350-p and a UE 9060. The CWG 9340 may communicate with the MCN 9010 via the ISP modem 9030 and the Internet 9020. The CGW 9341 may communicate with the MCN 9010 via the CGW 9340, the ISP modem 9030 and the Internet 9020.

Each CGW 9340 and 9341 may include a DHCP server. The DHCP server of the CGW 9340 may provide IP addresses for the corresponding subnets 9350-1, 9350-2 . . . 9350-p and the DHCP server of the CGW 9341 may provide IP addresses for the corresponding subnet 9350-2.

Each CGW may include NICs. For example, the CGW 9340 may include NICs 9342-1, 9342-2 and 9342-p that may interface with the corresponding subnets 9350-1, 9350-2 and 9350-p using a wired connection, such as Ethernet, or a wireless connection, such as WiFi. Subnet 9350-1 may include cellular access points, for example HNB1 thru HNBn1, (e.g., HNB1 indicated by 9352-1) and other wireless access points WiFi1 thru WiFim1 (e.g., WiFi1 indicated by 9354-1). Subnet 9350-2 may include cellular access points, for example HNB1 thru HNBn2, (e.g., HNB1 indicated by 9352-2) and other wireless access points, such as WiFi1 thru WiFim2 (e.g., WiFi1 indicated by 9354-2). Subnet p 9350-p may include cellular access points, for example HNB1 thru HNBnp, (e.g., HNB1 indicated by 9352-p) and other wireless access points, such as WiFi1 thru WiFimp (e.g., WiFi1 indicated by 9354-p).

The CGW 9341 may interface with the CGW 9340 via the NIC 9342-1 and an Ethernet connection in a hierarchical arrangement in which the CGW 9341 may function as a flow regulation (e.g., convergence/segregation) point within the subnet 9350-1 and the CGW 9340 may function as a flow regulation (e.g., convergence/segregation) point within the subnets 9350-1, 9350-2 . . . 9350-p.

The number of HNB and WiFi access points for a subnet (e.g., any subnet) may be any number including zero. Other wired access points may be included in subnets 9350-1, 9350-2 . . . 9350-p.

Two or more of the subnets 9350-1 and 9350-2 may be established near, adjacent and/or overlapping each other. In such a situation, the RATs associated with subnets 9350-1 and 9350-2 may overlap such that a first RAT (e.g., the HNB 9352-1 of the subnet 9350-1) and the second RAT (e.g., the WiFi 9354-2 of subnet 9350-2) may carry a portion of the message stream of the UE 9060. Because the packet flows may be split between different subnets 9350-1 and 9350-2, CGWs 9340 and 9341 may coordinate certain operations (e.g., including UE discovery and/or flow regulation) for the subnets 9350-1, 9350-2 . . . 9350-p.

FIG. 93 shows a UE 9060 that may connect to a WiFi AP of subnet 9350-2 and a HNB of subnet 9350-1. The UE 9060 may connect over multiple subnets that may have with their own CGWs that may coordinate UE Discovery, communications requests/results between or among CGWs, tunneling between CGWs, or the like.

For the hierarchical configuration shown, for example in FIG. 93, a CGW may be a different physical device. At least one CGW may provide flow regulation operations for each subnet.

Discovery methods may be used to support multiple subnets (e.g., to discover UE's that may be connected via multiple subnets). Multiple IP address domains may be used. The DHCP server functionality in the outer CGW (e.g., the external CGW) may be enabled to support subnets that may not have a CGW and subnets that may have a CGW with the DHCP server disabled. For those CGWs within specific subnets, the DHCP server may be enabled or disabled. Subnet 9350-1, 9350-2 . . . 9350-P may have a DHCP server configured, which may reside on any CGW.

IP addresses may be assigned to the interfaces connecting to different subnets. The PMIP protocol may be modified to support different IP addresses associated to the same UE. The same IP address may be assigned to the interfaces such that the DHCP forward functionality may be enabled on the WiFi AP.

Within the context of IPv6 and IP address auto-configuration, the DHCP functionality may or may not be used (e.g., when connecting via a WiFi AP). Router Solicitations/Advertisements may be used for prefix allocation. The prefixes advertised by the CGW-MAG may be allocated from the MCN and may be relayed by the CGW-LMA to the CGW-MAG. Multiple prefixes may be advertised, e.g., one from the MCN and one from the CGW-LMA (e.g., the local prefix). Using a local IP address may enable bypassing the MCN, as appropriate.

In certain representative embodiments, a MAG and a LMA may be located within a CGW. CGWs may be preconfigured with MAG functionality. The LMA role may be pre-determined and/or pre-configured on one of the CGW.

The LMA functionality/entity may be separate and/or standalone and/or may be combined with MAG functionality. The LMA functionality/entity may serve the UEs (e.g., all UEs) served by the same subnet or network (e.g., one anchor point for one subnet or all of the subnets).

The MAG and LMA functionality/entity may be shown to be internal to a device or apparatus (e.g., a CGW) and a PMIP tunnel may be between these entities. Such a tunnel may not be used, for example, when the MAG-LMA interaction may be internally handled in a CGW device. PMIP BU (or other registration operation) may be done so that the LMA may know where a specific UE is connected. This may be done, for example, for UE discovery handling.

The LMA role may be configured within the external CGW (e.g., the CGW operationally closest to the MCN) or the MAG/LMA functionality may be configured within the external CGW such that the CGW may serve one or more specific subnets.

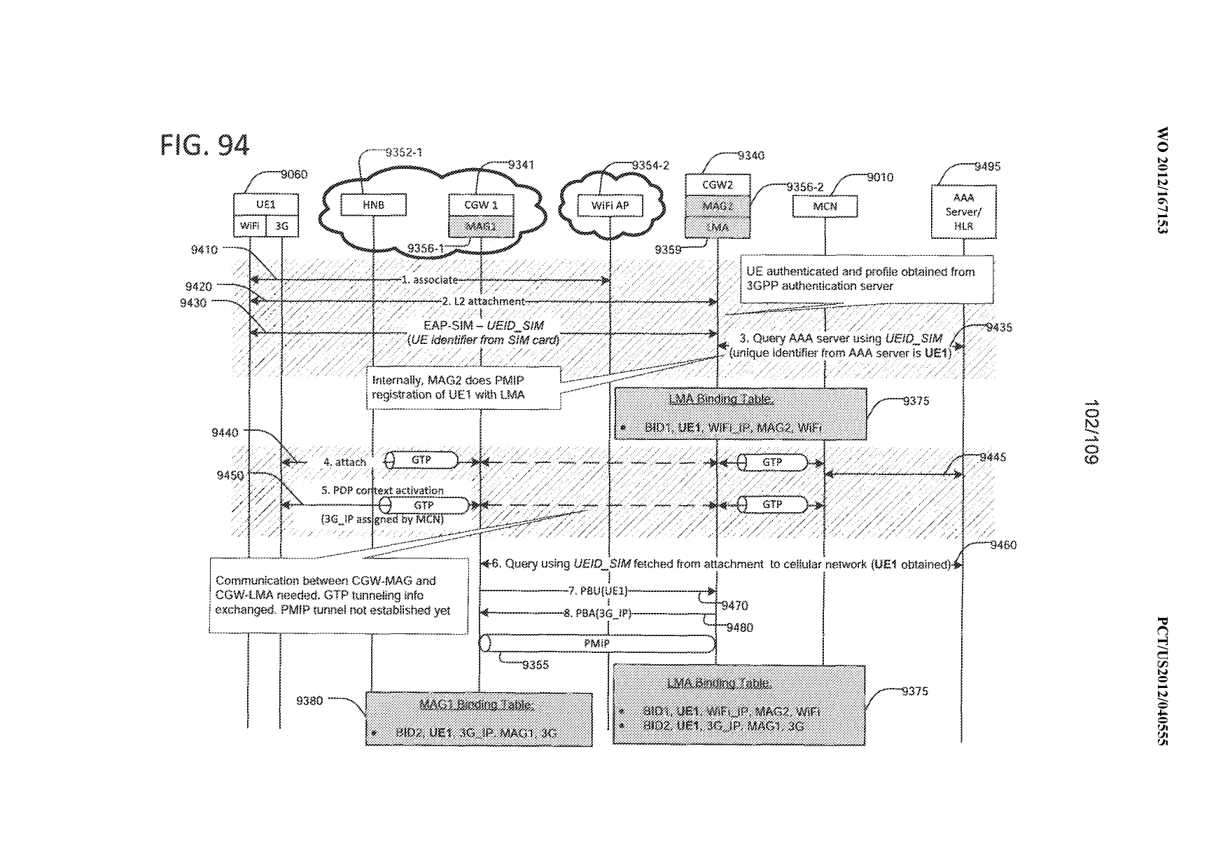

FIG. 94 depicts another method for UE discovery using a communication network that may use PMIP to provide inter-CGW communication. For example, FIG. 94 may illustrate UE discovery by an LMA 9359 in a network, such as the network shown in FIG. 93.

Referring to FIG. 94, at 9410 the WiFi of UE 9060 may associate with the WiFi AP 9354-2 of subnet 9350-2. At 9420, a layer 2 attachment may be established between the WiFi of UE 9060 and the MAG 9356-2 and/or the converged gateway 9340. At 9430, the UE 9060 may initiate authentication using the identifier of the SIM card of the UE 9060. At 9435, responsive to receiving the UEID, the CGW 9340 may send a query including the UEID to the AAA server 9495 for authentication of the UEID and retrieval (and/or storage) of the UE's unique identifier (UE1 in this example). When the UEID may not be authenticated, further operations with the WiFi of UE 9060 may be stopped or blocked. If successfully authenticated, MAG 9356-2 and LMA 9359 may internally exchange PBU and PBA messages (e.g., using the UE's unique identifier UE1) to bind the UE in the LMA table and the MAG binding table for the WiFi connection (e.g., internally done by the CGW 9340 and not shown on the FIG. 94). A PIMP tunnel may be established between the MAG 9356-2 and the LMA 9359. The LMA binding table 9375 may include entries (e.g., BID1, UE1, WiFi IP, MAG2, WiFi).

Responsive to the UEID being authenticated, at 9440, GTP tunnels may be established between the CGW 9340 and the MCN 9010 and between the CGW 9341 and the HNB 9352-1. The 3G RAT of the UE 9060 may attach to the HNB 9352-1 using the GTP tunnels via the CGW 9340 and MCN 9010. The UEID may be used during the attachment to identify the UE 9060 to the MCN 9010. At 9445, the MCN 9010 may verify the UEID with the AAA server or HLR 9495 for completion of the attachment. Responsive to validation (authentication) of the UEID, at 9450, the PDP context activation may be initiated and the MCN 9010 may assign a 3G_IP address to the UE 9060. At operation 9460, the MAG 9356-1 may query the AAA server or HLR 9495 using the UEID (e.g., associated with the SIM card) fetched from the attachment to obtain the UE1 unique identifier (e.g. UE1). At 9470 and 9480, the MAG 9356-1 and LMA 9359 may exchange PBU and PBA messages (using UE1 unique identifier) to bind the UE in the LMA binding table 9375 and the MAG binding table 9380 for the 3G connection. A PIMP tunnel 9355 may be established between the MAG 9356-1 and the LMA 9359. The LMA binding table 9375 may include entries, such as BID1, UE1, WiFi IP, MAG2, WiFi and BID2, UE1, 3G_IP, MAG1, 3G, or the like. The MAG 9356-1 may be bound to the UE 9060 via a 3G connection and the MAG 9356-2 may be bound to the UE 9060 via a WiFi connection. The MAG binding tables 9370 and 9380 may provide corresponding binding entries.

Incoming data may be directed to the CGW-LMA 9359 upon reception (e.g., destined or sent from the UE 9060). The LMA 9359 may redirect the data or a portion of the data (e.g., one or more data flows) to the CGW-MAGs 9356-1, 9356-2 and/or 9356-P located in the subnet or to the combined MAG functionality. The LMA 9359 may redirect the data or a portion of the data depending where the UE may be connected and depending on what internal rules may be applicable. The applicable rules may be, for example, an IFOM rule that may provide for some flows to be sent on a specific subnet while other flows may be sent on other subnets.

Data redirected to a CGW-MAG 9356-1, 9356-2 and/or 9356-P may be sent using a PMIP tunnel (e.g., encapsulated). The MAG may de-encapsulate the data and may forward it to the UE 9060. Outgoing data sent from the UE while connected to a CGW-MAG may be sent through the PMIP tunnel to the CGW-LMA (e.g., encapsulated) and the LMA 9359 may de-encapsulate the data and may send it to the Internet.

A CGW configured with the MAG functionality may implement PMIP protocol and may send PBU to the LMA 9359 on behalf of the UE 9060. The sending of the PBU may be triggered when the UE attaches to the network, when the UE accesses the network, when the UE 9060 may successfully authenticated using WiFi, when a PDP context is successfully activated using 3G, or the like.

The CGW configured with the LMA functionality may keep track of the registrations of UEs in a local binding table (HoA-CoA, and UE_ID association, among others). The DHCP functionality within the LMA may be used to allocate a HoA to the UE when connecting via WiFi.

UE discovery may be handled using PMIP registration. The MAG may identify the UE. The UE may register with the LMA, which may track the UE's registration. DHCP may be used over WiFi to obtain dynamically an IP address. Other procedures during Layer 2 attachment may be used to obtain an IP address dynamically or to specify an already allocated static IP address (e.g. using IPCP negotiation).

The PMIP protocol may be based on the MAGs being able to identify the UE when connecting via an interface. This identification operation may be implemented during network access and/or during an authentication phase. When the UE attaches to an access link connected to a MAG, the MAG may query an authentication server (AAA server) and may obtain the UE's profile. In the profile, the unique UE identifier (e.g., UE_ID) and the LMA address may be configured. As an example, for non-3GPP access (e.g., trusted or untrusted), Extensible Authentication Protocol-SIM (EAP-SIM) may be used between the UE and the MAG. This may enable the MAG to obtain the UE's profile from the 3GPP authentication server. The same mechanism, e.g., the EAP-SIM between the UE and the MAG and the UE's profile retrieval from the AAA server may be done (occur) when the UE accesses the network using the cellular interface.

The UE may power-on the WiFi interface and may associate with a WiFi AP. The UE may be authenticated when accessing the network. For example, the EAP-SIM may be used between the UE and the CGW2. The AAA server may be queried to authenticate the UE and obtain its profile. For example, the unique UE_ID may be set to UE1, may be obtained from the UE's profile and may trigger a PBU to be sent by the MAG2 to the LMA, which may be internal to the CGW2. The 3G interface may be turn-on (e.g., now turned on) and the UE may attach to the cellular network. The CGW1 may terminate the GTP tunnel and may communicate with the CGW2-LMA node and may forward attachment information and/or GTP specific information. The CGW2 may establish another GTP tunnel with the serving node in the MCN and the UE may be authenticated with the AAA server or HLR. The PMIP tunnel between the CGW-MAG and CGW-LMA may or may not be established yet. When established, it may be used to forward UE data between the CGWs. The CGW1 may notice (e.g., determine) that a PDP context may have been activated with the MCN. A 3G IP address may also be obtained when the PDP context may be successfully activated. This may trigger a query to the AAA server/HLR to obtain the UE's profile and/or its unique identifier. The MAG may then start PMIP registration by sending a PBU to the LMA specifying UE1 (e.g., a unique UE identifier). The LMA may return the 3G IP address in the PBA and may keep that information in its binding table. The MAG1 may save (e.g., store) the information in its own mapping or binding table. The LMA may know by looking at its mapping or binding table that the UE may be connected to the network via the 3G interface and the WiFi interface.

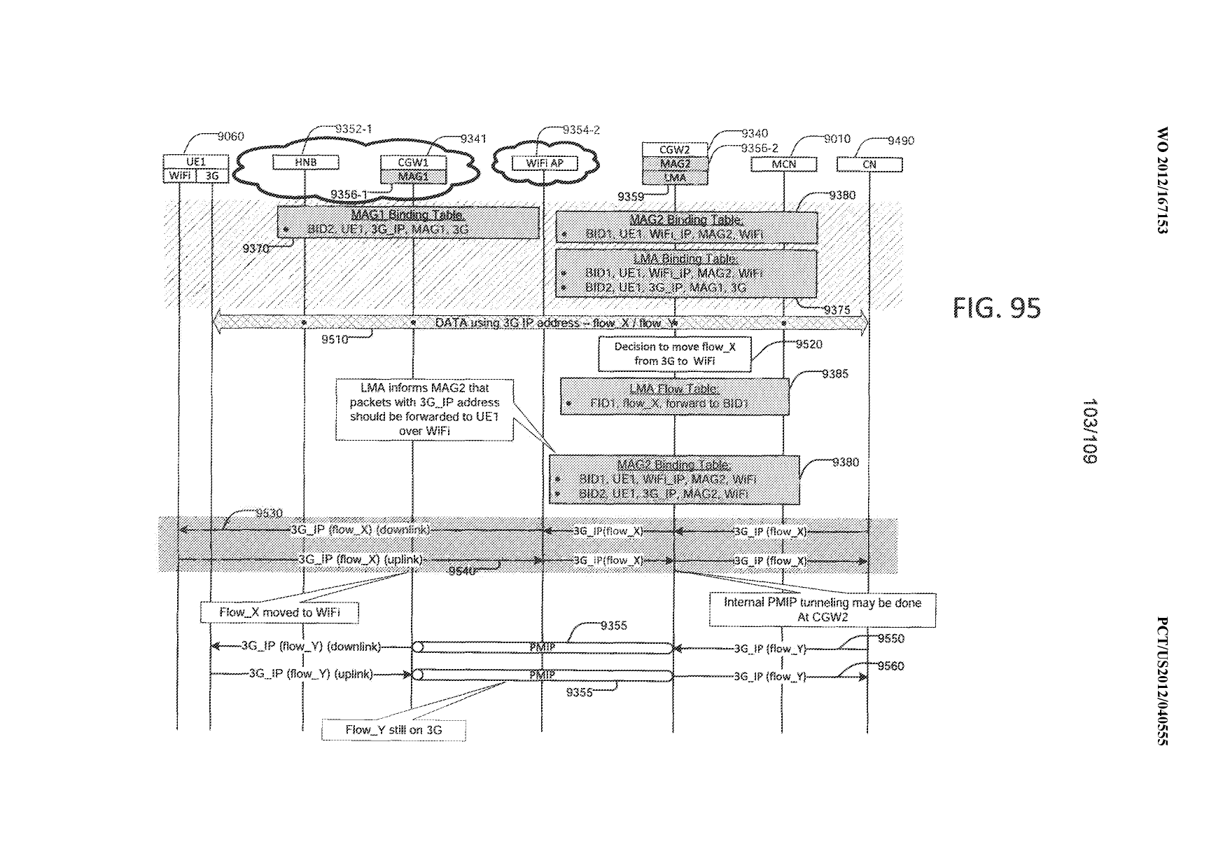

FIG. 95 depicts another method for UE discovery using a communication network that may use PMIP to provide inter-CGW communication. For example, FIG. 95 may depict UE discovery by an LMA 9359 in a network, such as the network shown with respect to FIG. 93.

Referring to FIG. 95, the flow adjustment may start with the initial conditions that the binding table 9370 of MAG 9356-1 may include an entry of BID2, UE1, 3G_IP, MAG1, 3G and the binding table 9380 of MAG 9356-2 may include the entry of BID1, UE1, WiFi IP, MAG2, WiFi such that the MAG 9356-1 may connect (bind) to the UE 9060 for cellular access and the MAG 9356-2 may connect (bind) to the UE 9060 for WiFi access. The LMA 9359 may include corresponding entries in its binding table 9375.

At 9510, the connection of the UE 9060 via the HNB 9352-1 may enable data or data flows to be bidirectional provided (e.g., uplink and/or downlink communications) between the UE 9060 and the CN 9490. At 9520, a portion of data (e.g., one or more flows) or the entire data routed between the UE 9060 and the CN 9490 may be directed (e.g., moved and/or offloaded) to another RAT (e.g., the WiFi interface/connection). For example, at 9520, based on an internal or an external trigger (e.g., an event or condition), the LMA 9359 may determine or decide to move a flow or the entire data sent via the HNB 9352-1 to another interface using the WiFi AP 9354-2. The LMA 9359 may include an entry in its flow table 9385 of FID1, flow_X, forward to BID1. The LMA 9359 and MAG 9356-2 may be internal to the CGW 9340. The LMA may communicate the flow adjustment of flow_X to the MAG 9356-2. This communication may be a flow mobility initiate (FMI) message from the LMA 9359 to the MAG 9356-2 or another communication mechanism to create or adjust a flow mobility state in the MAG 9356-2.

The binding table 9380 of the MAG 9356-2 may be updated to include an entry for the forwarded flow_X. At 9430, the data flow (e.g., flow_X) may be sent to the UE 9060 via the WiFi AP 9354-2 in the downlink direction and may use an established PMIP tunnel 9358. At 950, the data flow (e.g., flow_X) may be sent from the UE 9060 via the WiFi AP 9454-2 in the uplink direction.

The data flows to the UE 9060 may be segregated by the LMA 9359 during operations 9530 and 9540. The data flows from the UE 9060 may be aggregated by the LMA 9359 during the 9550 and 9560. The operations shown at 9530 and 9540 may illustrate the Flow_X mobility from HNB 9052-2 to WiFi AP 9054-1, initiated by the LMA. Segregation may be supported at the UE and the LMA as and may be initiated by either the UE or LMA. Similarly, aggregation may be supported by the UE and LMA and may be initiated by either the UE or LMA.

Segregation may also be supported on the UE. For example, the UE, based on the application type and policies, may decide on which interface to send the data. This may include associating an IP address to an application opening a socket. Aggregation may be done by the UE and/or the LMA (using e.g. MNTP client/server/L4 protocols like MPTCP, L3 aggregation, etc).

At 9550 and 9560, another data flow (e.g., flow_Y) associated with (bound to the 3G connection) may be sent to the UE 9060 via the HNB 9352-1 in the downlink direction (e.g., 9550) and from the UE 9060 via the HNB 9352-1 in the uplink direction (e.g., 9560).

One or more data flows associated with a data stream may be moved to new interfaces and/or RATs using this mechanism.

Although flow adjustment may be shown with data and/or data flows being moved to the WiFi interface, such data and/or data flows may be moved from the cellular interface to the WiFi interface or any other existing interface.

Although flow adjustment may be shown using a 3G interface and a WiFi interface, other interfaces or RATs may be possible and may be used with this flow mobility mechanism, for example, Bluetooth, Ethernet, Zigbee, and/or WLAN, among others and may be handled in the same or a similar way.

The UE may be registered with the LMA via WiFi and 3G and data may be exchanged (including flow_X and flow_Y) between the UE and a CN over the 3G interface (e.g., CGW1-HNB). A decision may be made (e.g., taken) to move the “flow_X” from the 3G interface to the WiFi interface. An entry may be created in the LMA's flow table. This entry may be the rule to move the flow_X to the WiFi. The LMA may inform the MAG in the WiFi subnet where the UE may be connected that traffic using the 3G_IP address may be associated to UE1. MAG2 may update its binding table, accordingly. The traffic associated to the “flow_X” may be received at the LMA and redirected to MAG2 (depending of the rules) using a PMIP tunnel. MAG2 may forward the data to the UE over the WiFi interface. The traffic associated to “flow_Y” may remain on the 3G interface. The PMIP tunnels may or may not be used to handle signaling internal to a CGW (e.g., the CGW2).

Because the LMA may register each UE as it joins (attaches or connects) to the communication network, delays associated with UE discovery may be reduced or eliminated.

Although communications may be shown between a MCN and UE, any traffic handling scenarios (e.g., public internet traffic, through the MCN or the MCN-based SIPTO and/or the MCN value added traffic) which may transit through the MCN may use the UE discovery and forwarding mechanisms of various representative embodiments.

Although a hierarchical CGW architecture is shown in FIG. 93, any number of CGWs in any hierarchical configuration may be possible, for example, as long as one LMA or one master LMA may be defined within the configuration. The LMA or master LMA may be associated with the CWG (e.g., the external CGW) that may be operatively located closest to the MCN.

The LMA/MAG mechanism may be used to redirect data flows to any interface on any subnet such that data flow may be forwarded to different interfaces as the UE moves between subnets with simultaneous connection to two or more RAN interfaces (e.g., WiFi, cellular, Bluetooth and/or WLAN, among others).

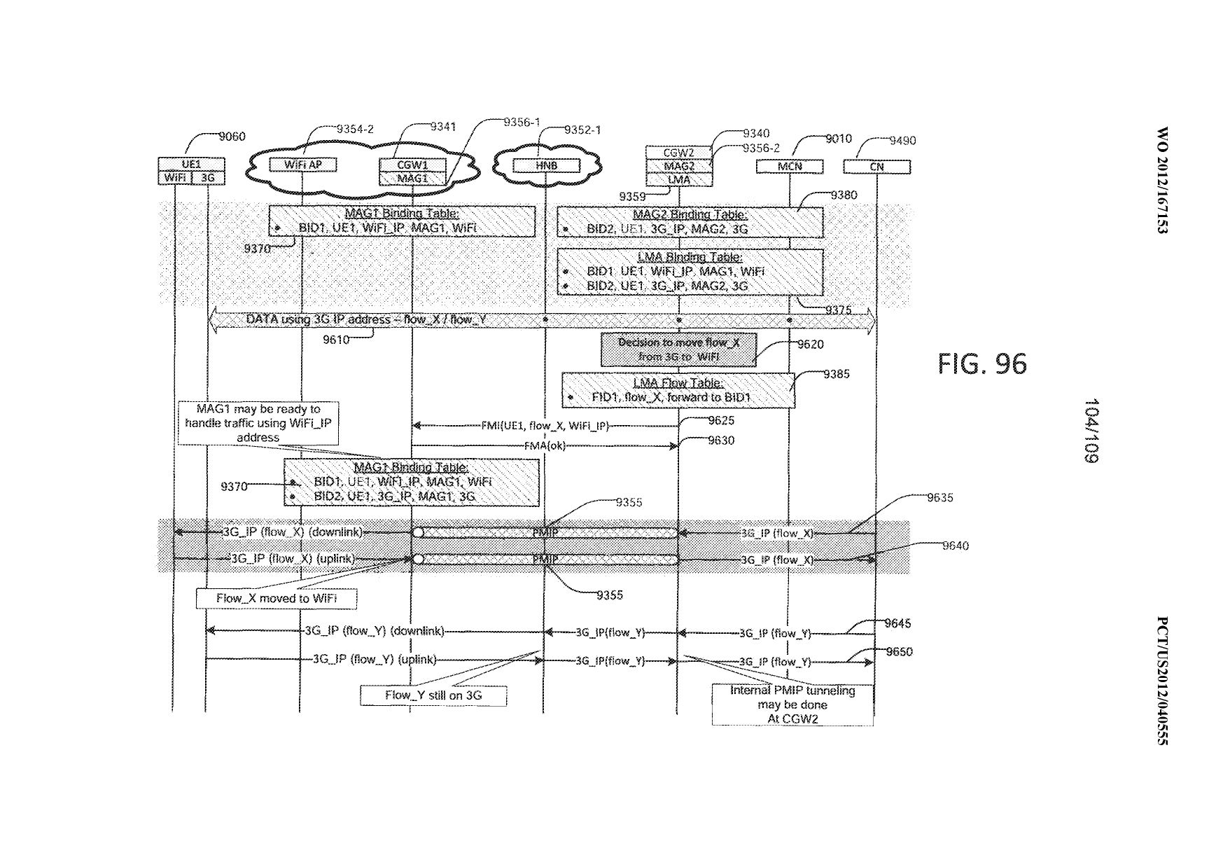

FIG. 96 depicts another method for flow mobility using a communication network that may use PMIP to provide inter-CGW communication. For example, FIG. 96 may depict flow mobility using LMA 9359 in a network, such as the network shown with respect to FIG. 93.

Referring to FIG. 96, the flow adjustment may start with the initial conditions that the binding table 9380 of MAG 9356-2 may include an entry of BID2, UE1, 3G_IP, MAG2, 3G and the binding table 9370 of MAG 9356-2 may include the entry of BID1, UE1, WiFi_IP, MAG1, WiFi such that the MAG 9356-2 may connect (bind) to the UE 9060 for cellular access and the MAG 9356-1 may connect (bind) to the UE 9060 for WiFi access. The LMA 9359 may include corresponding entries in its binding table 9375.

At 9610, the connection of the UE 9060 via the HNB 9352-1 may enable data or data flows to be bidirectional provided (e.g., uplink and/or downlink communications) between the UE 9060 and the CN 9490. At 9620, a portion of data (e.g., one or more flows) or the entire data routed between the UE 9060 and the CN 9490 may be directed (e.g., moved and/or offloaded) to another RAT (e.g., the WiFi interface/connection). For example, at 9620, based on an internal or an external trigger (e.g., an event or condition), the LMA 9359 may determine or decide to move a flow or the entire data sent via the HNB 9352-1 to another interface using the WiFi AP 9354-2. The LMA 9359 may include an entry in its flow table 9385 of FID1, flow_X, forward to BID1. The LMA 9359 and MAG 9356-2 may be internal to the CGW 9340. The LMA may communicate the flow adjustment of flow_X to the MAG 9356-1. This communication may be a flow mobility initiate (FMI) message from the LMA 9359 to the MAG 9356-1 or another communication mechanism to create or adjust a flow mobility state in the MAG 9356-1.

The binding table 9370 of the MAG 9356-2 may be updated to include an entry for the forwarded flow_X. At 9635, the data flow (e.g., flow_X) may be sent to the UE 9060 via the WiFi AP 9354-2 in the downlink direction and may use a PMIP tunnel, such as 9355. At 9640, the data flow (e.g., flow_X) may be sent from the UE 9060 via the WiFi AP 9354-2 in the uplink direction and may use a PMIP tunnel, such as 9355. The PMIP tunnel 9355 may be established as needed, established previously, or established at any point in time.

At 9645 and 9650, another data flow (e.g., flow_Y) associated with (bound to the 3G connection) may be sent to the UE 9060 via the HNB 9352-1 in the downlink direction (e.g., 9645) and from the UE 9060 via the HNB 9352-1 in the uplink direction (e.g., 9650).

The data flows to the UE 9060 may be segregated by the LMA 9359 during operations 9635 and 9640. The data flows from the UE 9060 may be aggregated by the LMA 9359 during 9645 and 9650. The operations shown at 9635 and 9640 may illustrate the Flow_X mobility from HNB 9052-2 to WiFi AP 9354-2, initiated by the LMA. Segregation may be supported at the UE and the LMA as and may be initiated by either the UE or LMA. Similarly, aggregation may be supported by the UE and LMA and may be initiated by either the UE or LMA.

One or more data flows associated with a data stream may be moved to new interfaces and/or RATs using this mechanism.

Although flow adjustment may be shown with data and/or data flows being moved to the WiFi interface, such data and/or data flows may be moved from the cellular interface to the WiFi interface or any other existing interface.

Although flow adjustment may be shown using a 3G interface and a WiFi interface, other interfaces or RATs may be possible and may be used with this flow mobility mechanism, for example, Bluetooth, Ethernet, Zigbee, and/or WLAN, among others and may be handled in the same or a similar way.

The UE may be registered with the LMA via WiFi and 3G and data may be exchanged (including flow_X and flow_Y) between the UE and a CN over the 3G interface (e.g., CGW1-HNB). A decision may be made (e.g., taken) to move the “flow_X” from the 3G interface to the WiFi interface. An entry may be created in the LMA's flow table. This entry may be the rule to move the flow_X to the WiFi. The LMA may inform the MAG in the WiFi subnet where the UE may be connected that traffic using the 3G_IP address may be associated to UE1. MAG1 may update its binding table, accordingly. The traffic associated to the “flow_X” may be received at the LMA and redirected to MAG1 (depending of the rules) using a PMIP tunnel. MAG1 may forward the data to the UE over the WiFi interface. The traffic associated to “flow_Y” may remain on the 3G interface. The PMIP tunnels may or may not be used to handle signaling internal to a CGW (e.g., the CGW2).

Because the LMA may register each UE as it joins (attaches or connects) to the communication network, delays associated with UE discovery may be reduced or eliminated.

Although communications may be shown between a MCN and UE, any traffic handling scenarios (e.g., public internet traffic, through the MCN or the MCN-based SIPTO and/or the MCN value added traffic) which may transit through the MCN may use the UE discovery and forwarding mechanisms of various representative embodiments.

Although a hierarchical CGW architecture is shown in FIG. 93, any number of CGWs in any hierarchical configuration may be possible, for example, as long as one LMA or one master LMA may be defined within the configuration. The LMA or master LMA may be associated with the CWG (e.g., the external CGW) that may be operatively located closest to the MCN.

The LMA/MAG mechanism may be used to redirect data flows to any interface on any subnet such that data flow may be forwarded to different interfaces as the UE moves between subnets with simultaneous connection to two or more RAN interfaces (e.g., WiFi, cellular, Bluetooth and/or WLAN, among others).

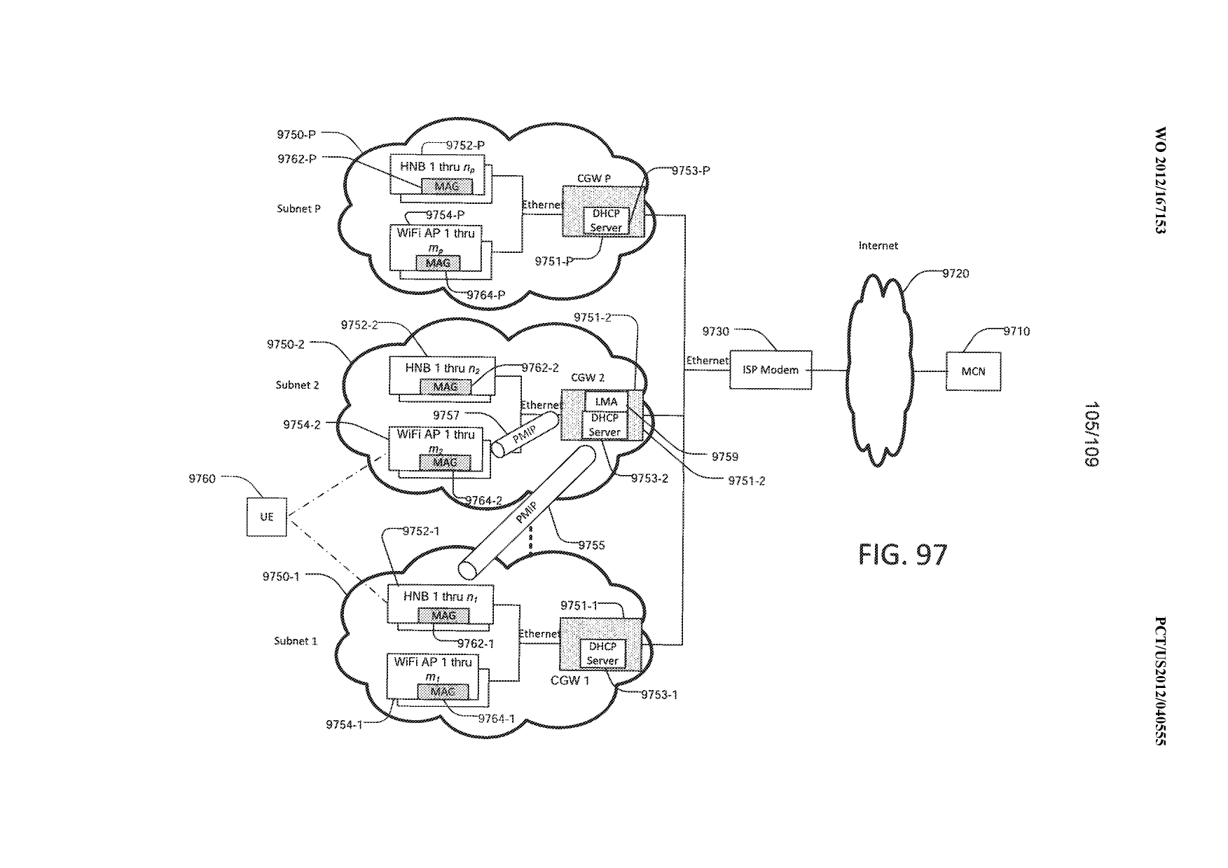

FIG. 97 depicts a communication network with access points (AP) that may include MAGs. As shown in FIG. 97, an access point, such as HNBs 9752-1 . . . 9752-P and WiFi AP 9754-1 . . . 9754-P, may include a MAG, such as MAG 9762-1 . . . 9762-P and 9764-1 . . . 9764-P. A CGW, such as CGW 9756-2, may include a LMA, such as LMA 9759. In this network topology, the CGWs may use tunneling for UE discovery and CGW flow mobility, aggregation, and segregation operations for data splitting, offloading and/or load balancing (e.g., data flow processing/regulation).

Referring to FIG. 97, the representative network 9700 may include the MCN 9710, the Public Internet 9720, the ISP modem 9730, a plurality of CGWs 9751-1, 9751-2 . . . 9′751-p, a plurality of corresponding subnets 9750-1, 9750-2 . . . 9′750-p and the UE 9760. Each CWG 9751-1, 9751-2 . . . 9751-p may communicate to the MCN 9710 via the ISP modem 9730 and the Internet 9720 using, for example IP.

A CGW, such as CGWs 9751-1, 9751-2 . . . 9751-p may include a DHCP server, such as DHCP servers 9753-1, 9753-2, . . . 9′753-p. A DHCP server may provide IP addresses for its corresponding subnet, such as subnet 9750-1, 9750-2 . . . 9750-p.

A CGW, for example CGW 9751-1, may include a NIC that may interface with the corresponding subnet, for example 9750-1, using a wired connection, such as Ethernet, or wireless connection, such as WiFi. The subnet 9750-1 may include cellular access points, such as HNB1 thru HNBn1 (e.g., HNB1 indicated by 9752-1), and other wireless access points, such as, WiFi1 thru WiFim1 (e.g., WiFi1 indicated by 9754-1). The subnet 9750-2 may include cellular access points, for example HNB1 thru HNBn2 (e.g., HNB1 indicated by 9752-2), and other wireless access points, such as, WiFi1 thru WiFim2 (e.g., WiFi1 indicated by 9754-2). The subnet 9750-p may include cellular access points, such as HNB1 thru HNBnp (e.g., HNB1 indicated by 9752-p), and other wireless access points, such as WiFi1 thru WiFimp (e.g., WiFi1 indicated by 9754-p).

Two of more the subnets 9750-1 and 9750-2 may be established near, adjacent and/or overlapping each other. For example, a subnet 9750-1 may have a coverage area on one floor of a building and subnet 9750-2 may have an overlapping coverage area. The RATs associated with subnets 9750-1 and 9750-2 may overlap such that a first RAT (e.g., the WiFi 9754-2 of the subnet 9750-2) and the second RAT (e.g., the HNB 9752-1 of the subnet 9750-1) may carry a portion of a message stream of the UE 9760. This may be done, for example, to increase throughput to the UE 9760. The HNB 9752-2 of subnet 9750-2 and the WiFi 9754-2 of subnet 9750-2 may carry a split data stream associated with the UE 9760 by splitting the packets (e.g., packet flows) between the two RATs. Because the packet flows may be split between subnets 9750-1 and 9750-2, the CGW 9751-2 (e.g., the CGW with the LMA 9759) may coordinate with the APs (HNBs 9752-1, 9752-2 . . . 9752-p and WiFi APs 9754-1, 9754-2 . . . 9′754-p) via their MAGs to perform operations, such as UE discovery, flow regulation, or the like for subnets 9750-1, 9750-2 . . . 9′750-p.

Although FIG. 97 may depict LMA 9759 within CGW 9751-2, the LMA may be a separate entity or apparatus or part of any other network apparatus.

Incoming data, such as incoming data and/or data flows from the MCN 9710 to the UE 9760, may be directed to the LMA 9759. The LMA 9759 may segregate the data flows and may redirect the data and/or the data flows to any of the MAGs, such as MAGS 9762-1, 9762-p, 9764-1 and/or 9762-p. The LMA 9759 may send the data locally to any of the MAGs, such as MAGs 9762-2 and/or 9764-2, in subnet 9750-2. This may be performed, for example, based on) rules, such as internal or received rules. For example, the data or data flows may be redirected to the MAG 9762-1 for the HNB interface 9752-1 and the MAG 9764-2 for the WiFi AP 9754-2, and may be sent over respective PMIP tunnels 9755 and 9757. By way of example, the MAG 9762-1 may de-encapsulate the tunnel encapsulated data or data flow at the HNB 9752-1 and may forward the de-encapsulated data to the UE 9760 and/or the MAG 9764-2 may de-encapsulate the tunnel encapsulated data or data flow at the WiFi 9754-2 and may forward the de-encapsulated data to the UE 9760.

Outgoing data sent from the UE 9760 may go through the serving MAG (e.g., the MAG 9764-2 for the WiFi data or data flow and the MAG 9762-1 for the HNB data or data flow). The respective MAG 9762-1 and/or 9764-2 may send the data or data flow through the respective PMIP tunnel 9755 and/or 9757 to the CGW-LMA 9759 (e.g., in encapsulated form). The LMA 9759 may de-encapsulate the tunnel encapsulated data or data flow, may aggregate it and may send it to the Internet.

Each access point configured with the MAG functionality may implement PMIP protocol and may send proxy binding updates (PBU) to the LMA 9759 on behalf of the UE 9760. Each MAG 9762-1 . . . 9762-P and 9764-1 . . . 9764-P may maintain binding tables. The sending of the PBU may be triggered e.g. when the UE 9760 accesses the network, when the UE 9760 may be successfully authenticated (e.g., over the WiFi) and/or when a PDP context maybe successfully activated over 3G. The CGW 9751-2 may be configured with LMA functionality and may keep track of UEs' registrations in a local binding table. The DHCP functionality within the LMA 9759 may be used to allocate the HoA to the UE 9760, for example, when connecting via WiFi.

Different IP addresses may be assigned to the different interfaces, e.g. WiFi and 3G. The internal communications between the MAG and LMA may be modified to be more efficient. For example, function calls may be used instead of messaging and PMIP encapsulation may be avoided.

By placing the MAG functionality in the access point it may be possible to reduce or eliminate certain CGWs (e.g., CGWs that may not include the LMA functionality). Signaling between the MAG and CGW-LMA may be the same or similar to those in FIGS. 90 and 91.

The LMA role may be pre-determined and may be configured within one of the CGW. The access points (APs) may be configured with MAG functionality such that the MAGs may forward the traffic to the LMA and the UEs may be served by the same LMA, as an anchor point for the subnets.

Data may be tunneled through the LMA's subnet even if the UE maybe outside of the LMA's subnet. By providing the MAG functionality within the APs, PMIP protocol may be used in any number of different communication architectures.

Existing WiFi APs and HNBs may be updated with MAG functionality via the communication network or otherwise. PMIP registration may be updated when inter-HNB handover (HO) may be done (e.g., during or after HO). Inter-WiFi AP HO operations may be provided to enable (or update) PMIP registration (e.g., when moving the UE to another WiFi AP interface).

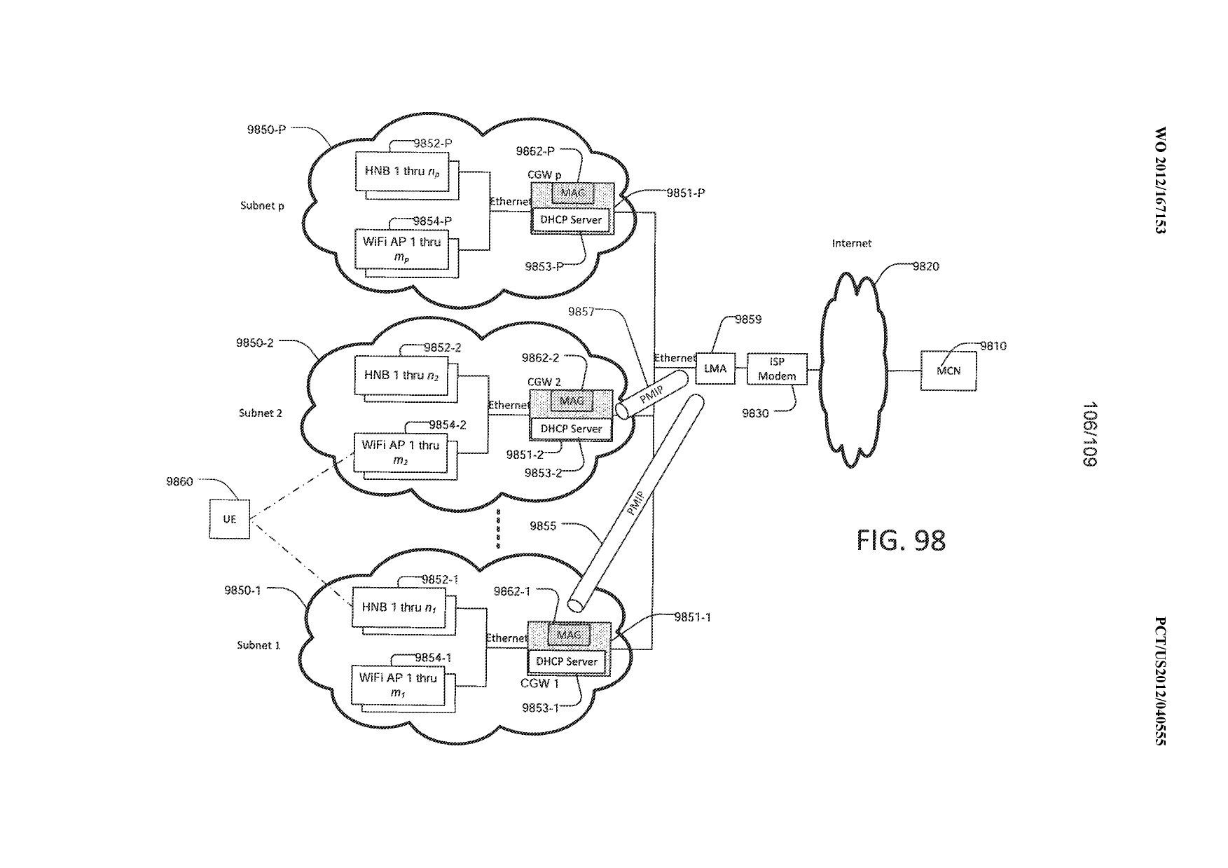

FIG. 98 depicts a communication network that may include a Local Mobility Anchor (LMA) node. Referring to FIG. 98, the network may include the MCN 9810, the Public Internet 9820, the ISP modem 9830, a plurality of CGWs 9851-1, 9851-2 . . . 9851-p, a plurality of corresponding subnets 9850-1, 9850-2 . . . 9850-p and the UE 9860. A CGW, such as CWG 9851-1, 9851-2 . . . 9851-p, may communicate with the MCN 9810 via ISP modem 9830 and the Internet 9820.

A CGW, such as CGW 9851-1, 9851-2 . . . 9851-p, may include a DHCP server, such as DHCP server 9853-1, 9853-2, . . . 9853-p. A DHCP server may provide IP addresses for its corresponding subnet, such as subnet 9850-1, 9850-2 . . . 9850-p, using DHCP.

A CGW, for example CGW 9851-1, may include a NIC that may interface with the corresponding subnet, for example 9850-1, using a wired connection or a wireless connection. The subnet 9850-1 may include cellular access points, such as HNB1 thru HNBn1 (e.g., HNB1 indicated by 9852-1), and other wireless access points, such as WiFi1 thru WiFim1 (e.g., WiFi1 indicated by 9854-1). The subnet 9850-2 may include cellular access points, such as HNB1 thru HNBn2 (e.g., HNB1 indicated by 9852-2), and other wireless access points, such as WiFi1 thru WiFim2 (e.g., WiFi1 indicated by 9854-2). The subnet 9850-p may include cellular access points, such as HNB1 thru HNBnp (e.g., HNB1 indicated by 9852-p), and other wireless access points, such as WiFi1 thru WiFimp (e.g., WiFi1 indicated by 9854-p).

Two or more subnets, such as subnets 9850-1 and 9850-2, may be established near, adjacent and/or overlapping each other. In such a situation, the RATs associated with subnets 9850-1 and 9850-2 may overlap such that a first RAT (e.g., the WiFi 9854-2 of the subnet 9850-2) and the second RAT (e.g., the HNB 9852-1 of the subnet 9850-1) may carry a portion of a data stream of the UE 9860. For example, to increase throughput to the UE 9860, the HNB 9852-1 of subnet 9850-1 and the WiFi 9854-2 of the subnet 9850-2 may carry a split data stream that may be associated with the UE 9860 by splitting the packets (e.g., packet flows) between the two RATs. Because the packet flows may be split between different subnets 9850-1 and 9850-2, the CGWs, such as CGWs 9851-1, 9851-2 . . . 9851-p, may coordinate operations, such as UE discovery, flow regulation, or the like, for subnets 9850-1, 9850-2 . . . 9850-p.

Incoming data, such as incoming data and/or data flows from the MCN 9810 to the UE 9860, may be directed to the LMA node 9859. The LMA node 9859 may segregate the data flows and may redirect the data and/or the data flows to MAGs 9862-1, 9862-2 . . . 9862-p based on rules. For example, the data or data flows may be redirected to the MAG 9862-1 for the HNB interface 9852-1 and MAG 9862-2 for the WiFi AP 9854-2, and may be sent over respective PMIP tunnels 9855 and 9857 using encapsulation/de-encapsulation techniques.

Outgoing data sent from the UE 9860 may go through the serving MAG (e.g., the MAG 9862-2 for the WiFi data or data flow and the MAG 9862-1 for the HNB data or data flow). The respective MAG 9862-1 and/or 9862-2 may send the data or data flow through the respective PMIP tunnel 9855 and/or 9857 to the LMA node 9859. The LMA 9859 may de-encapsulate the data or data flow and may aggregate it (e.g., to rebuild the split message) and may send it to the Internet.

Each CGW configured with the MAG functionality may implement PMIP protocol and may send proxy binding updates (PBU) to the LMA node 9859 on behalf of the UE 9860. MAGs, such as MAG 9862-1 . . . 9862-P may maintain binding tables. The sending of the PBU may be triggered (e.g., when the UE accesses the network and when the UE may be successfully authenticated and/or when a PDP context is successfully activated over 3G). The DHCP functionality associated with the LMA node 9859 may be used to allocate the HoA to the UE 9860, for example, when connecting via WiFi.

By placing the LMA functionality as a separate node it may be possible to reduce the functions residing in the CGWs. The LMA node may act as an anchor point and may direct the data or data flows to one or more CGWs for the flow mobility, aggregation, and/or segregation operations. Signaling between the MAG and LMA node may be the same or similar to those in FIGS. 90 and 91.

The LMA role may be pre-determined and may be configured on a new node outside of the subnets. The CGWs may be configured with MAG functionality such that the MAGs may forward traffic to the LMA node and the UEs may be served by the same LMA, which may be an anchor point for the subnets. With the LMA node, the traffic from one subnet may not have to transit via a subnet of the LMA, because the traffic may directly go to the LMA node outside of the subnets.

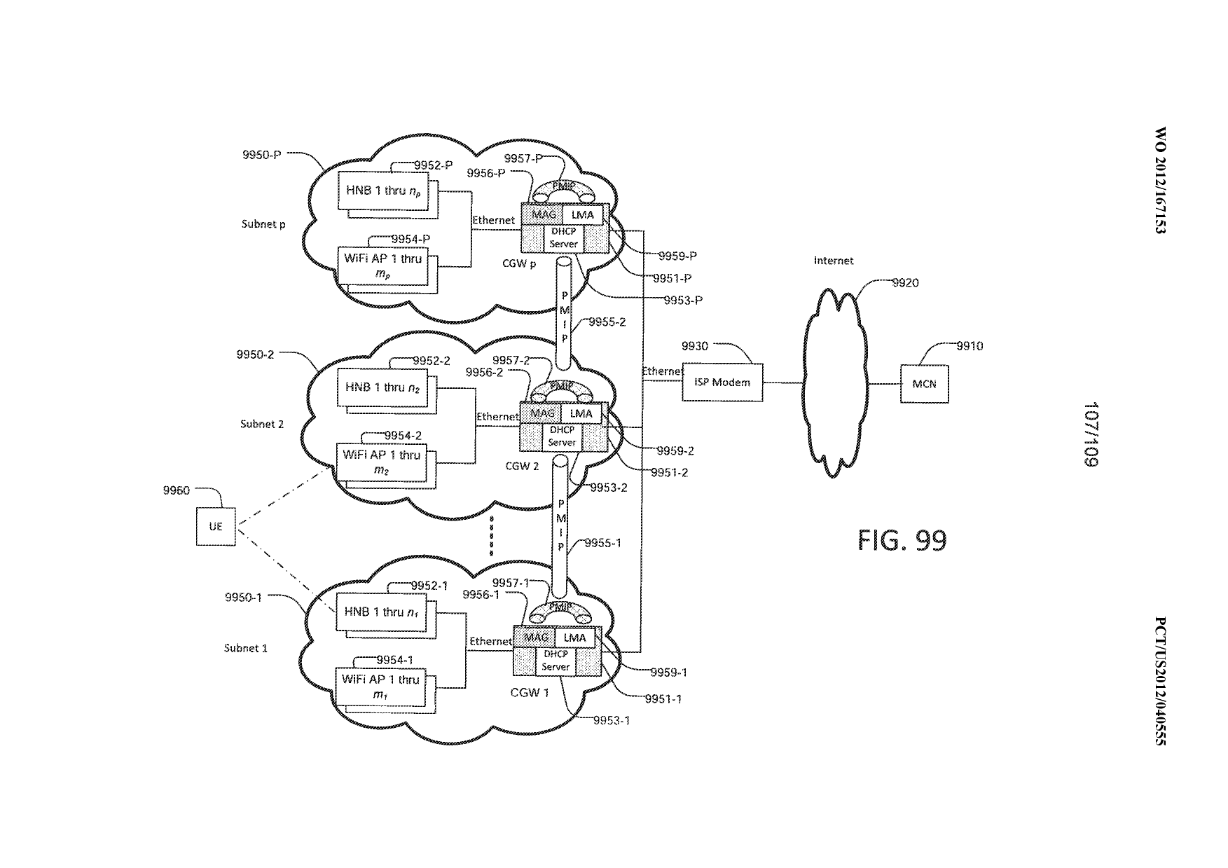

FIG. 99 depicts a communication network that may include one or more LMAs. As shown in FIG. 99, a network may include a CGW, such as CGW 9951-1, 9951-2 and 9951-P, and may include a MAG, such as MAG 9956-1, 8656-2 and 9956-P, and may include a LMA, such as LMA 9959-1, 9959-2 and 9959-P. In this network topology, the CGWs may use tunneling for UE/LMA discover and CGW flow mobility, aggregation and segregation operations for data splitting, offloading and/or load balancing (e.g., data flow processing/regulation).

Referring to FIG. 99, the network may include the MCN 9910, the Public Internet 9920, the ISP modem 9930, CGWs 9951-1, 9951-2 . . . 9951-p, subnets 9950-1, 9950-2 . . . 9950-p, and the UE 9960. A CGW, such as CWG 9951-1, 9951-2 . . . 9951-p, may communicate with the MCN 9910 via, for example, the ISP modem 9930 and the Internet 9920.

A CGW, such as CGW 9951-1, 9951-2 . . . 9951-p may include a DHCP server, such as DHCP server 9953-1, 9953-2, . . . 9953-p, and a MAG, such as MAGs 9956-1, 9956-2 . . . 9956-p. A DHCP server may provide IP addresses for its corresponding subnet, such as subnet 9950-1, 9950-2 . . . 9950-p, using DHCP.

A CGW, for example CGW 9951-1, may include a NIC that may interface with the corresponding subnet, for example 9950-1, using a wired connection or a wireless connection. The subnet 9950-1 may include cellular access points, such as HNB1 thru HNBn1 (e.g., HNB1 indicated by 9952-1), and other wireless access points, such as WiFi1 thru WiFim1 (e.g., WiFi1 indicated by 9954-1). The Subnet 9950-2 may include cellular access points, such as HNB1 thru HNBn2 (e.g., HNB1 indicated by 9952-2), and other wireless access points, such as WiFi1 thru WiFim2 (e.g., WiFi1 indicated by 9954-2). The Subnet 9950-p may include cellular access points, such as HNB1 thru HNBnp (e.g., HNB1 indicated by 9952-p), and other wireless access points, such as WiFi1 thru WiFimp (e.g., WiFi1 indicated by 9954-p).

The number of HNB and WiFi access points for a subnet may be any number including zero. Other wired access points may be included in subnets 9950-1, 9950-2 . . . 9950-p.

Two of more of the subnets 9950-1 and 9950-2 may be established near, adjacent to and/or overlapping each other. The RATs associated with subnets 9950-1 and 9950-2 may overlap such that a first RAT (e.g., the WiFi 9954-2 of the subnet 9950-2) and the second RAT (e.g., the HNB 9952-1 of the subnet 9950-1) may each carry a portion of a message stream of the UE 9960.

Incoming data (e.g., incoming data and/or data flows) from the MCN 9910 to the UE 9960 may be directed to a selected LMA (e.g., LMA 9959-2). The selected LMA 9959 may redirect the data and/or the data flows to MAGs 9956-1 and/or 9956-p or may send the data locally to the MAG 9956-2 in its own subnet 9950-2 based on rules. The data or data flow redirected to the MAG 9956-1 for the HNB 9952-1 and the MAG 9956-2 for the WiFi AP 9954-2 may be sent over respective PMIP tunnels 9955-1 and 9957-2. For example, the MAG 9956-1 may de-encapsulate the data or data flow and may forward the de-encapsulated data to the UE 9960 via the HNB 9952-1. The MAG 9956-2 may de-encapsulate the data or data flow and may forward the de-encapsulated data to the UE 9960 via the WiFi AP 9954-2.

Outgoing data sent from the UE 9960 may go through the serving CGW-MAG. For example, the MAG 9956-1 for the HNB data or data flow and the MAG 9956-2 for the WiFi data or data flow. The respective MAG 9956-1 and/or 9956-2 may send the data or data flow through the respective PMIP tunnel 9955-1 and/or 9957-2 to the CGW-LMA 9959-2. The LMA 9959-2 may de-encapsulate the data or data flow, may aggregate the data or data flow (e.g., to rebuild the split data) and may send it to the Internet. Within each CWG, a PMIP tunnel 9957-1, 9957-2 . . . 9957-p may or may not be established. When a tunnel may not be established, another internal signaling mechanism may be used to communicate between the LMA and MAG internal to a CWG (e.g., since the MAG-LMA functionalities may be implemented into the same physical node).

A CGW, such as CGW 9951-1, 9951-2 . . . 9951-p, may be configured with an LMA, such as LMA 9959-1, 9959-2 . . . 9959-p, and a MAG, such as MAG 9956-1, 9956-2 . . . 9956-p. This may be done, for example, to provide combined LMA/MAG functionality. This may implement PMIP protocol and/or may send proxy binding updates (PBU) to the selected LMA 9959-2 on behalf of the UE 9960. Each MAG 9956-1, 9956-2 . . . 9956-p may maintain a binding table. The sending of the PBU may be triggered (e.g., when the UE accesses the network, when the UE may be successfully authenticated over WiFi and/or when a PDP context may be successfully activated over 3G, among others).

The LMA may be selected based on the first LMA to register a connection and/or interface with the UE. The selection process may be the same or similar to that of CWG selection operations described herein. The selection of the LMA may be time-based (e.g., the first to register the UE), based on signal quality levels (e.g., SNR, SNI, and/or QoS indicators, or the like), based on load of the LMAs involved, hierarchically based (e.g., the LMA closest to the MCN), or the like.

The CGW where the UE connects may be provided with MAG functionality and a MAG may become an LMA for some UEs. This may depend, for example, on where the UE may first connect and/or where the UE may be pre-assigned to a particular LMA.

Routing functionality (e.g., routing operations) at the entrance of the network for packets that may be destined for the UE may route the packets to the selected LMA (e.g., LMA 9959-2) which may forward the packets to the appropriate MAG (e.g., the MAG 9956-1 for the HNB 9952-1 and the MAG 9956-2 for the WiFi AP 9954-2). The selected LMA 9959-2 may provide IFOM by configuring each CGW-LMA to locally include IFOM or flow adjustment policies.

The LMA discovery mechanism (e.g., including existing mechanisms) may be used for LMA functionality negotiation/discovery.

A first CGW that may be first to connect to a first UE may become the selected LMA for the first UE and a second CGW that may not be first to connect to the first UE may direct data or data flows to or receive data or data flows from the selected LMA for the first UE. The second CGW that may first to connect to a second UE may become the selected LMA for the second UE. This may occur without regard to the assignment of the first LMA to the first UE. When the first UE connects with the second CGW, the second CGW may conduct LMA discovery and may find that the first CGW may be performing as the selected LMA for the first UE. The second CGW may enable MAG functionality for the first UE. Data tunneling between the CGW-LMA and CGW-MAGs may be used including, for example, tunnels 9955-1, 9955-2, 9957-1, 9957-2, and/or 9957-p.

By implementing distributed LMA functionality/nodes, bottlenecks may be avoided at the LMAs (e.g., by distributing the anchor points), the LMA functionality may be scalable and/or IFOM policies on different LMAs may be different (e.g., independent of each other and specific for the subnet involved).

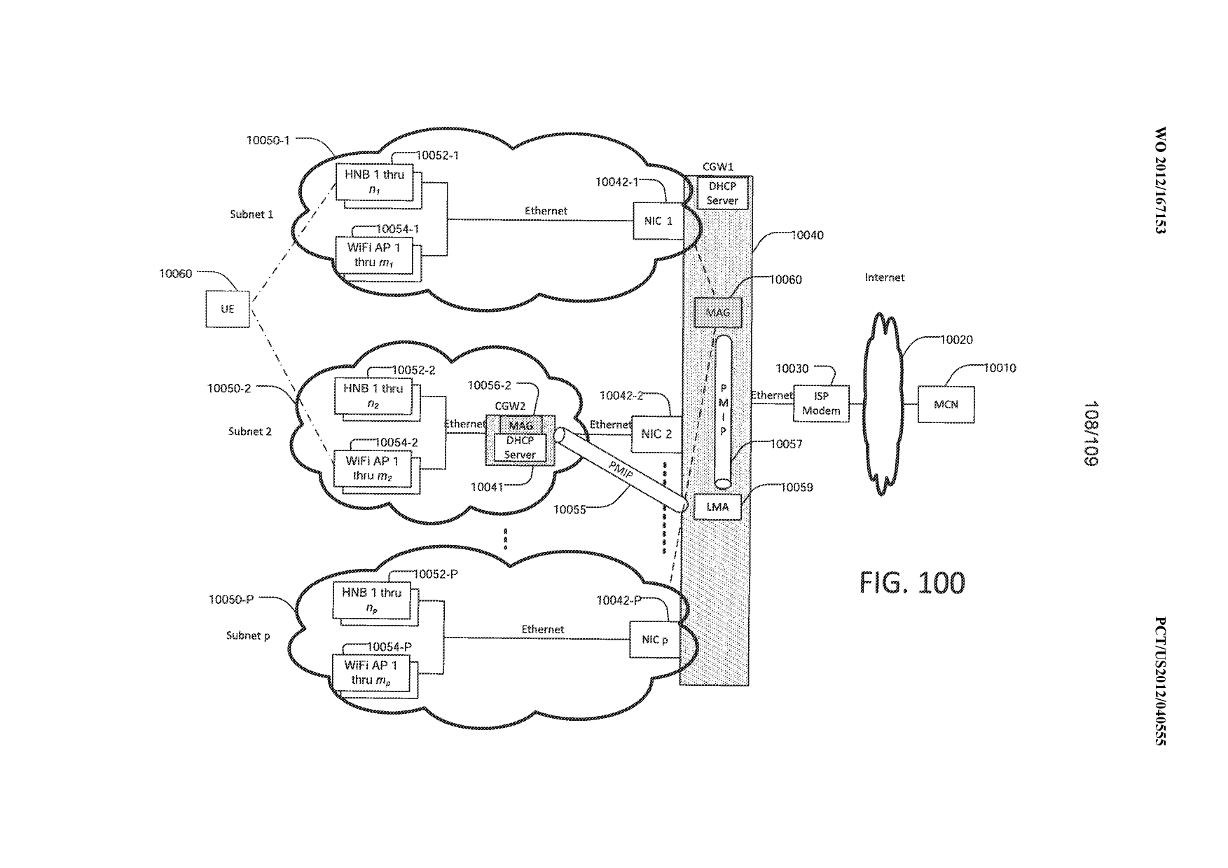

FIG. 100 depicts a communication network that may use an external CGW with a common LMA. As shown in FIG. 100, a network may include a CGW, such as CGW 10040, which may include MAG 10060. MAG 10060 may be associated with subnets 10050-1 and 10050-p that may not have a CGW. CGW 10040 may include a LMA 10059 and PIMP tunnels 10055 and 10057, which may be established for data splitting or offloading.

Referring to FIG. 100, the network may include MCN 10010; the Internet 10020; the ISP modem 10030; CGWs 10040 and 10041; subnets 10050-1, 10050-2 . . . 10050-p; UE 10060; or the like. CWG 10040 may communicate with MCN 10010 via, for example, ISP modem 10030 and Internet 10020. CGW 10041 may communicate with MCN 10010 via CGW 10040, the ISP modem 10030, and the Internet 10020.

A CGW, such as CGW 10040 and 10041 may include a DHCP server. The DHCP server of the CGW 10040 may provide IP addresses for the corresponding subnets 10050-1, 10050-2 . . . 10050-p and the DHCP server of the CGW 10041 may provide IP addresses for the corresponding subnet 10050-2.

Each CGW may include NICs. For example, the CGW 10040 may include NICs 10042-1, 10042-2 and 10042-p that may interface with the corresponding subnets 10050-1, 10050-2, and 10050-p using a wired connection or wireless technologies. Subnet 10050-1 may include cellular access points, such as HNB1 thru HNBn1 (e.g., HNB1 indicated by 10052-1), and other wireless access points, such as WiFi1 thru WiFim1 (e.g., WiFi1 indicated by 10054-1). Subnet 10050-2 may include cellular access points, such as HNB1 thru HNBn2 (e.g., HNB1 indicated by 10052-2), and other wireless access points, such as WiFi1 thru WiFim2 (e.g., WiFi1 indicated by 10054-2). Subnet p 10050-p may include cellular access points, such as HNB1 thru HNBnp (e.g., HNB1 indicated by 10052-p), and other wireless access points, such as WiFi1 thru WiFimp (e.g., WiFi1 indicated by 10054-p).

The CGW 10041 may interface with the CGW 10040 via the NIC 10042-2 and an Ethernet connection in a hierarchical arrangement in which the CGW 10041 may function as a flow regulation (e.g., convergence/segregation) point within the subnet 10050-2 and the CGW 10040 may function as a flow regulation (e.g., convergence/segregation) point within the subnets 10050-1, 10050-2 . . . 10050-p.

The number of HNB and WiFi access points for a subnet may be any number including zero. Other wired access points may be included in subnets 10050-1, 10050-2 . . . 10050-p.

Two or more of the subnets 10050-1 and 10050-2 may be established near, adjacent and/or overlapping each other. In such a situation, the RATs associated with subnets 10050-1 and 10050-2 may overlap such that a first RAT (e.g., the HNB 10052-1 of the subnet 10050-1) and the second RAT (e.g., the WiFi 10054-2 of subnet 10050-2) may carry a portion of the data stream of the UE 10060. Because the packet flows may be split between subnets 10050-1 and 10050-2, the CGWs 10040 and 10041 may coordinate operations, such as UE discovery, flow regulation, or the like for the subnets 10050-1, 10050-2 . . . 10050-p.

FIG. 100 shows that the UE 10060 that may connect to the WiFi AP 10054-2 of subnet 10050-2 and the HNB 10052-1 of subnet 10050-1. The UE 10060 may connect over multiple subnets that may have their own CGW that may coordinate Discovery, communication requests/results between or among, tunneling between CGWs, or the like.

For the hierarchical configuration shown in FIG. 100, CGWs may be a different physical device and at least one CGW may provide flow regulation operations for each subnet.

Discovery methods may be used to support multiple subnets (e.g., to discover UE's connected via multiple subnets). Multiple IP address domains may be used. The DHCP server functionality in the outer CGW (e.g., the external CGW) may be enabled to support those subnets that may not have an internal CGW and any subnets that may have a CGW with the DHCP Server disabled. For those CGWs within specific subnets, the DHCP Server may be enabled or disabled. Each subnet 10050-1, 10050-2 . . . 10050-P may have a DHCP Server configured, regardless on which CGW it may reside.

Different IP addresses may be assigned to the interfaces connecting to different subnets. The PMIP protocol may be modified to support different IP addresses associated to the same UE. The IP address may be assigned to the interfaces such that the DHCP forward functionality may be enabled on the WiFi AP.

Within the context of IPv6 and IP address auto-configuration, the DHCP functionality may or may not be used (e.g., when connecting via a WiFi AP). Router Solicitations/Advertisements may be used for prefix allocation. The prefixes advertised by the CGW-MAG may be allocated from the MCN and may be relayed by the CGW-LMA to the CGW-MAG. Multiple prefixes may be advertised, e.g., one from the MCN and one from the CGW-LMA (e.g., the local prefix). Using a local IP address may enable bypassing the MCN, as appropriate.

A MAG and a LMA may be located within the external CGW. It is contemplated that CGWs (e.g., all CGWs) may be preconfigured with MAG functionality. The LMA role may be pre-determined and/or pre-configured on the external CGW.

By combining the MAG functionality from multiple subnets (e.g., the MAG in the external CGW may handle all subnets that do not have an internal CGW), the number of MAGS and the complexity of communications between the LMA and the MAGs may be reduced.

When a MAG may be combined with the LMA in the external CGW, the PMIP may be enhanced to provide for a common MAG associated with multiple subnets. For example, the PMIP protocol and/or MAG may include a subnet or interface identifier in addition to or in lieu of a MAG identifier. For example, the MAG functionality within the external CGW may use enhanced PMIP because a MAG may have to handle multiple registrations for the same UE from different interfaces (or subnets) simultaneously (e.g. the UE may connect via HNB and via WiFi on two different subnets that do may not have an internal CGW/MAG).

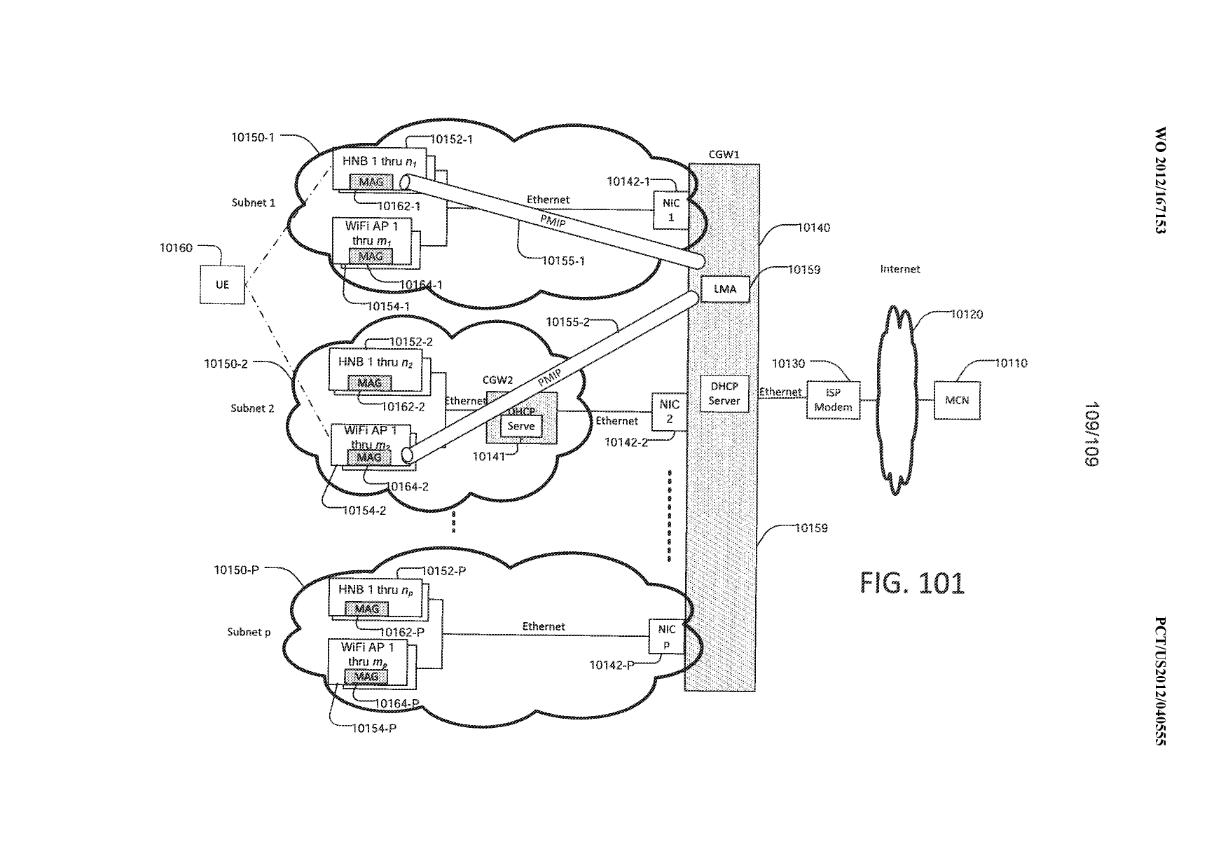

FIG. 101 depicts a communication network with APs that may include MAGs and a common LMA. As shown in FIG. 101, a network may have APs that may include MAGs 10162-1, 10162-2 . . . 10162-p. The CGW 10140 may include LMA 10159. PIMP tunnels 10155-1, 10155-2 may be established for message splitting and/or offloading.

Referring to FIG. 101, the network may include the MCN 10110; the Internet 10120; the ISP modem 10130; a plurality of CGWs 10140 and 10141; a plurality of subnets 10150-1, 10150-2 . . . 10150-p; and the UE 10160. The CWG 10140 may communicate with the MCN 10110 via the ISP modem 10130 and the Internet 10120. The CGW 10141 may communicate with the MCN 10110 via, for example, the CGW 10140, the ISP modem 10130, and the Internet 10120.

A CGW, SUCH AS CGW 10140 and 10141 may include a DHCP server. The DHCP server of the CGW 10140 may provide IP addresses for the corresponding subnets 10150-1, 10150-2 . . . 10150-p. The DHCP server of the CGW 10141 may provide IP addresses for the corresponding subnet 10150-2.

A CGW may include NICs. For example, the CGW 10140 may include NICs 10142-1, 10142-2 and 10142-p that name interface with the corresponding subnets 10150-1, 10150-2 and 10150-p using a wired connection or wireless connection. The subnet 10150-1 may include cellular access points, such as HNB1 thru HNBn1 (e.g., HNB1 indicated by 10152-1), and other wireless access points, such as WiFi1 thru WiFim1 (e.g., WiFi1 indicated by 10154-1). Subnet 10150-2 may include cellular access points, such as HNB1 thru HNBn2 (e.g., HNB1 indicated by 10152-2), and other wireless access points, such as WiFi1 thru WiFim2 (e.g., WiFi1 indicated by 10154-2). Subnet p 10150-p may include cellular access points, such as HNB1 thru HNBnp (e.g., HNB1 indicated by 10152-p), and other wireless access points, such as WiFi1 thru WiFimp (e.g., WiFi1 indicated by 10154-p).

The CGW 10141 may interface with the CGW 10140 via the NIC 10142-2 and an Ethernet connection in a hierarchical arrangement in which the CGW 10141 may function as a flow regulation (e.g., convergence/segregation) point within the subnet 10150-2 and the CGW 10140 may function as a flow regulation (e.g., convergence/segregation) point within the subnets 10150-1, 10150-2 . . . 10150-p.

The number of HNB and WiFi access points for a subnet may be any number including zero. Other wired access points may be included in subnets 10150-1, 10150-2 . . . 10150-p.

Two or more of the subnets (e.g., subnets 10150-1 and 10150-2) may be established near, adjacent to and/or overlapping each other. In such a situation, the RATs associated with different subnets 10150-1 and 10150-2 may overlap such that a first RAT (e.g., the HNB 10152-1 of the subnet 10150-1) and the second RAT (e.g., the WiFi 10154-2 of Subnet 10150-2) may carry a portion of the data stream of the UE 10160. Because the packet flows may be split between different subnets 10150-1 and 10150-2, the CGWs 10140 and APs 10162-1, 10162-2, 10162-P, 10164-1, 10164-2 and/or 10164-P may coordinate certain operations (e.g., UE discovery and/or flow regulation) for the subnets 10150-1, 10150-2 . . . 10150-p.

FIG. 101 shows the UE 10160 that may connect to a WiFi AP 10154-2 of one subnet 10150-2 and a HNB 10152-1 of another subnet 10150-1. The UE 10160 may connect over multiple subnets, each with their own CGW that may coordinate UE Discovery, communications requests/results between or among CGWs, tunneling between CGWs, or the like.

A MAG may be located within an AP (e.g., APs may be configured with MAG functionality) and the LMA may be located at the external CGW. The APs may be preconfigured with MAG functionality. The LMA role may be pre-determined and/or pre-configured on the external CGW (e.g., closest to the MCN).

CGWs in the subnets (e.g., internal CGWs) may not have PMIP functionality. By including MAG in the APs, a UE may connect to a subnet with a local CGW or without a local CGW.

WiFi APs and HNBs may be updated with MAG functionality. PMIP registration may be updated when inter-HNB HO may be done and inter-WiFi AP HO operations may be set up to update PMIP registration when UEs move between WiFi interfaces.

The UE Discovery mechanism may relate to the discovery by the CGWs that a user device may be reachable by two different RAN interfaces (e.g., both WiFi and cellular). This may be done, for example, by the CGW-LMA by looking at the internal binding table, which may include all the UE's registration. A UE that may have registered via HNB and via WiFi may have 2 entries in the LMA's binding table. No specific mechanism/exchange of data may be needed to do UE discovery when PMIP tunneling may be used.

IFOM policies may be configured on one or more CGWs and may be applied by the CGW based on LIF or a re-routing feature implementation on the UE. The re-routing feature may be manipulating a routing table so that a specific outgoing interface may be forced. This re-routing feature may not present itself as a new interface though (e.g., as compared to the LIF).

BWA may use a MNTP client on the terminal or UE and a MNTP server in the CGW. The CGW handling the 3G connection may also handle the MNTP server functionality.

A converged gateway (CGW) may be used for discovering a wireless transmit/receive unit (WTRU) in a communication network. The CGW may comprise a memory and a processor. The processor may be configured to identify a WTRU that may be in communication with a network node belonging to a first subnet. The processor may be configured to store the identity of the WTRU in the memory. The processor may be configured to transmit the identity of the WTRU to another CGW that is in communication with a second subnet. The processor may be configured to provide a MAG and a LMA. A PMIP tunnel may be established to another CGW and the identity of the WTRU may be transmitted to the other CGW using PMIP. For example, proxy binding updates may be transmitted to a LMA that is located within the other CGW.

A CGW may be used for discovering a WTRU in a communication network. The CGW may comprise a memory and a processor. The processor may be configured to identify a first connection that may allow a WTRU to communicate with a first subnet. The processor may be configured to identify a second connection that may allow the WTRU to communicate with a second subnet. The processor may be configured to associate the identity of the WTRU with the first connection and the second connection such that the CGW may be able to transmit data to the WTRU using the first connection or the second connection. The processor may be configured to provide a first MAG for the first subnet and may be configured to provide a second MAG for the second subnet. The processor may also be configured to provide a LMA and may be able to establish a PMIP tunnel to another CGW. The identity of the WTRU may be transmitted to the other CGW using PMIP.

Dynamic mobility management may be provided for the UE by allowing a converged gateway (CGW) to discover the UE. For example, the CGW may identify the UE in communication a first CGW that may be within a first subnet. The CGW may store the identity of the WTRU in the memory. The CGW may transmit the identity of the UE to a second CGW that may be in communication with a second subnet. A LMA may be provided. A first PMIP tunnel may be established to the first CGW. A second PMIP tunnel may be established to the second CGW. The identity of the WTRU may be transmitted to the second CGW via the second PMIP tunnel. Proxy binding updates may be received. Data from a first MAG the may be within the first CGW may be received.

Dynamic mobility management may be provided by discovering a WTRU in a network. A WTRU may be identified in communication with a first subnet. The identity of the WTRU may be stored. The identity of the WTRU may be transmitted to a first CGW that may be in communication with a second subnet. The first LMA may be provided. A first MAG may be provided. A first PMIP tunnel may be established to the first CGW. A second PMIP tunnel may be established to the second CGW. The second CGW may be in communication with a third subnet. The identity of the WTRU may be transmitted to the first CGW using the first PMIP tunnel. The identity of the WTRU may be transmitted to the second CGW using the second PMIP tunnel. Data may be received from a second MAG that may be within the first CGW. Data may be received from a third MAG that may be within the second CGW.

Embodiments of the disclosure may be directed to methods, devices, and systems for managing UE flow discovery associated with a plurality of flows of split messages served by a plurality of flow regulating devices on a network. A method may include a first flow regulating device. The first flow regulating device may receive, via a first radio access technology (RAT) interface, registration information indicating that the UE that may be by the first RAT interface. The first flow regulating device may receive, via a second RAT interface, further registration information indicating that the UE may be served by the second RAT interface. The first flow regulating device may store binding information from the information that may be received from the first and second RAT interfaces that may indicate the UE may be simultaneously being served by the first and second RAT interfaces. The first flow regulating device may receive at least one data flow from the first RAT interface, as a first RAT flow, and at least one further data flow from the second RAT interface, as a second RAT flow. The first flow regulating device may control aggregation of the first and second RAT flows.

The storing of the binding information may include associating, by the first flow regulating device, the first RAT interface and the second RAT interface using a unique identifier of the UE.

The first flow regulating device may determine (e.g., without user intervention) whether the UE may be authenticated using a pre-established identifier of the UE.

The associating of the first and second RAT interfaces may occur responsive to the determination that the UE may be authenticated and may use the pre-established identifier, as the unique identifier of the UE.

The first RAT interface may include a first mobility access gateway (MAG) and the second RAT interface may include a second MAG such that a first IP tunnel may be established between the first MAG and the first flow regulating device and a second IP tunnel may be established between the second MAG and the first flow regulating device.

The receiving of the first RAT flow may include obtaining the first RAT flow from the established first IP tunnel. The receiving of the second RAT flow may include obtaining the second RAT flow from the established second IP tunnel.

The flow regulating devices may include a respective mobility access gateway (MAG) and the first flow regulating device may include a mobility anchor (MA) such that a plurality of IP tunnels may be established between each respective MAG of the plurality of flow regulating devices and the MA of the first flow regulating device.

The receiving of the first RAT flow may include obtaining the first RAT flow from the established IP tunnel associated with the first RAT interface; and the receiving of the second RAT flow may include obtaining the second RAT flow from the established IP tunnel associated with the second RAT interface.

The first flow regulating device may send to the MAG associated with the first RAT flow, a flow adjustment message that may indicate that at least one data flow associated with the second RAT flow, as the adjusted flow, having been served by the second RAT interface may be served by the first RAT interface; and may receive the adjusted flow via the first RAT interface and the MAG associated with the first RAT flow.

The plurality of flow regulating devices may include the first flow regulating device and at least one further flow regulating device in a hierarchical arrangement.

The further flow regulating devices may include a respective mobility access gateway (MAG) and the first flow regulating device may include a mobility anchor (MA) such that the first flow regulating device may include a MAG for each respective subnet not associated with one of the further flow regulating devices.

The receiving of the first RAT flow may include obtaining the first RAT flow via a first MAG of one of the further flow regulating devices and the receiving of the second RAT flow may include obtaining the second RAT flow via a second MAG of the first flow regulating device.

The first flow regulating device may include a common MAG serving respective subnets that may not be associated with one of the further flow regulating devices such that the receiving of the first RAT flow may include obtaining the first RAT flow via a first MAG of one of the further flow regulating devices and the receiving of the second RAT flow may include obtaining the second RAT flow via the common MAG of the first flow regulating device.

Another representative method may include a first flow regulating device: (1) receiving, via a first radio access technology (RAT) interface, information indicating that the UE is being served by the first RAT interface; (2) receiving via a second RAT interface, information indicating that the UE is being served by the second RAT interface; (3) storing binding information from the information received from the first and second RAT interfaces that indicates the UE is simultaneously being served by the first and second RAT interfaces; (4) receiving a message including a plurality of data flows that are destined for the UE; (5) determining using a flow table, which one or ones of the data flows are to be served by the first RAT interface, as a first RAT flow, and which one or ones of the data flows are to be served by the second RAT interface, as a second RAT flow; and (6) controlling segregation and routing of the first RAT flow to the first RAT interface and the second RAT flow to the second RAT interface.

The first flow regulating device may send the first RAT flow to the established first IP tunnel associated with the first RAT interface and the second RAT flow to the established second IP tunnel associated with the second RAT interface.

The first flow regulating device may send to the MAG associated with the first RAT flow a flow adjustment message that may indicate that at least one data flow associated with the second RAT flow, as the adjusted flow, having been served by the second RAT interface may be served by the first RAT interface and may send the adjusted flow via the first RAT interface and the MAG associated with the first RAT flow to the UE.

The routing of the first RAT flow may include sending the first RAT flow via a first MAG of one of the further flow regulating devices and the routing of the second RAT flow may include sending the second RAT flow via a second MAG of the first flow regulating device.

The routing of the first RAT flow may include sending the first RAT flow via a first MAG of one of the further flow regulating devices and the routing of the second RAT flow may include sending the second RAT flow via the common MAG of the first flow regulating device.

An apparatus may be configured to manage user equipment (UE) flow discovery associated with a plurality of flows of split messages and may include a transmitter/receiver unit configured to receive, via a first radio access technology (RAT) interface, registration information that may indicate that the UE may be served by the first RAT interface. The transmitter/receiver unit may receive, via a second RAT interface, further registration information that may indicate that the UE may be served by the second RAT interface. The transmitter/receiver unit may receive at least one data flow from the first RAT interface, as a first RAT flow, and at least one further data flow from the second RAT interface, as a second RAT flow. A memory may be configured to store binding information from the information received from the first and second RAT interfaces that may indicate that the UE may be simultaneously served by the first and second RAT interfaces. A processor may be configured to control aggregation of the first and second RAT flows.

An apparatus may include a transmitter/receiver unit that may be configured receive, via a first radio access technology (RAT) interface, information that may indicate that the UE may be served by the first RAT interface. The transmitter/receiver unit may receive, via a second RAT interface, information that may indicate that the UE may be served by the second RAT interface. The transmitter/receiver unit may receive a message that may include a plurality of data flows that may be destined for the UE. A memory may be configured to store binding information from the information that may be received from the first and second RATs that may indicate the UE may be simultaneously served by the first and second RAT interfaces. A processor may be configured to use a flow table to determine which one or ones of the data flows may be served by the first RAT interface, as a first RAT flow, and which one or ones of the data flows may be served by the second RAT interface, as a second RAT flow. The processor may be configured to control segregation and routing of the first RAT flow to the first RAT interface and the second RAT flow to the second RAT interface.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.)

1.-38. (canceled)

39. An apparatus for discovering a wireless transmit/receive unit (WTRU) in a network comprising:
a processor, the processor being configured to:
identify a WTRU in communication with a network node belonging to a first subnet;
establish a data tunnel to a second apparatus in a second subnet, the apparatus being able to communicate with the WTRU using a radio access technology within the second subnet; and
send an identity of the WTRU to the apparatus in the second subnet.

40. The apparatus of claim 39, wherein the second apparatus is a converged gateway (CGW).

41. The apparatus of claim 39, wherein the processor is further configured to provide a mobile access gateway.

42. The apparatus of claim 41, wherein the processor is further configured to provide a local mobility anchor (LMA).

43. The apparatus of claim 40, wherein the processor is configured to establish the data tunnel to the CGW by establishing a proxy mobile internet protocol (PMIP) tunnel to the CGW.

44. The apparatus of claim 43, wherein the processor is configured to send the identity of the WTRU to the CGW via the PMIP tunnel.

45. The apparatus of claim 41, wherein the processor is further configured to send a proxy binding update to a local mobility anchor (LMA) for the WTRU.

46. The apparatus of claim 45, wherein the CGW includes the LMA.

47. The apparatus of claim 42, wherein the processor is further configured to receive a proxy binding update via the LMA.

48. The apparatus of claim 43, wherein the processor is further configured to receive encapsulated data via the PMIP tunnel.

49. An apparatus for discovering a wireless transmit/receive unit (WTRU) in a network, the apparatus comprising:
a processor, the processor being configured to:
identify a first connection between a WTRU and a first subnet;
identify a second connection between the WTRU and a second subnet;
establish a data tunnel to a second apparatus, the second apparatus being able to utilize a plurality of radio access technologies within the second subnet; and
associate an identity of the WTRU with the first connection and the second connection such that data can be sent to the WTRU using the first connection or the second connection.

50. The apparatus of claim 49, wherein the second apparatus is a converged gateway (CGW).

51. The apparatus of claim 50, wherein the processor is further configured to provide a mobile access gateway (MAG) for the first subnet.

52. The apparatus of claim 51, wherein the processor is further configured to provide a MAG for the second subnet.

53. The apparatus of claim 52, wherein the processor is further configured to provide a local mobility anchor (LMA).

54. The apparatus of claim 53, wherein the data tunnel is a proxy mobile internet protocol (PMIP) tunnel.

55. The apparatus of claim 53, wherein the processor is further configured to send the identity of the WTRU to the CGW via the PMIP tunnel.

56. The apparatus of claim 53, wherein the processor is further configured to receive a proxy binding update via the LMA.

57. The apparatus of claim 53, wherein the processor is further configured to receive encapsulated data via the data tunnel.

58. A method for providing dynamic mobility management by discovering a wireless transmit/receive unit (WTRU) in a network comprising:
identifying a WTRU in communication with a node belonging to a first subnet;
establishing a data tunnel to an apparatus via a local mobility anchor (LMA), the apparatus being able to communicate with the WTRU using a radio access technology within a second subnet; and
sending an identity of the WTRU to the apparatus via the data tunnel.

59. The method of claim 58, wherein the apparatus is a converged gateway (CGW).

60. The method of claim 58, wherein establishing the data tunnel to the apparatus via the LMA comprises establishing a first data tunnel to the LMA and requesting the LMA to establish a second tunnel to the apparatus.

61. The method of claim 60, wherein the first data tunnel is a proxy mobile internet protocol (PMIP) tunnel.

62. The method of claim 61, further comprising receiving a proxy binding update.

63. The method of claim 61, further comprising receiving data from a first mobile access gateway (MAG) within the apparatus via the LMA.

64. A method for providing dynamic mobility management by discovering a wireless transmit/receive unit (WTRU) in a network, the method comprising:
identifying a WTRU in communication with a first subnet;
establishing a data tunnel to a second apparatus in a second subnet, the apparatus being able to communicate with the WTRU using a radio access technology within the second subnet; and
sending an identity of the WTRU to the apparatus.

65. The method of claim 64, wherein the apparatus is a converged gateway (CGW).

66. The method of claim 64, further comprising providing a first local mobility anchor (LMA).

67. The method of claim 66, further comprising providing a first mobility access gateway (MAG).

68. The method of claim 65, wherein establishing the data tunnel to the CGW comprises establishing a first proxy mobile internet protocol (PMIP) tunnel to the CGW.

69. The method of claim 68, wherein the CGW is a first CGW and the method further comprises establishing a second PMIP tunnel to a second CGW.

70. The method of claim 69, wherein the second CGW is in communication with a third subnet.

71. The method of claim 69, wherein sending the identity of the WTRU to the apparatus comprises sending the identity of the WTRU to the first CGW using the first PMIP tunnel.

72. The method of claim 70, further comprising sending the identity of the WTRU to the second CGW using the second PMIP tunnel.

73. The method of claim 67, further comprising receiving data from a second mobile access gateway (MAG) that is within the first CGW.

74. The method of claim 69, wherein the second CGW includes a MAG and the method further comprises receiving data from the MAG.

75. A method for managing data flow for a wireless transmit/receive unit (WTRU) in a communication network, the method comprising:
identifying a first radio access technology (RAT) linkage in a first subnet for a WTRU;
sending a request message including an identifier of the WTRU to a converged gateway (CGW) for connecting radio access technologies within a second subnet;
receiving an acknowledgement message from the CGW identifying a second RAT linkage for the WTRU; and
storing serving information indicating that the WTRU is able to receive data via the first RAT linkage or via the second RAT linkage.

76. The method of claim 75, wherein sending the request message comprises sending the request message via a domain naming service.

77. The method of claim 75, wherein sending the request message comprises broadcasting the request message on a network.
